(19) United States
(12) Patent Application Publication
(10) Pub. No.: US 2026/0246308 A1
(43) Pub. Date: Aug. 20, 2026

(54) MULTI-USE WIRELESS CHARGING APPARATUSES AND METHODS

(71) Applicant: TOYOTA MOTOR ENGINEERING & MANUFACTURING NORTH AMERICA, INC., PLANO, TX (US)

(72) Inventors: YANGHE LIU, Ann Arbor, MI (US); MASANORI ISHIGAKI, Ann Arbor, MI (US); ERIN J. RUTLEDGE, Tipton, MI (US); JAIME N. MOORE, Ann Arbor, MI (US); PHOUVADOL P. KHOUPHONGSY, Saline, MI (US); ERCAN M. DEDE, Ann Arbor, MI (US); MICHAEL P. ROWE, Pinckney, MI (US); FREDERICK W. MAU, McKinney, TX (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 19/447,598

(22) Filed: Jan. 13, 2026

Related U.S. Application Data
(63) Continuation-in-part of application No. 19/229,550, filed on Jun. 5, 2025.
Application No. 19/229,550 is a continuation-in-part of application No. 18/478,929, filed on Sep. 29, 2023.
Application No. 18/478,929 is a continuation-in-part of application No. 18/949,656, filed on Nov. 15, 2024, now abandoned.
Application No. 18/949,656 is a continuation-in-part of application No. 18/771,653, filed on Jul. 12, 2024, now abandoned.

(51) Int. Cl. H02J 50/50; H01F 27/28; H01F 27/29; H01F 41/04; H02J 50/00; H02J 50/12

(52) U.S. Cl. CPC H02J 50/502; H01F 27/2804; H01F 27/29; H01F 41/041; H02J 50/005; H02J 50/12

(57) ABSTRACT

Apparatuses and methods are provided for multi-use wireless charging. An example multi-use wireless charging apparatus may comprise: (1) a body configured to be used for one or more purposes other than wireless charging; and (2) one or more coil repeater assemblies attached to the body. The one or more coil repeater assemblies may be configured to increase inductive flux linkage between an active power supply located proximate the body and receiving inductive coils of one or more devices placed proximate the body.

### CROSS-REFERENCE TO RELATED APPLICATIONS

The present application is a continuation-in-part of and claims the benefit of priority to U.S. patent application Ser. No. 19/229,550 filed on Jun. 5, 2025, which is a continuation-in-part of and claims the benefit of priority to: (1) U.S. patent application Ser. No. 18/478,929 filed on Sep. 29, 2023; and (2) U.S. patent application Ser. No. 18/949,656 filed on Nov. 15, 2024, which is a continuation-in-part of and claims the benefit of priority to U.S. patent application Ser. No. 18/771,653 filed on Jul. 12, 2024, which are incorporated herein by reference in their entirety.

### TECHNICAL FIELD

The present disclosure relates generally to electromagnetic coils, and, more particularly, some embodiments relate to electromagnetic coils for wireless charging.

### DESCRIPTION OF RELATED ART

Electromagnetic coils are used in a wide variety of electrical applications in connection with the inductive transfer of power. For example, different forms of electrical coils are used in transformers, inductive power couplings and motors. Conventionally, electrical coils have been formed by wrapping a strand of wire into one or more loops.

The “skin effect,” e.g., distribution of alternating current (AC) within a conductor near within a conductor so that the current density near the surface of the conductor is greater than at its core, causes the effective resistance of a conductor to increase with the frequency of the AC current. Litz wire has been used to reduce the skin effect, particularly in high frequency applications. Litz wire is a type that includes many thin wires, individually coated with an insulating film, and twisted together.

### BRIEF SUMMARY OF THE DISCLOSURE

According to various embodiments of the disclosed technology, a multi-use wireless charging apparatus is provided. The multi-use wireless charging apparatus may comprise: (1) a body configured to be used for one or more purposes other than wireless charging; and (2) one or more coil repeater assemblies attached to the body. The one or more coil repeater assemblies may be configured to increase inductive flux linkage between an active power supply located proximate the body and receiving inductive coils of one or more devices placed proximate the body.

In some embodiments of the multi-use wireless charging apparatus, the one or more coil repeater assemblies may comprise an inductive coil disposed on a surface of the body. In certain of such embodiments, the inductive coil may comprise a conductive ink that is ink-printed onto the surface of the body. In some embodiments, the inductive coil may comprise a conductive material that is 3D-printed onto the surface of the body.

In certain embodiments of the multi-use wireless charging apparatus, the one or more coil repeater assemblies may comprise: (a) a substrate comprising an adhesive disposed on a first surface of the substrate, wherein the substrate is attached to a surface of the body via the adhesive; (b) an inductive coil disposed on a second surface of the substrate or embedded within the substrate; and (c) one or more tuning capacitors disposed on the second surface of the substrate or embedded within the substrate, wherein the one or more tuning capacitors are electrically connected to each end of the inductive coil.

In various embodiments of the multi-use wireless charging apparatus, the one or more coil repeater assemblies may comprise an inductive coil embedded within the body. In some of such embodiments, the body may comprise a flexible fabric and the one or more coil repeater assemblies may comprise: (i) a substrate stitched into the flexible fabric of the body; (ii) an inductive coil disposed on a surface of the substrate or embedded within the substrate; and (iii) one or more tuning capacitors disposed on the surface of the substrate or embedded within the substrate, wherein the one or more tuning capacitors are electrically connected to each end of the inductive coil.

In some embodiments of the multi-use wireless charging apparatus, the one or more coil repeater assemblies may comprise an inductive coil of wider diameter than a transmitting inductive coil of the active power supply.

In certain embodiments of the multi-use wireless charging apparatus, the active power supply may be mechanically integrated with the body.

In various embodiments of the multi-use wireless charging apparatus, the multi-use wireless charging apparatus may further comprise a non-inductive magnetic structure attached to the body and positioned to secure the body to a wireless charging interface of the active power supply. In some of such embodiments, the non-inductive magnetic structure may be positioned to align the one or more coil repeater assemblies with the wireless charging interface of the active power supply when the body is magnetically secured to the wireless charging interface of the active power supply. In some embodiments, the non-inductive magnetic structure may be disposed on an outer surface of the body or embedded within the body.

In some embodiments of the multi-use wireless charging apparatus, an outer surface of the body may comprise a recess dimensioned to snugly accommodate a wireless charging interface of the active power supply when the body is placed upon the wireless charging interface of the active power supply.

In certain embodiments of the multi-use wireless charging apparatus, the body may comprise a cradle dimensioned to receive a first device of the one or more devices. In some of such embodiments, the cradle may comprise a recess in the body dimensioned to snugly accommodate the first device. In some of such embodiments, the cradle may comprise one or more structures extending outwards from a mobile device-facing surface of the body.

In various embodiments of the multi-use wireless charging apparatus, a mobile device-facing surface of the body may comprise a non-slip surface or a gripping surface.

In some embodiments of the multi-use wireless charging apparatus, the multi-use wireless charging apparatus may further comprise a non-inductive magnetic structure attached to the body and positioned to secure the one or more devices to a mobile device-facing surface of the body.

In certain embodiments of the multi-use wireless charging apparatus, the one or more coil repeater assemblies may comprise: (a) an inductive coil comprising turns of a trace bundle; (b) one or more tuning capacitors electrically connected to each end of the inductive coil; and (c) the trace bundle comprising traces formed from trace segments electrically interconnected by interlayer connectors, a respective trace comprising electrically interconnected trace segments across multiple layers.

In various embodiments of the multi-use wireless charging apparatus, the one or more coil repeater assemblies may comprise an inductive coil comprising: (a) a first conductor layer comprising first trace segments; (b) a second conductor layer comprising second trace segments; and (c) an insulating layer disposed between the first and second conductor layers. In some of such embodiments, each trace of the formed traces may comprise a respective subset of the first trace segments electrically interconnected by a subset of the interlayer connectors to a corresponding subset of the second trace segments such that the interconnected trace segments are woven through and around the insulating layer. Relatedly, the traces may be formed as a conductive line woven through and around the insulating layer to form the inductive coil. In some of such embodiments, the interlayer connector may comprise through vias filled with a conductive material.

In some embodiments of the multi-use wireless charging apparatus, the multi-use wireless charging apparatus may comprise a payment card.

In certain embodiments of the multi-use wireless charging apparatus, the multi-use wireless charging apparatus may comprise a mouse pad.

In various embodiments of the multi-use wireless charging apparatus, the multi-use wireless charging apparatus may comprise wireless speakers.

In some embodiments of the multi-use wireless charging apparatus, the multi-use wireless charging apparatus may comprise wireless headphones.

In certain embodiments of the multi-use wireless charging apparatus, the multi-use wireless charging apparatus may comprise an article of clothing.

In some embodiments of the multi-use wireless charging apparatus, the multi-use wireless charging apparatus may comprise a storage container and the body may comprise a container body. Accordingly, the storage container may comprise: (a) the container body; (b) a recess defined by walls of the container body; and (c) the one or more coil repeater assemblies attached to the container body and positioned to increase inductive flux linkage between the active power supply and the receiving inductive coils of the one or more devices when the container body is placed upon the active power supply and the one or more devices are placed within the recess. In some of such implementations, the storage container comprises at least one of: (i) a purse; (ii) a handbag; (iii) a clutch; (iv) a suitcase; (v) a toolbox; (vii) a wallet; (viii) a jewelry tray; or (ix) a valet tray. In certain implementations, the one or more coil repeater assemblies may comprise: (A) a first coil repeater assembly attached to an inner surface of a wall of the container body; and (B) a second coil repeater attached to an outer wall of the container body opposite the first coil repeater assembly.

In certain embodiments of the multi-use wireless charging apparatus, the multi-use wireless charging apparatus may comprise furniture and the body may comprise a furniture body. Accordingly, the furniture may comprise: (a) the furniture body comprising a mobile device-facing surface; and (b) the one or more coil repeater assemblies attached to the furniture body and positioned to increase inductive flux between the active power supply located proximate the furniture body and the receiving inductive coils of the one or more devices placed upon the mobile device-facing surface of the furniture body. In some of such implementations, the furniture body may comprise a drawer and the mobile device-facing surface may comprise an interior surface of the drawer. In some implementations, the furniture body may comprise a desk or table and the mobile device-facing surface may comprise an upwards-facing surface of the desk or table. In certain embodiments, the furniture body may comprise an airplane tray and the mobile device-facing surface may comprise an upwards-facing surface of the airplane tray. In some embodiments, the furniture body may comprise at least one of a chair, a recliner, or a couch. Relatedly, the mobile device-facing surface may comprise an armrest of the at least one of the chair, the recliner, or the couch. In various embodiments, a first coil repeater assembly of the one or more coil repeater assemblies may be disposed on the mobile device-facing surface of the furniture body or embedded within the furniture body adjacent the mobile device-facing surface of the furniture body. In some embodiments, the active power supply may be mechanically integrated with the furniture body. In certain embodiments, the one or more coil repeater assemblies comprise: (i) a substrate comprising an adhesive disposed on a first surface of the substrate, wherein the substrate is attached to the mobile device-facing surface of the furniture body via the adhesive; (ii) an inductive coil disposed on a second surface of the substrate or embedded within the substrate; and (iii) one or more tuning capacitors disposed on the second surface of the substrate or embedded within the substrate, wherein the one or more tuning capacitors are electrically connected to each end of the inductive coil. In various embodiments, the active power supply may comprise a transmitting inductive coil embedded within the furniture body and the one or more coil repeater assemblies may comprise an inductive coil embedded within the furniture body between the transmitting inductive coil and the mobile device-facing surface of the furniture body.

In various embodiments of the presently disclosed technology, an apparatus is provided. The apparatus may comprise: (1) a body dimensioned to fit snugly upon a transmitting wireless charging interface disposed within an interior of a vehicle; and (2) one or more coil repeater assemblies attached to the body. The one or more coil repeater assemblies may be configured to increase inductive flux linkage between the transmitting wireless charging interface and a receiving wireless charging interface of a mobile device placed upon the body.

In some embodiments of the apparatus, the transmitting wireless charging interface may be disposed within a recess of a console of the vehicle. Relatedly, the body may be dimensioned to fit snugly within the recess of the console when the body is placed upon the transmitting wireless charging interface.

In certain embodiments of the apparatus, the transmitting wireless charging interface may comprise a raised wireless charging pad disposed within the interior of the vehicle.

In various embodiments of the apparatus, the one or more coil repeater assemblies may comprise an inductive coil positioned to radially align with the transmitting wireless charging interface when the body is fit snugly upon the transmitting wireless charging interface. In some of such embodiments, the inductive coil may have a wider diameter than an inductive coil associated with the transmitting wireless charging interface.

In some embodiments of the apparatus, the apparatus may further comprise a non-inductive magnetic structure attached to the body and positioned to secure the body to the transmitting wireless charging interface. In certain of such embodiments, the non-inductive magnetic structure may be disposed on a transmitting wireless charging interface-facing surface of the body or embedded within the body.

In certain embodiments of the apparatus, the body may comprise a cradle dimensioned to receive the mobile device. In some of such embodiments, the cradle may comprise a recess in the body dimensioned to snugly accommodate the mobile device. In other embodiments, the cradle may comprise one or more structures extending outwards from the body.

In various embodiments of the apparatus, a mobile device-facing surface of the body may comprise a non-slip surface or a gripping surface.

In some embodiments of the apparatus, the apparatus may further comprise a non-inductive magnetic structure attached to the body and positioned to secure the mobile device to the body.

In certain embodiments of the apparatus, the body may comprise: (i) a first surface for receiving the mobile device; and (ii) a second surface for receiving a second mobile device. Relatedly, the one or more coil repeater assemblies may be positioned to increase inductive flux linkage between the transmitting wireless charging interface and each of the mobile device and the second mobile device when the mobile device and the second mobile device are received on the first and second surfaces of the body respectively.

In various embodiments of the apparatus, the one or more coil repeater assemblies may comprise: (i) an inductive coil comprising turns of a trace bundle; (ii) an inductive coil comprising turns of a trace bundle; and (iii) the trace bundle comprising traces formed from trace segments electrically interconnected by interlayer connectors, a respective trace comprising electrically interconnected trace segments across multiple layers.

In various embodiments of the apparatus, the one or more coil repeater assemblies may comprise an inductive coil comprising: (a) a first conductor layer comprising first trace segments; (b) a second conductor layer comprising second trace segments; and (c) an insulating layer disposed between the first and second conductor layers. In some of such embodiments, each trace of the formed traces may comprise a respective subset of the first trace segments electrically interconnected by a subset of the interlayer connectors to a corresponding subset of the second trace segments such that the interconnected trace segments are woven through and around the insulating layer. Relatedly, the traces may be formed as a conductive line woven through and around the insulating layer to form the inductive coil. In some of such embodiments, the interlayer connector may comprise through vias filled with a conductive material.

In various embodiments of the presently disclosed technology, a method of constructing an apparatus for wireless charging is provided. The method may comprise forming a coil repeater assembly comprising: (a) a substrate; (b) an inductive coil disposed on a surface of the substrate or embedded within the substrate; and (c) one or more tuning capacitors disposed on the surface of the substrate or embedded within the substrate. The method may further comprise attaching the coil repeater assembly to a body of the apparatus.

In some embodiments of the method, the coil repeater assembly may further comprise an adhesive disposed on a second surface of the substrate opposite the first surface. Relatedly, attaching the coil repeater assembly to the body of the apparatus may comprise attaching the coil repeater assembly to the body of the apparatus via the adhesive.

In certain embodiments of the method, the body of the apparatus may comprise a flexible fabric. Relatedly, attaching the coil repeater assembly to the body of the apparatus may comprise stitching the substrate to the body of the apparatus. In some of such embodiments, the body of the apparatus may comprise at least one of: (a) an article of clothing; (b) a wallet; (c) a purse; (d) a handbag; (e) a clutch; and (f) a suitcase.

In various embodiments of the method, attaching the coil repeater assembly to the body of the apparatus may comprise embedding the coil repeater assembly within the body of the apparatus. In some of such embodiments, embedding the coil repeater assembly within the body of the apparatus may comprise: (a) printing the coil repeater assembly onto a temporary construction surface of the body of the apparatus; and (b) adding additional material to the body of the apparatus to cover the coil repeater assembly and the temporary construction surface of the body of the apparatus. In certain embodiments, printing the coil repeater assembly onto the temporary construction surface of the body of the apparatus may comprise using conductive ink to print the coil repeater assembly onto the temporary construction surface of the body of the apparatus. In various embodiments, printing the coil repeater assembly onto the temporary construction surface of the body of the apparatus may comprise 3D printing layers of conductive material to form the coil repeater assembly onto the temporary construction surface of the body of the apparatus.

In some embodiments of the method, attaching the coil repeater assembly to the body of the apparatus may comprise printing the coil repeater assembly onto a surface of the body of the apparatus. In certain of such embodiments, printing the coil repeater assembly onto the surface of the body of the apparatus may comprise using conductive ink to print the coil repeater assembly onto the surface of the body of the apparatus. In various embodiments, printing the coil repeater assembly onto the surface of the body of the apparatus may comprise 3D printing layers of conductive material to form the coil repeater assembly onto the surface of the body of the apparatus.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIGS. 1A-1C are view of an example printed circuit board (PCB) coil in accordance with embodiments of the present disclosure.

FIGS. 2A-2C depict examples of various trace densities in accordance with embodiments disclosed herein.

FIGS. 3A-3C illustrates an example four layer implementation of PCB coil in accordance with an embodiment of the present disclosure.

FIGS. 4A-4C illustrates an example six layer implementation of PCB coil in accordance with an embodiment of the present disclosure.

FIG. 5 is a schematic block diagram of an example PCB coil having varying coil density in accordance with embodiments of the present disclosure.

FIGS. 6A and 6B illustrate examples of interlayer connectors in accordance with embodiments of the present disclosure.

FIGS. 7A through 7D-2 depict a flow diagram of an example method of manufacturing a PCB coil in accordance with embodiments of the present disclosure.

FIG. 8 is an example of a mulita-route design in accordance with an embodiment of the present disclosure.

FIG. 9 illustrates example of corner connections in fabricating a PCB coil in accordance with embodiments of the present disclosure.

FIG. 10 shows changing trend of Q-factor for various PCB coils in accordance with embodiments of the present disclosure.

FIG. 11 shows a typical wireless charging system.

FIG. 12 provides a block diagram illustrating a conventional wireless charging configuration for a mobile device.

FIG. 13 provides a diagram illustrating an example of an improved wireless charging configuration for a mobile device according to one or more embodiments.

FIG. 14 provides a diagram illustrating an example of a mobile device case with a coil repeater assembly for wireless charging according to one or more embodiments.

FIG. 15A provides a diagram illustrating an example of a coil repeater assembly for wireless charging according to one or more embodiments.

FIG. 15B provides a diagram illustrating an example circuit of tuning capacitors for use in a coil repeater assembly according to one or more embodiments.

FIG. 16 provides a diagram illustrating another example of a coil repeater assembly for wireless charging according to one or more embodiments.

FIG. 17 provides a diagram illustrating another example of a coil repeater assembly for wireless charging according to one or more embodiments.

FIG. 18A provides a diagram illustrating an example of a stacked arrangement of coil repeater assemblies according to one or more embodiments.

FIG. 18B provides a diagram illustrating an example circuit of a stacked arrangement of coil repeater assemblies according to one or more embodiments.

FIGS. 19A-19B provide diagrams illustrating examples of case bodies for a mobile device case according to one or more embodiments.

FIG. 20 provides a flow diagram illustrating an example method of constructing a mobile device case with a coil repeater assembly for wireless charging according to one or more embodiments.

FIG. 21 provides a diagram illustrating an example of a mobile device case with a microchannel coil for wireless charging according to one or more embodiments.

FIG. 22 provides a flow diagram illustrating an example method of constructing a mobile device case with a microchannel coil for wireless charging according to one or more embodiments.

FIG. 23 provides a diagram illustrating an example of a coil repeater assembly for wireless charging according to one or more embodiments.

FIGS. 24A-24C provide diagrams illustrating examples of mobile device cases with a coil repeater assembly for wireless charging according to one or more embodiments.

FIG. 25 provides a flow diagram illustrating an example method of constructing a mobile device case with a coil repeater assembly for wireless charging according to one or more embodiments.

FIG. 26 provides a flow diagram illustrating an example method of providing wireless charging for a mobile device in a vehicle according to one or more embodiments

FIG. 27 illustrates a multi-device wireless charging apparatus, according to one or more embodiments.

FIG. 28 illustrates another multi-device wireless charging apparatus, according to one or more embodiments.

FIGS. 29A-29B illustrate a generalized multi-device charging apparatus comprising a recessed base to accommodate an external wireless charger, according to one or more embodiments.

FIG. 30 illustrates a generalized multi-device charging apparatus comprising a non-inductive magnetic structure to magnetically secure to an external wireless charger, according to one or more embodiments.

FIGS. 31A-31B illustrate a generalized multi-device charging apparatus comprising a slot to receive an external wireless charger, according to one or more embodiments.

FIG. 32 illustrates a generalized multi-device charging apparatus comprising a recess to receive a mobile device, according to one or more embodiments.

FIG. 33 illustrates a generalized multi-device charging apparatus comprising a cradle to receive a mobile device, according to one or more embodiments.

FIG. 34 illustrates a generalized multi-device charging apparatus comprising another cradle to receive a mobile device, according to one or more embodiments.

FIG. 35 illustrates a generalized multi-device charging apparatus comprising a non-inductive magnetic structure to magnetically secure to a mobile device, according to one or more embodiments.

FIG. 36 illustrates generalized multi-device wireless charging apparatus comprising multiple embedded coil repeater assemblies in a “slinky configuration,” according to one or more embodiments.

FIGS. 37A-37B illustrate a multi-platform wireless charging apparatus, according to one or more embodiments.

FIG. 38 illustrates another multi-platform wireless charging apparatus, according to one or more embodiments.

FIG. 39 illustrates a base platform multi-device wireless charging apparatus, according to one or more embodiments.

FIG. 40 illustrates a generalized multi-device charging apparatus comprising a recessed base to accommodate an external wireless charger, according to one or more embodiments.

FIG. 41 illustrates a generalized multi-device charging apparatus comprising a non-inductive magnetic structure to magnetically secure to an external wireless charger, according to one or more embodiments.

FIG. 42 illustrates a graph depicting effective charging ranges for example coil repeater assemblies disclosed herein.

FIG. 43 illustrates another graph depicting effective charging ranges for example coil repeater assemblies disclosed herein.

FIGS. 44A-44B illustrate a multi-use wireless charging apparatus comprising a generalized storage container, according to one or more embodiments.

FIG. 45 illustrates a multi-use wireless charging apparatus comprising a wallet, according to one or more embodiments.

FIG. 46 illustrates a multi-use wireless charging apparatus comprising a bag, according to one or more embodiments.

FIG. 47 illustrates a multi-use wireless charging apparatus comprising a suitcase, according to one or more embodiments.

FIGS. 48A-48B illustrate a multi-use wireless charging apparatus comprising a generalized piece of furniture, according to one or more embodiments.

FIG. 49 illustrates a multi-use wireless charging apparatus comprising a desk, according to one or more embodiments.

FIG. 50 illustrates a multi-use wireless charging apparatus comprising a couch, according to one or more embodiments.

FIG. 51 illustrates a multi-use wireless charging apparatus comprising an article of clothing, according to one or more embodiments.

FIG. 52 illustrates a multi-use wireless charging apparatus comprising a payment card, according to one or more embodiments.

FIGS. 53A-53C illustrate an in-vehicle wireless charging apparatus, according to one or more embodiments.

FIGS. 54A-54C illustrate another in-vehicle wireless charging apparatus, according to one or more embodiments.

FIGS. 55A-55C illustrate an example process for designing, fabricating, and testing repeater coils for wireless charging, according to one or more embodiments.

FIG. 56 depicts an example flowchart for designing, fabricating, and testing repeater coils for wireless charging, according to one or more embodiments.

FIG. 57 illustrates an example graph plotting temperature of a transmitting wireless charging coil as a function of time in multi-coil systems comprising different repeater coil designs, according to one or more embodiments.

FIG. 58 illustrates an example graph plotting temperature of a receiving wireless charging coil as a function of time in multi-coil systems comprising different repeater coil designs, according to one or more embodiments.

FIG. 59 illustrates an example graph plotting temperature of tuning capacitor(s) of a repeater coil as a function of time in multi-coil systems comprising different repeater coil designs, according to one or more embodiments.

FIG. 60 illustrates an example graph plotting temperature of an inductive coil of a repeater coil as a function of time in multi-coil systems comprising different repeater coil designs, according to one or more embodiments.

FIG. 61 illustrates an example graph plotting power received by a receiving wireless charging coil of a mobile device as a function of (vertical) air gap between a wireless charging interface of an external wireless charger and a wireless charging interface of the mobile device in multi-coil systems comprising different repeater coil designs, according to one or more embodiments.

FIG. 62 illustrates an example graph plotting power transfer efficiency as a function of (vertical) air gap between a wireless charging interface of an external wireless charger and a wireless charging interface of the mobile device in multi-coil systems comprising different repeater coil designs, according to one or more embodiments.

FIG. 63 illustrates an example graph plotting power received by a receiving wireless charging coil of a mobile device as a function of lateral offset between a wireless charging interface of an external wireless charger and a wireless charging interface of the mobile device in multi-coil systems

FIG. 64 illustrates an example graph plotting power transfer efficiency as a function of lateral offset between a wireless charging interface of an external wireless charger and a wireless charging interface of the mobile device in multi-coil systems comprising different repeater coil designs, according to one or more embodiments.

FIG. 65 is an example computing component that may be used to implement various features of embodiments described in the present disclosure.

The figures are not exhaustive and do not limit the present disclosure to the precise form disclosed.

### DETAILED DESCRIPTION

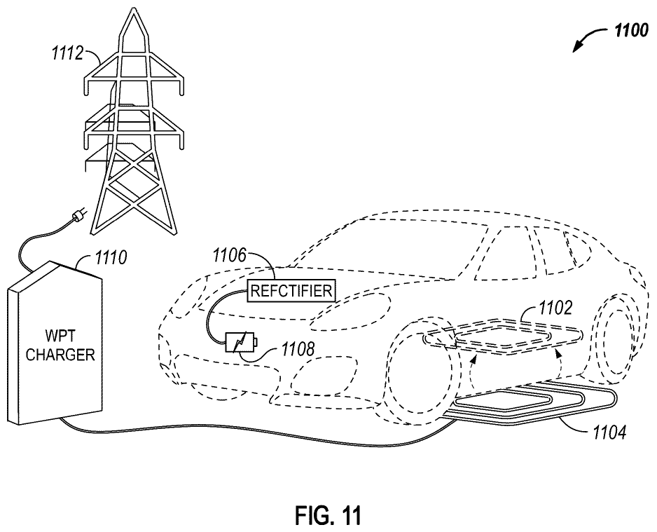

As alluded to above, electromagnetic coils are used in a variety of electrical applications in connection with the inductive transfer of power, such as wireless power transfer for power exchange in electrical vehicle applications. Wireless power transfer has been widely researched and developed due to its ease of use and elimination of manual power plugging. This technology has gained attention from not only the low-power consumer electronics industry but also the high-power electric vehicle (EV) wireless charging community. A typical wireless charging system 1100 is shown in FIG. 11, which includes an electric vehicle 1102 having a receiver coil 1104 installed on a chassis of the electric vehicle 1102. Wireless power transfer utilizes a magnetic field to transfer power wirelessly from an energized transmitter pad (or ground-based infrastructure) 1106, having a transmitter coil 1112, to the receiver coil 1104. Conventionally, the receiver and transmitter coils have dimensions of 350 mm×350 mm with an air space of around which the coil turns. The air space may be, for example, 150 mm-250 mm for a passenger vehicle wireless charging. After the receiver coil absorbs the magnetic field in the form of AC power, a rectifier 1108 converts the power into DC current to charge the vehicle main battery 1110. The power transfer efficiency relies on many factors such as, but not limited to, air gap between the receiver coil 1104 and the transmitter coil 1112, alignment between the coils, coil compatibility (e.g., matching of resonance frequencies), etc.

As discussed above, performance of the power transfer of a wireless charging system, such as that shown in FIG. 11, can be negatively impacted by the skin effect that causes an increase in effective resistance within the coils. This increased effective resistance can result in temperature fluctuations and reduced power coupling between the coils. To reduce the skin effect, electromagnetic coils used in high frequency applications are often wound from Litz wire.

Litz wire is a type of wire that includes many wires, individually coated with an insulating film, and twisted together. The individual wires are combined and twisted following a prescribed pattern often involving several levels of twisting (groups of twisted wires twisted together, etc.). Due to the combination of separate smaller wires, the conductor formed from a Litz wire can have a greater surface area than a conventional solid conductor, thereby reducing the skin effect. As a result of this and the twisting configuration, the power losses associated with Litz wire coils can be substantially lower than conventional solid wire coils when used in high-frequency applications.

However, conventional Litz wires suffer from a number of disadvantages. For example, the resistance of a Litz wire coil is higher than theoretically achievable because individual strands are round and coated with an insulator so that the overall cross-section includes a substantial amount of non-conducting elements, such as air and insulator. Additionally, the conductors are thermally insulated and lack a heat-carrying path aside from the conductors themselves. As a result, power handling by a Litz wire may be need to be reduced to account for thermal considerations. Furthermore, the manufacturing process for Litz wire and Litz wire coils is expensive and intricate, requiring special, costly equipment. For example, in wireless charging coil applications, a Litz wire coil can include at least 800 individual strands that are twisted together to collectively form the conductor, which then needs to be wound to form the coil itself. Further, a Litz wire may be bulkier than desired for some applications because of packing density from wire to wire and the space occupied by the insulation between strands.

To address these issues, among others, a coil can be formed directly into a printed circuit board (PCB), for example, by forming the coil on the circuit board. While some prior art approaches have attempted to form coils in PCB, these conventional printed circuit board coils suffer from certain short comings and difficulties. For example, some conventional PCB coils rely on non-standard PCB manufacturing techniques, such as using blind or buried vias to connect layers of a PCB. These vias require expensive and non-standard manufacturing techniques that complicate the manufacturing of and increase costs associated with the conventional PCB coils. Additionally, the conventional PCB coils are not scalable to different size coils, power levels, etc. This may be due to the design. For example, when designing a planar coil on PCB for wireless charging, the size and power level requirements are defined and the design is made to meet these parameters. Thus, the coil designed may be specific for meeting these requirements, such as physical constraints, inductance, resonance and magnetic field distribution. Furthermore, conventional PCB coils can suffer from uneven distribution of induced current and inductance within the PCB coil. Further, stacked PCB coils can introduce unwanted parasitic capacitance due to some of the coils receiving more of the magnetic field than others. Ultimately, this can result in higher resistance leading to thermal considerations as power requirements increase.

Accordingly, embodiments disclosed herein provide for methods and devices that replaces conventional Litz wire and conventional PCB coils with a scalable PCB coil for fitting various charging applications with different power levels, size requirements, etc. The embodiments disclosed herein provide this scalability while maintaining high power transfer efficiency and high power handling. For example, embodiments disclosed herein begin with a unit cell design, which can be repeated in multiple layers and scaled to any number of planar sizes.

In some embodiments, a PCB coil is provided that includes a plurality of conductor layers and one or more substrate or insulator layers. The conductor layers may be provided as any conductive material known in the art, for example but not limited to, copper. Each one or more insulator layers is provided between two conductor layers. Thus, the number of insulator layers may be one less than the number of conductor layers. Each conductor layer can comprise a plurality of trace segments formed therein. A plurality of interlayer connectors are fabricated that interconnect trace segments of different conductor layers to form one or more traces. These traces may function similar to a strand of wire in a conventional Litz wire. The interlayer connectors may be provided as through vias formed at an edge of the insulator layer, with the trace segments extending across the insulator layer from one through via on one edge to another through via on another edge. As such, the trace winds or is twisted around the insulating layer. The one or more traces collectively provide for a trace bundle that can then be formed into a coil structure to provide the PCB coil.

Each trace may comprise a trace density based on spacing between each trace segment and spacing between each interlayer connector forming the trace. For example, a smaller spacing between trace segments and/or interlayer connectors translates to higher density (e.g., more trace segments per unit of distance) and larger spacing translates to a lower density. In some embodiments, the density of the traces can be varied as a function of location along the PCB coil. By varying the trace density, current propagating in the coil can be controlled which can address thermal considerations. For example, a higher density of traces can be formed to reduce thermal properties, such as temperatures, which permit larger currents through the coil. A lower density can be used where thermal considerations are less prominent. For example, if thermal considerations are of less prominent, a lower density can carry enough power with higher temperature but reduce total weight and material cost.

A nonlimiting advantage of the embodiment disclosed herein is that it can be extended to any size or number of PCB layers as needed for any desired application. For example, power level and physical installation space can vary significantly for different grades of vehicles (e.g., commercial vehicles compared to consumer vehicles, hybrid vehicles compared to fully electric vehicles, a car compared to a truck, etc.). Conventional PCB coils and Litz wires require a special design of the receiver coil on the vehicle, for example, based on design space, gap, power level, thermal requirements, and electrical requirements. Whereas, embodiments disclosed herein provide for scalability through a base trace design pattern that can be repeated at design stages to form trace bundles and extended to multiple PCB layers, as well as varied in physical size, without redesigning the base trace pattern. This base trace design pattern (e.g., the unit cell), which defines the trace segments and interlayer connectors forming a single trace route, can be provided according to the power and space needs of a given application and then repeated to provide multiple traces. Parameters, such as trace segment lengths, spacings, etc., that define the base trace pattern can adjusted as desired without requiring a redesign of the base pattern. Thus, embodiments disclosed herein can be implemented for any n space, gap, power level, thermal requirements, and electrical requirements.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

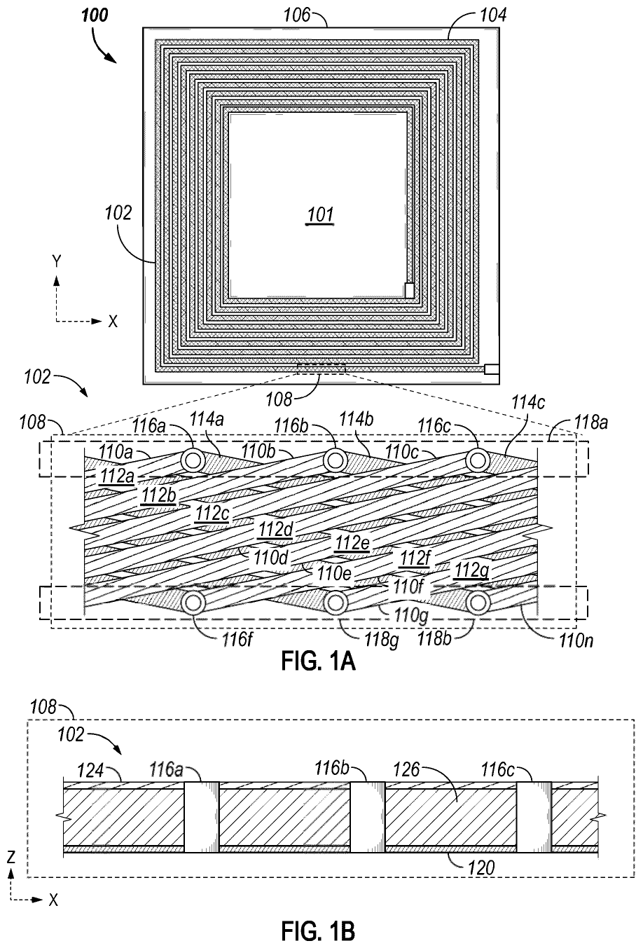

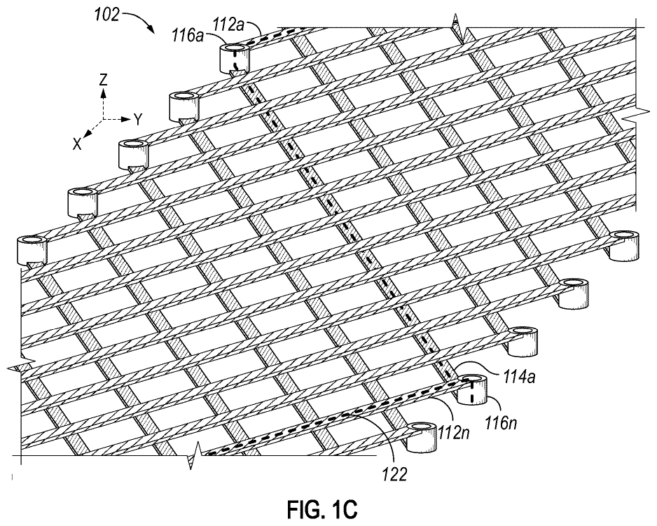

FIG. 1A is a top down view of an example PCB coil 100 in accordance with embodiments of the present disclosure. The PCB coil 100 includes a trace bundle 102 wound through a plurality of turns or loops around air space 101 to form a coil 104 on a substrate 106. FIG. 1B illustrates a side view of a portion the trace bundle 102 and FIG. 1C depicts a perspective view of a portion of the trace bundle 102 with the substrate 106 removed for illustrative purposes only to assist with ease of understanding and as relative orientation between parts.

FIG. 1A includes zoomed in view 108 which depicts an enlargement of a portion of trace bundle 102. As shown in the view 108, the trace bundle 102 comprises a plurality of individual trace (or trace strands) 110a-110n (collectively referred to herein as traces 110) that are twisted or wound around portions of substrate 106 to form the trace bundle 102. The portions of substrate 106 around which traces 110 are wound can be considered insulating layers 126, which are shown in FIG. 1B. In this example, six traces 110 are shown, but any number of traces may be provided as desired. The traces may be formed of a conductor, such as, but not limited to, copper.

Each trace 110 is formed from trace segments 112a-112n (collectively referred to herein as trace segments 112) and trace segments 114a-114n (collectively referred to herein as trace segments 114) that are connected by interlayer connectors 116a-116n (collectively referred to herein as interlayer connectors 116). As an illustrative example, trace 110a is shown comprising a trace segment 112a that is connected to a trace segment 114a by an interlayer connector 116a. This pattern of connection is repeated along the length of the trace bundle 102. The interlayer connectors 116 may be provided at outer perimeters or edge regions 118a and 118b of trace bundle 102, with the trace segments 112 and 114 extending linearly across the trace bundle 102 from an interlayer connectors 116 to another interlayer connectors 116 on edge region 118b. Thus, each trace segment 112 can be substantially parallel to other trace segments 112 and each trace segment 114 can be substantially parallel to other trace segments 114. Both trace segments extend linearly in the X-axis direction, but in opposite directions along the Y-axis, in this example.

As shown in FIG. 1B, trace segments 112 can be formed in a conductor layer 124 on a first (e.g., upper) side of insulating layer 126 and trace segments 114 can be in from a conductor layer 120 on a second or opposite (e.g., bottom) side of insulating layer 126. Interlayer connectors 116 interconnect one of trace segments 112 to one of trace segments 114. Thus, each trace segment of a given layer can be substantially parallel to other trace segments of the same layer. The interlayer connectors 116 can be formed on the outer perimeter or edge regions 118a and 118b of insulating layer 126. Trace segments and interlayer connectors can be formed using any PCB manufacturing techniques as known in the art. Reference to upper and bottom side are provided as examples to assist with ease of understanding and as relative orientation between layers. Reference to upper and bottom are not intended to limit the disclosure to vertical orientations.

Each trace 110 follows a trace route that winds around the insulating layer 126. FIG. 1C depicts an example trace route 122 for trace 110a, through which trace segment 112a is connected to trace segment 114a via interlayer connector 116a and trace segment 114a is connected to trace segment 112n via interlayer connector 116n. In this example, each trace segment extends linearly from one interlayer connector 116 to the next, without deviation from the trace route. As a result, in the example shown in FIG. 1C, trace 110 is wound around an insulating layer 126 forming a generally rectangular helical pattern having rotations or turns in a first direction (e.g., Z-axis direction) and translations across a plane perpendicular to the first direction (e.g., X-Y plane in this example).

In operation, an alternating current (AC) can be applied to the trace bundle 102, which will flow in substantially equal amounts in each of the individual traces 110. Because the current may be distributed uniformly across the strands, the AC resistance may be reduced. In embodiments, system trade-offs such as number and size of individual traces, numbers of layers of the PCB coil, connection complexities, board space, and the like, may be considered to determine the optimum routing pattern and design.

In embodiments, trace bundle 102 can be reproducible and scalable through repeated routing of multiple trace 110a-110n. For example, the trace bundle 102 can be formed by repeating the trace route 122 for each trace 110 and providing a spacing or gap between each adjacent trace 110. By repeating the trace route 122 with a different starting point spaced apart from a neighboring trace 110, a plurality of traces 110 can be formed having a common shape with a spacing therebetween in the X-Y plane. As a result, the trace bundle 102 can comprise a number of helical patterns, as shown in FIG. 1C, twisted around insulating layer 126. Scalability can be achieved by altering starting points, spacings, and dimensions of the various components to form traces of desired dimensions.

While the examples of FIGS. 1A-1C illustrate a portion of trace bundle 102 that extends along the X-axis direction, the coil 104 comprises similar structural configurations for other positions of trace bundle 102 of other orientations. For example, a length of trace bundle 102 that extends in the Y-axis direction (e.g., right or left sides of PCB coil 100 in FIG. 1A) would have a similar structure as that shown FIGS. 1A-1C, but with an orientation rotated according to the changed orientation of the length of trace bundle 102.

Furthermore, with reference to the example axes shown in FIGS. 1A-1C, the axes are provided as examples to assist with ease of understanding and as relative orientation between parts. The axes are not intended to limit the disclosure to horizontal or vertical directions.

In embodiments, design parameters of a trace bundle 102 can varied to achieve differing trace densities. Trace density may be controlled based on spacing between routes of each traces 110a-110n and by the patterned geometry of the trace bundle 102. The location of the interlayer connectors 116 on the outer perimeter can enable scaling and replication of the pattern as well as tight and uniform individual trace placement and density since the interlayer connectors are not used within the trace segments themselves, potentially disrupting uniformity of the pattern and the density of the pattern. For example, spacing between adjacent interlayer connectors 116 can be adjusted which translates to an adjustment of the spacing between the connected trace segments.

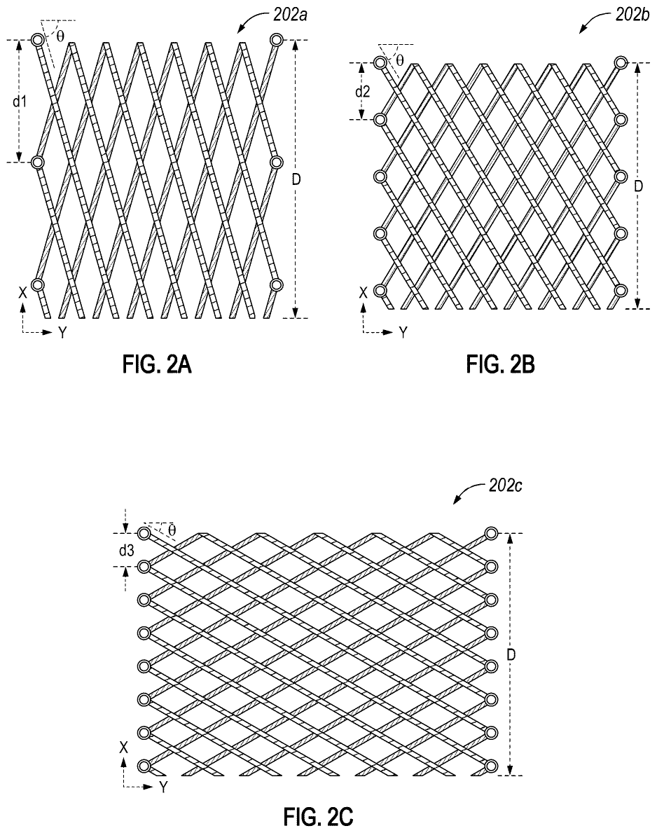

FIGS. 2A-2C depict examples of different trace densities in accordance with embodiments disclosed herein. FIGS. 2A-2C show portions of trace bundles 202a-202c, respectively, each of which may be substantially the same as trace bundle 102 of FIGS. 1A-1C, except that the trace density is differed between each trace bundle. FIG. 2A shows a length D of trace bundle 202a having a first trace density, FIG. 2B shows the length D of trace bundle 202b having a second trace density that is higher than the first trace density, and FIG. 2C shows the length D of trace bundle 202c having a third trace density that is higher than the second trace density (e.g., increased number of trace segments per unit length).

In each figure, the length of each portion of the respective trace bundle is the same, denoted as distance D, but the distance between adjacent interlayer connectors is changed. For example, FIG. 2A shows a distance of d1 between adjacent interlayer connectors, while FIG. 2B shows a distance of d2, which is smaller than d1. Similarly, FIG. 2C show s distance of d3 between adjacent interlayer connectors, which is smaller than d2. As a result, the angle θ formed between trace segments and the Y-axis decreases as the distance between interlayer connectors decreases. The spacing between trace segments also decreases with decreased distance between interlayer connectors. Thus, an increased number of trace segments, and therefore traces, are present within distance D of the trace bundle.

Returning to FIGS. 1A-1C, coil 104 is shown as an example of a two-layer PCB coil, having two conductors layers each having a plurality of trace segments that are interconnected by the interlayer connectors to define traces 110. However, embodiments disclosed herein can be extended to more than two layers, for example, a four-layer PCB coil, six-layer PCB coil, eight layers, to as many layers as desired. In each case, an insulating layer is provided between two neighboring conductor layers. Thus, the number of insulating layers is N−1, where N is the number of conductor layers. Through the multi-layer structure, a trace bundle (such as trace bundle 102) can include a number of sub-bundles. Each sub-bundle may be defined by a pair of conductor layers having trace segments formed thereon and interconnected by interlayer connectors forming traces that wind around one or more insulating layers. In embodiments, providing additional layers may function to increase trace density as there more layers means that more traces are present with a length of the coil 104. This approach to varying the trace density can be used alone or in tandem with the adjusting of spacing between interlayer connectors discussed above.

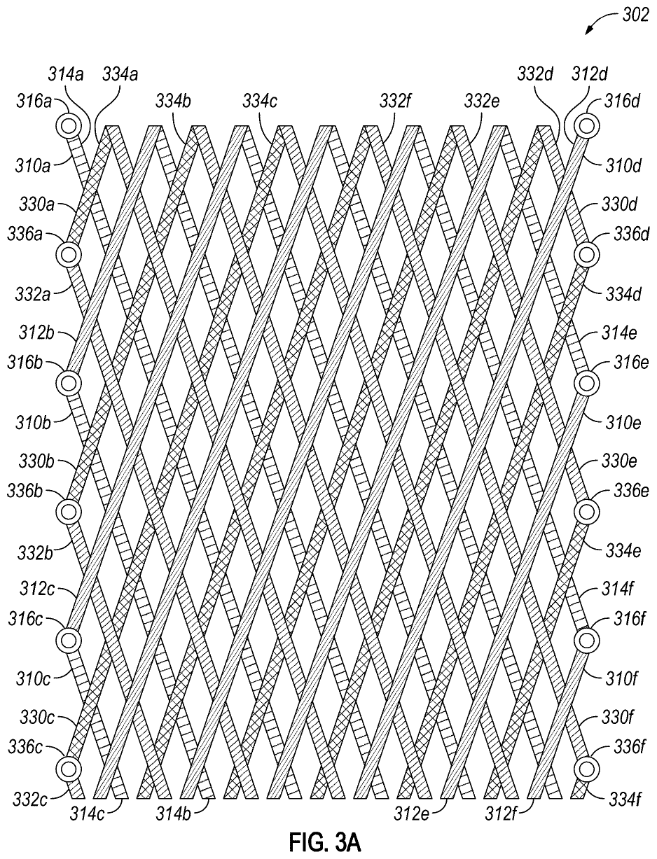

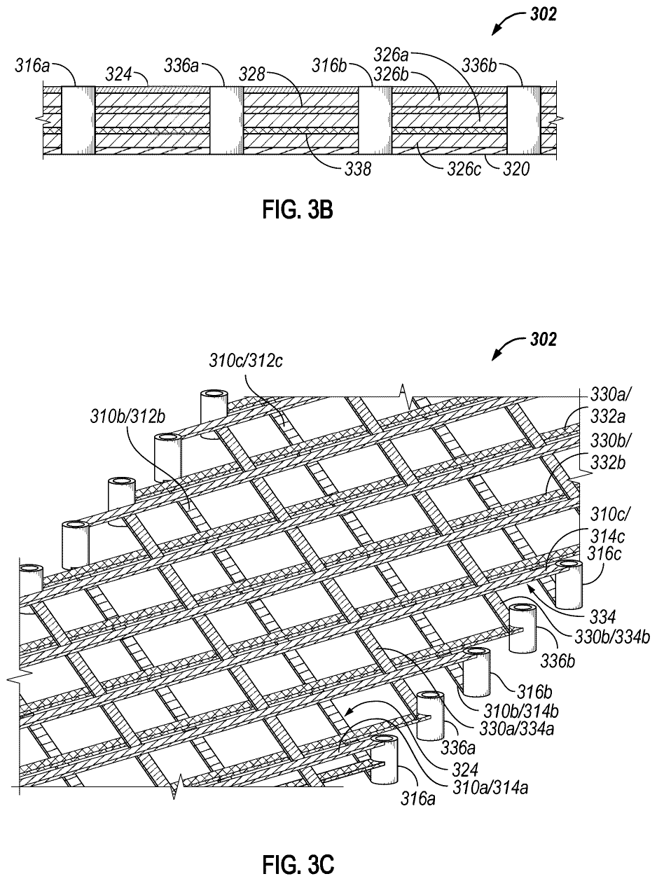

FIGS. 3A-3C illustrates an example four layer trace bundle 302 in accordance with an embodiment of the present disclosure. Trace bundle 302 may be included as part of a four layer PCB coil. FIG. 3A is a top down view of a portion the trace bundle 302, FIG. 3B is a side view of a portion the trace bundle 302, and FIG. 3C is a perspective view of a portion of the trace bundle 302 with the insulating layers removed for illustrative purposes only to assist with ease of understanding and as relative orientation between parts.

In the example of FIGS. 3A=3C, trace bundle 302 comprises a first plurality of traces 310 and a second plurality of traces 330 that are twisted or wound around one or more of insulating layers 326a-326c to form the trace bundle 302. In this example, traces 310 may provide a first sub-bundle and traces 330 provide a second sub-bundle. In the example shown in FIG. 3A, eight traces 310 and eight traces 330 are shown, but any number of traces may be provided as desired. The traces may be formed of a conductor, such as, but not limited to, copper.

Each trace 310 is formed from trace segments 312a-312n (collectively referred to herein as trace segments 312) and trace segments 314a-314n (collectively referred to herein as trace segments 314) that are connected by interlayer connectors 316a-316n (collectively referred to herein as interlayer connectors 316).

Each trace 330 is formed from trace segments 332a-332n (collectively referred to herein as trace segments 332) and trace segments 334a-334n (collectively referred to herein as trace segments 334) that are connected by interlayer connectors 336a-336n (collectively referred to herein as interlayer connectors 336).

As shown in FIG. 3B, trace segments 312 can be formed in a conductor layer 324 on a first (e.g., upper) side of insulating layer 326a and trace segments 314 can be formed in a conductor layer 320 on a bottom side of insulating layer 326c. Further, trace segments 332 can be formed in a conductor layer 328 between a bottom side of insulating layer 326a and a first (e.g., upper) side of insulating layer 326b and trace segments 334 can be formed in a conductor layer 338 between a bottom side of insulating layer 326b and an upper side of insulating layer 326c. Interlayer connectors 336 interconnect one of trace segments 312 to one of trace segments 314, while interlayer connectors 336 interconnect one of trace segments 332 to one of trace segments 334.

Thus, each trace 310 and 330 follows a trace route that winds around one or more of insulating layers 326a-326c. For example, each trace 310 winds around each of insulating layer 326a-326c, each trace 330 winds around insulating layer 326b.

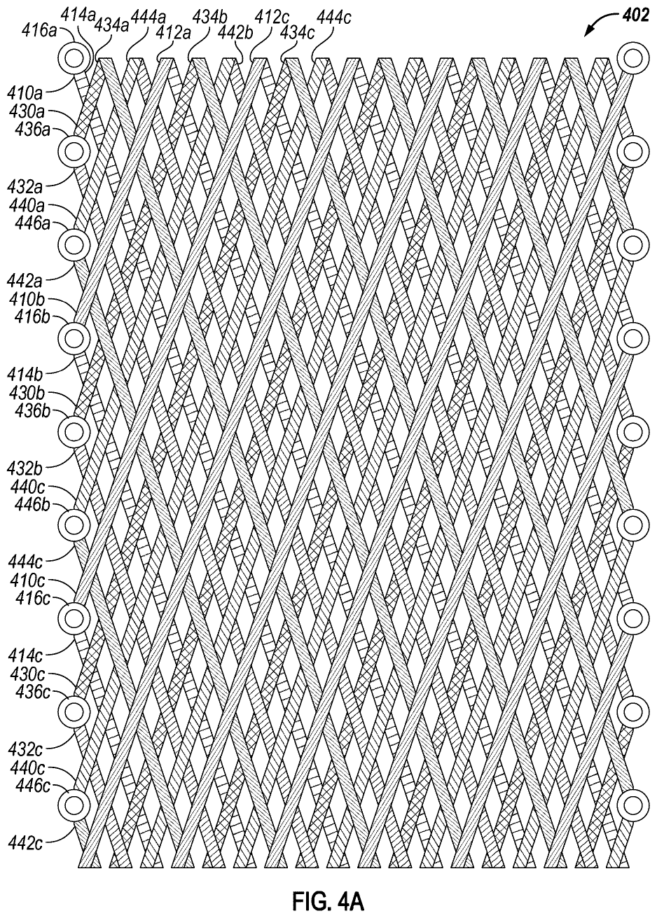

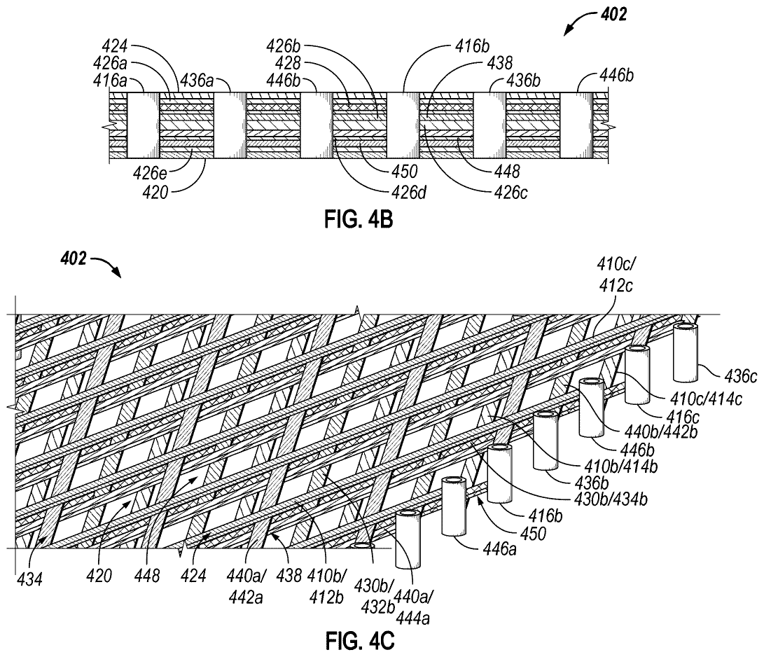

FIGS. 4A-4C illustrates an example six layer trace bundle 402 in accordance with an embodiment of the present disclosure. Trace bundle 402 may be included as part of a six layer PCB coil. FIG. 4A is a top down view of a portion the trace bundle 402, FIG. 4B is a side view of a portion the trace bundle 402, and FIG. 4C is a perspective view of a portion of the trace bundle 402 with the insulating layers removed for illustrative purposes only to assist with ease of understanding and as relative orientation between parts.

In the example of trace bundle 402, trace bundle 402 comprises a first plurality of traces 410, a second plurality of traces 430, and a third plurality of traces 440 that are twisted or wound around one or more of insulating layers 426a-426e to form the trace bundle 402. Traces 410 may provide a first sub-bundle, traces 430 may provide a second sub-bundle, and traces 440 may provide a third sub-bundle. Each trace 410 is formed from trace segments 412a-412n (collectively referred to herein as trace segments 412) and trace segments 414a-414n (collectively referred to herein as trace segments 414) that are connected by interlayer connectors 416a-416n (collectively referred to herein as interlayer connectors 416). Each trace 430 is formed from trace segments 432a-432n (collectively referred to herein as trace segments 432) and trace segments 434a-434n (collectively referred to herein as trace segments 434) that are connected by interlayer connectors 436a-436n (collectively referred to herein as interlayer connectors 436). Each trace 440 is formed from trace segments 442a-442n (collectively referred to herein as trace segments 442) and trace segments 444a-444n (collectively referred to herein as trace segments 444) that are connected by interlayer connectors 446a-446n (collectively referred to herein as interlayer connectors 446).

As shown in FIG. 4B, trace segments 412 can be formed in a conductor layer 424 on an upper side of insulating layer 426a and trace segments 414 can be formed in a conductor layer 420 on a bottom side of insulating layer 426e. Further, trace segments 432 can be formed in a conductor layer 428 between a bottom side of insulating layer 426a and an upper side of insulating layer 426b and trace segments 434 can be formed in a conductor layer 438 between a bottom side of insulating layer 426b and an upper side of insulating layer 426c. Additionally, trace segments 442 can be formed in a conductor layer 448 between a bottom side of insulating layer 426c and an upper side of insulating layer 426d and trace segments 444 can be formed in a conductor layer 450 between a bottom side of insulating layer 426d and an upper side of insulating layer 426e. Interlayer connectors 416 interconnect one of trace segments 412 to one of trace segments 414, while interlayer connectors 436 interconnect one of trace segments 432 to one of trace segments 434 and interlayer connectors 446 interconnect one of trace segments 442 to one of trace segments 444.

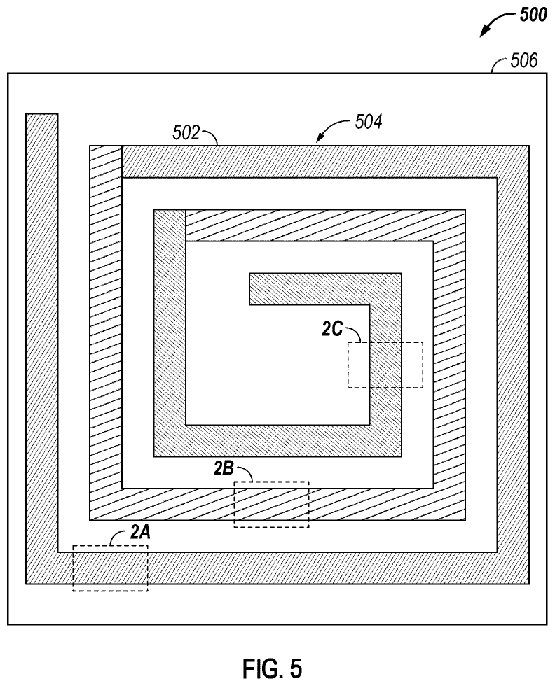

FIG. 5 is a schematic block diagram of an example PCB coil 500 having varying coil density along the length of the PCB coil 500 in accordance with embodiments of the present disclosure.

The PCB coil 500 includes a trace bundle 502 wound through a plurality of turns or loops to form a coil 504 on a substrate 506. The trace bundle 502, coil 504, and substrate 506 may be substantially similar to trace bundle 102, coil 104, and substrate 106 as described in connection with FIGS. 1A-1C. Thus, trace bundle 502 comprises a plurality of individual traces (e.g., traces 110) that are twisted or wound around portions of substrate 506, considered insulating layers (not shown in FIG. 5 for easy of understanding) to form the trace bundle 502. Each trace is formed from trace segments (e.g., trace segments 112 and 114) that are connected by interlayer connectors (e.g., interlayer connectors 116).

FIG. 5 illustrates a plurality of locations 508a-508c along the coil 504 and a zoomed in view of a portion of trace bundle 502 at each location 508a-508c. In this example, location 508c is closer to a center of the trace bundle 502 than location 508b and location 508a, while location 508a is the farthest from the center (e.g., an outer end of the coil). As can be seen from FIG. 5, the trace density of trace bundle 502 at each location 508a-508c differs relative to the other locations 508a-508c. For example, the trace density of trace bundle 502 at location 508a is illustratively shown as trace bundle 202a having the trace density described in connection with FIG. 2A, the trace density of trace bundle 502 at location 508b is illustratively shown as trace bundle 202b having trace density described in connection with FIG. 2B, the trace density of trace bundle 502 at location 508b is illustratively shown as trace bundle 202c having the trace density described in connection with FIG. 2C. That is, for example, the spacing between adjacent interlayer connectors is reduced as one progresses from location 508a to location 508c, thus increasing trace density at each location.

As described above, by varying the trace density, current propagating in the coil can be controlled which can address thermal considerations. For example, at inner turns of a PCB coil 504 (e.g., locations 508c), thermal considerations can dominate as the inner turns become hotter than outer turns (e.g., location 508a) due to non-uniform current distribution. A higher density of traces can be provided at these inner locations to permit larger currents through those locations of the PCB coil 504, which lowers temperature and improves overall performance. A lower density of trace segments can be utilized where thermal considerations are less prominent (e.g., location 508a), which allows for less conductive material to be used in manufacturing thus lower manufacturing costs. Thus, PCB coil 500 can be provided to address varying current and thermal demands across the PCB coil by varying the density of traces across the length of the PCB coil 500.

In some embodiments, the change in trace density need not be at a corner or turn of the coil 504, and may instead be at any point along a vertical and/or horizontal length of the coil. That is, for example, a change in trace density may occur at any location along the length of the coil 504 according to a desired implementation.

While three different locations and trace densities are shown in this example, the embodiments disclosed herein are not intended to be limited to three. Any number of changes in trace density may be provided along the length of coil 504.

Additionally, while the example shown in FIG. 5 leverages spacing between interlayer connectors 516 to adjust the trace density, embodiments disclosed herein are not so limited. For example, trace density may be adjusted through adding or remove sub-bundles to the trace bundle 502. As an illustrative example, a two layer trace bundle (e.g., trace bundle 102) may be used at location 508a, a four layer trace bundle (e.g., trace bundle 302) at location 508b, and a six layer trace bundle (e.g., trace bundle 402) at location 508c. In this case, at each transition, a single trace from a lower numbered layer trace bundle may be connected to one or more traces of a larger numbered layer trace bundle (e.g., transitioning from trace bundle 102 to trace bundle 302 may require a single trace 110 to connect to two traces 310 or to two sub-bundles, such as a trace 310 and a trace 330).

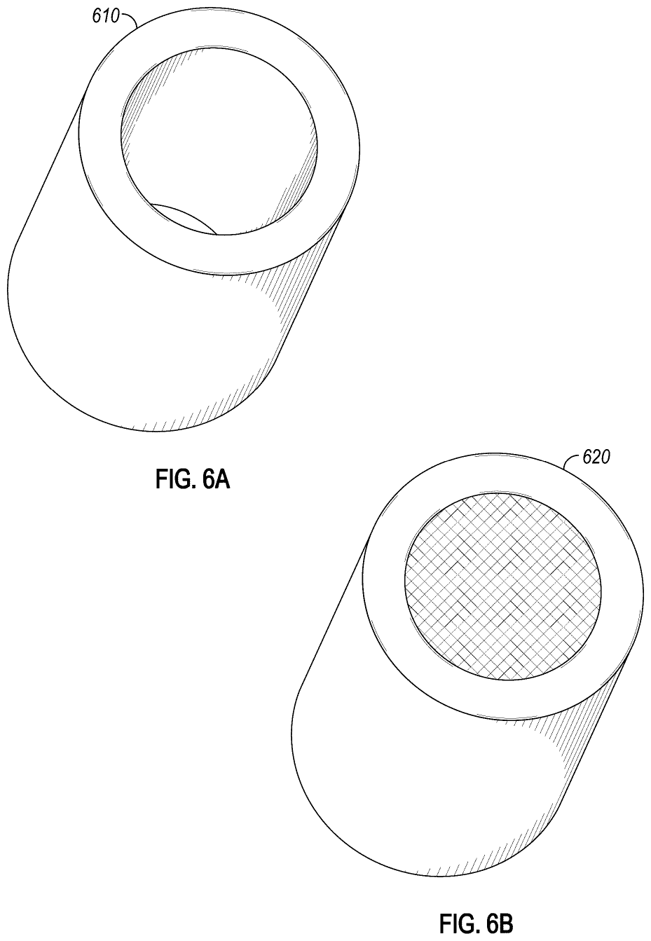

FIGS. 6A and 6B illustrate examples of interlayer connectors in accordance with embodiments of the present disclosure. FIGS. 6A and 6B show interlayer connectors 610 and 620, respectively, which can be implemented as any interlayer connectors disclosed herein. FIG. 6A depicts interlayer connectors 610 as a hollow through via and FIG. 6B depicts interlayer connectors 620 as a filled through via.

To increase reliability and conductivity of the embodiments disclosed herein, filled through vias of FIG. 6B can be used. The PCB coils disclosed herein generally operate under high power conditions which can lead to temperature changes. Thin copper-plated through vias could be fragile under thermal cycling because of thermal expansion. Thus, in high power applications, filling the through via can be utilized to enhance the strength and also reduce overall resistance in a connected trace for lower power loss. The filled through via of FIG. 6B can be implemented by electroless plating when the through via size is small. As another example, the filling can be done through a conductive paster curing process. After the through vias are filled, a conductive paste, such as, but not limited to, copper paste or silver paste can be applied followed by a high temperature curing for solidification.

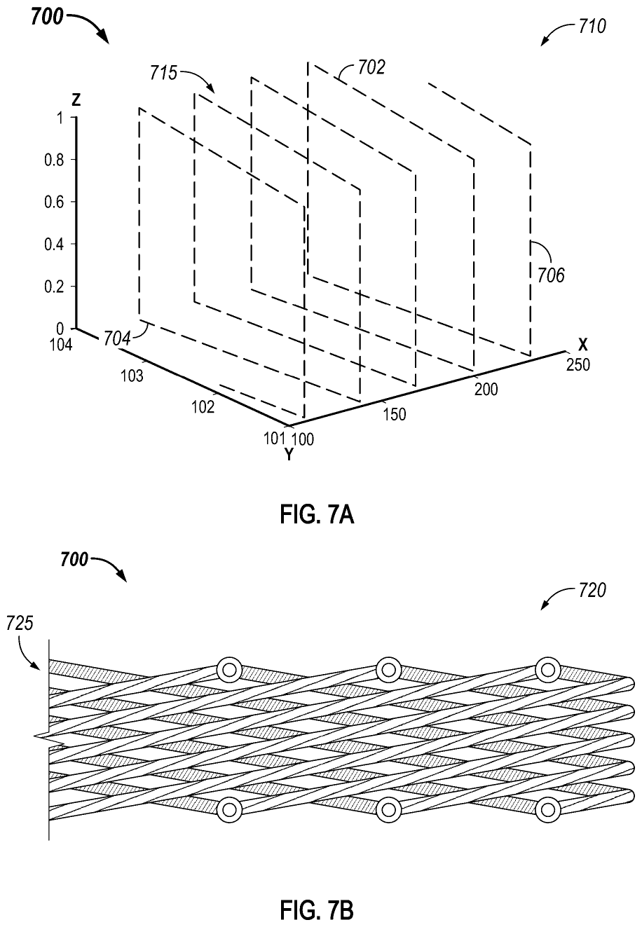

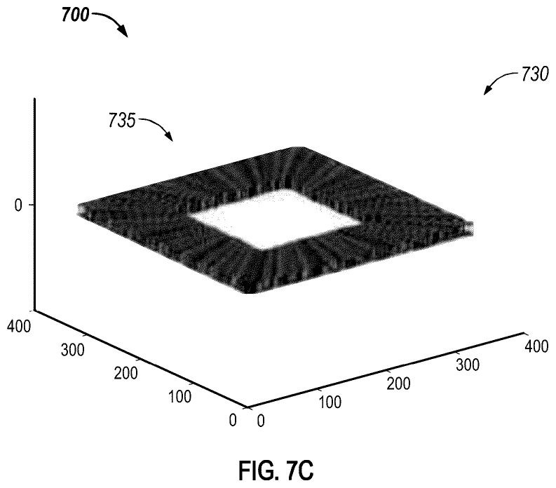

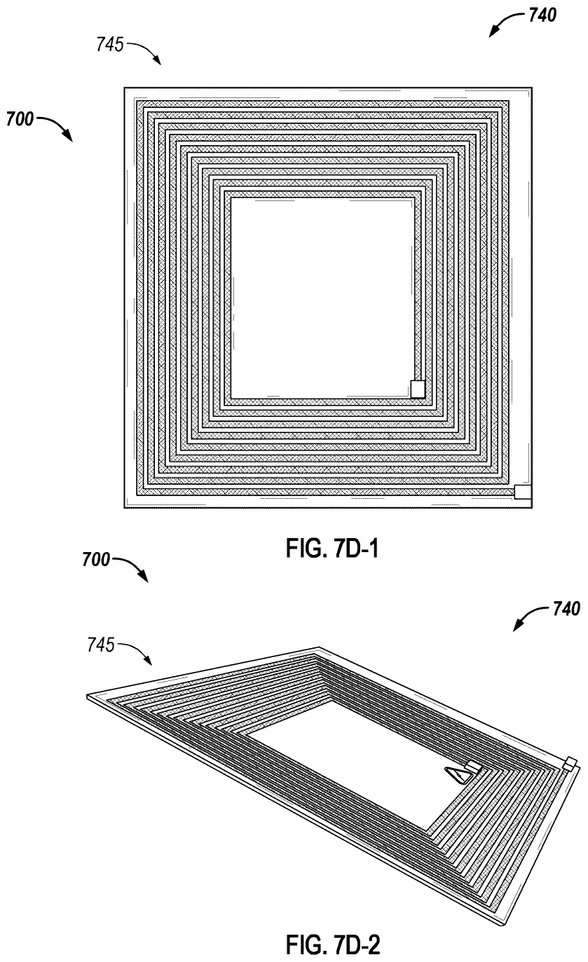

FIGS. 7A through 7D-2 depict a flow of an example method 700 for manufacturing a PCB coil in accordance with embodiments of the present disclosure. The method 700 provides for generating repeatable trace routes, such as trace route 122 describe above, from which traces and trace bundles can be fabricated that are both reproducible and scalable with minimal redesign.

At operation 710, a route design 715 is generated for a signal trace of a trace bundle. This route design 715 may represent a unit cell. In some embodiments, route design 715 can be generated using a trace design tool, such as MATLAB® or other trace design system. For example, design parameters can be entered into the trace design system that executes code to generate the route design 715 according the design parameters. The design parameters may include, for example by not limited to, a desired orientation, starting point, thickness of coil, width of coil, and length of coil. Consideration of system trade-offs may be made determine the optimum routing pattern and design, such as number and size of individual traces, numbers of layers of the PCB, connection complexities, board space, and the like. From these inputs, the trace design system can automatically generate the route design 715. Thus, the route design can be repeatable and scalable as desired.

Route design 715 is an example of design from which a single trace (e.g., trace 110) can be fabricated. For example, route design 715 comprises segment designs 702 and 704 which are generated at a distance apart from each other. The segment designs 702 and 704 may correspond to a design for each trace segment of the trace. For example, segment deigns 702 may correspond to trace segments 112 of FIGS. 1A-1C and segment deigns 704 may correspond to trace segments 114. The distance between segment deigns 702 and 704 may correspond to the thickness of an insulating layer (e.g., insulating layer 126) on which the trace segments are to be formed. Route design 715 also includes vertical lines or connector designs 706 which can correspond to locations of the interlayer connectors (e.g., interlayer connectors 116).

While route design 715 is shown having certain dimensions, these dimensions are provided as examples for illustrative purposes. As noted above, design parameters may be entered according to a desired implementation which the trace design system uses to generate the optimal route design 715.

Once generated, route design 715 can be used to generate a bundle design 725 at operation 720. For example, the trace design system can take design parameters of the unit cell route design 715 and repeat the route design 715 at different starting points so to generate a bundle design 725. Example design parameters for operation 720 include, but are not limited to, a minimum trace width and a minimum gap distance between each trace adjacent trace. The minimum trace width defines the width of each trace segment and interlayer connectors that forms the trace, with the route design 715 at a mid-point of the minimum trace width. In this example, bundle design 725 is shown as an example corresponding to the trace bundle 102 of FIG. 1A, in which multiple route design 715 are generated with spacing therebetween to provide for a number of traces (e.g., traces 110). Examples of some trace widths and spacings are provided in Table 1 below.

From the trace bundle design 725 at operation 720, a coil design 735 is generated at operation 730. That is, the bundle design 715 can be extended according to desired dimensions of a PCB coil to be manufactured and through a desired number of turns (also referred to as coil numbers) to provide a coil design 735. In an example implementation, the PCB coil may have dimensions of 150 mm×150 mm, 350 mm×350 mm, and the like.

From the coil design 735, a physical PCB coil 745 can be fabricated at operation 740. The PCB coil 745 can be fabricated using any PCB manufacturing techniques as known in the art.

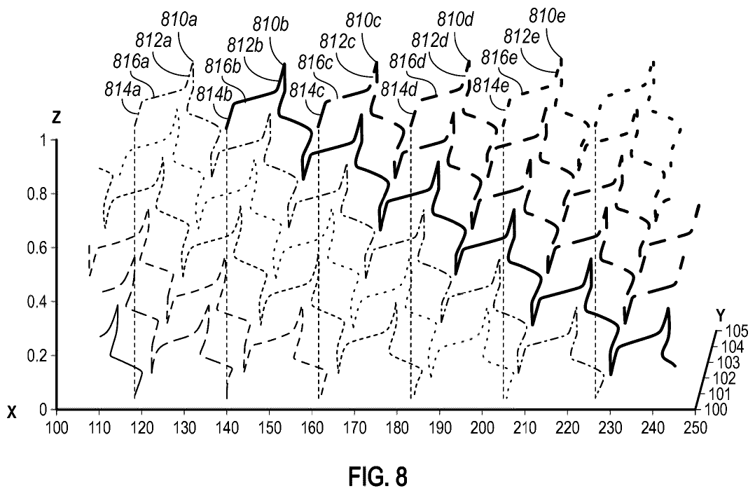

FIG. 8 is an example of a multi-route design 815 for multi-layer embodiment. Multi-route design 815 includes a plurality of individual route designs 810a-e generated, for example, at operation 710 of FIG. 7A. Each route design 810a-810e comprises segment designs 812a-e and 814a-e and connector designs 816a-e, respectively. In this example, each route design 810a-810e includes segment designs that are connected by connector designs through a single vertical space (e.g., corresponding to insulating layers). That is, for example, route design 810a includes segment design 812a is connected to segment design 814a by connector design 816a that steps through each insulating layer space in a sequential order, and thus the trace fabricated from route design 810a would be formed on each insulating layer of the resulting trace bundle.

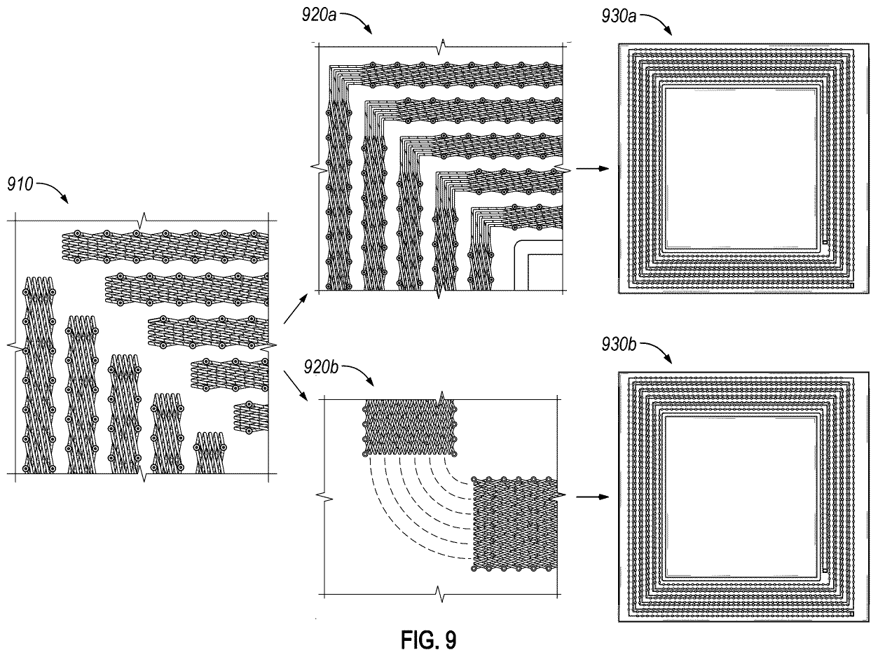

FIG. 9 illustrates example of corner connections in fabricating a PCB coil in accordance with embodiments of the present disclosure. Unconnected portions of a coil design 910 may be generated at operation 720. During operation 730, trace segments from one trace bundle 912 can be connected to another trace bundle 914 using, for example, a corner approach (e.g., right angle) as shown in design 920a, a rounded approach as shown in design 920b, or other desired connection methods. In either case, operation 730 results in a coil design, such as design 930a or 930b in a couple examples.

Table 1 below provides example of different PCB coils constructed according to the embodiments disclosed herein and experimental results on power transfer efficiency achieved by tuning design parameters between different designs. Table 1 below shows test results of inductance (L), AC resistance (Rac), DC resistance (Rdc), and quality (Q) factors for PCB coils of different boards organized by board number having different numbers of turns (e.g., coil numbers), conductor layers, thickness of conductive material of each layer (e.g., copper thickness in ounces), number of traces across a trace bundle (e.g., number of traces per a layer), total number traces in a trace bundle, trace width, and trace spacing. AC and DC resistance may reflect loss and the Q-factor can reflect the efficiency of power transfer.

TABLE 1

| Design parameters | | | | | | | | | | | |
|---|---|---|---|---|---|---|---|---|---|---|---|
| | | | Copper | | | | Min trace | Measured values | | | |
| Board | Coil | | thickness | Traces | # of | Trace | spacing/ | L | | | Q |
| number | # | Layers | (oz) | across | traces | width | width | (uH) | Rac(mΩ) | Rdc(mΩ) | measured |
| 1 | 1 | 4 | 2 | 15 | 59 | 0.2467 | 0.2 | 6.23 | 53.31 | 48.23 | 62.81 |
| 1 | 2 | 4 | 2 | 4 | 15 | 1.2947 | 0.2 | 6.32 | 85.18 | 37.02 | 39.63 |
| 1 | 3 | 4 | 2 | 7 | 27 | 0.7118 | 0.2 | 6.22 | 54.58 | 36.68 | 60.94 |
| 1 | 4 | 4 | 2 | 11 | 43 | 0.3997 | 0.2 | 6.17 | 43.56 | 33.94 | 75.61 |
| 2 | 5 | 4 | 4 | 10 | 39 | 0.3463 | 0.32 | 6.18 | 29.94 | 20.02 | 110.26 |
| 2 | 6 | 4 | 4 | 4 | 15 | 1.1989 | 0.32 | 6.45 | 78.09 | 5.65 | 44.16 |
| 2 | 7 | 4 | 4 | 6 | 23 | 0.745 | 0.32 | 6.08 | 50.25 | 23.74 | 64.66 |
| 2 | 8 | 4 | 4 | 8 | 31 | 0.4998 | 0.32 | 6.32 | 44.18 | 31.1 | 76.35 |
| 3 | 9 | 4 | 6 | 2 | 7 | 2.2377 | 0.45 | 5.84 | 82.88 | 5.34 | 37.6 |
| 3 | 10 | 4 | 6 | 4 | 15 | 1.0951 | 0.45 | 6.12 | 72.68 | 11.97 | 45.02 |
| 3 | 11 | 4 | 6 | 5 | 19 | 0.8237 | 0.45 | 5.89 | 45.34 | 5.87 | 69.43 |
| 3 | 12 | 4 | 6 | 7 | 27 | 0.4923 | 0.45 | 6.19 | 37.43 | 17.74 | 88.35 |
| 4 | 13 | 6 | 6 | 2 | 11 | 2.1308 | 0.45 | 5.98 | 96.98 | 3.59 | 32.94 |
| 4 | 14 | 6 | 6 | 4 | 23 | 1.0402 | 0.45 | 6.03 | 77.09 | 2.01 | 41.79 |
| 4 | 15 | 6 | 6 | 5 | 29 | 0.7792 | 0.45 | 6.05 | 52.48 | 2.46 | 61.67 |
| 4 | 16 | 6 | 6 | 7 | 41 | 0.4598 | 0.45 | 6.09 | 28.84 | 8.95 | 112.77 |
| 5 | 17 | 8 | 6 | 2 | 15 | 2.0551 | 0.45 | 5.72 | 106.77 | 5.06 | 28.62 |
| 5 | 18 | 8 | 6 | 4 | 31 | 0.99 | 0.45 | 5.81 | 81.88 | 4.59 | 37.88 |
| 5 | 19 | 8 | 6 | 5 | 39 | 0.736 | 0.45 | 5.94 | 60.06 | 5.99 | 52.85 |
| 5 | 20 | 8 | 6 | 6 | 47 | 0.5578 | 0.45 | 5.92 | 47.22 | 6.75 | 66.99 |

As can be seen from Table 1, AC resistance may be related to number of traces, width, and traces across. The thinner traces may lead to lower AC resistance because the thin trace acts similarly to Litz wire. The DC resistance may be affected by number of layers and thickness of copper. The lowest DC resistance occurred in PCB coils having 6 layers and 6-oz of copper.

Increases in amounts of copper may not necessarily be a key contributor to high Q-factors. For example, the highest Q-factor occurred in boards No. 4 and No. 2, but not in No. 5 which has more layers and more copper. A high-performance PCB coil should have a good balance of different structure paraments such as trace width, thickness, number of layers, etc. Generally, in order to achieve high Q, the loss may need to be minimized.

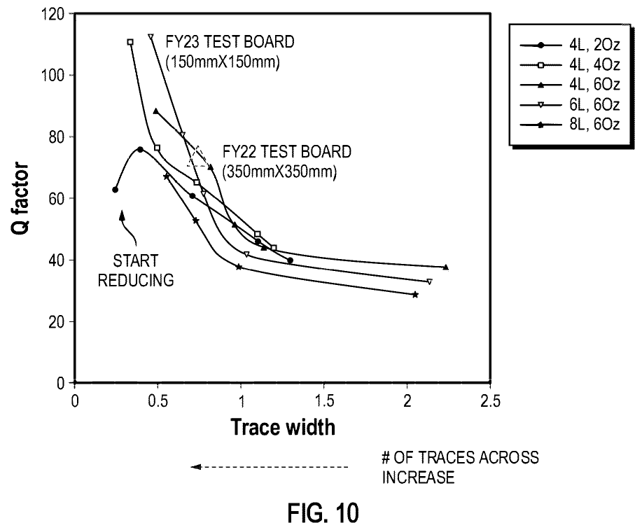

FIG. 10 shows changing trend of Q-factor for the PCB coils of Table 1. As can be seen in FIG. 10, as number of relatively traces increases, the Q-factor increases as well, but there may not be sufficient copper due to minimum gap widths between traces. Optimal design for high Q-factor performance could be achieved by selecting a balancing point between these competing parameters.

Based on the Table 1 and FIG. 10, an example candidate for an optimal PCB board for high power transfer applications (e.g., FIG. 11 below) may be a design having 6-layers with larger number of traces. Moving from 150 mm×150 mm size PCB coil to 350 mm×350 mm may increase the Q-factor result.

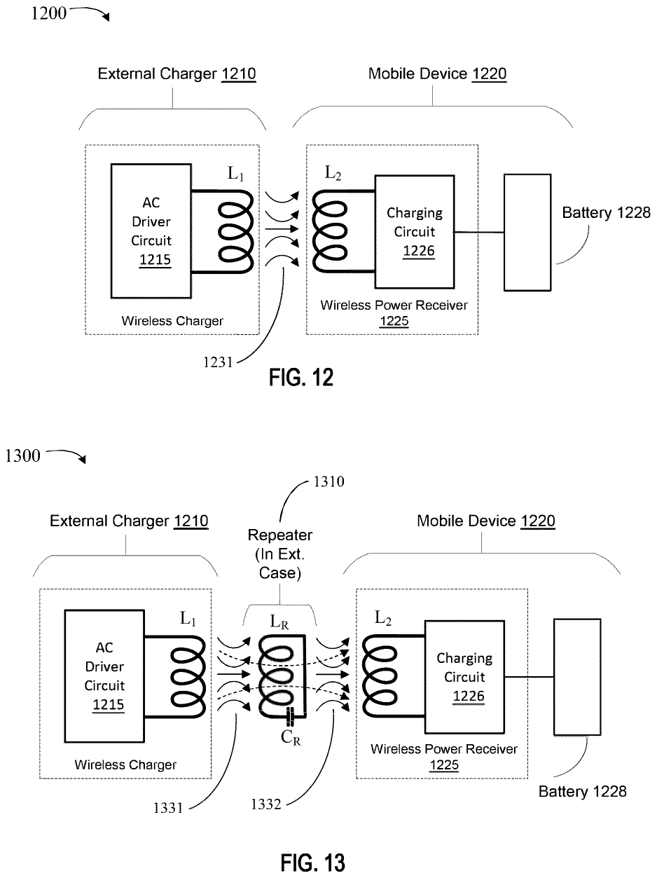

As described in greater detail below and in conjunction with FIGS. 12-26, in various embodiments the above-described PCB coils/trace bundles can be incorporated in modules for wireless charging, such as mobile device cases, coil repeater assemblies, or other types of wireless charging modules.

FIG. 12 provides a block diagram illustrating a conventional wireless charging configuration 1200 for a mobile device. The wireless charging configuration includes an external charger 1210 and a mobile device 1220, which operate together using inductive wireless charging to charge the mobile device. As one example, the mobile device 1220 can be a mobile telephone (e.g., a smartphone). The external charger 1210 is a wireless charger—e.g., a wireless charging pad (such as, e.g., a pad that lays on a flat surface or magnetically attaches to a mobile device)—that includes an alternating current (AC) driver circuit 1215 that is electrically coupled to a first inductive coil (inductor) L1. The external charger is typically of a relatively lower power (e.g., 10-30 W). The mobile device 1220 includes a wireless power receiver 1225 and a battery 1228. The wireless power receiver 1225 includes a second inductive coil (inductor) L2 that is electrically coupled to a charging circuit 1226 (which can include, e.g., a rectifier and/or other electronic components). The second inductive coil L2 is a wireless charging coil in the mobile device 1220 that is used for wireless charging of the mobile device.

The AC driver circuit 1215 is configured to provide AC power to the first coil L1 sufficient to generate a magnetic field 1231 (e.g., an electromagnetic field) which, in turn, passes (e.g., permeates or radiates) into the second coil L2 (i.e., the wireless charging coil in the mobile device 1220) when the second coil L2 is in sufficiently close proximity to the first coil L1. The AC driver circuit is further configured such that, in conjunction with the first coil L1, the provided AC power is of a selected frequency fC—which can be designed to match (at least approximately) a resonant frequency of the wireless power receiver 1225.

When the first coil L1 and the second coil L2 are in sufficiently close proximity and when power is applied by the AC driver circuit 1215, the magnetic field 1231 from L1 passes (e.g., permeates or radiates) into the second coil L2 (i.e., the wireless charging coil in the mobile device 1220). The second coil L2 (in conjunction with the charging circuit 1225) then transfers power from the magnetic field 1231 into electric power, via inductive coupling, to be supplied to charge the battery 1228. In this way, the wireless power receiver 1225 generates (e.g., provides) electric power to charge the battery 1228 when the second coil L2 is exposed to a changing magnetic field 1231 from L1.

Existing wireless charging technologies used in connection with mobile devices—such as the conventional wireless charging configuration 1200 as described with reference to FIG. 12—encounter significant power transfer inefficiency and limitations when mobile devices are covered with thick (or dense) protective cases. For example, the longer transmission path caused by a thick case leads to an extremely slow charging speed or complete failure of the charging process. Such difficulties are alleviated by the improved wireless charging technology described below.

FIG. 13 provides a diagram illustrating an example of an improved wireless charging configuration 1300 for a mobile device according to one or more embodiments, with reference to components and features described herein including but not limited to the figures and associated description. As shown in FIG. 13, the improved wireless charging configuration 1300 includes the external charger 1210 (FIG. 12, already discussed) and the mobile device 1220 (FIG. 12, already discussed). The improved wireless charging configuration 1300 as shown in FIG. 13 also includes a wireless charging repeater circuit 1310, which is included as part of an external case (e.g., a protective case for the mobile device) (not shown in FIG. 13). The external case with the wireless charger repeater circuit 1310 is typically attached to the mobile device 1220 and, thus, the wireless charger repeater circuit 1310 is situated between the external charger 1210 and the wireless power receiver 1225 of the mobile device 1220. The external charger 1210 is external to both the mobile device 1220 and the external case that has the wireless charging repeater circuit 1310.

The wireless charging repeater circuit 1310 includes a third inductive coil (inductor) LR and a tuning capacitor CR that is electrically coupled to each end of the coil LR. The capacitor CR includes one or more physical capacitors, which are selected based on the particular requirements for the wireless charging repeater circuit 1310 such as, e.g., capacitance value, size/space considerations, etc. The third inductive coil LR and the capacitor CR form a resonant circuit, and the components are selected such that the resonant frequency of the wireless charging repeater circuit 1310 matches (at least approximately) the resonant frequency fC of the external charger 1210 and/or the resonant frequency of the wireless power receiver 1225. In some embodiments the wireless charging repeater circuit 1310 includes additional electronic components (not shown in FIG. 13). Notably, however, in all embodiments the wireless charging repeater circuit 1310 excludes electrical connection to any active component (including components such as, e.g., a battery, solar cell or other power source) that supplies power.

The external case is designed to be attached to the mobile device such that it covers at least a portion of the mobile device 1220. For example, in embodiments the external case is a protective case that snaps on the back of the mobile device 1220 and covers all or a portion of the back and edges of the mobile device 1220. The inductive coil LR of the wireless charging repeater circuit 1310 is arranged such that, when the external case is attached to the mobile device 1220, the inductive coil LR is located proximate to the coil L2 (i.e., the wireless charging coil in the mobile device 1220) of the wireless power receiver 1225 in the mobile device 1220. For example, in embodiments when the external case is attached to the mobile device 1220, the inductive coil LR is located parallel to and within a short distance from the coil L2 in the wireless power receiver 1225 such that the center of the inductive coil LR is aligned (at least approximately) with the center of the coil L2.

In operation, the external case is attached to the mobile device 1220 (e.g., snapped on the back of the mobile device 1220). When the external charger 1210 is placed in sufficiently close proximity to the external case (as attached to the mobile device 1220), and power is applied by the AC driver circuit 1215, a first magnetic field 1331 (e.g., an electromagnetic field) from the coil L1 passes (e.g., permeates or radiates) into the inductive coil LR of the wireless charging repeater circuit 1310. The wireless charging repeater circuit 1310 then generates a second magnetic field 1332 (e.g., an electromagnetic field) via the inductive coil LR of the wireless charging repeater circuit 1310 from the first magnetic field 1331, via inductive coupling between the coil L1 and the inductive coil LR. The second magnetic field 232 passes (e.g., permeates or radiates) into the coil L2. The coil L2 then transfers power from the second magnetic field into electric power, via inductive coupling between the coil L2 and the coil LR, to be supplied to charge the battery 1228 in the mobile device 1220.

In some circumstances, some of the magnetic field 1331 from the coil L1 can pass through the coil LR and into the coil L2 (illustrated as dotted lines between the coil L1 and the coil L2). The amount of the magnetic field 1331 that can reach the coil L2 can depend on several factors, including the strength of the magnetic field 1331, the thickness of the external case, among other factors. Further, the presence of the wireless charging repeater circuit 1310 improves the focus of the flux to help correct any misalignment between the external charger 1210 and the mobile device 1220. As a result, in operation the coil LR boosts flux linkage between the coil L1 and the coil L2 to enhance coupling and transfer of power between the external charger 1210 and the mobile device 1220.

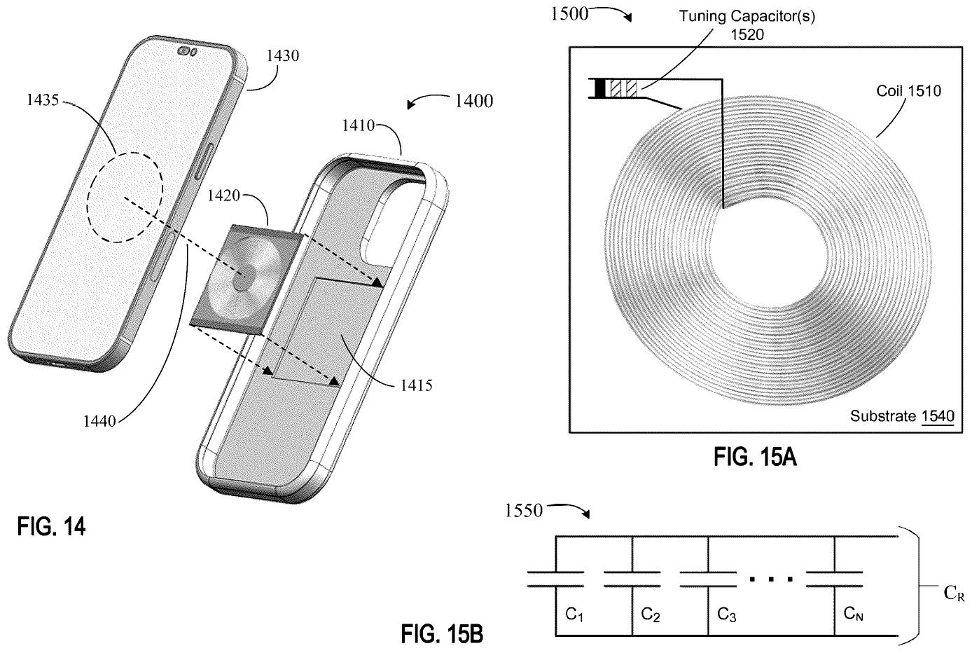

FIG. 14 provides a diagram illustrating an example of a mobile device case 1400 with a coil repeater assembly for wireless charging according to one or more embodiments, with reference to components and features described herein including but not limited to the figures and associated description. As shown in FIG. 14, the mobile device case 1400 includes a case body 1410 and a coil repeater assembly 1420 that is positioned on or within an interior surface of the case body 1410. The mobile device case 1400 is configured to be attached to the mobile device 1430. For example, in some embodiments the mobile device case 1400 is designed such that the mobile device case 1400 snaps onto the back of the mobile device 1430. The mobile device 1430 corresponds to the mobile device 1220 (FIGS. 12 and 13, already discussed) and, thus, includes a wireless charging coil L2, where the location of the coil L2 in the mobile device 1430 is indicated by the dotted circle 1435.

The coil repeater assembly 1420 includes a wireless charging repeater circuit and a substrate. The wireless charging repeater circuit of the coil repeater assembly 1420 corresponds to the wireless charging repeater circuit 1310 (FIG. 13, already discussed) and, thus, includes an inductive coil LR that is electrically coupled to a capacitor CR. Notably, however, in all embodiments the wireless charging repeater circuit of the coil repeater assembly 1420 excludes electrical connection to any active component (including components such as, e.g., a battery, solar cell or other power source) that supplies power. The substrate provides a supporting structure to hold or position the wireless charging repeater circuit. Further details regarding the coil repeater assembly 1420 are provided herein with reference to FIGS. 15A-15B, 16 and 17.

The coil repeater assembly 1420 is attached on or within an interior surface of the case body 1410 (e.g., via an adhesive or other techniques for attachment). In some embodiments, the case body 1410 includes a recessed region 1415 to hold the coil repeater assembly 1420 in position. In some embodiments, the recessed region 1415 is of a depth that matches (at least approximately) the thickness of the coil repeater assembly 1420 to permit the coil repeater assembly 1420 of the mobile device case 1400 to fit as closely as possible to the mobile device 1430—e.g., such that in some embodiments the inductive coil LR is positioned against the back of the mobile device 1430 (or in some other embodiments there may be a very thin gap between the coil LR and the back of the mobile device 1430) when the mobile device case 1400 is attached to the mobile device 1430.

The case body 1410 is designed to be attached to the mobile device 1430—for example, by snapping onto the back of the mobile device 1430. Thus, the particular configuration and dimensions of the case body 1410 will depend on the configuration and dimensions of the mobile device 1430—which in turn can depend on the manufacturer and/or model of the mobile device 1430. In embodiments, the case body 1410 also includes cutouts or spaces to permit use of various features of the mobile device 1430 while the mobile device case 1400 is attached thereto. As one example, if the mobile device 1430 is a smartphone with a camera, the case body 1410 can include an opening to allow external light to enter a camera sensor in the mobile device 1430, thus enabling use of the camera while the mobile device case 1400 is attached.

The coil repeater assembly 1420 is arranged on or within the interior surface of the case body 1410 such that, when the mobile device case 1400 is attached to the mobile device 1430, the inductive coil LR of the wireless charging repeater circuit is located proximate to a wireless charging coil (e.g., the coil L2) in the mobile device 1430. For example, in embodiments, when the mobile device case 1400 is attached to the mobile device 1430, the coil LR is located parallel to and within a short distance from the wireless charging coil (where the location of the wireless charging coil in the mobile device 1430 is indicated by the dotted circle 1435). As one example, in some embodiments the coil LR is positioned against the back of the mobile device 1430 when the mobile device case 1400 is attached to the back of mobile device 1430, and in some other embodiments there may be a very thin gap between the coil LR and the back of the mobile device 1430. Further, the center of the coil LR is aligned (at least approximately) with the center of the wireless charging coil (indicated in FIG. 14 by the dotted line 1440). The location of the wireless charging coil can depend on the manufacturer and model of the mobile device 1430 and, thus, the case body 1410 and the location of the coil repeater assembly 1420 (and of any recessed region 1415 to hold the coil repeater assembly 1420) on or within the interior surface of the case body 1410 can likewise be positioned based on the manufacturer and model of the mobile device 1430 for which the case body 1410 is intended to fit.

In operation, with the mobile device case 1400 attached to the mobile device 1430, the mobile device case 1400 is placed in proximity to an external wireless charger (such as, e.g., the external charger 1210 in FIGS. 12-13, already discussed), such that the external wireless charger, the coil repeater assembly 1420 having a wireless charging repeater circuit (part of the mobile device case 1400) and the mobile device 1430 form a wireless charging configuration (e.g., such as, e.g., the wireless charging configuration 1300 in FIG. 13, already discussed). As such, the wireless charging configuration operates as described with reference to the wireless charging configuration 1300 in FIG. 13. In particular, when exposed to a changing magnetic field from the external wireless charger, the wireless charging repeater circuit of the coil repeater assembly 1420 operates to generate a magnetic field that passes (e.g., permeates or radiates) into the wireless charging coil (e.g., the coil L2) in the mobile device.

FIG. 15A provides a diagram illustrating an example of a coil repeater assembly 1500 for use in wireless charging according to one or more embodiments, with reference to components and features described herein including but not limited to the figures and associated description. The coil repeater assembly 1500 is to be placed on or within a surface of a mobile device case body (such as, e.g., the case body 1410 of the mobile device case 1400 in FIG. 14, already discussed). In embodiments the coil repeater assembly 1500 corresponds to the coil repeater assembly 1420 (FIG. 14, already discussed). As shown in FIG. 15, the coil repeater assembly 1500 includes an inductive coil 1510, one or more tuning capacitor(s) 1520, and a substrate 1540. The tuning capacitor(s) 1520 are electrically coupled to each end of the coil 1510, and the inductive coil 1510 and the one or more tuning capacitor(s) 1520 form a wireless charging repeater circuit that corresponds to the wireless charging repeater circuit 1310 (FIG. 13, already discussed). As such, the inductive coil 1510 corresponds to the inductive coil LR (FIG. 13, already discussed), and the tuning capacitor(s) 1520 correspond to the capacitor CR (FIG. 13, already discussed). Notably, however, in all embodiments the wireless charging repeater circuit excludes electrical connection to any active component (including components such as, e.g., a battery, solar cell or other power source) that supplies power. The components LR and CR of the wireless charging repeater circuit are selected such that the resonant frequency of the wireless charging repeater circuit matches (at least approximately) the resonant frequency fC of the external charger and/or the resonant frequency of the wireless power receiver of the mobile device.

The substrate 1540 provides a supporting structure to hold or position the wireless charging repeater circuit (or components thereof), such as the inductive coil 1510 and/or the tuning capacitors 1520. In some embodiments the substrate 1540 is any material suitable for a printed circuit board (PCB), such as, e.g., a fiberglass/epoxy material (e.g., FR4). In some embodiments, the substrate 1540 is a ceramic or crystalline material e.g., as used in manufacturing thin film circuits. In some embodiments, the substrate is a flexible film or thin film including a material such as used in thin film circuitry or flexible circuitry. Use of a flexible film or thin film as a substrate enables use in a case body that is flexible or pliable. As an example, in some embodiments, the substrate is of a thickness of approximately 1 mm or less for a PCB, or 0.5 mm or less for a thin film or flexible circuit.

As alluded to above, in some embodiments the inductive coil 1510 may comprise one of the PCB coils/trace bundles described above in conjunction with FIGS. 1-11.

For example, in certain embodiments inductive coil 1510 may comprise: (1) a first conductor layer comprising first trace segments; (2) a second conductor layer comprising second trace segments; and (3) interlayer connectors electrically interconnecting segments of the first trace segments to segments of the second trace segments to form traces. Here, substrate 1540 may comprise an insulating layer disposed between the two conductor layers. As alluded to above, each trace of the formed traces may comprise a respective subset of the first trace segments electrically interconnected by a subset of the interlayer connectors to a corresponding subset of second trace segments such that the interconnected trace segments are woven through and around substrate 1540. Accordingly, the traces may form as a conductive line woven through and around substrate 1540 to form the inductive coil 1510 of the coil repeater assembly 1500. In some of these embodiments, density of the traces may vary across a length of the inductive coil 1510. For example, a first density of the traces at a first location on the inductive coil 1510 may be greater than a second density of the traces at a second location on the inductive coil 1510, wherein the first location is closer to a center of the inductive coil 1510 than the second location. As a related example, the density of the traces may be greater at higher current locations of the inductive coil 1510 than lower current locations of the inductive coil 1510. As described above, the density of the traces may be based on at least one of: (a) spacing between trace segments of a respective conductor layer; and (b) spacing between the interlayer connectors. As described above, a trace segment of a respective conductor layer may extend in a linear direction and parallel to other trace segments of the respective conductor layer. Relatedly, first trace segments of the first conductor layer may cross over the second trace segments of the second conductor layer (see e.g., FIGS. 1-11 above).

Related to the example embodiment for the inductive coil 1510 discussed in the previous paragraph, in certain embodiments the inductive coil 1510 may comprise turns of a trace bundle. As described above, the trace bundle may comprise traces formed from trace segments electrically interconnected by interlayer connectors. A respective trace may comprise electrically interconnected trace segments across multiple layers. Relatedly, density of the traces may vary across a length of the inductive coil 1510.

More generally, the inductive coil 1510 may comprise a metallic inductive coil winding made of a metal such as copper, copper alloy, etc. In embodiments the coil 1510 is a metallic trace (e.g., copper, copper alloy, etc.) that is disposed on a surface of the substrate 1540 through one of any of a number of techniques known in electronics manufacturing (e.g., techniques used in manufacturing PCBs and/or thin film or flexible circuits). In some embodiments, the coil 1510 is made of multiple thin copper traces arranged in a parallel or in a spiral or concentric configuration on the surface of the substrate. Each of these traces is narrow and thin, collectively acting like strands of a litz wire. They are isolated from each other with dielectric material inherent to the substrate. In some embodiments (e.g., limited planar size), a single flat copper winding path is used instead copper strands. It will be understood that, while the coil 1510 illustrated in FIG. 15A is a circular winding (or an approximation thereto), the coil 1510 can in embodiments be a winding of another shape such as, e.g., a square, a rectangle, etc. (or an approximation thereto).

The one or more tuning capacitor(s) 1520 are one or more small capacitors such as, e.g., used in manufacturing PCBs and/or thin film or flexible circuits. In some embodiments the one or more tuning capacitor(s) 1520 are thin film capacitors. The one or more capacitors 1520 are selected based on the particular requirements for the wireless charging repeater circuit of the coil repeater assembly 1500 such as, e.g., capacitance value, size/space considerations, etc. In some embodiments, the tuning capacitor(s) 1520 are placed on the substrate 1540 and electrically coupled to the coil 1510 via, e.g., metallic traces. In some other embodiments, the tuning capacitor(s) 1520 are placed elsewhere on or within the case body and electrically coupled to the coil 1510 via, e.g., wires.

In some embodiments, the wireless charging repeater circuit of the coil repeater assembly 1500 further includes a charge indicator element. In some embodiments, the charge indicator element includes an AC-powered LED light which connects to the circuit in the repeater board. When power transfer occurs via the wireless charging repeater circuit, the charge indicator is on. Once the battery is full and no wireless power is being transferred, the charge indicator is off. The charge indicator can be embedded into the protective case. Generally, the charge indicator should be exposed to the outside of the case rather than covered by the case, thus enabling a user to easily tell that the mobile device is being charged.

In some embodiments, the wireless charging repeater circuit of the coil repeater assembly 1500 further includes a tuning subcircuit as an auxiliary tuning stage to help provide that the wireless charging repeater circuit resonates at the same frequency as other components of wireless power transfer system (e.g., the external charger and the charging circuit of the mobile device). The tuning subcircuit includes one or more tuning capacitors that can be selected (e.g., inserted or changed) to adjust or fine-tune the resonant frequency of the wireless charging repeater circuit. Further details regarding the tuning capacitors for a tuning subcircuit are provided herein with reference to FIG. 15B and FIG. 17. In some embodiments, the tuning subcircuit further includes other components (not shown in FIG. 15B or FIG. 17) in various circuit configurations such as, e.g., resistors, extra inductors, switches (e.g., IGBTs) for even more complex applications, etc.

FIG. 15B provides a diagram illustrating an example circuit 1550 of tuning capacitors for use in a coil repeater assembly according to one or more embodiments, with reference to components and features described herein including but not limited to the figures and associated description. The circuit 1550 of tuning capacitors corresponds to the tuning capacitor CR (FIG. 13, already discussed) and/or to the tuning capacitor(s) 1520 (FIG. 14A, already discussed). As shown in FIG. 15B, the circuit 1550 includes one or more capacitors C1, C2, C3, . . . CN that are electrically coupled or connected in parallel. The capacitors C1, C2, C3, . . . CN are selected based on the particular requirements for the wireless charging repeater circuit of the coil repeater assembly 1500 such as, e.g., capacitance value, size/space considerations, etc. In some embodiments, the tuning capacitors C1, C2, C3, . . . CN are coupled or connected in other circuit configurations (e.g., series, series-parallel, etc.). In embodiments the tuning capacitors can be selected (e.g., inserted or changed) as part of a tuning subcircuit to adjust or fine-tune the resonant frequency of the wireless charging repeater circuit.

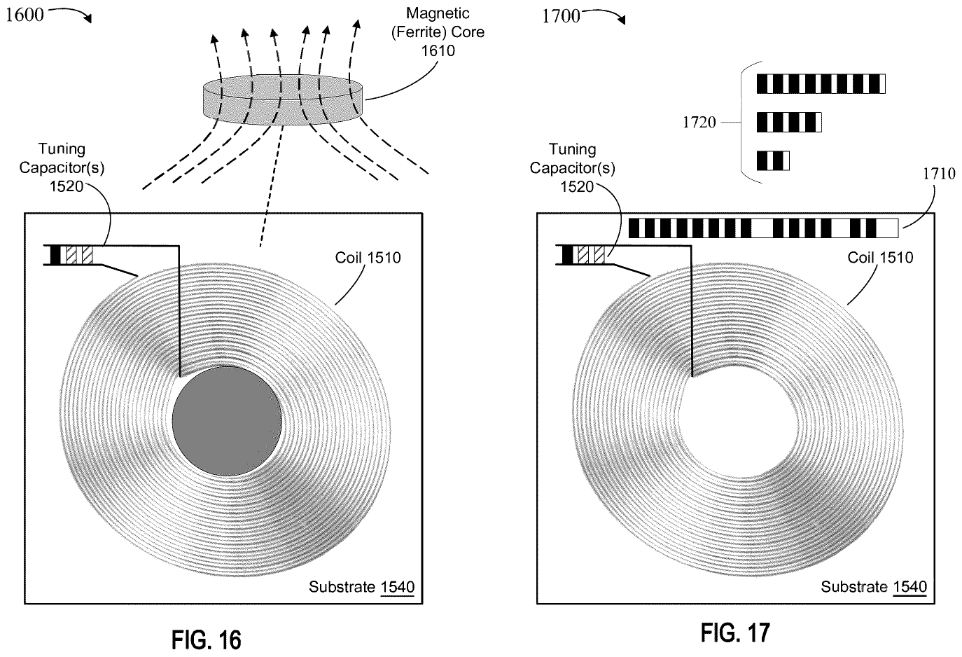

FIG. 16 provides a diagram illustrating an example of a coil repeater assembly 1600 for use in wireless charging according to one or more embodiments, with reference to components and features described herein including but not limited to the figures and associated description. In embodiments the coil repeater assembly 1600 corresponds to the coil repeater assembly 1420 (FIG. 14, already discussed). The coil repeater assembly 1600 includes several components that are illustrated and discussed with reference to the coil repeater assembly 1500 in FIG. 15 (including the inductive coil 1510 and the tuning capacitors 1520 of the wireless charging repeater circuit), and discussion of such components will not be repeated except as necessary to describe the embodiments of FIG. 16. In addition to those components, the coil repeater assembly 1600 also includes a magnetic core 1610 such as, e.g., a ferrite core. The magnetic core 1610 is arranged in the interior of the coil LR of the wireless charging repeater circuit. In embodiments the coil LR is wound around the magnetic core 1610. The magnetic core 1610 can be inserted to increase the magnetic field in the center area (e.g., to focus the magnetic field or to prevent magnetic leakage to air).

FIG. 17 provides a diagram illustrating an example of a coil repeater assembly 1700 for use in wireless charging according to one or more embodiments, with reference to components and features described herein including but not limited to the figures and associated description. In embodiments the coil repeater assembly 1700 corresponds to the coil repeater assembly 1420 (FIG. 14, already discussed). The coil repeater assembly 1700 includes several components that are illustrated and discussed with reference to the coil repeater assembly 1500 in FIG. 15 (including the inductive coil 1510 and the tuning capacitors 1520 of the wireless charging repeater circuit), and discussion of such components will not be repeated except as necessary to describe the embodiments of FIG. 17. In addition to those components, the coil repeater assembly 1700 also includes a slot 1710 configurable to hold one or more tuning capacitors 1720 (e.g., to provide a capacitor circuit such as the circuit 1550 (e.g., a tuning subcircuit) in FIG. 15B, already discussed), which can include one or more supplementary capacitors. The slot 1710 includes one or more socket(s) to hold one or more of the tuning capacitors 1720, where the socket(s) are electrically coupled or connected to each end of the inductive coil 1510 to provide electrical coupling or connectivity of the capacitor(s) 1720 to each end of the coil 1510. If the slot 1710 includes more than one socket, in some embodiments the sockets are connected in parallel, in some embodiments the sockets are connected in series, and in some embodiments the sockets are connected in other configurations (e.g., series-parallel).

The modular configuration provided by the slot 1710 and the tuning capacitors 1720 provides flexibility in design of the wireless charging repeater circuit of the coil repeater assembly 1700. For example, to enable use of higher total capacitance for the tuning capacitor CR, the slot 1710 can hold additional individual capacitors that are electrically coupled in parallel to provide an increased capacitance value. Moreover, a selection of modular tuning capacitors 1720 (e.g., of different capacitance values) can be provided to enable tuning or customization of the wireless charging repeater circuit for different models of the mobile device (e.g., the mobile device 1430).

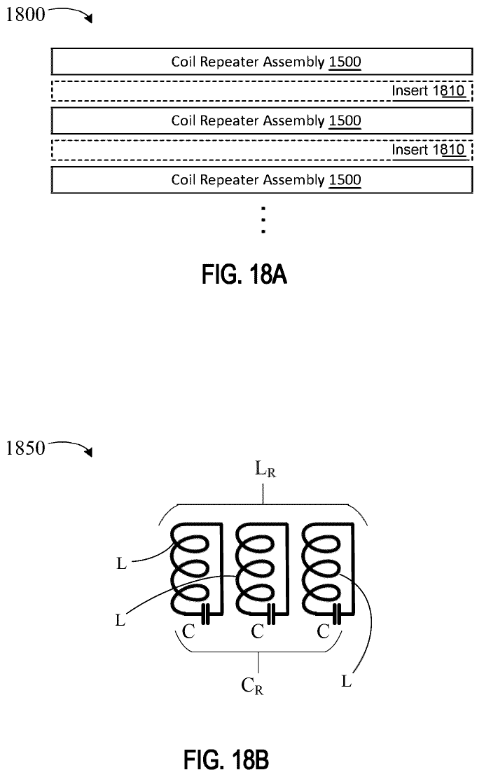

FIG. 18A provides a diagram illustrating an example of a stacked arrangement 1800 of coil repeater assemblies (side view) according to one or more embodiments, with reference to components and features described herein including but not limited to the figures and associated description. The stacked arrangement 1700 is used in embodiments as a wireless charging repeater circuit in the mobile device case 1400 for wireless charging. As shown in FIG. 18A, the stacked arrangement 1800 includes a plurality of layers, including a plurality of coil repeater assemblies 1500. In some embodiments, the stacked arrangement 1800 also includes one or more optional insert layers 1810. Each insert layer 1810 is arranged between and adjacent to two coil repeater assemblies 1500. For example, as illustrated in FIG. 18A the layers of the stacked arrangement 1800 are placed adjacent to each other (e.g., pressed together) in a stacked formation. The insert layer 1810 comprises an electrically-insulating layer, and can be used, e.g., to adjust the spacing between any two coil repeater assemblies 1500.

Although the example stacked arrangement 1800 as illustrated in FIG. 18A shows five layers—comprising three coil assemblies 1500, each separated by an insert layer 1810, it will be understood that or fewer or additional layers can be included in any particular embodiment of the stacked arrangement 1800. For example, the stacked arrangement 1800 can include two layers (two coil repeater assemblies 1500), three layers (two coil repeater assemblies 1500 separated by an insert layer 1810, or three coil repeater assemblies 1500 without an insert layer 1810), etc. Furthermore, while the example stacked arrangement 1800 as illustrated in FIG. 18A shows a plurality of coil repeater assemblies 1500, it will be understood that one or more coil repeater assemblies 1600 or one or more coil repeater assemblies 1700 can, in any particular embodiment, be substituted for one or more coil repeater assemblies 1500 in the stacked arrangement 1800.

FIG. 18B provides a diagram illustrating an example wireless charging repeater circuit 1850 for a stacked arrangement of coil repeater assemblies (e.g., the stacked arrangement 1800 in FIG. 18A) according to one or more embodiments, with reference to components and features described herein including but not limited to the figures and associated description. As shown in FIG. 18B, the wireless charging repeater circuit 1850 includes a series of coils L, each coil L corresponding to a coil in one of the coil repeater assemblies 1500 in the stacked arrangement 1600. As illustrated in FIG. 18B, the wireless charging repeater circuit 1850 also includes one or more tuning capacitor(s) CR electrically coupled to each end of one of the coils L. When combined in a stacked arrangement, the coils L provide the coil LR of the wireless charging repeater circuit 1850 and the capacitors C provide the tuning capacitor CR. In embodiments the wireless charging repeater circuit 1850 can include additional components not shown in FIG. 18B. While the example wireless charging repeater circuit 1850 as illustrated in FIG. 18B shows three coils/tuning capacitors (representing three stacked coil assemblies), it will be understood that or fewer or additional coils/tuning capacitors (representing fewer or additional stacked coil assemblies), can be included in any particular embodiment of the wireless charging repeater circuit 1850.

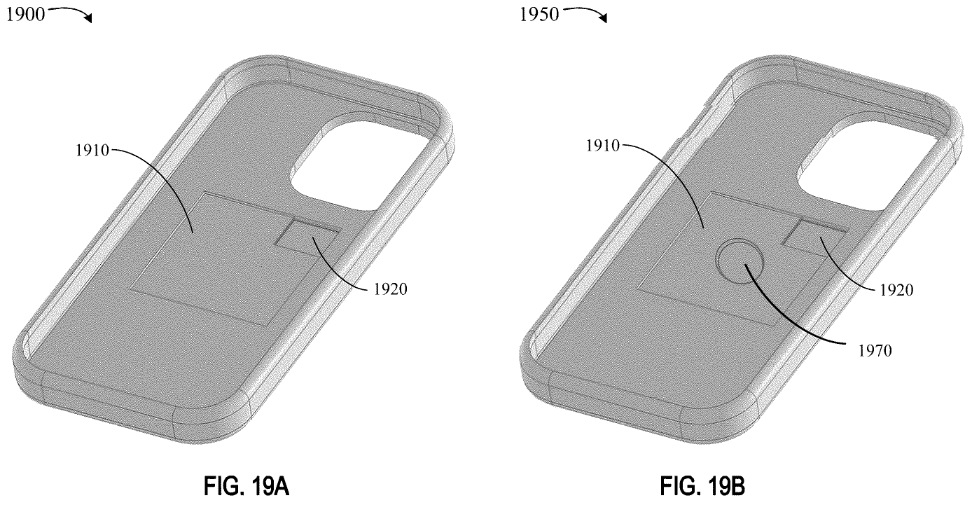

FIGS. 19A-19B provide diagrams illustrating examples of a case body 800 and a case body 850 for a mobile device case according to one or more embodiments, with reference to components and features described herein including but not limited to the figures and associated description. Each of the case body 1900 and the case body 1950 are alternative examples for use in a mobile device case (such as, e.g., the mobile device case 1400 in FIG. 14, already discussed). As shown in FIG. 19A, the case body 1900 includes a first recessed region 1910 and a second recessed region 1920, where the depth of the second recessed region 1920 is different (e.g., deeper) than the depth of the first recessed region 1910. The first recessed region 1910 is similar to the recessed region 1415 (FIG. 14, already discussed), such that in embodiments the recessed region 1910 is of a depth that matches (at least approximately) the thickness of most of the coil repeater assembly—except for, e.g., an area where the tuning capacitor(s) or other circuitry of the wireless charging repeater circuit that is in the coil repeater assembly are located). The second recessed region 1920 is located in an area that corresponds to the location of the tuning capacitor(s) or other circuitry. In embodiments the second recessed region 1920 is of a depth that matches (at least approximately) the thickness of the portion of the coil repeater assembly that includes tuning capacitor(s) or other circuitry. Thus, together the first recessed region 1910 and the second recessed region 1920 hold the coil repeater assembly (such as the coil repeater assembly 1420 in FIG. 14, already discussed).

Turning now to FIG. 19B, the illustrated case body 1950 typically includes the features of the case body 1900 (FIG. 19A) (i.e., the first recessed region 1910 and the second recessed region 1920), along with a third recessed region 1970. The third recessed region 1970 is typically deeper than the first recessed region 1910. The third recessed region 1970 is located in an area that corresponds to the location of a magnetic core (e.g., the magnetic core 1610 in FIG. 16, already discussed) in the wireless charging repeater circuit that is in the coil repeater assembly. In embodiments the third recessed region 1970 is of a depth that matches (at least approximately) the thickness of the portion of the coil repeater assembly that includes the magnetic core. In some embodiments, the case body 1950 includes the first recessed region 1910 and third recessed region 1970 but not the second recessed region 1920 (e.g., use of thin film capacitor(s) as the tuning capacitor(s)).

Each of the case body 1900 and the case body 1950 is designed to be attached to a mobile device (such as, e.g., the mobile device 1430 in FIG. 14)—for example, by snapping onto the back of the mobile device. Thus, the particular configuration and dimensions of the case body 1900 and/or the case body 1950 will depend on the configuration and dimensions of the mobile device—which in turn can depend on the manufacturer and/or model of the mobile device. Further, in embodiments, when a mobile device case with the case body 1900 or the case body 1950 is attached to the mobile device, the center of the coil LR of the wireless charging repeater circuit is aligned (at least approximately) with the center of the wireless charging coil in the mobile device. The location of the wireless charging coil can depend on the manufacturer and model of the mobile device and, thus, the location of the coil repeater assembly (and of the first recessed region 1910 to hold the greater portion of the coil repeater assembly) on or within the interior surface of the case body 1900 and/or the case body 1950 can likewise be positioned based on the manufacturer and model of the mobile device for which the case body 1900 and/or the case body 1950 is intended to fit.

In embodiments, the case body 1900 and/or the case body 1950 also include cutouts or spaces to permit use of various features of the mobile device while the mobile device case is attached thereto. As one example, if the mobile device is a smartphone with a camera, the case body 1900 and/or the case body 1950 can include an opening to allow external light to enter a camera sensor in the mobile device, thus enabling use of the camera while the mobile device case is attached.

In operation, with a mobile device case having the case body 1900 or the case body 1950 attached to the mobile device (such as, e.g., the mobile device 1430), the mobile device case is placed in proximity to an external wireless charger (such as, e.g., the external charger 1210 in FIGS. 12-13, already discussed), such that the external wireless charger, the with a coil repeater assembly having a wireless charging repeater circuit (part of the mobile device case)—and the mobile device form a wireless charging configuration (e.g., such as, e.g., the wireless charging configuration 1300 in FIG. 13, already discussed). As such, the wireless charging configuration operates as described with reference to the such as, e.g., the wireless charging configuration 1300 in FIG. 13. In particular, when exposed to a changing magnetic field from the external wireless charger, the wireless charging repeater circuit of the coil repeater assembly operates to generate a magnetic field that passes (e.g., permeates or radiates) into the wireless charging coil (e.g., the coil L2) in the mobile device.

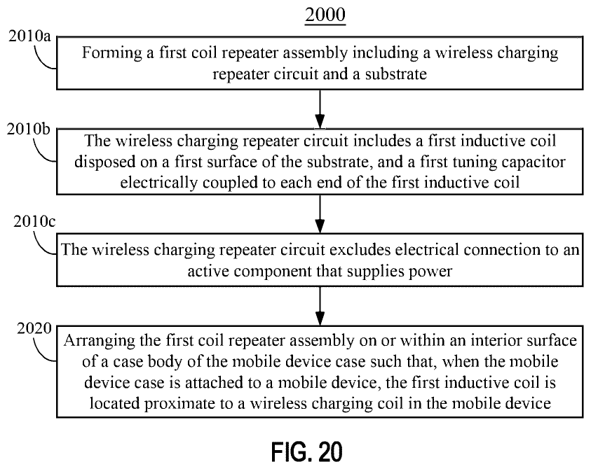

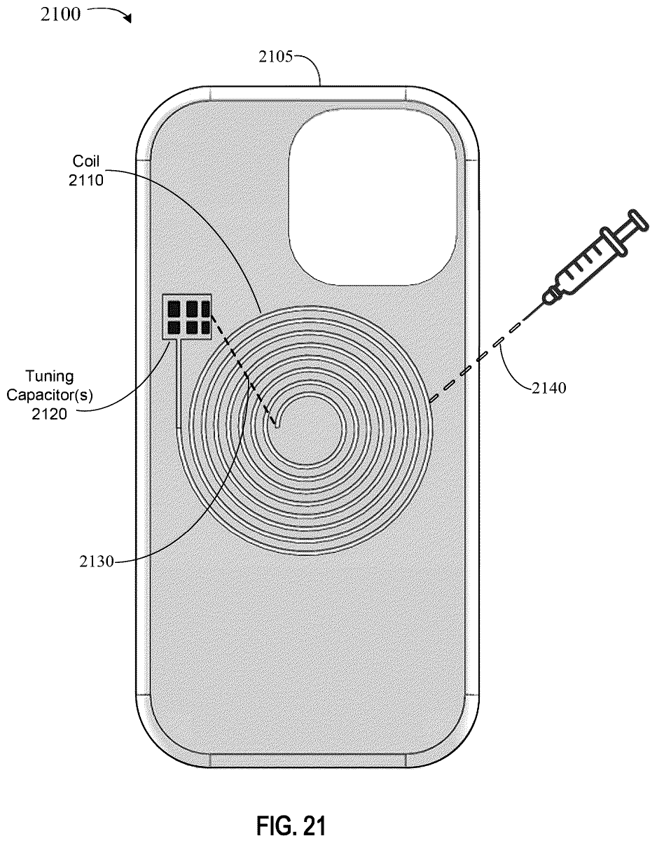

FIG. 20 provides a flow diagram illustrating an example method 900 of constructing a mobile device case with a coil repeater assembly for wireless charging according to one or more embodiments, with reference to components and features described herein including but not limited to the figures and associated description. In embodiments, the mobile device case corresponds to one or more of the mobile device case 1400 (FIG. 14, already discussed), the mobile device case with the case body 1900 (FIG. 19A, already discussed), and/or the mobile device case with the case body 1950 (FIG. 19B, already discussed). In embodiments, the coil repeater assembly corresponds to one or more of the coil repeater assembly 1420 (FIG. 14, already discussed), the coil repeater assembly 1500 (FIG. 15, already discussed), the coil repeater assembly 1600 (FIG. 16, already discussed), and/or the coil repeater assembly 1700 (FIG. 7, already discussed).

Block 2010a provides for forming a first coil repeater assembly including a wireless charging repeater circuit and a substrate, where at block 2010b the wireless charging repeater circuit includes a first inductive coil disposed on a first surface of the substrate, and a first tuning capacitor electrically coupled to each end of the first inductive coil, and where at block 2010c the wireless charging repeater circuit excludes electrical connection to an active component that supplies power. Block 2020 provides for arranging the first coil repeater assembly on or within an interior surface of a case body of the mobile device case such that, when the mobile device case is attached to a mobile device, the first inductive coil is located proximate to a wireless charging coil in the mobile device. In embodiments, the wireless charging repeater circuit corresponds to the wireless charging repeater circuit 1310 (FIG. 13, already discussed).

FIG. 21 provides a diagram illustrating an example of a mobile device case 2100 with a microchannel coil for wireless charging according to one or more embodiments, with reference to components and features described herein including but not limited to the figures and associated description. As illustrated in FIG. 21, the mobile device case 2100 includes a case body 2105 having an inductive coil 2110, along with one or more tuning capacitor(s) 1220. The inductive coil 2110 is a conductor-filled microchannel coil formed in the case body 2105—e.g., in the interior surface of the case body 2105. For example, in embodiments the inductive coil 2110 is formed in the case body by molding a microchannel coil into the case body 2105 and then injecting a conductive liquid (e.g., liquid metal) 2140 into the microchannel coil. In embodiments, the injected liquid metal remains in liquid (or semi-liquid) state, such that the inductive coil 2110 remains flexible or pliable—which, in turn, enables use in a case body that is flexible or pliable.

In some embodiments, the microchannel coil that provides the inductive coil 2110 is formed within the case body 2105 via injection molding, three-dimensional (3D) printing, or other processes. The microchannel coil can be formed or refined via laser cutting, micro-milling or other techniques. Once the microchannel coil has been formed and/or refined, next a conductive fluid or paste is injected into the microchannel coil, and then the microchannel coil is sealed via 3D printing, epoxy curing or other techniques for sealing. In some embodiments, the microchannel coil is formed and the metal fluid/paste is placed in the microchannel coil which is then sealed, all via 3D printing, where materials are switched between non-conductive and conductive materials during the 3D printing process to create the microchannel coil (e.g., in the case body formed with a non-conductive material) that is filled with a conductive material (e.g., metallic liquid or paste) then sealed (e.g., with a non-conductive material).

In some embodiments, a magnetic core (e.g. a ferrite core, not shown in FIG. 21) is arranged in the center of the microchannel coil of the inductive coil 2110. Such a magnetic core operates as described herein with reference to the magnetic core 1610 (FIG. 16, already discussed). In some embodiments, the magnetic core is placed in the center of the microchannel coil via 3D printing (e.g., as part of an integrated 3D printing process). In some embodiments, the magnetic core is made of a thin magnetic plate (e.g., a thin ferrite plate) which is placed at the center of the microchannel coil, e.g. in a recessed region/cavity (not shown in FIG. 21). For example, the recessed region can be similar to the recessed region 1970 (FIG. 19B, already discussed) designed to hold the thin magnetic plate in the center of the microchannel coil.

The inductive coil 2110 and the tuning capacitor(s) 2120 form a wireless charging repeater circuit that corresponds to the wireless charging repeater circuit 1310 (FIG. 13, already discussed). As such, the inductive coil 2110 corresponds to the inductive coil LR (FIG. 13, already discussed), and the tuning capacitor(s) 2120 correspond to the capacitor CR (FIG. 2, already discussed). The tuning capacitor(s) 2120 are electrically coupled to each end of the inductive coil 2110. For example, in embodiments one end of the tuning capacitor(s) 2120 are coupled to a near end of the inductive coil 2110, and the other end of the tuning capacitor(s) 2120 are coupled to a far end of the inductive coil 2110 via an electronic path 2130 (e.g., a metallic wire or metallic wire trace embedded in the case body 2105). Notably, however, in all embodiments the wireless charging repeater circuit excludes electrical connection to any active component (including components such as, e.g., a battery, solar cell or other power source) that supplies power. The components LR and CR of the wireless charging repeater circuit are selected such that the resonant frequency of the wireless charging repeater circuit matches (at least approximately) the resonant frequency fC of the external charger and/or the resonant frequency of the wireless power receiver of the mobile device. The tuning capacitor(s) 2120 can include one or more physical capacitors (e.g., connected in parallel), and can include thin film capacitor(s). In some embodiments, the case body 2105 includes a recessed region to hold the tuning capacitor(s) 2120. In some embodiments, the case body 2105 includes a socket to hold at least one of the plurality of physical capacitors, where the at least one of the plurality of physical capacitors is removeable. The socket is electrically coupled or connected to each end of the inductive coil 2110 to provide electrical coupling or connectivity of the tuning capacitor(s) 2120 to each end of the coil 2110.

The case body 2105 is designed to be attached to a mobile device (such as, e.g., the mobile device 1430 in FIG. 14)—for example, by snapping onto the back of the mobile device. Thus, the particular configuration and dimensions of the case body 2105 will depend on the configuration and dimensions of the mobile device—which in turn can depend on the manufacturer and/or model of the mobile device. In embodiments, the case body 2105 also includes cutouts or spaces to permit use of various features of the mobile device while the mobile device case 2100 is attached thereto. As one example, if the mobile device is a smartphone with a camera, the case body 2105 can include an opening to allow external light to enter a camera sensor in the mobile device, thus enabling use of the camera while the mobile device case 2100 is attached.

The inductive coil 2110 is manufactured within the case body 2105 such that, when the mobile device case 2100 is attached to the mobile device, the inductive coil 2110 of the wireless charging repeater circuit is located proximate to a wireless charging coil (e.g., the coil L2) in the mobile device. For example, in embodiments, when the mobile device case 2100 is attached to the mobile device, the coil 2110 is located parallel to and within a short distance from the wireless charging coil in the mobile device. Further, the center of the coil 2110 is aligned (at least approximately) with the center of the wireless charging coil in the mobile device. The location of the wireless charging coil can depend on the manufacturer and model of the mobile device and, thus, the location of the coil 2110 within the case body 2105 can likewise be positioned based on the manufacturer and model of the mobile device for which the case body 2105 is intended to fit. As described above, in certain embodiments the inductive coil may comprise one of the PCB coils/trace bundles described in conjunction with FIGS. 1-11.

In operation, with the mobile device case 2100 attached to the mobile device (such as, e.g., the mobile device 1430), the mobile device case 2100 is placed in proximity to an external wireless charger (such as, e.g., the external charger 1210 in FIGS. 12-13, already discussed), such that the external wireless charger, the wireless charging repeater circuit (part of the mobile device case 2100)—and the mobile device form a wireless charging configuration (e.g., such as, e.g., the wireless charging configuration 1300 in FIG. 13, already discussed). As such, the wireless charging configuration operates as described with reference to the wireless charging configuration 1300 in FIG. 13. In particular, when exposed to a changing magnetic field from the external wireless charger, the wireless charging repeater circuit operates to generate a magnetic field that passes (e.g., permeates or radiates) into the wireless charging coil (e.g., the coil L2) in the mobile device.

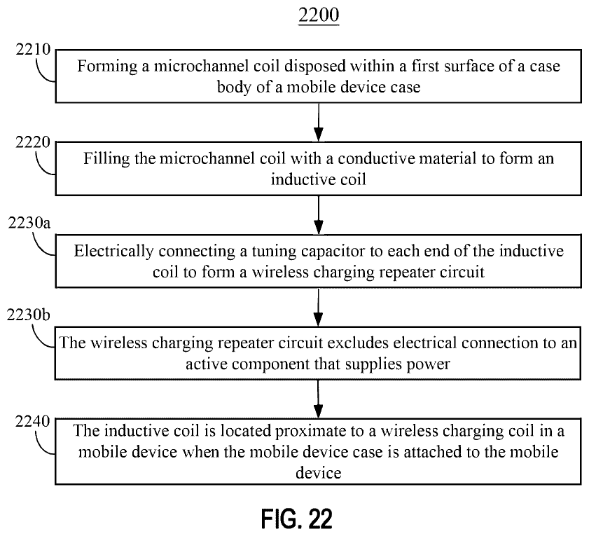

FIG. 22 provides a flow diagram illustrating an example method 2200 of constructing a mobile device case with a coil repeater assembly for wireless charging according to one or more embodiments, with reference to components and features described herein including but not limited to the figures and associated description. Block 2210 provides for forming a microchannel coil disposed within a first surface of a case body of a mobile device case. Block 2220 provides for filling the microchannel coil with a conductive material to form an inductive coil. As described above, in certain embodiments the inductive coil may comprise one of the PCB coils/trace bundles described in conjunction with FIGS. 1-11. In some embodiments, the conductive material is a metal in liquid or paste form. Block 2230a provides for electrically connecting a tuning capacitor to each end of the inductive coil to form a wireless charging repeater circuit, where at block 2230b the wireless charging repeater circuit excludes electrical connection to an active component that supplies power. Block 2240 provides that the inductive coil is located proximate to a wireless charging coil in a mobile device when the mobile device case is attached to the mobile device. In embodiments, the wireless charging repeater circuit corresponds to the wireless charging repeater circuit 1310 (FIG. 13, already discussed).

### Flexible Sticker Coil Repeater Assembly for Mobile Device Case

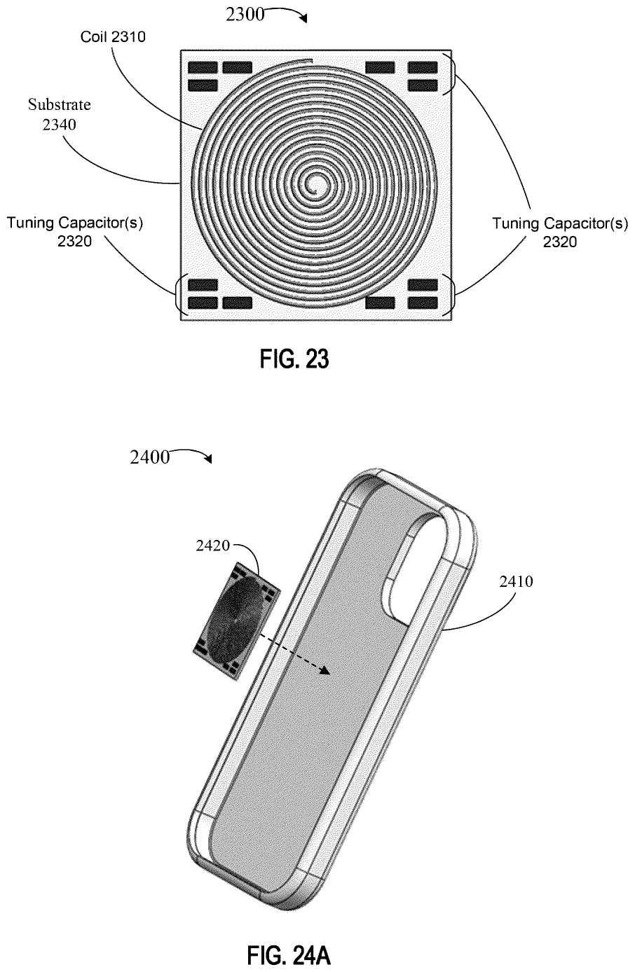

FIG. 23 provides a diagram illustrating an example of a coil repeater assembly 2300 for wireless charging according to one or more embodiments, with reference to components and features described herein including but not limited to the figures and associated description.

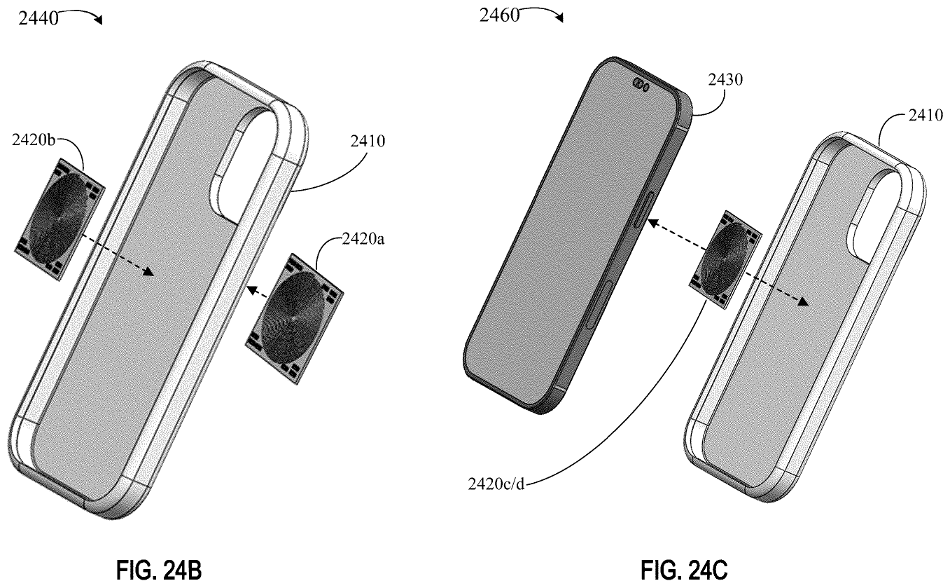

The coil repeater assembly 2300 is to be placed on a surface of a mobile device case body (such as, e.g., a case body for a mobile device case as described below with reference to FIGS. 24A-24C herein) and/or a back surface of a mobile device (such as the mobile device 1430 of FIG. 14, already discussed). In embodiments the coil repeater assembly 2300 is the same as or similar to the coil repeater assembly 1420 (FIG. 14, already discussed) and/or the coil repeater assembly 1500 (FIGS. 15A-15B, already discussed).

As shown in FIG. 23, the coil repeater assembly 2300 includes an inductive coil 2310, one or more tuning capacitor(s) 2320, and a substrate 2340. The tuning capacitor(s) 2320 are electrically coupled to each end of the coil 2310, and the inductive coil 2310 and the one or more tuning capacitor(s) 2320 form a wireless charging repeater circuit that corresponds to the wireless charging repeater circuit 1310 (FIG. 13, already discussed). As such, the inductive coil 2310 corresponds to the inductive coil LR (FIG. 13), and the tuning capacitor(s) 2320 correspond to the capacitor CR (FIG. 13). Notably, however, in all embodiments the wireless charging repeater circuit excludes electrical connection to any active component (including components such as, e.g., a battery, solar cell or other power source) that supplies power. The components LR and CR of the wireless charging repeater circuit are selected such that the resonant frequency of the wireless charging repeater circuit matches (at least approximately) the resonant frequency fC of the external charger and/or the resonant frequency of the wireless power receiver of the mobile device.

The substrate 2340 provides a supporting structure to hold or position the wireless charging repeater circuit (or components thereof), such as the inductive coil 2310 and/or the tuning capacitor(s) 2320. For example, in embodiments the inductive coil 2310 is disposed on a first surface of the substrate 2340 (e.g., via techniques for thin film/flexible film circuitry), and the tuning capacitor(s) 2320 are electrically coupled to each end of the first inductive coil. In embodiments the tuning capacitor(s) 2320 are also disposed on the first surface of the substrate 2340 (e.g., via techniques for thin film/flexible film circuitry). The substrate 2340 includes an adhesive disposed on a second surface of the substrate 2340, where the second surface of the substrate 2340 is on an opposite side of the substrate 2340 relative to the first surface. In embodiments the adhesive is a common adhesive such as, e.g., a acrylic-based adhesive, a silicone-based adhesive, an epoxy-based adhesive, etc.

In some embodiments the substrate 2340 includes one or more of a thin flexible polymer or a paper (e.g., flexible) material. Accordingly, in some embodiments, when the substrate 2340 is a flexible material the coil repeater assembly 2300 can be considered as a flexible sticker to be attached to a surface of a case body and/or a mobile device via the adhesive on the second surface of the substrate 2340. In some embodiments the thin flexible polymer for the substrate 2340 is a thin polyimide polymer suitable for use as a dielectric substrate in flexible printed circuits. An example of a suitable substrate material includes a thin polyimide such as Kapton® (from DuPont); other examples of suitable substrate materials include polyethylene terephthalate (PET) or polydimethylsiloxane (PDMS). These materials are flexible and dielectric.

In some embodiments the substrate 2340 is a multilayer film for which some circuit elements are disposed on an outer and other circuit elements are disposed an inner layer (e.g., one or more conductor layers of a PCB coil/trace bundle as described above in conjunction with FIGS. 1-11). Electrical connections can be made between layers, e.g., using via holes, electrical interconnectors, etc.

In some embodiments the substrate 2340 includes a thin rigid material. In such embodiments the coil repeater assembly 2300 can be attached to a surface of a case body and/or a mobile device via the adhesive on the second surface of the substrate 2340. In some embodiments, the thin rigid material is formed from a PCB material (e.g., FR4) where the circuit elements (e.g., the inductive coil 2310 and/or the tuning capacitor(s) 2320) are disposed on one surface (e.g., a front surface) and the opposite surface (e.g., a back surface) is etched away to obtain the desired thickness.

In some embodiments, the thickness of the substrate 2340 is less than approximately 0.1 mm (e.g., approximately 4 mils) such that, when the coil repeater assembly 2300 is placed on an inside surface of a mobile device case body and/or a back surface of a mobile device, the coil repeater assembly 2300 does not interfere with attaching the case body to the mobile device case. In some embodiments, the thickness of the substrate 2340 is an order of magnitude thinner than a mobile device case body (e.g., one-tenth). In some embodiments, where a case body thickness is in a range of 1-3 mm, the thickness of the substrate 2340 is within a range of approximately 0.1 mm to 0.3 mm (e.g., a range of approximately 4 to 12 mils).

As described above, in some embodiments the inductive coil 2310 may comprise one of the PCB coils/trace bundles described above in conjunction with FIGS. 1-11.

For example, in certain embodiments inductive coil 2310 may comprise: (1) a first conductor layer comprising first trace segments; (2) a second conductor layer comprising second trace segments; and (3) interlayer connectors electrically interconnecting segments of the first trace segments to segments of the second trace segments to form traces. Here, substrate 2340 may comprise an insulating layer disposed between the two conductor layers. As alluded to above, each trace of the formed traces may comprise a respective subset of the first trace segments electrically interconnected by a subset of the interlayer connectors to a corresponding subset of second trace segments such that the interconnected trace segments are woven through and around substrate 2340. Accordingly, the traces may form as a conductive line woven through and around substrate 2340 to form the inductive coil 2310 of the coil repeater assembly 2300. In some of these embodiments, density of the traces may vary across a length of the inductive coil 2310. For example, a first density of the traces at a first location on the inductive coil 2310 may be greater than a second density of the traces at a second location on the inductive coil 2310, wherein the first location is closer to a center of the inductive coil 2310 than the second location. As a related example, the density of the traces may be greater at higher current locations of the inductive coil 2310 than lower current locations of the inductive coil 2310. As described above, the density of the traces may be based on at least one of: (a) spacing between trace segments of a respective conductor layer; and (b) spacing between the interlayer connectors. As described above, a trace segment of a respective conductor layer may extend in a linear direction and parallel to other trace segments of the respective conductor layer. Relatedly, first trace segments of the first conductor layer may cross over the second trace segments of the second conductor layer (see e.g., FIGS. 1-11 above).

Related to the example embodiment for the inductive coil 2310 discussed in the previous paragraph, in certain embodiments the inductive coil 2310 may comprise turns of a trace bundle. As described above, the trace bundle may comprise traces formed from trace segments electrically interconnected by interlayer connectors. A respective trace may comprise electrically interconnected trace segments across multiple layers. Relatedly, density of the traces may vary across a length of the inductive coil 2310.

More generally, the inductive coil 2310 may comprise a metallic inductive coil winding (or windings) made of a metal such as copper, copper alloy, etc. In embodiments the inductive coil 2310 is a single layer flat design, or a multi-layer flat design, or a multiwire Litz wire shape design, etc. In some embodiments the inductive coil 2310 is part of an ink circuit that is disposed on the substrate 2340 via an ink printing technique using conductive ink. The ink circuit includes the coil, electrical connections, and attachment pads for any passive components such as, e.g., tuning capacitor(s). In embodiments the inductive coil 2310 is the same as or similar to the inductive coil 1510 (FIG. 15A, already discussed).

The one or more tuning capacitor(s) 2320 are thin film capacitors (e.g., thin chip capacitors), typically made of ceramic; the capacitor(s) 2320 can be multilayer ceramic with a high dielectric property. The one or more capacitors 2320 are selected based on the particular requirements for the wireless charging repeater circuit of the coil repeater assembly 2300 such as, e.g., capacitance value, size/space considerations, etc. In embodiments one or more tuning capacitor(s) 2320 the same as or similar to the one or more tuning capacitor(s) 1520 (FIGS. 15A-15B, already discussed).

FIGS. 24A-24C provide diagrams illustrating examples of mobile device cases with a coil repeater assembly for wireless charging according to one or more embodiments, with reference to components and features described herein including but not limited to the figures and associated description. Turning to FIG. 24A, the illustrated mobile device case 2400 includes a case body 2410 and a coil repeater assembly 2420 that is positioned on a surface (e.g., interior surface) of the case body 2410. The mobile device case 2400 is configured to be attached to a mobile device such as, e.g., the mobile device 1220 (FIGS. 12 and 13, already discussed) or the mobile device 1430 (FIG. 14, already discussed). For example, in some embodiments the mobile device case body 2410 is designed such that the mobile device case 2400 snaps onto the back of the mobile device. The mobile device, thus, includes a wireless charging coil L2 (for example, the location of the coil L2 in the mobile device 1430 is indicated by the dotted circle 1435 in FIG. 14).

In embodiments the case body 2410 is a standard or stock case body (e.g., a preexisting mobile device case body) made for attachment to a particular model of a mobile device. Thus, the particular configuration and dimensions of the case body 2410 will depend on the configuration and dimensions of the mobile device (e.g., the mobile device 1430)—which in turn can depend on the manufacturer and/or model of the mobile device (e.g., the mobile device 1430). In embodiments, the case body 2410 also includes cutouts or spaces to permit use of various features of the mobile device while the mobile device case 2400 is attached thereto.

As one example, if the mobile device is a smartphone with a camera, the case body 2410 can include an opening to allow external light to enter a camera sensor in the mobile device, thus enabling use of the camera while the mobile device case 2400 is attached.

The coil repeater assembly 2420 is a thin assembly that includes a wireless charging repeater circuit and a substrate, with an adhesive on one surface of the substrate. The coil repeater assembly 2420 corresponds to the coil repeater assembly 2300 (FIG. 23). The wireless charging repeater circuit corresponds to the wireless charging repeater circuit 1310 (FIG. 13). As such, includes an inductive coil that corresponds to the inductive coil LR (FIG. 2), and tuning capacitor(s) that correspond to the capacitor CR (FIG. 13). Notably, however, in all embodiments the wireless charging repeater circuit excludes electrical connection to any active component (including components such as, e.g., a battery, solar cell or other power source) that supplies power.

The coil repeater assembly 2420 is attached to a surface (e.g., an interior surface) of the case body 2410 via the adhesive, such that when the mobile device case 2400 is attached to the mobile device (e.g., the mobile device 1430), the inductive coil LR of the wireless charging repeater circuit is located proximate to a wireless charging coil (e.g., the coil L2) in the mobile device. For example, in embodiments, when the mobile device case 2400 is attached to the mobile device, the coil LR is located parallel to and within a short distance from the wireless charging coil (where, for example, the location of the wireless charging coil in the mobile device 1430 is indicated by the dotted circle 1435). As one example, in some embodiments the coil LR is positioned against the back of the mobile device when the mobile device case 2400 is attached to the back of mobile device, and in some other embodiments there may be a very thin gap between the coil LR and the back of the mobile device. Further, the center of the coil LR is aligned (at least approximately) with the center of the wireless charging coil (e.g., such as illustrated in FIG. 14 by the dotted line 1440). The location of the wireless charging coil can depend on the manufacturer and model of the mobile device and, thus, the case body 2410 and the location of the coil repeater assembly 2420 (e.g., on the interior surface of the case body 2410) can likewise be positioned based on the manufacturer and model of the mobile device for which the case body 2410 is intended to fit.

The mobile device case 2400 as illustrated in FIG. 24A has a number of advantages. For example, when the coil repeater assembly 2420 is applied to the interior surface of the case body 2410, the coil repeater assembly 2420 is not visible (i.e., from a view perspective outside of the mobile device and case) when the mobile device case 2400 is attached to the mobile device. In addition, the coil repeater assembly 2420 provides for a wireless charger repeater circuit to be applied to a standard or stock mobile device case body (e.g., a preexisting mobile device case body) without the need to modify the mobile device case body.

In operation, with the mobile device case 2400 attached to the mobile device (such as, e.g., the mobile device 1430), the mobile device case 2400 is placed in proximity to an external wireless charger (such as, e.g., the external charger 1210 in FIGS. 12-13, already discussed), such that the external wireless charger, the coil repeater assembly 2420 having wireless charging repeater circuit (part of the mobile device case 2400), and the mobile device form a wireless charging configuration (e.g., such as, e.g., the wireless charging configuration 1300 in FIG. 13, already discussed). As such, the wireless charging configuration operates as described with reference to the wireless charging configuration 1300 in FIG. 13. In particular, when exposed to a changing magnetic field from the external wireless charger, the wireless charging repeater circuit operates to generate a magnetic field that passes (e.g., permeates or radiates) into the wireless charging coil (e.g., the coil L2) in the mobile device.

Turning now to FIG. 24B, a mobile device case 2440 is illustrated. The mobile device case 2440 has features and components that are the same as or similar to the mobile device case 2400 (FIG. 24A) which will not be repeated herein except as to describe the mobile device case 2440. The illustrated mobile device case 2440 includes a case body 2410 and at least one coil repeater assembly 2420 (e.g., the coil repeater assembly 2420a as shown in FIG. 24B). The coil repeater assembly 2420a is positioned on a surface (e.g., an exterior surface) of the case body 2410. The coil repeater assembly 2420a is attached to a surface (e.g., an exterior surface) of the case body 2410 via the adhesive, such that when the mobile device case 2440 is attached to the mobile device (e.g., the mobile device 330), the inductive coil LR of the wireless charging repeater circuit is located proximate to a wireless charging coil (e.g., the coil L2) in the mobile device. For example, in embodiments, when the mobile device case 2440 is attached to the mobile device, the coil LR is located parallel to and within a short distance from the wireless charging coil (where, for example, the location of the wireless charging coil in the mobile device 1430 is indicated by the dotted circle 1435). Further, the center of the coil LR is aligned (at least approximately) with the center of the wireless charging coil (e.g., such as illustrated in FIG. 14 by the dotted line 1440).

In some embodiments, the mobile device case 2440 includes a second coil repeater assembly 2420 (e.g., the coil repeater assembly 2420b as shown in FIG. 24B) attached to the case body 2410. In some embodiments, the coil repeater assembly 2420b is positioned on an opposite surface (e.g., an interior surface) of the case body 2410 with reference to the coil repeater assembly 2420a, and the coil repeater assembly 2420b is positioned and applied the same as the coil repeater assembly 2420 described herein with reference to FIG. 24A. The coil repeater assembly 2420b is attached parallel to the coil repeater assembly 2420a, such that the coils of each coil repeater assembly are in alignment. When coil repeater assemblies 2420 are stacked as such, any connections that might be needed between them can be made, e.g., using via holes in each substrate. Each of the coil repeater assembly 2420a and/or the coil repeater assembly 2420b corresponds to the coil repeater assembly 2300 (FIG. 23).

In operation, with the mobile device case 2440 attached to the mobile device (e.g., the mobile device 1430), the mobile device case 2440 is placed in proximity to an external wireless charger (such as, e.g., the external charger 1210 in FIGS. 12-13, already discussed), such that the external wireless charger, the coil repeater assembly 2420 having a wireless charging repeater circuit (part of the mobile device case 2440) and the mobile device form a wireless charging configuration (e.g., such as, e.g., the wireless charging configuration 1300 in FIG. 13, already discussed). As such, the wireless charging configuration operates as described with reference to the wireless charging configuration 1300 in FIG. 13. In particular, when exposed to a changing magnetic field from the external wireless charger, the wireless charging repeater circuit of the coil repeater assembly 2420 operates to generate a magnetic field that passes (e.g., permeates or radiates) into the wireless charging coil (e.g., the coil L2) in the mobile device.

Turning now to FIG. 24C, a mobile device arrangement 2460 is illustrated. The mobile device arrangement 2460 has features and components that are the same as or similar to the arrangement described with reference to the mobile device case 2400 (FIG. 24A) and/or the arrangement described with reference to the mobile device case 2440 (FIG. 24B), which will not be repeated herein except as to describe the mobile device case arrangement 2460. As shown in FIG. 24C, a mobile device 2430 has a coil repeater assembly 2420 (e.g., indicated in FIG. 24C as the coil repeater assembly 2420c) attached via the adhesive to an exterior surface (e.g., the back surface) of the mobile device 2430. In embodiments the mobile device 2430 corresponds to the mobile device 1430 (FIG. 14, already discussed). When applied to the mobile device 2430, the inductive coil LR of the wireless charging repeater circuit (of the coil repeater assembly 2420c) is located proximate to a wireless charging coil (e.g., the coil L2) in the mobile device 2430. For example, in embodiments the coil LR is located parallel to and within a short distance from the wireless charging coil (where, for example, the location of the wireless charging coil in the mobile device is indicated by the dotted circle 1435 as illustrated in FIG. 14). Further, the center of the coil LR is aligned (at least approximately) with the center of the wireless charging coil (e.g., such as illustrated in FIG. 14 by the dotted line 1440).

In some embodiments, there is no coil repeater assembly 2420 applied to the case body 2410 (and, in some embodiments, there may be no mobile device case attached to the mobile device 2430). In some embodiments, a second coil repeater assembly 2420 (e.g., the coil repeater assembly 2420d as shown in FIG. 24C) is applied to the case body 2410. For example, in some embodiments, the coil repeater assembly 2420d is applied to an interior surface of the case body 2410, where the coil repeater assembly 2420d is positioned and applied the same as the coil repeater assembly 2420 described herein with reference to FIG. 24A. In some embodiments, the coil repeater assembly 2420d is applied to an exterior surface of the case body 2410, where the coil repeater assembly 2420d is positioned and applied the same as the coil repeater assembly 2420a described herein with reference to FIG. 24b. Each of the coil repeater assembly 2420c and/or the coil repeater assembly 2420d corresponds to the coil repeater assembly 2300 (FIG. 23). In some embodiments, a coil repeater assembly 2420 is applied to the surface of an external wireless charger (not shown in FIG. 24C) in addition to or instead of application to the mobile device.

In operation, the mobile device 2430 (with or without a mobile device case attached) is placed in proximity to an external wireless charger (such as, e.g., the external charger 1210 in FIGS. 12-13, already discussed), such that the external wireless charger, the coil repeater assembly 2420 having a wireless charging repeater circuit and the mobile device form a wireless charging configuration (e.g., such as, e.g., the wireless charging configuration 1300 in FIG. 13, already discussed). As such, the wireless charging configuration operates as described with reference to the wireless charging configuration 1300 in FIG. 13. In particular, when exposed to a changing magnetic field from the external wireless charger, the wireless charging repeater circuit of the coil repeater assembly 2420 operates to generate a magnetic field that passes (e.g., permeates or radiates) into the wireless charging coil (e.g., the coil L2) in the mobile device.

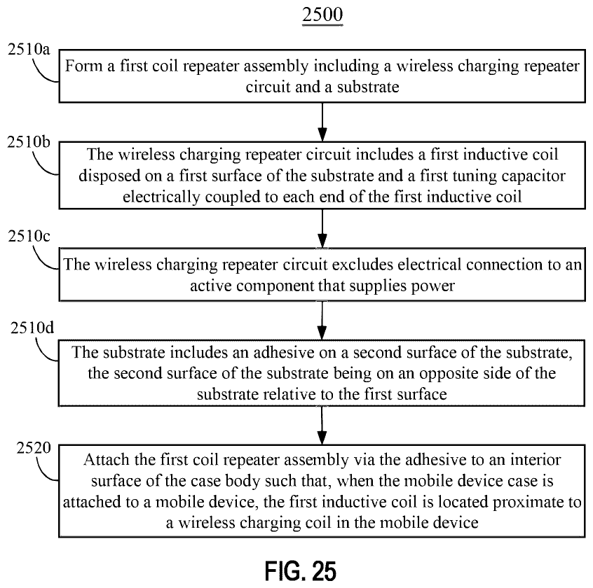

FIG. 25 provides a flow diagram illustrating an example method of constructing a mobile device case with a coil repeater assembly for wireless charging according to one or more embodiments, with reference to components and features described herein including but not limited to the figures and associated description. Block 2510a provides for forming a first coil repeater assembly comprising a wireless charging repeater circuit and a substrate, where at block 2510b the wireless charging repeater circuit includes a first inductive coil disposed on a first surface of the substrate and a first tuning capacitor electrically coupled to each end of the first inductive coil, at block 2510c the wireless charging repeater circuit excludes electrical connection to an active component that supplies power, and at block 2510d the substrate includes an adhesive on a second surface of the substrate, the second surface of the substrate being on an opposite side of the substrate relative to the first surface. Block 2520 provides for attaching the first coil repeater assembly via the adhesive to an interior surface of the case body such that, when the mobile device case is attached to a mobile device, the first inductive coil is located proximate to a wireless charging coil in the mobile device.

In some embodiments, the substrate includes one or more of a thin flexible polymer or a paper material. That is, the paper can be layered with the thin flexible polymer. In some embodiments, the substrate includes a thin rigid material.

As alluded to above, in some embodiments the first inductive coil may comprise one of the PCB coils/trace bundles described above in conjunction with FIGS. 1-11.

For example, in certain embodiments the first inductive coil may comprise: (1) a first conductor layer comprising first trace segments; (2) a second conductor layer comprising second trace segments; and (3) interlayer connectors electrically interconnecting segments of the first trace segments to segments of the second trace segments to form traces. Here, the substrate may comprise an insulating layer disposed between the two conductor layers. As alluded to above, each trace of the formed traces may comprise a respective subset of the first trace segments electrically interconnected by a subset of the interlayer connectors to a corresponding subset of second trace segments such that the interconnected trace segments are woven through and around the substrate. Accordingly, the traces may form as a conductive line woven through and around the substrate to form the first inductive coil of the first coil repeater assembly. In some of these embodiments, density of the traces may vary across a length of the first inductive coil. For example, a first density of the traces at a first location on the first inductive coil may be greater than a second density of the traces at a second location on the first inductive coil, wherein the first location is closer to a center of the first inductive coil than the second location. As a related example, the density of the traces may be greater at higher current locations of the first inductive coil than lower current locations of the first inductive coil. As described above, the density of the traces may be based on at least one of: (a) spacing between trace segments of a respective conductor layer; and (b) spacing between the interlayer connectors. As described above, a trace segment of a respective conductor layer may extend in a linear direction and parallel to other trace segments of the respective conductor layer. Relatedly, first trace segments of the first conductor layer may cross over the second trace segments of the second conductor layer (see e.g., FIGS. 1-11 above).

Related to the example embodiment for the first inductive coil discussed in the previous paragraph, in certain embodiments the first inductive coil may comprise turns of a trace bundle. As described above, the trace bundle may comprise traces formed from trace segments electrically interconnected by interlayer connectors. A respective trace may comprise electrically interconnected trace segments across multiple layers. Relatedly, density of the traces may vary across a length of the first inductive coil.

In some embodiments, the first inductive coil may be an ink-printed coil. In some embodiments, the first inductive coil is a multi-layer ink-printed coil, wherein a second layer of the multi-layer ink-printed coil is disposed on a second substrate parallel to the substrate.

In some embodiments, the method further includes forming a second coil repeater assembly including a second inductive coil (of the same/similar construction as the first inductor coil) disposed on a first surface of a second substrate, and a second tuning capacitor electrically coupled to each end of the second inductive coil, where the second inductive coil and the second tuning capacitor are part of the wireless charging repeater circuit and where the second substrate includes an adhesive on a second surface of the second substrate, the second surface of the second substrate being on an opposite side of the second substrate relative to the first surface of the second substrate, and attaching the second coil repeater assembly via the adhesive on the second substrate to an exterior surface of the case body, the exterior surface of the case body being on an opposite side of the case body relative to the first surface of the case body, such that the second inductive coil is located proximate to the first inductive coil.

### In-Vehicle Applications

In embodiments, a coil repeater assembly 2300 is attached via the adhesive to a surface of a vehicle proximate to (e.g., adjacent to) a wireless charger in the vehicle. For example, in some embodiments the coil repeater assembly 2300 is attached to a surface of the vehicle where a mobile device would (otherwise) be placed for wireless charging. When placed in proximity to a wireless charger in the vehicle, the inductive coil LR of the wireless charging repeater circuit (part of the coil repeater assembly 2300) is located proximate to a wireless charger driver coil of the wireless charger (e.g., corresponding to the coil L1 in FIG. 2) in the vehicle. Thus, for example, in embodiments the coil LR is located parallel to and within a short distance from the wireless charger driver coil (e.g., the coil L1 in FIG. 2) of the wireless charger. Further, the center of the coil LR is aligned (at least approximately) with the center of the wireless charger driver coil (e.g., the coil L1 in FIG. 13) of the wireless charger. Placement of the coil repeater assembly 2300 in a vehicle in such a manner provides enhancement of the wireless charging power provided to a mobile device by the wireless charger in the vehicle when the mobile device (having a wireless charging coil) is placed proximate to the wireless charger and the coil repeater assembly 2300. For example, the charging power is enhanced when the mobile device has a case attached.

In operation, a mobile device (with or without a mobile device case attached) is placed in proximity to a coil repeater assembly 2300, which is attached to a part of a vehicle (as described above) in proximity to (e.g., adjacent to) a wireless charger driver coil of a wireless charger (such as, e.g., the charger 1210 in FIGS. 12-13, already discussed) located in the vehicle—such that the wireless charger, the coil repeater assembly 2300 having a wireless charging repeater circuit and the mobile device form a wireless charging configuration (e.g., such as, e.g., the wireless charging configuration 1300 in FIG. 13, already discussed). As such, the wireless charging configuration operates as described with reference to the wireless charging configuration 1300 in FIG. 13. In particular, when exposed to a changing magnetic field from the wireless charger driver coil of the in-vehicle wireless charger, the wireless charging repeater circuit of the coil repeater assembly 2300 operates to generate a magnetic field that passes (e.g., permeates or radiates) into the wireless charging coil (e.g., the coil L2) in the mobile device.

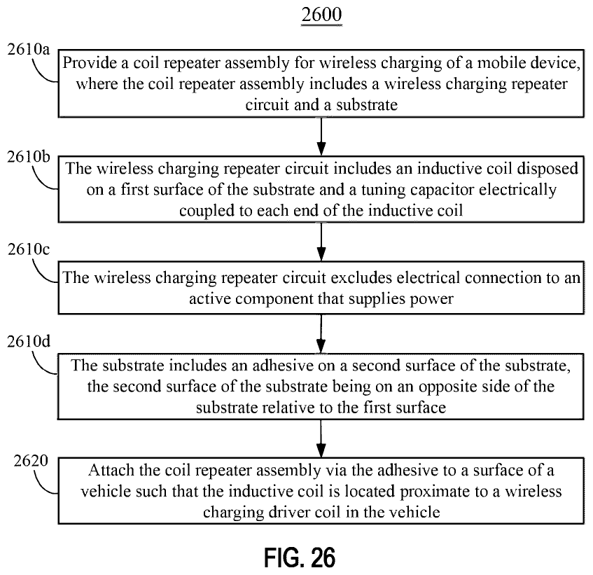

FIG. 26 provides a flow diagram illustrating an example method of providing wireless charging for a mobile device in a vehicle according to one or more embodiments, with reference to components and features described herein including but not limited to the figures and associated description. At block 2610a a coil repeater assembly for wireless charging of a mobile device is provided, where the coil repeater assembly includes a wireless charging repeater circuit and a substrate, where at block 2610b the wireless charging repeater circuit includes an inductive coil disposed on a first surface of the substrate and a tuning capacitor electrically coupled to each end of the inductive coil, at block 2610c the wireless charging repeater circuit excludes electrical connection to an active component that supplies power, and at block 2610d the substrate includes an adhesive on a second surface of the substrate, the second surface of the substrate being on an opposite side of the substrate relative to the first surface. Block 2620 provides for attaching the coil repeater assembly via the adhesive to a surface of a vehicle such that the inductive coil is located proximate to a wireless charging driver coil in the vehicle.

In some embodiments, the substrate includes one or more of a thin flexible polymer or a paper material. In some embodiments, the substrate includes a thin rigid material.

As alluded to above, in some embodiments the inductive coil may comprise one of the PCB coils/trace bundles described above in conjunction with FIGS. 1-11.

For example, in certain embodiments the inductive coil may comprise: (1) a first conductor layer comprising first trace segments; (2) a second conductor layer comprising second trace segments; and (3) interlayer connectors electrically interconnecting segments of the first trace segments to segments of the second trace segments to form traces. Here, the substrate may comprise an insulating layer disposed between the two conductor layers. As alluded to above, each trace of the formed traces may comprise a respective subset of the first trace segments electrically interconnected by a subset of the interlayer connectors to a corresponding subset of second trace segments such that the interconnected trace segments are woven through and around the substrate. Accordingly, the traces may form as a conductive line woven through and around the substrate to form the inductive coil of the coil repeater assembly. In some of these embodiments, density of the traces may vary across a length of the inductive coil. For example, a first density of the traces at a first location on the inductive coil may be greater than a second density of the traces at a second location on the inductive coil, wherein the first location is closer to a center of the inductive coil than the second location. As a related example, the density of the traces may be greater at higher current locations of the inductive coil than lower current locations of the inductive coil. As described above, the density of the traces may be based on at least one of: (a) spacing between trace segments of a respective conductor layer; and (b) spacing between the interlayer connectors. As described above, a trace segment of a respective conductor layer may extend in a linear direction and parallel to other trace segments of the respective conductor layer. Relatedly, first trace segments of the first conductor layer may cross over the second trace segments of the second conductor layer (see e.g., FIGS. 1-11 above).

Related to the example embodiment for the inductive coil discussed in the previous paragraph, in certain embodiments the inductive coil may comprise turns of a trace bundle. As described above, the trace bundle may comprise traces formed from trace segments electrically interconnected by interlayer connectors. A respective trace may comprise electrically interconnected trace segments across multiple layers. Relatedly, density of the traces may vary across a length of the inductive coil.

In some embodiments, the inductive coil may be an ink-printed coil. In some embodiments, the inductive coil is a multi-layer ink-printed coil, where a layer of the multi-layer ink-printed coil is disposed on a second substrate parallel to the substrate.

As described herein a coil repeater assembly (e.g., the coil repeater assembly 1420, the coil repeater assembly 1500, the coil repeater assembly 1600, the coil repeater assembly 1700, the coil repeater assembly 2300 and/or the coil repeater assembly 2420) can be placed in various configurations in or on a mobile device case body, on a mobile device, or elsewhere. As such, based on design criteria and the design of the respective mobile device case and mobile device, in some embodiments the coil repeater assembly is located closer to the wireless charging coil in the mobile device, and in other embodiments the coil repeater assembly is located closer to the wireless charging driver coil of the wireless charger. When the coil repeater assembly is located closer to the wireless charging coil in the mobile device, the wireless charging repeater circuit operates to concentrate the magnetic field (e.g., magnetic flux) emitted by the wireless charger into the wireless charging coil in the mobile device. When the coil repeater assembly is located closer to the wireless charging driver coil of the wireless charger, the wireless charging repeater circuit operates to redirect a larger portion of the magnetic field (e.g., magnetic flux) emitted by the wireless charger into the wireless charging coil in the mobile device.

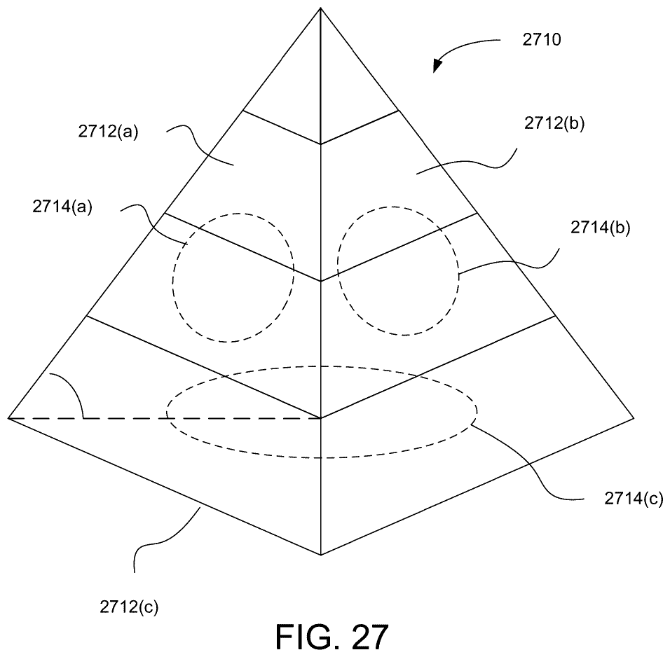

FIGS. 27-41 illustrate example apparatuses for multi-device wireless charging, in accordance with various embodiments of the presently disclosed technology.

More specifically, FIGS. 27-41 illustrate apparatuses configured to increase or otherwise optimize inductive flux linkage between a single external wireless charger (e.g., a single wireless charging pad or other external wireless charging source) and multiple mobile devices being wirelessly charged. Accordingly, the presently disclosed apparatuses may be implemented to facilitate simultaneous multi-device charging using a single external wireless charger conventionally used to wirelessly charge only a single mobile device at a time. In this way, the presently disclosed apparatuses can expand the utility of existing and new external wireless charger technologies by enabling multi-device charging in a manner that would not be feasible conventionally

As described in greater detail below, the presently disclosed multi-device wireless charging apparatuses can achieve the above-described technical advantages through strategic positioning, orienting, and dimensioning of coil repeater assemblies.

In some implementations, the coil repeater assemblies may comprise the inductive coils described in conjunction with FIGS. 1-11. In other implementations however, other inductive coil configurations may be used.

As alluded to above, and as described in greater detail below, the unique properties of the presently disclosed inductive coils can enable wireless charging with larger (vertical) air gaps and lateral offsets than existing technologies. Relatedly, the presently disclosed inductive coils can enable wireless charging at greater tilt angles than existing technologies. Leveraging these unique capabilities, the apparatuses depicted in FIGS. 27-41 may include various configurations that use airgaps, lateral offsets, tilt angles, or some combination thereof, to wirelessly charge multiple mobile devices on compact, convenient to use structures.

Such apparatuses will now be described in greater detail in conjunction with FIGS. 27-41.

FIG. 27 illustrates one such apparatus—namely a multi-device wireless charging apparatus 2710. Wireless charging apparatuses 2710 is an example of a “pyramid configuration” comprising a base surface 2712(c) and three or more face surfaces (i.e., face surfaces 2712(a), face surface 2712(b), and one or more face surfaces not directly depicted in FIG. 27) tapering towards each other from base surface 2712(c).

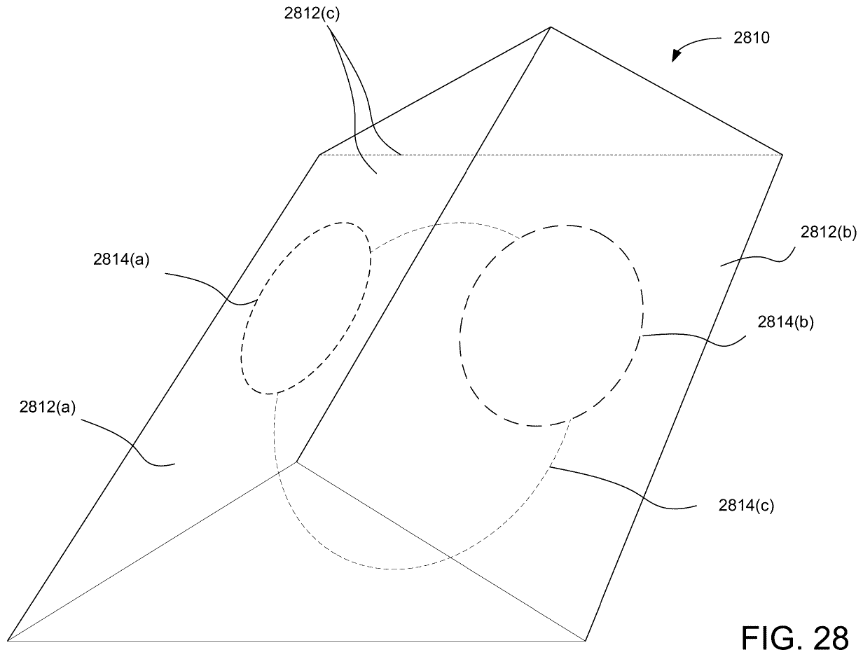

FIG. 28 illustrates a second such apparatus—namely a multi-device wireless charging apparatus 2810. Wireless charging apparatuses 2810 is an example of a “wedge configuration” comprising a base surface 2812(c) and two face surfaces (i.e., face surface 2812(a) and face surface 2812(b)) tapering towards each other from base surface 2812(c).

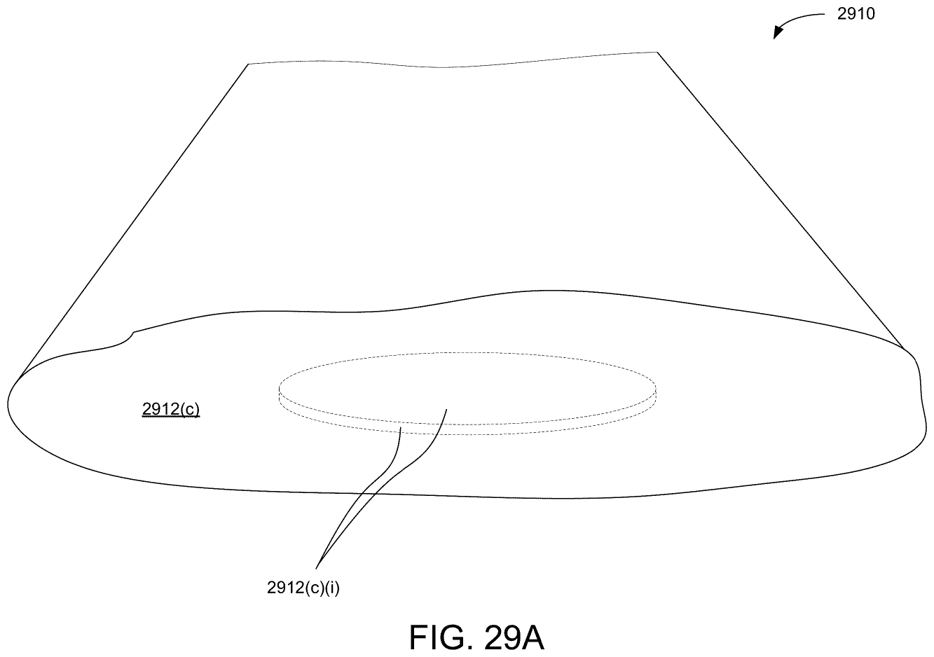

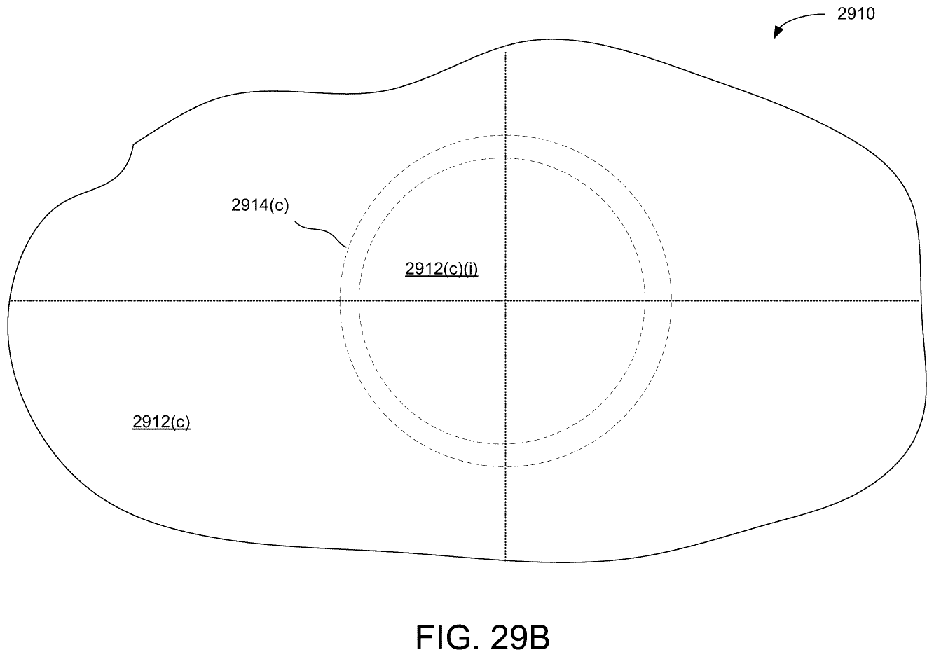

FIGS. 29A-29B, 30, 31A-31B and 32-35 illustrate generalized multi-device wireless charging apparatuses highlighting features that may be incorporated into multi-device wireless charging apparatus 2710 or multi-device wireless charging apparatus 2810.

Referring again to FIG. 27, the face surfaces of multi-device wireless charging apparatus 2710 may each be configured to receive a mobile device (e.g., mobile phones, smart watches, e-readers, portable speakers, wireless headphones or ear buds, hearing aids, wireless medical devices, an electric power tool, etc.) to be charged. For example, face surface 2712(a) may be configured to receive a first mobile device and face surface 2712(b) may be configured to receive a second mobile device.

Similarly, the face surfaces of multi-device wireless charging apparatus 2810 may each be configured to receive a mobile device (e.g., mobile phones, smart watches, e-readers, portable speakers, wireless headphones or ear buds, hearing aids, wireless medical devices, an electric power tool, etc.) to be charged. For example, face surface 2812(a) may be configured to receive a first mobile device and face surface 2812(b) may be configured to receive a second mobile device.

Referring again to FIG. 27, a coil repeater assembly may be positioned adjacent to each face surface of multi-device wireless charging apparatus 2710 to facilitate wireless charging of a separate mobile device.

For example, in some implementations a coil repeater assembly 2714(a) may be disposed on face surface 2712(a) (e.g., structurally integrated with, or attached to, such as via adhesive). In other implementations, coil repeater assembly 2714(a) may be embedded within multi-device wireless charging apparatus 2710 adjacent to (e.g., immediately beneath) face surface 2712(a). Likewise, in some implementations a coil repeater assembly 2714(b) may be disposed on face surface 2712(b) (e.g., via adhesive). In other implementations, coil repeater assembly 2714(b) may be embedded within multi-device wireless charging apparatus 2710 adjacent to (e.g., immediately beneath) face surface 2712(b). As alluded to above, each coil repeater assembly may comprise an inductive coil and one or more tuning capacitors electrically connected to each end of the inductive coil. In some implementations, the inductive coil may comprise one of the inductive coils described in conjunction with FIGS. 1-11.

Referring again to FIG. 27, coil repeater assembly 2714(a) may be positioned and oriented to increase inductive flux linkage between an external wireless charger (e.g., that multi-device wireless charging apparatus 2710 is placed upon) and a first mobile device received on face surface 2712(a). For example, an inductive coil of coil repeater assembly 2714(a) may be disposed across a plane that is parallel (or approximately parallel) to face surface 2712(a) (i.e., the surface upon which the first mobile device rests). Likewise, coil repeater assembly 2714(b) may be positioned and oriented to increase inductive flux linkage between the (same) external wireless charger (e.g., that multi-device wireless charging apparatus 2710 is placed upon) and a second mobile device received on face surface 2712(b). For example, an inductive coil of coil repeater assembly 2714(b) may be disposed across a plane that is parallel (or approximately parallel) to face surface 2712(b) (i.e., the surface upon which the second mobile device rests).

Similar to multi-device wireless charging apparatus 2710, a coil repeater assembly may be positioned adjacent to each face surface of multi-device wireless charging apparatus 2810 to facilitate wireless charging of a separate mobile device.

For example, in some implementations a coil repeater assembly 2814(a) may be disposed on face surface 2812(a) (e.g., structurally integrated with, or attached to, such as via adhesive). In other implementations, coil repeater assembly 2814(a) may be embedded within multi-device wireless charging apparatus 2810 adjacent to (e.g., immediately beneath) face surface 2812(a). Likewise, in some implementations a coil repeater assembly 2814(b) may be disposed on face surface 2812(b). In other implementations, coil repeater assembly 2814(b) may be embedded within multi-device wireless charging apparatus 2810 adjacent to (e.g., immediately beneath) face surface 2812(b). As alluded to above, each coil repeater assembly may comprise an inductive coil and one or more tuning capacitors electrically connected to each end of the inductive coil. In some implementations, the inductive coil may comprise one of the inductive coils described in conjunction with FIGS. 1-11.

Coil repeater assembly 2814(a) may be positioned and oriented to increase inductive flux linkage between an external wireless charger (e.g., that multi-device wireless charging apparatus 2810 is placed upon) and a first mobile device received on face surface 2812(a). For example, an inductive coil of coil repeater assembly 2814(a) may be disposed across a plane that is parallel (or approximately parallel) to face surface 2812(a) (i.e., the surface upon which the first mobile device rests). Likewise, coil repeater assembly 2814(b) may be positioned and oriented to increase inductive flux linkage between the (same) external wireless charger (e.g., that multi-device wireless charging apparatus 2810 is placed upon) and a second mobile device received on face surface 2812(b). For example, an inductive coil of coil repeater assembly 2814(b) may be disposed across a plane that is parallel (or approximately parallel) to face surface 2812(b) (i.e., the surface upon which the second mobile device rests).

Referring again to FIG. 27, in certain implementations multi-device wireless charging apparatus 2710 may comprise an additional coil repeater assembly 2714(c) positioned adjacent base surface 2712(c). For example, in some implementations coil repeater assembly 2714(c) may be disposed on base surface 2712(c) (e.g., structurally integrated with, or attached to, such as via adhesive). In other implementations, coil repeater assembly 2714(c) may be embedded within multi-device wireless charging apparatus 2710 adjacent to (e.g., immediately beneath) base surface 2712(c).

As alluded to above, coil repeater assembly 2714(c) may be positioned, oriented, and in some cases dimensioned, to increase inductive flux linkage between an external wireless charger (e.g., that multi-device wireless charging apparatus 2710 is placed upon) and any one or combination of coil repeater assembly 2714(a), coil repeater assembly 2714(b), a first mobile device received on face surface 2712(a), and a second mobile device received on face surface 2712(b). For example, coil repeater assembly 2714(c) may be positioned such that an inductive coil of coil repeater assembly 2714(c) is centered directly above an inductive coil of the external wireless charger when multi-device wireless charging apparatus 2710 is placed upon the external wireless charger. Likewise, the inductive coil of coil repeater assembly 2714(c) may be disposed across a plane that is parallel (or approximately parallel) to a plane across which the inductive coil of the external wireless charger is disposed. Moreover, in some implementations, the inductive coil of coil repeater assembly 2714(c) may have a wider diameter than an inductive coil of the external wireless charger that multi-device wireless charging apparatus 2710 is placed upon—thereby effectively extending/improving the lateral offset charging capabilities of the external wireless charger.

Likewise, in certain implementations multi-device wireless charging apparatus 2810 may comprise an additional coil repeater assembly 2814(c) positioned adjacent base surface 2812(c). For example, in some implementations coil repeater assembly 2814(c) may be disposed on base surface 2812(c). In other implementations, coil repeater assembly 2814(c) may be embedded within multi-device wireless charging apparatus 2810 adjacent to (e.g., immediately beneath) base surface 2812(c).

As alluded to above, coil repeater assembly 2814(c) may be positioned, oriented, and in some cases dimensioned, to increase inductive flux linkage between an external wireless charger (e.g., that multi-device wireless charging apparatus 2810 is placed upon) and any one or combination of coil repeater assembly 2814(a), coil repeater assembly 2814(b), a first mobile device received on face surface 2812(a), and a second mobile device received on face surface 2812(b). For example, coil repeater assembly 2814(c) may be positioned such that an inductive coil of coil repeater assembly 2814(c) is centered directly above an inductive coil of the external wireless charger when multi-device wireless charging apparatus 2810 is placed above the external wireless charger. Likewise, the inductive coil of coil repeater assembly 2814(c) may be disposed across a plane that is parallel (or approximately parallel) to a plane across which the inductive coil of the external wireless charger is disposed. Moreover, in some implementations, the inductive coil of coil repeater assembly 2814(c) may have a wider diameter than an inductive coil of the external wireless charger that multi-device wireless charging apparatus 2810 is placed above—thereby effectively extending/improving the lateral offset charging capabilities of the external wireless charger.

Referring again to FIG. 27, in some implementations base surface 2712(c) may comprise a recess (e.g., a disc-shaped recess) dimensioned to accommodate an external wireless charger to ensure that an inductive coil of coil repeater assembly 2714(c) is centered directly above an inductive coil of the external wireless charger when multi-device wireless charging apparatus 2710 is placed above the external wireless charger. The same/similar may be true for multi-device wireless charging apparatus 2810 and its corresponding structures.

An example of such a configuration is depicted in FIGS. 29A-29B for a generalized multi-device charging apparatus 2910. As depicted, generalized multi-device charging apparatus 2910 comprises a base surface 2912(c) which comprises a recess 2912(c)(i). Recess 2912(c)(i) may be of a geometry that corresponds to the dimensions of a standard wireless charging pad such that generalized multi-device charging apparatus 2910 fits snugly on the wireless charging pad to provide physical alignment. For example, in certain implementations recess 2912(c)(i) may comprise a disc-shaped recess that is dimensioned to fit snugly over the wireless charging pad. In some of these implementations, recess 2912(c)(i) may further comprise a notch or elongated groove (not directly depicted in FIGS. 29A-29B) dimensioned to fit snugly over a cord connected to the wireless charging pad such that generalized multi-device charging apparatus 2910 can rest flat and stable on the surface of a desk or other furniture element upon which the wireless charging pad is positioned.

As depicted in FIG. 29B, recess 2912(c)(i) may also help align the wireless charging pad such that an inductive coil of the wireless charging pad is centered below an inductive coil of a coil repeater assembly 2914(c) of generalized multi-device charging apparatus 2910. As alluded to above, the inductive coil of coil repeater assembly 2914(c) may be disposed across a plane parallel (or approximately parallel) to the inductive coil of the wireless charging pad when the wireless charging pad is received/accommodated within recess 2912(c)(i).

Referring again to FIG. 27, in certain implementations (alterative or in addition to a recess in base surface 2712(c)), multi-device wireless charging apparatus 2710 may comprise a non-inductive magnetic structure disposed on, or embedded within multi-device wireless charging apparatus 2710 adjacent, base surface 2712(c). This non-inductive magnetic structure may secure an external wireless charger to base surface 2712(c) via magnetic attraction. Relatedly, the non-inductive magnetic structure may be positioned and sized to align and center an inductive coil of coil repeater assembly 2714(c) over an inductive coil of the external wireless charger. The same/similar may be true for multi-device wireless charging apparatus 2810 and its corresponding structures.

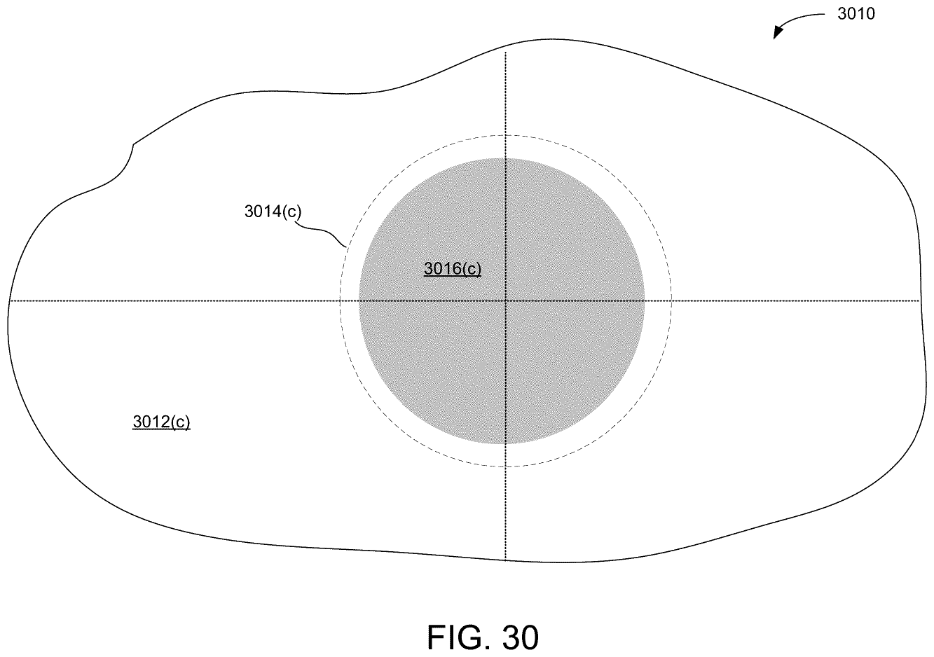

An example of such a configuration is depicted in FIG. 30 for a generalized multi-device charging apparatus 3010. As depicted, generalized multi-device charging apparatus 3010 comprises a base surface 3012(c). Generalized multi-device charging apparatus 3010 further comprises a non-inductive magnetic structure 3016(c). Non-inductive magnetic structure 3016(c) may include one or more magnetic elements or ferromagnetic materials, arranged to magnetically attract and secure an external wireless charger to base surface 3012(c). In some implementations, non-inductive magnetic structure 3016(c) may be disposed on base surface 3012(c), or provided as a separate component coupled thereto. In other implementations, non-inductive magnetic structure 3016(c) may be embedded within generalized multi-device charging apparatus 3010 adjacent base surface 3012(c).

As depicted, in certain implementations non-inductive magnetic structure 3016(c) may be disc-shaped and may be dimensioned to mirror the shape/dimensions of a standard wireless charging pad. As depicted in FIG. 30, non-inductive magnetic structure 3016(c) may also help align the wireless charging pad such that an inductive coil of the wireless charging pad is centered below an inductive coil of a coil repeater assembly 3014(c) of generalized multi-device charging apparatus 3010. As alluded to above, the inductive coil of coil repeater assembly 3014(c) may be disposed across a plane parallel (or approximately parallel) to the inductive coil of the wireless charging pad when the wireless charging pad is magnetically secured to base surface 3012(c).

Referring again to FIG. 27, in various implementations, multi-device wireless charging apparatus 2710 may comprise a slot dimensioned to receive an external wireless charger. Such a slot may have an entrance/opening on one of the faces surfaces of multi-device wireless charging apparatus 2710, such as face surface 2712(a). The slot may secure the external wireless charger within multi-device wireless charging apparatus 2710. Relatedly, the slot may be positioned and sized to align an inductive coil of coil repeater assembly 2714(c) over an inductive coil of the external wireless charger. The same/similar may be true for multi-device wireless charging apparatus 2810 and its corresponding structures.

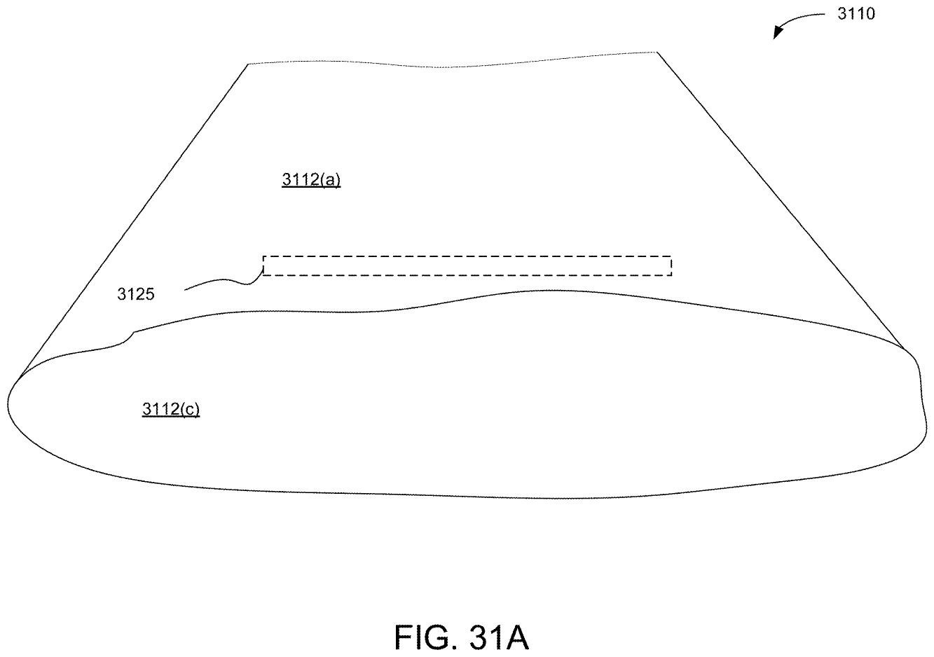

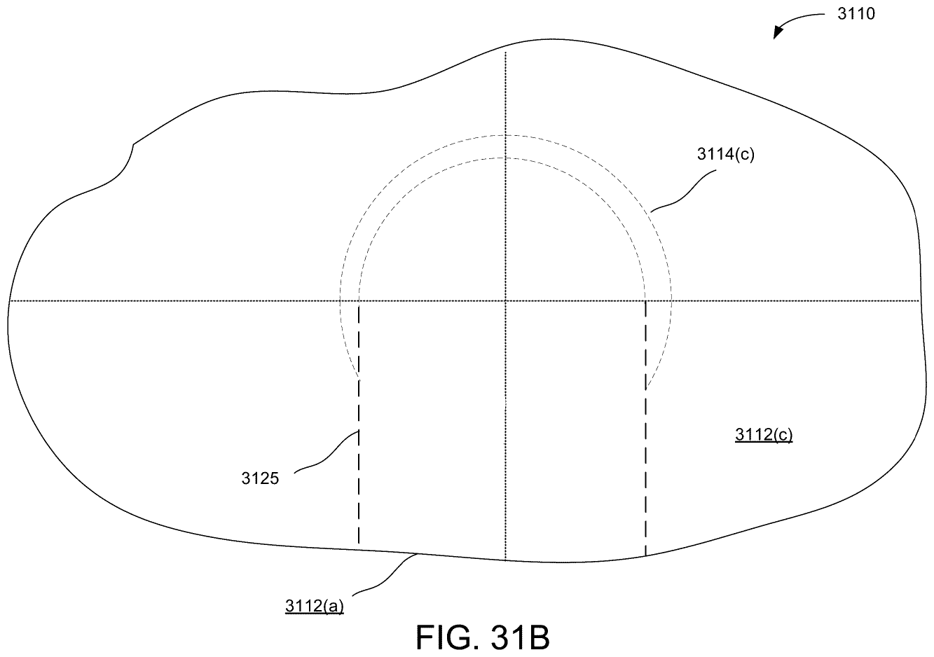

An example of such a configuration is depicted in FIGS. 31A-31B for a generalized multi-device charging apparatus 3110. As depicted, generalized multi-device charging apparatus 3110 comprises a base surface 3112(c) and a face surface 3112(a). Generalized multi-device charging apparatus 3110 further comprises a slot 3125 having an entrance/opening disposed on face surface 3112(a). In certain implementations slot 3125 may be dimensioned to snugly accommodate/receive a standard wireless charging pad. As depicted in FIG. 31B, slot 3125 may also help align the wireless charging pad such that an inductive coil of the wireless charging pad is centered below an inductive coil of a coil repeater assembly 3114(c) of generalized multi-device charging apparatus 3110. As alluded to above, the inductive coil of coil repeater assembly 3114(c) may be disposed across a plane parallel (or approximately parallel) to the inductive coil of the wireless charging pad when the wireless charging pad is secured within slot 3125.

Referring again to FIG. 27, in some implementations one or more of the faces surfaces of multi-device wireless charging apparatus 2710 may comprise a support structure (e.g., a cradle or similar support structure) to secure a mobile device. The same/similar may be true for multi-device wireless charging apparatus 2810 and its corresponding structures.

An example support structure may include any projecting, raised, or otherwise protruding element on a face surface, such as a protrusion, ridge, lip, ledge, platform, post(s) and so on. In some implementations the support structure may provide a bearing surface against which a portion of a mobile device rests, thereby preventing movement of the mobile device in a downward direction relative to the face surface. The support structure may be formed integrally as part of the face surface or may be provided as a separate component that is attached, bonded, or otherwise affixed or coupled thereto. The geometry of the support structure may vary, and may comprise a straight/flat, curved, angled, or irregular shape to accommodate mobile devices of different dimensions, weights, or orientations. In some implementations, the support structure may be removable and replaceable. Relatedly, in certain implementations the support structure may be moveable or have an adjustable geometry.

As may be appreciated, an example support structure may also facilitate improved/optimized alignment for wireless charging.

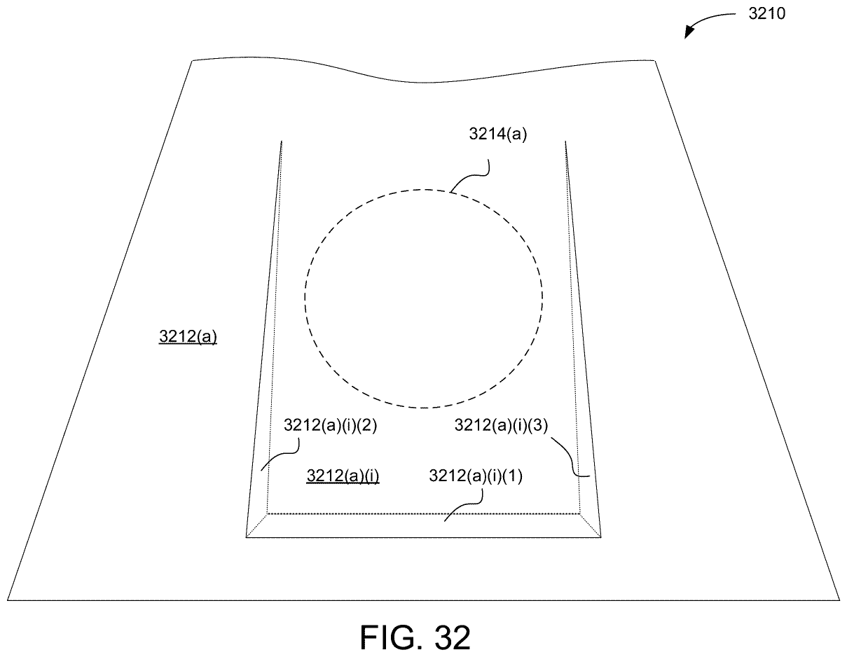

FIGS. 32-34 illustrate examples of support structure (e.g., cradles or other support structures) that may be incorporated on the face surfaces of multi-device wireless charging apparatuses 2710 and 2810.

Namely, FIG. 32 depicts a generalized multi-device charging apparatus 3210. Generalized multi-device charging apparatus 3210 comprises a face surface 3212(a) and a coil repeater assembly 3214(a). As alluded to above, in some implementations coil repeater assembly 3214(a) may be disposed face surface 3212(a). In other implementations, coil repeater assembly 3214(a) may be embedded within generalized multi-device charging apparatus 3210 adjacent (e.g., immediately below) face surface 3212(a).

Face surface 3212(a) comprises a recess 3212(a)(i). Recess 3212(a)(i) may be defined by a bottom lip 3212(a)(i)(1), a side lip 3212(a)(i)(2), and a side lip 3212(a)(i)(3). Bottom lip 3212(a)(i)(1) may support a mobile device received by recess 3212(a)(i) from below. Side lips 3212(a)(i)(2) and 3212(a)(i)(3) may be positioned to cradle the mobile device from the sides such that the mobile device fits snugly within recess 3212(a)(i). Relatedly (and as alluded to above), the lips of recess 3212(a)(i) may be positioned to align a receiving inductive coil of the mobile device with an inductive coil of coil repeater assembly 3214(a) when the mobile device is received within recess 3212(a)(i). As may be appreciated, different faces of generalized multi-device charging apparatus 3210 may comprise recesses of different shapes and sizes to accommodate different shapes and sizes of mobile devices.

As depicted, in certain implementations recess 3212(a)(i) may be wedge-shaped such that a depth of recess 3212(a)(i) decreases with decreasing proximity to bottom lip 3212(a)(i)(1). Relatedly, in some of such implementations recess 3212(a)(i) may not comprise a top lip. Such a wedge-shaped configuration for recess 3212(a)(i) may facilitate easier insertion and removal of mobile devices from recess 3212(a)(i).

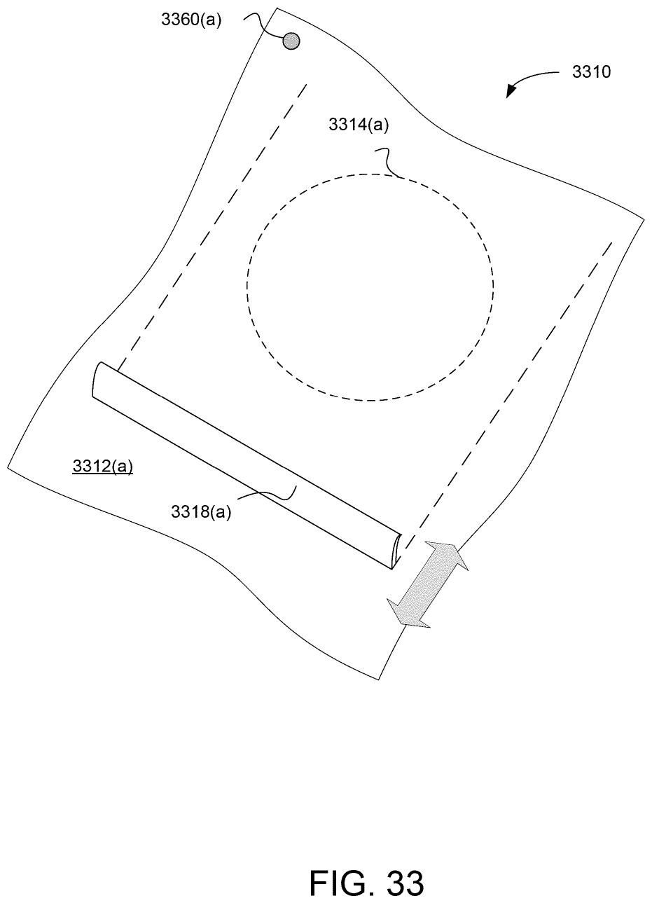

FIG. 33 depicts a generalized multi-device charging apparatus 3310. Generalized multi-device charging apparatus 3310 comprises a face surface 3312(a) and a coil repeater assembly 3314(a). As alluded to above, in some implementations coil repeater assembly 3314(a) may be disposed on face surface 3312(a). In other implementations, coil repeater assembly 3314(a) may be embedded within generalized multi-device charging apparatus 3310 adjacent (e.g., immediately below) face surface 3312(a).

Face surface 3312(a) comprises a bottom lip 3418(a) extending outwards from face surface 3312(a). Bottom lip 3318(a) may support a mobile device received by face surface 3312(a) from below. Relatedly (and as alluded to above), bottom lip 3318(a) may be positioned to align a receiving inductive coil of the mobile device with an inductive coil of coil repeater assembly 3314(a) when the mobile device rests on bottom lip 3318(a). In some implementations, position of bottom lip 3318(a) may be adjusted up and down face surface 3312(a) by a user to enable inductive coils of mobile devices of different sizes and heights to align with the inductive coil of coil repeater assembly 3314(a) when resting on bottom lip 3318(a).

As depicted, in some implementations generalized multi-device charging apparatus 3310 may further comprise a visual wireless charging metric indicator 3360(a) disposed on face surface 3312(a). For example, visual wireless charging metric indicator 3360(a) may comprise one or more light-emitting diodes (LEDs) or other light sources. Visual wireless charging metric indicator 3360(a) may be configured to indicate one or more of various charging metrics for wireless charging of a mobile device received by face surface 3312(a). Examples of such charging metrics may include voltage and current levels, charging efficiency, coupling efficiency, alignment tolerance, surface temperature, electromagnetic field strength, etc. Accordingly, visual wireless charging metric indicator 3360(a) can assist a user with determining a position (e.g., spatially and orientationally) of the mobile device on face surface 3312(a) to improve/optimize charging efficiency for the mobile device.

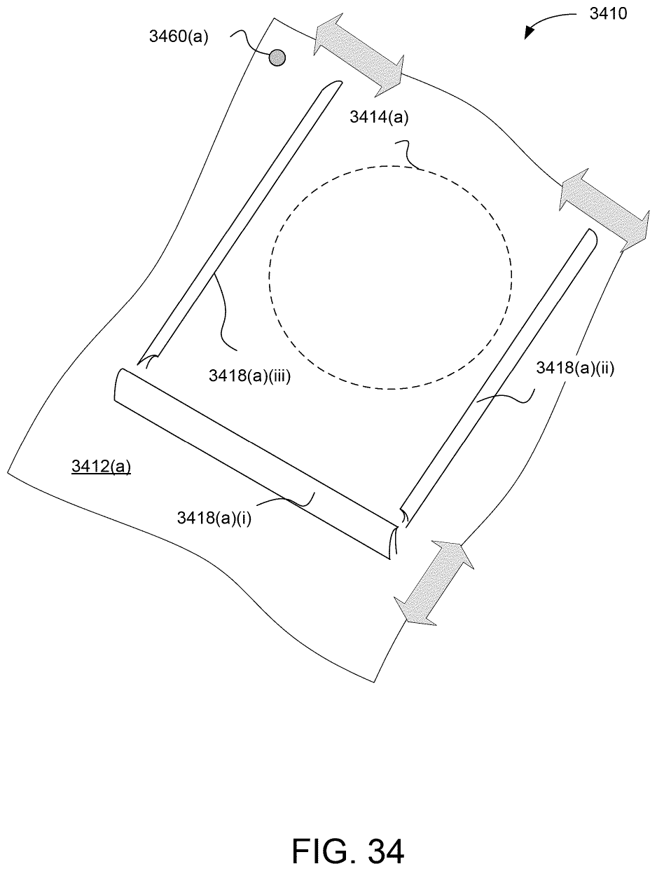

FIG. 34 depicts a generalized multi-device charging apparatus 3410. Generalized multi-device charging apparatus 3410 comprises a face surface 3412(a) and a coil repeater assembly 3414(a). As alluded to above, in some implementations coil repeater assembly 3414(a) may be disposed on face surface 3412(a). In other implementations, coil repeater assembly 3414(a) may be embedded within generalized multi-device charging apparatus 3410 adjacent (e.g., immediately below) face surface 3412(a).

Like face surface 3312(a), face surface 3412(a) comprises a bottom lip 3418(a)(i) extending outwards from face surface 3412(a). Face surface 3412(a) also comprises side lips 3418(a)(ii) and 3418(a)(iii) extending outwards from face surface 3412(a). As depicted, in certain implementations side lips 3418(a)(ii) and 3418(a)(iii) may be approximately parallel to each other and approximately orthogonal to bottom lip 3418(a)(i).

Like bottom lip 3318(a), bottom lip 3418(a)(i) may support a mobile device received by face surface 3412(a) from below. Side lips 3418(a)(ii) and 3418(a)(iii) may be positioned to cradle the mobile device from the sides. Relatedly (and as alluded to above), the lips of face surface 3412(a) may be positioned to align a receiving inductive coil of the mobile device with an inductive coil of coil repeater assembly 3414(a) when the mobile device is/cradled by the lips. In some implementations, position of bottom lip 3418(a)(i) may be adjusted up and down face surface 3412(a) to enable inductive coils of mobile devices of different sizes and heights to align with the inductive coil of coil repeater assembly 3414(a) when resting on bottom lip 3418(a). Likewise, positions of side lips 3418(a)(ii) and 3418(a)(iii) may be adjusted sidewise along face surface 3412(a) to accommodate mobile devices of different sizes and widths.

As depicted, in some implementations generalized multi-device charging apparatus 3410 may further comprise a visual wireless charging metric indicator 3460(a) disposed on face surface 3412(a). For example, visual wireless charging metric indicator 3460(a) may comprise one or more light-emitting diodes (LEDs) or other light sources. Visual wireless charging metric indicator 3460(a) may be configured to indicate one or more of various charging metrics for wireless charging of a mobile device received by face surface 3412(a). Examples of such charging metrics may include voltage and current levels, charging efficiency, coupling efficiency, alignment tolerance, surface temperature, electromagnetic field strength, etc. Accordingly, visual wireless charging metric indicator 3460(a) can assist a user with determining a position (e.g., spatially and orientationally) of the mobile device on face surface 3412(a) to improve/optimize charging efficiency for the mobile device.

In some implementations, the lips of face surface 3412(a) may comprise snap-fit mechanisms that allow a mobile device to snap into place within the lips. Such a snap-fit may facilitate alignment between a receiving inductive coil of the mobile device with an inductive coil of coil repeater assembly 3414(a).

Referring again to FIG. 27, in various implementations (alterative or in addition to other supporting structures), multi-device wireless charging apparatus 2710 may comprise non-inductive magnetic structures to secure mobile devices to its respective face surfaces via magnetic attraction. The same/similar may be true for multi-device wireless charging apparatus 2810 and its corresponding structures.

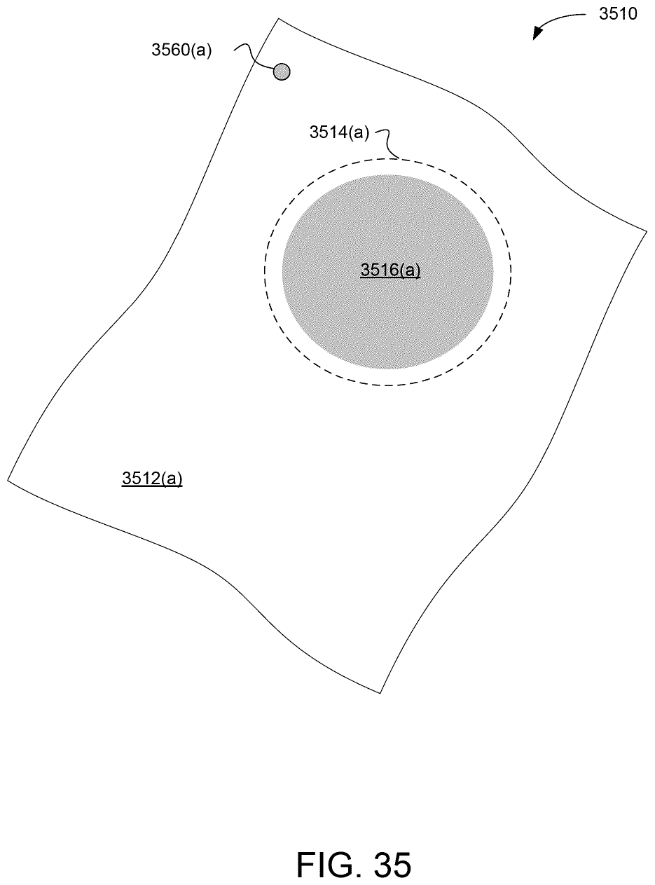

FIG. 35 illustrates an example of such a configuration. Namely, FIG. 35 illustrates a generalized multi-device wireless charging apparatus 3510 comprising a face surface 3512(a) and a coil repeater assembly 3514(a) disposed on, or embedded beneath, face surface 3512(a).

As depicted in FIG. 35, generalized multi-device wireless charging apparatus 3510 may also comprise a non-inductive magnetic structure 3516(a).

As described above, non-inductive magnetic structure 3516(a) may secure a mobile device to face surface 3512(a) via magnetic attraction. Non-inductive magnetic structure 3516(a) may be positioned to help align a receiving inductive coil of the mobile device with an inductive coil of coil repeater assembly 3514(a). Non-inductive magnetic structure 3516(a) may include one or more magnetic elements or ferromagnetic materials, arranged to magnetically attract and secure the mobile device to face surface 3512(a). In some implementations, non-inductive magnetic structure 3516(a) may be disposed on face surface 3512(a), or provided as a separate component coupled thereto. In other implementations, non-inductive magnetic structure 3516(a) may be embedded within generalized multi-device charging apparatus 3510 adjacent face surface 3512(a).

As described above, non-inductive magnetic structure 3516(a) may secure a mobile device to face surface 3512(a) via magnetic attraction. Non-inductive magnetic structure 3516(a) may also be positioned to help align a receiving inductive coil of the mobile device with an inductive coil of coil repeater assembly 3514(a).

As depicted, in some implementations generalized multi-device charging apparatus 3510 may further comprise a visual wireless charging metric indicator 3560(a) disposed on face surface 3512(a). For example, visual wireless charging metric indicator 3560(a) may comprise one or more light-emitting diodes (LEDs) or other light sources. Visual wireless charging metric indicator 3560(a) may be configured to indicate one or more of various charging metrics for wireless charging of a mobile device received by face surface 3512(a). Examples of such charging metrics may include voltage and current levels, charging efficiency, coupling efficiency, alignment tolerance, surface temperature, electromagnetic field strength, etc. Accordingly, visual wireless charging metric indicator 3560(a) can assist a user with determining a position (e.g., spatially and orientationally) of the mobile device on face surface 3512(a) to improve/optimize charging efficiency for the mobile device.

Referring again to FIGS. 27 and 28, in some implementations the above-described faces surfaces may comprise non-slip surfaces (e.g., a surface comprising a rubber or silicone, a non-slip fabric, a textured or raised pattern, a friction-enhancing polymer, a non-slip vinyl, etc.) or gripping surfaces (e.g., a Velcro surface, a surface comprising hook-and-loop fasteners, etc.) that secure mobile devices and prevent them from slipping down.

As depicted in FIGS. 27 and 28, the inductive coils of coil repeater assemblies associated with face surfaces (e.g., the inductive coils of coil repeater assemblies 2714(a), 2714(b), 2814(a), 2814(b), etc.) may be tilted with respect to: (a) the inductive coils of coil repeater assemblies associated with the base surfaces (e.g., the inductive coils of coil repeater assemblies 2714(c) and 2814(c); (b) the inductive coils associated with external wireless chargers; or (c) some combination thereof.

To increase the flux linkage between inductive coils that are tilted with respect each other, multi-device wireless charging apparatuses 2710 and 2810 may comprise additional embedded coil repeater assemblies/inductive coils that essentially bridge this gap in tilt angle. Such a “slinky-like” configuration of embedded coil repeater assemblies/inductive coils can also increase flux linkage by bridging (vertical) air gaps and lateral offsets.

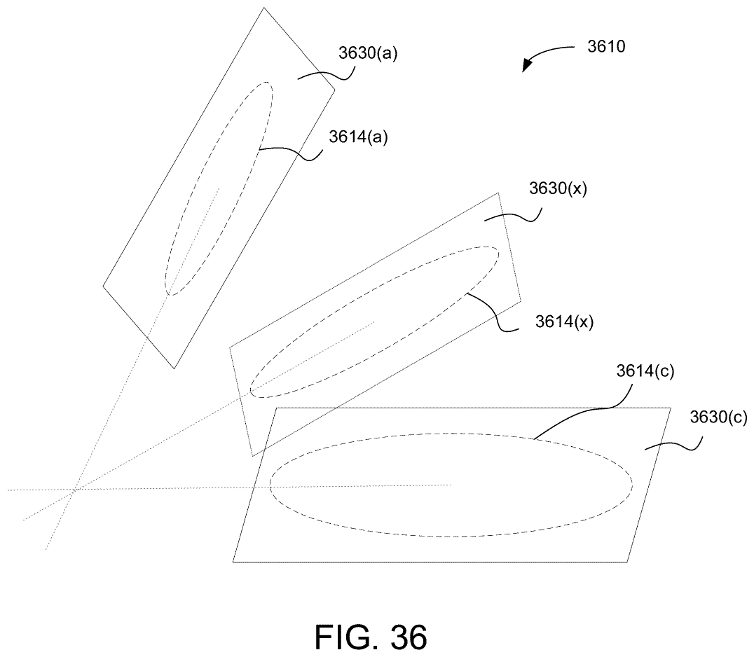

FIG. 36 illustrates an example of such a configuration. Namely, FIG. 36 depicts a generalized multi-device wireless charging apparatus 3610 that comprises: (1) a coil repeater assembly 3614(c) associated with a base surface 3630 of generalized multi-device wireless charging apparatus 3610 (e.g., disposed immediately above the base surface); (2) a coil repeater assembly 3614(a) associated with a face surface of generalized multi-device wireless charging apparatus 3610 (e.g., disposed immediately below the face surface); and (3) a coil repeater assembly 3614(x) disposed between coil repeater assemblies 3614(c) and 3614(a) to essentially bridge a tilt angle, (vertical) air gap, and lateral offset between coil repeater assemblies 3614(c) and 3614(a). While not depicted, in some implementations additional coil repeater assemblies may be disposed between coil repeater assembly 3614(x) and coil repeater assemblies 3614(c) and 3614(a) respectively in a “slinky-like” configuration. Moreover, in certain implementations additional coil repeater assemblies may be embedded within generalized multi-device wireless charging apparatus 3610 to essentially bridge tilt angles, (vertical) air gaps, and lateral offsets to coil repeater assemblies associated with other face surfaces of generalized multi-device wireless charging apparatus 3610.

As depicted in FIG. 36, coil repeater assembly 3614(c) may be disposed across a plane 3630(c), which in some implementations may be approximately parallel to a base surface of generalized multi-device wireless charging apparatus 3610. Likewise, plane 3630(c) may be approximately parallel to a plane across which an inductive coil of an external wireless charger is disposed.

As depicted in FIG. 36, coil repeater assembly 3614(a) may be disposed across a plane 3630(a), which in some implementations may be approximately parallel to a face surface of generalized multi-device wireless charging apparatus 3610. Likewise, plane 3630(a) may be approximately parallel to a plane across which a receiving inductive coil of a mobile device that is received on the face surface is disposed.

Coil repeater assembly 3614(x) may be disposed across a plane 3630(x). As depicted, plane 3630(x) may form an acute angle with plane 3630(c). Likewise, plane 3630(x) may form an acute angle with plane 3630(a). These acute angles may be smaller than the angle formed by planes 3630(c) and 3630(a).

Notwithstanding above, there still may be relative tilt angles, (vertical) air gaps, and lateral offsets between the coil repeater assemblies of generalized multi-device wireless charging apparatus 3610. However, and as discussed in greater detail below, the unique properties of the presently disclosed coil repeater assemblies/inductive coils can enable wireless charging with larger (vertical) air gaps and lateral offsets than existing technologies. Relatedly, the presently disclosed coil repeater assemblies/inductive coils can enable wireless charging at greater tilt angles than existing technologies. Leveraging these unique capabilities, the apparatuses depicted in FIGS. 27-41 (including multi-device wireless charging apparatuses 2710 and 2810) may include various configurations that use (vertical) air gaps, lateral offsets, tilt angles, or some combination thereof, to wirelessly charge multiple mobile devices on compact, convenient to use structures.

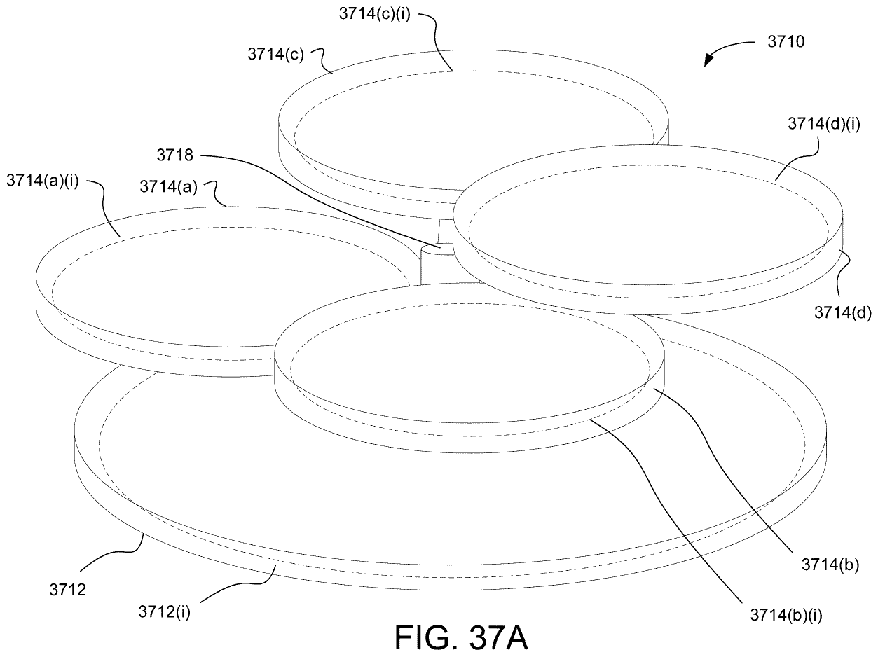

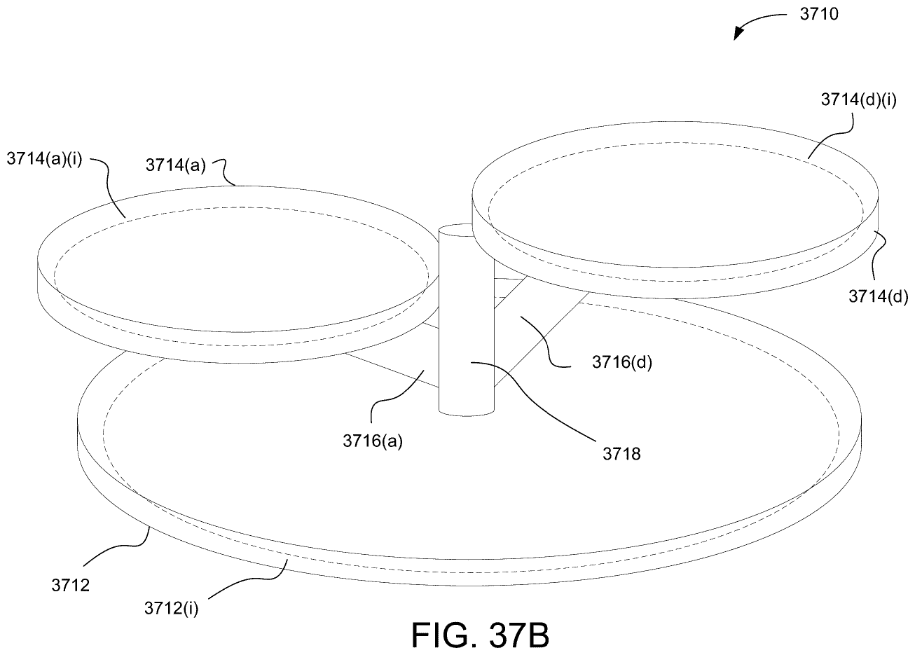

FIGS. 37A-37B depict perspective views of another example multi-device wireless charging apparatus 3710. Multi-device wireless charging apparatus 3710 is an example of a multi-platform configuration that arranges multiple platforms at different heights, lateral offsets, or a combination thereof, to receive multiple mobile devices on a compact structure that fits over an external wireless charger.

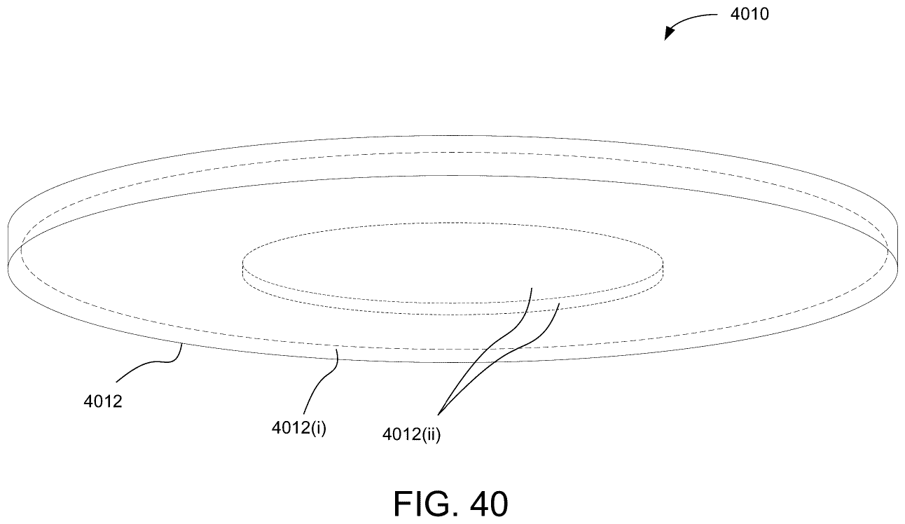

As depicted in FIGS. 37A and 37B, multi-device wireless charging apparatus 3710 may comprise a base platform 3712 and a pillar 3718 extending upwards from base platform 3712. Base platform 3712 may be placed above an external wireless charger. For example, and as depicted and described in greater detail in conjunction with FIG. 40, base platform 3712 may comprise a recess on its bottom surface. The recess may be sized to accommodate the external wireless charger, in for example a snug fit, that secures base platform 3712 to the external wireless charger.

Multi-device wireless charging apparatus 3710 also comprises multiple “branch platforms” that are mechanically connected to pillar 3718—namely a branch platform 3714(a), a branch platform 3714(b), a branch platform 3714(c), and a branch platform 3714(d). In certain implementations, the branch platforms may be directly attached to pillar 3718. In other implementations, rods extending away from pillar 3718 may mechanically connect respective branch platforms to pillar 3718. For example, and as depicted in FIG. 37B (which excludes branch platforms 3714(b) and 3714(c) for illustrative purposes), a rod 3716(a) may mechanically connect branch platform 3714(a) to pillar 3718. Likewise, a rod 3716(d) may mechanically connect branch platform 3714(d) to pillar 3718.

As discussed above, the branch platforms of multi-device wireless charging apparatus 3710 may be vertically offset, laterally offset, or a combination thereof, such that separate mobile devices can be received upon each branch platform without physically obstructing each other. In some implementations, the branch platforms may be arranged to minimize vertical interference (e.g., due to mobile device placements) between a bottom of each branch platform and base platform 3712. This may correspondingly reduce interference in inductive flux linkage between the bottom of each branch platform and base platform 3712.

In the specific examples of FIGS. 37A-37B, the branch platforms are shown as being at an approximately horizontal orientation, parallel to base 3712. However, in various implementations, the branch platforms can be angled such that a mobile device is facing in a more outward direction, rather than facing upward. This can allow the mobile device to be charged while it is also in use or being viewed by its user in situ. In some implementations, the rods connecting branch platforms to pillar 3718 can be configured to swing or rotate about pillar 3718 such that the various positions of the branch platforms around multi-device wireless charging apparatus 3710 can be adjusted. Likewise, the branch platforms can be mounted to the rods with a gimble, swivel or pivot joint, or other articulating mount such that their angle can be adjusted as desired. Examples of this might include, for example, a hinge assembly (for rotation and one axis), a ball and socket joint, a rotary coupling, a universal joint, and so on.

As depicted in FIGS. 37A-37B, in some implementations a coil repeater assembly may be disposed on or embedded beneath a top (i.e., mobile device-receiving) surface of each branch platform. For example, a coil repeater assembly 3714(a)(i) may be disposed on or embedded beneath the top surface of branch platform 3714(a). Likewise, a coil repeater assembly 3714(b)(i) may be disposed on or embedded beneath the top surface of branch platform 3714(b), a coil repeater assembly 3714(c)(i) may be disposed on or embedded beneath the top surface of branch platform 3714(c), and a coil repeater assembly 3714(d)(i) may be disposed on or embedded beneath the top surface of branch platform 3714(d).

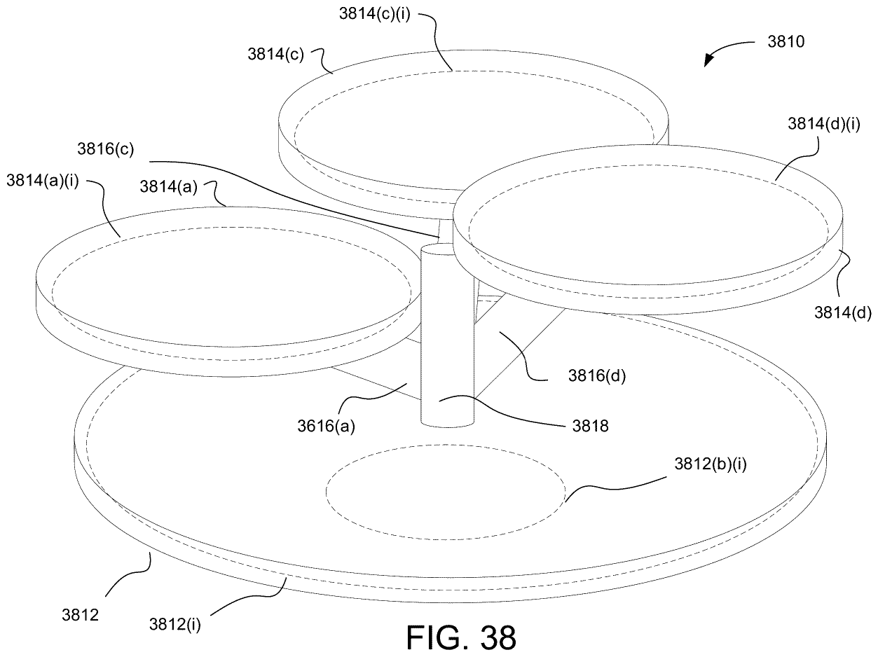

While not directly depicted in FIGS. 37A-38B, in some implementations one or more of the branch platforms may include non-inductive magnetic structures to help align receiving inductive coils of mobile devices received on the branch platforms with inductive coils of the coil repeater assemblies of the branch platforms. Likewise, visual indicators (e.g., LEDs or other lights) may be disposed on each branch platform to indicate charging efficiency (or another charging metric) for a mobile device received on a respective branch platform. Such visual indicators can assist users with positioning and orienting the mobile devices to improve/optimize wireless charging efficiency.

Likewise, while not directly depicted in FIGS. 37A-38B, in certain implementations one or more of the branch platforms may comprise supporting structures (e.g., cradles or other supporting structures) to receive/support the mobile devices, align the mobile devices for improved/optimal wireless charging, or some combination thereof.

Examples of such non-inductive magnetic structures and support structures are depicted and described in greater detail in conjunction with FIGS. 32-35.

Likewise, in some implementations the top (i.e., mobile device-facing) surfaces of the branch platforms may comprise non-slip surfaces (e.g., a surface comprising a rubber or silicone, a non-slip fabric, a textured or raised pattern, a friction-enhancing polymer, a non-slip vinyl, etc.) or gripping surfaces (e.g., a Velcro surface, a surface comprising hook-and-loop fasteners, etc.) that secure mobile devices and prevent them from slipping.

As depicted in FIGS. 37A-37B, in certain implementations a coil repeater assembly 3712(i) may also be disposed on (e.g., structurally integrated with, or attached to, such as via adhesive) or embedded within base platform 3712. In some implementations, to increase inductive flux linkage between coil repeater assembly 3712(i) and the coil repeater assemblies of the branch platforms, inductive coils of all the coil repeater assemblies of multi-device wireless charging apparatus 3710 may be disposed across approximately parallel planes. Relatedly, the inductive coil of coil repeater assembly 3712(i) may have a wider diameter than the inductive coils of the coil repeater assemblies of the branch platforms such that coil repeater assembly 3712(i) laterally overlaps with all the coil repeater assemblies of the branch platforms. In some implementations, the inductive coil of coil repeater assembly 3712(i) may also have a wider diameter than an inductive coil of an external wireless charger that multi-device wireless charging apparatus 3710 is placed above—thereby effectively extending/improving the lateral offset charging capabilities of the external wireless charger.

FIG. 38 depicts another example multi-device wireless charging apparatus 3810. Like multi-device wireless charging apparatus 3710, multi-device wireless charging apparatus 3810 is an example of a multi-platform configuration that arranges multiple platforms at different heights, lateral offsets, or a combination thereof, to receive multiple mobile devices on a compact structure that can be placed upon an external wireless charger.

As depicted, multi-device wireless charging apparatus 3810 has a substantially similar configuration to multi-device wireless charging apparatus 3710 except that branch platform 3714(b) and coil repeater assembly 3714(b)(i) have been replaced with a coil repeater assembly 3812(b)(i) that is disposed below a top surface of base platform 3812. Accordingly, in some implementations base platform 3812 may include a visual marking (e.g., an outline depicting a wireless charging pad, a raised portion in the shape of a wireless charging pad, etc.) that indicates to users that the portion of base platform 3812 above coil repeater assembly 3812(b)(i) is a potential wireless charging location for a mobile device.

For brevity, components of multi-device wireless charging apparatus 3810 sharing common reference numerals with multi-device wireless charging apparatus 3710/FIG. 37 will not be described again.

As may be appreciated, multi-device wireless charging apparatuses 3710 and 3810 are simply illustrative examples of multi-platform configurations. In other implementations, different numbers and configurations of branch platforms may be included/excluded, and different numbers and configurations of coil repeater assemblies may be included/excluded.

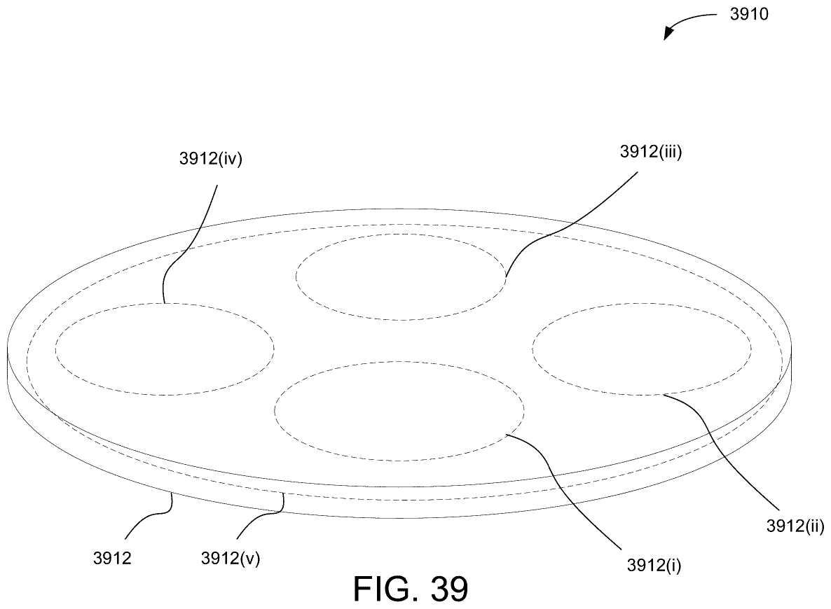

FIG. 39 depicts another example multi-device wireless charging apparatus 3910. Multi-device wireless charging apparatus 3910 is an example of a base platform configuration that uses lateral offsets to arrange multiple wireless charging locations across a base platform that fits over an external wireless charger.

As depicted, multi-device wireless charging apparatus 3910 comprises a base platform 3912.

In certain implementations, base platform 3912 may comprise one or more mobile device-specific coil repeater assemblies that are disposed on, or embedded beneath, a top (i.e., mobile device-facing) surface of base platform 3912. For example, in the specific example of FIG. 39, base platform 3912 comprises four mobile device-specific coil repeater assemblies—namely a mobile device-specific coil repeater assembly 3912(i), a mobile device-specific coil repeater assembly 3912(ii), a mobile device-specific coil repeater assembly 3912(iii) and a mobile device-specific coil repeater assembly 3912(vi). As depicted, the four mobile device-specific coil repeater assemblies may be arranged such that they are laterally offset from each other. Accordingly, four separate mobile devices may be placed above the four respective mobile device-specific coil repeater assemblies without physically obstructing each other.

In some implementations, base platform 3912 may include visual markings above each mobile device-specific coil repeater assembly (e.g., an outline depicting a wireless charging pad, a raised portion in the shape of a wireless charging pad, etc.) that indicates to users that a respective surface of base platform 3912 above a respective mobile device-specific coil repeater assembly is a potential wireless charging location for a mobile device. For example, a surface of base platform 3912 above mobile device-specific coil repeater assembly 3912(i) may include an outline of a wireless charging pad of the same/similar diameter and position as mobile device-specific coil repeater assembly 3912(i). Likewise, a surface of base platform 3912 above mobile device-specific coil repeater assembly 3912(ii) may include an outline of a wireless charging pad of the same/similar diameter and position as mobile device-specific coil repeater assembly 3912(ii).

While not directly depicted in FIG. 39, in some implementations base platform 3912 may include non-inductive magnetic structures to help align receiving inductive coils of mobile devices received on base platform 3912 with inductive coils of the mobile device-specific coil repeater assemblies of base platform 3912. Likewise, visual indicators (e.g., LEDs or other lights) may be disposed proximate a surface above each mobile device-specific coil repeater assembly to indicate charging efficiency for a mobile device received above a respective mobile device-specific coil repeater assembly. Such visual indicators can assist users with positioning and orienting the mobile devices to improve/optimize wireless charging efficiency.

Likewise, while not directly depicted in FIG. 39, in certain implementations one or more of the surfaces above the mobile device-specific coil repeater assemblies may comprise support structures (e.g., cradles or other support structures) to receive/support the mobile devices, align the mobile devices for improved/optimal wireless charging, arrange the mobile devices to avoid physically obstructing each other, or some combination thereof.

In various implementations, alternative or in addition to the mobile device-specific coil repeater assemblies, base platform 3912 may include a non-mobile device-specific coil repeater assembly 3912(v). Non-mobile device-specific coil repeater assembly 3912(v) may be disposed on a surface of base platform 3912 (e.g., a bottom/external wireless charger-facing surface of base platform 3912 or embedded within base platform 3912. In implementations where mobile device-specific coil repeater assemblies are also included with base platform 3912, non-mobile device-specific coil repeater assembly 3912(v) may be positioned between the mobile device-specific coil repeater assemblies and an external wireless charger that base platform 3912 is placed upon. To increase inductive flux linkage between non-mobile device-specific coil repeater assembly 3912(v) and the mobile device-specific coil repeater assemblies, inductive coils of all the coil repeater assemblies of multi-device wireless charging apparatus 3910 may be disposed across approximately parallel planes. Relatedly, the inductive coil of non-mobile device-specific coil repeater assembly 3912(v) may have a wider diameter than the inductive coils of mobile device-specific coil repeater assemblies such that non-mobile device-specific coil repeater assembly 3912(v) laterally overlaps with all the mobile device-specific coil repeater assemblies. In some implementations, the inductive coil of non-mobile device-specific coil repeater assembly 3912(v) may also have a wider diameter than an inductive coil of the external wireless charger that multi-device wireless charging apparatus 3910 is placed upon—thereby effectively extending/improving the lateral offset charging capabilities of the external wireless charger.

FIG. 40 illustrates a generalized multi-device wireless charging apparatus 4010 comprising a base platform 4012. FIG. 40 specifically highlights a recess feature for base platform 4012 that may be included on any one of multi-device wireless charging apparatuses 3710, 3810 or 3910.

As depicted, base platform 4012 may comprise a recess 4012(ii). Recess 4012(ii) may be of a geometry that corresponds to the dimensions of a standard wireless charging pad such that generalized multi-device charging apparatus 4010 fits snugly on the wireless charging pad to provide physical alignment. For example, in certain implementations recess 4012(ii) may comprise a disc-shaped recess that is dimensioned to fit snugly over the wireless charging pad. In some of these implementations, recess 4012(ii) may further comprise a notch or elongated groove (not directly depicted in FIG. 40) dimensioned to fit snugly over a cord connected to the wireless charging pad such that generalized multi-device charging apparatus 4010 can rest flat and stable on the surface of a desk or other furniture element upon which the wireless charging pad is positioned.

As depicted in FIG. 40B, recess 4012(ii) may also help align the wireless charging pad such that an inductive coil of the wireless charging pad is centered below an inductive coil of a coil repeater assembly 4012(i) of generalized multi-device charging apparatus 4010. As alluded to above, the inductive coil of coil repeater assembly 4012(i) may be disposed across a plane parallel (or approximately parallel) to the inductive coil of the wireless charging pad when the wireless charging pad is received/accommodated within recess 4012(ii).

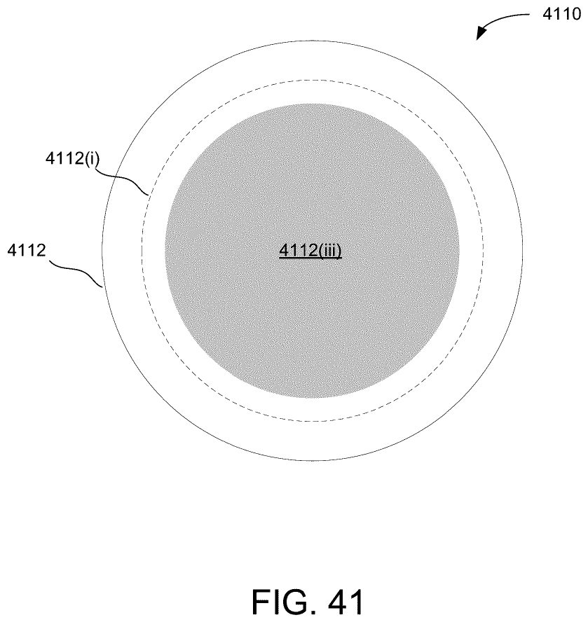

FIG. 41 illustrates a generalized multi-device wireless charging apparatus 4110 comprising a base platform 4112. FIG. 41 specifically highlights a non-inductive magnetic structure feature for base platform 4112 that may be included on any one of multi-device wireless charging apparatuses 3710, 3810 or 3910.

As depicted, base platform 4112 may comprise a non-inductive magnetic structure 4112(iii), which may be disposed on a bottom (i.e., external wireless charger-facing) surface of base platform 4112, or embedded above the bottom surface of base platform 4112. As depicted, in certain implementations non-inductive magnetic structure 4112(iii) may be disc-shaped and may be dimensioned to mirror the shape/dimensions of a standard wireless charging pad. As depicted in FIG. 41, non-inductive magnetic structure 4112(iii) may also help align the wireless charging pad such that an inductive coil of the wireless charging pad is centered below an inductive coil of a coil repeater assembly 4112(i) of base platform 4112. As alluded to above, the inductive coil of coil repeater assembly 4112(i) may be disposed across a plane parallel (or approximately parallel) to the inductive coil of the wireless charging pad when the wireless charging pad is magnetically secured to the bottom surface of base platform 4112.

As may be appreciated, each of the apparatuses described and depicted in conjunction with FIGS. 27-41 may be configured to rest upon or otherwise secure to an external wireless charger, such as a wireless charging pad. In some scenarios, the external wireless charger may rest upon a piece of furniture, such as a desk, a table, a drawer, an airplane tray table, or another piece of furniture. In other scenarios, the external wireless charger may be structurally integrated with the piece of furniture. In either of such scenarios, the apparatuses described and depicted in conjunction with FIGS. 27-41 may be configured to rest upon, or otherwise secure to the piece of furniture. In still further implementations, the apparatuses described and depicted in conjunction with FIGS. 27-41 may be structurally integrated with the piece of furniture. For example, an apparatus described and depicted in conjunction with FIGS. 27-41 may be structurally integrated with an airplane tray table that includes an external wireless charger. In such an implementation, the apparatus may be configured to fold up or otherwise compress into a flat configuration when the airplane tray table is stowed away, and “pop-up” when in use.

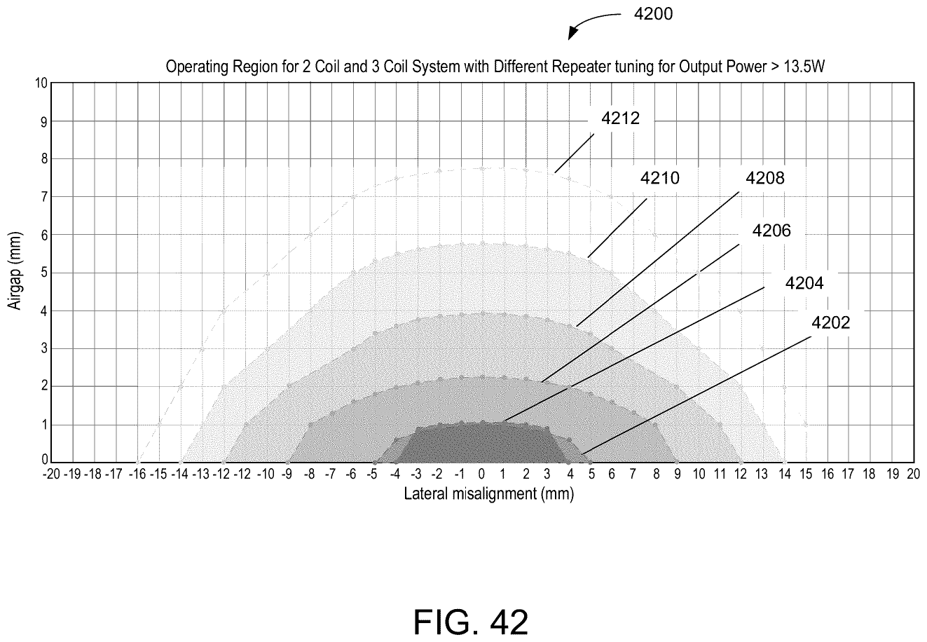

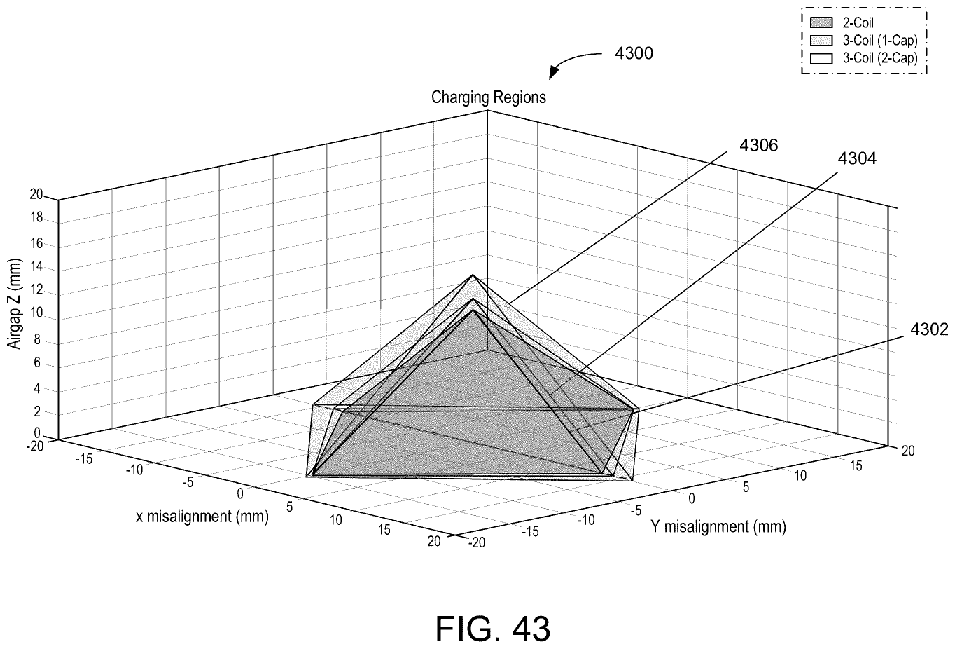

FIGS. 42-43 illustrate graphs depicting effective charging ranges for example coil repeater assemblies disclosed herein.

More specifically, the graphs of FIGS. 42-43 illustrate results from example experiments where different coil repeater assemblies disclosed herein (e.g., different implementations of coil repeater assembly 1420 comprising different numbers of tuning capacitors) were attached to an interior surface of a mobile device case (e.g., as depicted and described in conjunction with FIGS. 14-26).

In the example experiments, a mobile device was received within the mobile device case, and various wireless charging metrics were tested for the different coil repeater assemblies at: (1) different (vertical) air gaps between a wireless charging interface of the mobile device and a wireless charging interface of an external wireless charger; and (2) different lateral offsets between a center of the wireless charging interface of the mobile device and a center of the wireless charging interface of an active power supply (sometimes described herein as an external wireless charger).

Graphs 4200 and 4300 were derived from this experimental data.

Before describing graphs 4200 and 4300 in more detail, it may be appreciated that the experimental results reflected in graphs 4200 and 4300 may be similar (and can be extended) to various example apparatuses/coil repeater assemblies disclosed herein, including without limitation: (a) the mobile device cases and coil repeater assemblies depicted and described in conjunction with FIGS. 14-26; and (B) the multi-device wireless charging apparatuses and coil repeater assemblies depicted and described in conjunction with FIGS. 27-41. As described above, each of these apparatuses may comprise, inter alia, a surface configured to receive a wireless charging interface of a mobile device and a coil repeater assembly disposed on, or embedded beneath, the surface to increase inductive flux between the wireless charging interface of the mobile device and a wireless charging interface of an active power supply.

As depicted in FIG. 42, graph 4200 plots an effective charging range for the different coil repeater assemblies as a function of (vertical) air gap on the y-axis and lateral offset (i.e., misalignment) on the x-axis. In some implementations, an effective charging range for a coil repeater assembly (or an apparatus incorporating the coil repeater assembly) may comprise a spatial region of air gaps, lateral offsets, tilt angles, or any combination thereof, where wireless charging efficiency for a mobile device is 70% or greater. In other implementations, an effective charging range for a coil repeater assembly (or an apparatus incorporating the coil repeater assembly) may comprise a spatial region of air gaps, lateral offsets, tilt angles, or any combination thereof, where wireless charging efficiency for a mobile device is 80% or greater. In still further implementations, an effective charging range for a coil repeater assembly (or an apparatus incorporating the coil repeater assembly) may comprise a spatial region of air gaps, lateral offsets, tilt angles, or any combination thereof, where wireless charging efficiency for a mobile device is 90% or greater. As used herein, wireless charging efficiency may be defined as a percentage of inductive energy transmitted by the active power supply that is received by a receiving inductive coil of the mobile device. The above-described air gaps may be measured between a wireless charging interface of the mobile device and a wireless charging interface of the active power supply. Likewise, the lateral offsets may be measured from a center of the wireless charging interface of the mobile device and a center of the wireless charging interface of the active power supply. Tilt angles may be measured between a plane across which the wireless charging interface of the mobile device is disposed and a plane across which the wireless charging interface of the active power supply is disposed.

Referring again to FIG. 42, graph 4200 includes: (1) a curve 4202 that bounds an effective charging range for a first configuration where no coil repeater assembly was included in the mobile device case; (2) a curve 4204 that bounds an effective charging range for a second configuration where a coil repeater assembly comprising one tuning capacitor was included in the mobile device case; (3) a curve 4206 that bounds an effective charging range for a third configuration where a coil repeater assembly comprising two tuning capacitors was included in the mobile device case; (4) a curve 4208 that bounds an effective charging range for a fourth configuration where a coil repeater assembly comprising three tuning capacitors was included in the mobile device case; (5) a curve 4210 that bounds an effective charging range for a fifth configuration where a coil repeater assembly comprising four tuning capacitors was included in the mobile device case; and (6) a curve 4212 that bounds an effective charging range for a sixth configuration where a coil repeater assembly comprising five tuning capacitors was included in the mobile device case.

As depicted, the maximum air gap in the effective charging range for the sixth configuration (i.e., where the coil repeater assembly comprising five tuning capacitors was included in the mobile device case) was approximately 7.8 millimeters (mm). By contrast, the maximum air gap in the effective charging range for the first configuration (i.e., where no coil repeater assembly was included in the mobile device case) was approximately 1 mm. As may be appreciated, this significant increase in air gap-related effective charging range can be attributed in part to the unique capabilities of the presently disclosed coil repeater assemblies.

Related to above, the maximum lateral offset in the effective charging range for the sixth configuration (i.e., where the coil repeater assembly comprising five tuning capacitors was included in the mobile device case) was approximately 16 mm. By contrast, the lateral offset in the effective charging range for the first configuration (i.e., where no coil repeater assembly was included in the mobile device case) was approximately 5 mm. As may be appreciated, this significant increase in lateral offset-related effective charging range can be attributed in part to the unique capabilities of the presently disclosed coil repeater assemblies.

As illustrated in graph 4200, the presently disclosed coil repeater assemblies can also extend effective charging ranges for air gap and lateral offset simultaneously. For example, the effective charging range for the sixth configuration (i.e., where the coil repeater assembly comprising five tuning capacitors was included in the mobile device case) includes configurations where there was an air gap of approximately 4 mm and a lateral offset of approximately 12 mm. Such a configuration is well outside the effective charging range for the first configuration (i.e., where no coil repeater assembly was included in the mobile device case).

Referring now to FIG. 43, graph 4300 is analogous to graph 4200 except graph 4300 is plotted in three dimensions. Namely, air gap is plotted on the z-axis and lateral offsets in two dimensions are plotted on the x-axis and y-axis respectively.

Similar to graph 4200, graph 4300 includes: (1) a boundary surface 4302 that bounds an effective charging range for a first configuration where no coil repeater assembly was included in the mobile device case; (2) a boundary surface 4304 that bounds an effective charging range for a second configuration where a coil repeater assembly comprising one tuning capacitor was included in the mobile device case; and (3) a boundary surface 4306 that bounds an effective charging range for a third configuration where a coil repeater assembly comprising two tuning capacitors was included in the mobile device case. As depicted, the effective charging range for the third configuration is the largest/most extensive.

As may be appreciated, the experimental results illustrated in graphs 4200 and 4300 also demonstrate how the presently disclosed coil repeater assemblies can extend effective charging ranges to include configurations for a number of tilt angles between the wireless charging interface of the mobile device and the wireless charging interface of the active power supply. For example, in certain implementations the presently disclosed coil repeater assemblies can extend effective charging ranges to include configurations where a tilt angle between the wireless charging interface of the mobile device and the wireless charging interface of the active power supply exceeds 10, or even 25 degrees.

### Example Multi-Device Wireless Charging Implementations

As described above, each of the multi-device wireless charging apparatuses depicted and described in conjunction with FIGS. 27-41 may comprise: (1) a first surface for receiving a first mobile device; (2) a second surface for receiving a second mobile device; and (3) one or more coil repeater assemblies positioned to increase inductive flux linkage between an external wireless charger and each of the first and second mobile devices when the first and second mobile devices are received on the first and second surfaces respectively. In some implementations, the one or more coil repeater assemblies may comprise at least one of a configuration (A) and a configuration (B). The configuration (A) may comprise: (i) a first coil repeater assembly positioned to increase inductive flux linkage between the external wireless charger and the first mobile device when the first mobile device is received on the first surface, and (ii) a second coil repeater assembly positioned to increase inductive flux linkage between the external wireless charger and the second mobile device when the second mobile device is received on the second surface. The configuration (B) may comprise a third coil repeater assembly positioned to increase inductive flux linkage between the external wireless charger and each of the first and second mobile devices when the first and second mobile devices are received on the first and second surfaces respectively. Again, the one or more coil repeater assemblies may comprise any one or combination of the configuration (A) and the configuration (B).

For example, in the illustrative implementation of multi-device wireless charging apparatus 2710, the first surface may comprise face surface 2712(a). The second surface may comprise face surface 2712(b). The first coil repeater assembly may comprise coil repeater assembly 2714(a). The second coil repeater assembly may comprise coil repeater assembly 2714(b). The third coil repeater assembly may comprise coil repeater assembly 2714(c).

In the illustrative implementation of multi-device wireless charging apparatus 2810, the first surface may comprise face surface 2812(a). The second surface may comprise face surface 2812(b). The first coil repeater assembly may comprise coil repeater assembly 2814(a). The second coil repeater assembly may comprise coil repeater assembly 2814(b). The third coil repeater assembly may comprise coil repeater assembly 2814(c).

In the illustrative implementation of multi-device wireless charging apparatus 3710, the first surface may comprise a top (i.e., mobile device-facing) surface of branch platform 3714(a). The second surface may comprise a top (i.e., mobile device-facing) surface of branch platform 3714(b). The first coil repeater assembly may comprise coil repeater assembly 3714(a)(i). The second coil repeater assembly may comprise coil repeater assembly 3714(b)(i). The third coil repeater assembly may comprise coil repeater assembly 3712(i).

In the illustrative implementation of multi-device wireless charging apparatus 3810, the first surface may comprise a top (i.e., mobile device-facing) surface of branch platform 3814(a). The second surface may comprise a top (i.e., mobile device-facing) surface of base platform 3812 above coil repeater assembly 3812(b)(i). The first coil repeater assembly may comprise coil repeater assembly 3814(a)(i). The second coil repeater assembly may comprise coil repeater assembly 3814(b)(i). The third coil repeater assembly may comprise coil repeater assembly 3812(i).

In the illustrative implementation of multi-device wireless charging apparatus 3910, the first surface may comprise a top (i.e., mobile device-facing) surface of base platform 3912 above mobile device-specific coil repeater assembly 3912(i). The second surface comprise a top (i.e., mobile device-facing) surface of base platform 3912 above mobile device-specific coil repeater assembly 3912(ii). The first coil repeater assembly may comprise mobile device-specific coil repeater assembly 3912(i). The second coil repeater assembly may comprise mobile device-specific coil repeater assembly 3912(ii). The third coil repeater assembly may comprise non-mobile device-specific coil repeater assembly 3912(v).

As described above, the first coil repeater assembly may be disposed on the first surface or embedded within the apparatus adjacent the first surface. Likewise, the second coil repeater assembly may be disposed on the second surface or embedded within the apparatus adjacent the second surface.

As described above, an inductive coil of the third coil repeater assembly may have a wider diameter than an inductive coil of the external wireless charger.

As described above, in certain implementations the apparatus may further comprise a base surface. Accordingly, when the base surface is placed upon the external wireless charger the one or more coil repeater assemblies may be positioned to increase inductive flux linkage between the external wireless charger and each of the first and second mobile devices when the first and second mobile devices are received on the first and second surfaces respectively.

As described above, in certain implementations the base surface may comprise a recess shaped to accommodate the external wireless charger when the apparatus is placed upon the external wireless charger. Examples of such a recess are depicted and described in conjunction with FIGS. 29A-29B and 40.

As described above, in some implementations the apparatus may further comprise a non-inductive magnetic structure positioned to secure the base surface to the external wireless charger. Examples of such a non-inductive magnetic structure are depicted and described in conjunction with FIGS. 30 and 41.

In various implementations, the apparatus may further comprise a slot. The slot may be dimensioned to receive the external wireless charger such that when the external wireless charger is received within the slot, the one or more coil repeater assemblies are positioned to increase inductive flux linkage between the external wireless charger and each of the first and second mobile devices when the first and second mobile devices are received on the first and second surfaces respectively. Examples of such a slot are depicted and described in conjunction with FIG. 31A-31B.

In some implementations of the apparatus, the first surface may comprise a cradle dimensioned to receive the first mobile device. Such cradles and other support structures are depicted and described in conjunction with FIG. 32-34. In certain implementations, the cradle may comprise a recess in the first surface dimensioned to receive the first mobile device (see e.g., FIG. 32). In other implementations the cradle may comprise a structure extending outwards from the first surface to support the first mobile device from beneath and prevent the first mobile device from sliding downwards when the first device is received on the first surface (see e.g., FIGS. 33-34).

In various implementations, the apparatus may further comprise a non-inductive magnetic structure positioned to secure the first mobile device to the first surface via magnetic attraction. An example of such a non-inductive magnetic structure is depicted and described in conjunction with FIG. 35.

As described above, in some implementations the first surface may comprise a non-slip surface or a gripping surface. Examples of the non-slip surface may comprise any one or combination of: a rubber surface; a silicone surface; a non-slip fabric surface; a textured or raised-patterned surface; a friction-enhancing polymer surface; or a non-slip vinyl surface. Examples of the gripping surface may comprise any one or combination of: a Velcro surface; a surface comprising hook-and-loop fasteners; or a magnetic surface.

As described above, in certain implementations the apparatus may further comprise a visual wireless charging metric indicator. For example, the visual wireless charging metric indicator may comprise: (a) a first light that indicates efficiency for wireless charging of the first mobile device; and (b) a second light that indicates efficiency for wireless charging of the second mobile device. Examples of such visual wireless charging metric indicator are depicted and described in conjunction with FIGS. 33-35.

As described above, in some implementations the apparatus may further comprise a base platform and the first and second surfaces may be disposed on a mobile device-facing surface of the base platform. Accordingly, when the base platform is placed upon the external wireless charger the one or more coil repeater assemblies may be positioned to increase inductive flux linkage between the external wireless charger and each of the first and second mobile devices when the first and second mobile devices are received on the first and second surfaces respectively. In example of such a configuration is depicted and described in conjunction with FIG. 39.

As described above, in some implementations the apparatus may further comprise: (a) a base platform to be placed above the external wireless charger; (b) a pillar extending upwards from the base platform; and (c) a branch platform mechanically connected (e.g., directly or via a connecting rod) to the pillar. Here, the first surface may be disposed on a mobile device-facing surface of the branch platform. Relatedly, the first coil repeater assembly may be disposed on the first surface or embedded within the branch platform adjacent the first surface. Examples of such a configuration are depicted and described in conjunction with FIGS. 37A-37B and 38. In certain implementations, the second surface may be disposed on a mobile device-facing surface of the base platform. Relatedly, the second coil repeater assembly may be disposed on the second surface or embedded within the base platform adjacent the second surface. An example of such a configuration is depicted and described in conjunction with FIG. 38. In other implementations, the second surface may be disposed on a mobile device-facing surface of a second branch platform mechanically connected (e.g., directly or via a connecting rod) to the pillar. Relatedly, the second coil repeater assembly may be disposed on the second surface or embedded within the second branch platform adjacent the second surface. Examples of such a configuration are depicted and described in conjunction with FIGS. 37A-37B and FIG. 38. In some of the above-described implementations, the third coil repeater assembly may be disposed on or embedded within the base platform. Examples of such a configuration are depicted and described in conjunction with FIGS. 37A-37B and FIG. 38.

In some implementations, the apparatus may further comprise a base surface to be placed upon the external wireless charger, wherein the first and second surfaces taper away from the base surface and towards each other. Examples of such a configuration are depicted and described in conjunction with FIGS. 27 and 28. In certain of such implementations the apparatus may further comprise a fourth coil repeater assembly embedded within the apparatus between the first coil repeater assembly and the base surface. Relatedly, (1) the base surface may be disposed across a first plane, (2) the first surface may be disposed across a second plane that forms a first acute angle with the first plane, (3) the first coil repeater assembly may be disposed across a third plane that forms a second acute angle with the first plane, the second acute angle being less than or equal to the first acute angle, (4) the fourth coil repeater assembly may be disposed across a fourth plane that forms a third acute angle with the first plane, the third acute angle being less than the second acute angle. An example of such a configuration is depicted and described in conjunction with FIG. 36.

As described above, in some implementations the one or more coil repeater assemblies may comprise: (a) an inductive coil comprising turns of a trace bundle; (b) one or more tuning capacitors electrically connected to each end of the inductive coil; and (c) the trace bundle comprising traces formed from trace segments electrically interconnected by interlayer connectors, a respective trace comprising electrically interconnected trace segments across multiple layers. Relatedly, in certain implementations the one or more coil repeater assemblies may comprise an inductive coil comprising: (a) a first conductor layer comprising first trace segments; (b) a second conductor layer comprising second trace segments; and (c) an insulating layer disposed between the first and second conductor layers. Here, each trace of the formed traces may comprise a respective subset of the first trace segments electrically interconnected by a subset of the interlayer connectors to a corresponding subset of the second trace segments such that the interconnected trace segments are woven through and around the insulating layer. Relatedly, the traces may be formed as a conductive line woven through and around the insulating layer to form the inductive coil. In some of such implementations, the interlayer connectors may comprise through vias filled with a conductive material. The implementations of this paragraph are depicted and described in more detail in conjunction FIGS. 1-26.

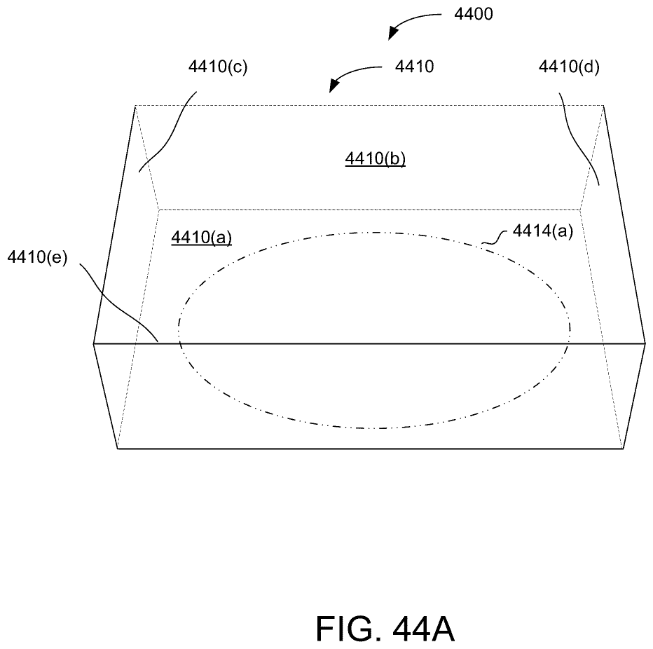

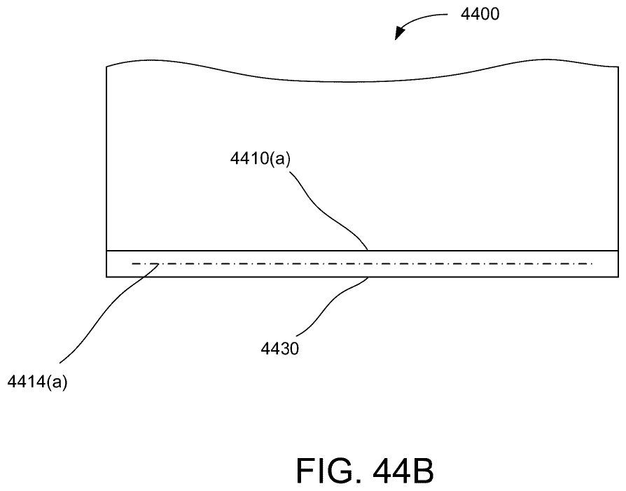

FIGS. 44-52 illustrate example multi-use wireless charging apparatuses that: (1) facilitate wireless charging; and (2) have utility beyond wireless charging.

More specifically, FIGS. 44-52 each illustrate an apparatus that: (1) increases or otherwise optimizes inductive flux linkage between an active power supply (e.g., a wireless charging pad or other wireless charging source) and one or more mobile devices placed upon or within the apparatus; and (2) has utility beyond wireless charging.

For example, a presently disclosed multi-use wireless charging apparatus may comprise a consumer product that has utility beyond wireless charging. Examples of such consumer products may include products that may comprise one or more coil repeater assemblies disposed thereon or embedded otherwise located therein, including without limitation: (a) various types of storage containers (e.g., purses, handbags, clutches, suitcases, toolboxes, jewelry trays, valet trays, wireless earbud cases, protective mobile device cases, brief cases, tackle boxes, golf bags, camera bags, storage compartments (e.g., such as a furniture armrest, a vehicle console, a vehicle door pocket, and so on) etc.); (b) various types of furniture (e.g., desks, workstations, tables, drawers, couches, chairs, recliners, airplane trays, counter tops, pool tables, etc.); and (c) other types of consumer products or devices (e.g., payment cards, mouse pads, mice, wireless speakers, wireless headphones, wireless ear buds, cordless tools, smartwatches, toothbrushes, medical devices, cameras, tablets, etc.). Accordingly, the presently disclosed apparatuses can expand the utility of such consumer products by additionally facilitating improved wireless charging of mobile devices.

As described in greater detail below, the presently disclosed multi-use wireless charging apparatuses can achieve the above-described technical advantages through strategic positioning, orienting, and dimensioning of coil repeater assemblies.

In some implementations, the coil repeater assemblies may comprise the inductive coils described in conjunction with FIGS. 1-11. In other implementations however, other inductive coil configurations may be used.

As alluded to above, the unique properties of the presently disclosed inductive coils can enable wireless charging with larger (vertical) air gaps and lateral offsets than existing technologies. Relatedly, the presently disclosed inductive coils can enable wireless charging at greater tilt angles than existing technologies. Leveraging these unique capabilities, the presently disclosed multi-use wireless charging apparatuses can facilitate wireless charging where air gaps, lateral offsets, tilt angles, or some combination thereof, are present. Tilt angle in the context of wireless charging refers to the angle between the plane of the transmitting coil (e.g., located in the wireless charger) and the plane of the receiving coil (e.g., located in the device, such as a cell phone or other device). If both coils are perfectly parallel, the tilt angle is 0°, resulting in optimal magnetic coupling and charging efficiency. As the tilt angle increases (i.e., the coils become less aligned), the efficiency of energy transfer between the charger and device typically decreases. With conventional solutions, charging efficiency is dramatically reduced as a function of tilt angle.

In accordance with the present disclosure, the use of inductive repeater coils may allow mobile devices to be placed on or within a presently disclosed multi-use wireless charging apparatus in an ad hoc manner (i.e., where there is not precise wireless charging alignment or zero tilt angle) and still be effectively wirelessly charged.

In various implementations, the presently disclosed multi-use wireless charging apparatuses can incorporate (or incorporate features of) the multi-device wireless charging apparatuses depicted and described in conjunction with FIGS. 27-41. As described above, such multi-device wireless charging apparatuses may be implemented to facilitate simultaneous multi-device charging using a single active wireless power source conventionally used to wirelessly charge only a single mobile device at a time.

FIGS. 44A-44B illustrate perspective views of an example multi-use wireless charging apparatus 4400.

Multi-use wireless charging apparatus 4400 illustrates a generalized storage container comprising a container body 4410 and a recess defined by walls of container body 4410 (i.e., walls 4410(a), 4410(b), 4410(c), 4410(d) and 4410(e)).

Multi-use wireless charging apparatus 4400 may comprise a form of various types of storage containers including a toolbox, a jewelry tray, a valet tray, a bag (e.g., a handbag, a purse, a clutch, a knapsack, etc.), a suitcase, a wallet, a golf bag, camera bag, or other type of storage container.

As depicted, multi-use wireless charging apparatus 4400 may further comprise a coil repeater assembly 4414(a). Coil repeater assembly 4414(a) may be attached to container body 4410 and positioned to increase inductive flux linkage between an active power supply (e.g., a wireless charging pad) that container body 4410 is placed upon and receiving inductive coils of one or more mobile devices placed within the recess of container body 4410. Examples of the mobile devices may include mobile phones, smart watches, tablets, e-readers, portable speakers, wireless headphones or ear buds, hearing aids, wireless medical devices, electric power tools, etc.

In some implementations, coil repeater assembly 4414(a) may be disposed on or embedded within a wall of container body 4410 (e.g., wall 4410(a)). In certain of these implementations, coil repeater assembly 4414(a) may be disposed on an inner surface of, or embedded within, a bottom (i.e., upwards-facing) wall of container body 4410 (e.g., inner wall 4410(a)). In other words, coil repeater assembly 4414(a) may be disposed on an inner surface of a wall of container body 4410 that is opposite an outer surface of the wall of container body 4410 (e.g., outer surface 4430) that typically or naturally rests on a flat surface (e.g., a tabletop) when container body 4410 is placed upon the flat surface. An active power supply (e.g., a wireless charging pad) may also be rested on the flat surface. Accordingly, when container body 4410 is placed upon the active power supply and flat surface, coil repeater assembly 4414(a) may be positioned to increase inductive flux linkage between the active power supply and receiving inductive coils of one or more mobile devices placed within the recess of container body 4410. In certain implementations, coil repeater assembly 4414(a) may be embedded within container body 4410 adjacent the inner surface of the bottom (i.e., upwards-facing) wall of container body 4410. For example, in certain implementations coil repeater assembly 4414(a) may be embedded within container body 4410 bottom wall between inner surface 4410(a) and outer surface 4430.

As described in conjunction with FIGS. 27-41, in certain implementations one or more additional coil repeater assemblies may be attached to container body 4410 to further increase inductive flux linkage between an active power supply that container body 4410 is placed upon and receiving inductive coils of one or more mobile devices placed within the recess of container body 4410. For example, in some implementations coil repeater assembly 4414(a) may be disposed on or embedded immediately beneath inner surface 4410(a). Relatedly, a second coil repeater assembly (not depicted) may be disposed on or embedded immediately above outer surface 4430. The inclusion of multiple coil repeater assembles in container body 4410 can effectively bridge the (vertical) air gap between the active power supply and the one or more mobile devices placed within the recess of container body 4410, and further increase the inductive flux linkage therebetween.

In some implementations, an inductive coil of coil repeater assembly 4414(a) may have wider diameter than an inductive coil of the active power supply that container body 4410 is placed upon—thereby effectively extending/improving the lateral offset charging capabilities of the active power supply.

As depicted and described in conjunction with FIGS. 29A-29B and 40, in some implementations an outer wall of container body 4410 (e.g., outer wall 4430) may comprise a recess dimensioned to snugly accommodate a wireless charging interface (e.g., a wireless charging pad) of an active power supply when container body 4410 is placed upon the wireless charging interface of the active power supply. When accommodated within the recess, the wireless charging interface of the active power supply may radially align with coil repeater assembly 4414(a), or other coil repeater assemblies attached to container body 4410.

As depicted and described in conjunction with FIGS. 30 and 41, in some implementations a non-inductive magnetic structure may be attached to container body 4410 and positioned to secure container body 4410 to the active power supply. As described above, the non-inductive magnetic structure can also help to radially align the active power supply with coil repeater assembly 4414(a), or other coil repeater assemblies attached to container body 4410. In some implementations the non-inductive magnetic structure may be disposed on an outer wall of container body 4410 (e.g., outer wall 4430) or embedded within container body 4410 adjacent the outer wall.

As depicted and described in conjunction with FIGS. 32-34, in some implementations an inner wall of container body 4410 (e.g., inner wall 4410(a)) may comprise a supporting structure (e.g., a cradle of similar supporting structure) dimensioned to receive a particular size and shape of mobile device. When received within the supporting structure, the mobile device may be better aligned for wireless charging. However, in other implementations supporting structures or cradles may be excluded from container body 4410 and mobile devices may be placed in the recess of container body 4410 in an ad hoc manner (i.e., where precise wireless charging alignment is not present or required). As described above, leveraging the unique capabilities of the presently disclosed coil repeater assemblies, the presently disclosed wireless charging apparatuses may improve wireless charging range where air gaps, lateral offsets, tilt angles, or some combination thereof, are present.

As depicted and described in conjunction with FIG. 35, in some implementations one or more non-inductive magnetic structures may be attached to container body 4410 and positioned to secure mobile devices to an surface of a wall of container body 4410 (e.g., inner surface 4410(a)). The one or more non-inductive magnetic structures can also help to radially align the received mobile devices with coil repeater assembly 4414(a), or other coil repeater assemblies attached to container body 4410. In some implementations, the one or more non-inductive magnetic structures may be disposed on an inner surface of a wall of container body 4410 (e.g., inner surface 4410(a)) or embedded within a wall of container body 4410 (e.g., adjacent the inner surface). However, in other implementations non-inductive magnetic structures may be excluded from container body 4410 and mobile devices may be placed in the recess of container body 4410 in an ad hoc manner (i.e., where precise wireless charging alignment is not present or required). As described above, leveraging the unique capabilities of the presently disclosed coil repeater assemblies, the presently disclosed wireless charging apparatuses may improve wireless charging range where air gaps, lateral offsets, tilt angles, or some combination thereof, are present.

Various techniques may be used to mechanically attach or affix coil repeater assembly 4414(a) to container body 4410. Such techniques may be used to attach additional coil repeater assemblies to container body 4410 as well.

For example, in certain implementations coil repeater assembly 4414(a) may be printed directly onto a surface (e.g., of an inner or outer wall) of container body 4410. For instance, conductive ink may be used to print coil repeater assembly 4414(a) directly onto the surface. This may include ink printing an inductive coil, electrical connections, and attachment pads for any passive components such as, e.g., tuning capacitor(s). In other implementations, layers of conductive material (e.g., graphite) may be 3D printed onto the surface to form coil repeater assembly 4414(a). In various implementations, the above-described ink printing and 3D printing techniques may be used where coil repeater assembly 4414(a) is ultimately embedded within container body 4410. For example, coil repeater assembly 4414(a) may be printed directly onto a temporary manufacturing surface of container body 4410. Accordingly, additional material may be added to container body 4410 to cover coil repeater assembly 4414(a) and the temporary manufacturing surface—thus embedding coil repeater assembly 4414(a) within container body 4410.

Similarly, coil repeater assembly 4414(a) may be covered with leather, nylon or other fabric to provide an appealing inner liner to the container or to protect the repeater coil from damage. For example, where the container is a purse and coil repeater assembly 4414(a) is disposed on an inner surface of the purse, a silk or other fabric liner may be provided to provide an aesthetic appearance to the purse. As another example, for a tool bag, a nylon or like liner may be provided to protect coil repeater assembly 4414(a) from damage from tools placed within the bag.

In some implementations, coil repeater assembly 4414(a) may be fabricated separately from container body 4410 and adhered to a surface (e.g., an inner or outer surface of a wall) of, or embedded within a wall of, container body 4410. For example, in some implementations coil repeater assembly 4414(a) may comprise: (1) a substrate comprising an adhesive disposed on a first surface of the substrate; (2) an inductive coil disposed on a second surface of the substrate or embedded within the substrate; and (3) one or more tuning capacitors disposed on the second surface of the substrate or embedded within the substrate, wherein the one or more tuning capacitors are electrically connected to each end of the inductive coil (such implementations are depicted and described in greater detail in conjunction with FIGS. 23-26). Accordingly, the adhesive may be used to attach the substrate to a surface of container body 4410. In some of such implementations, coil repeater assembly 4414(a) may be removed and replaced on different surfaces of container body 4410 depending on use case or scenario.

In certain implementations, coil repeater assembly 4414(a) may be fabricated separately from container body 4410 and stitched onto or into container body 4410. For example, in implementations container body 4410 may comprise a flexible fabric (e.g., where container body 4410 comprises a handbag or clutch). Accordingly, coil repeater assembly 4414(a) may be stitched onto or into the flexible fabric of container body 4410. In some of such implementations, coil repeater assembly 4414(a) may comprise: (1) a substrate comprising a flexible fabric; (2) an inductive coil disposed on a surface of the substrate or embedded within the substrate; and (3) one or more tuning capacitors disposed on the surface of the substrate or embedded within the substrate, wherein the one or more tuning capacitors are electrically connected to each end of the inductive coil. Accordingly, the flexible fabric of coil repeater assembly 4414(a) may be stitched onto or into the flexible fabric of container body 4410.

In certain implementations, a mobile device placed within the recess of container body 4410 may be attached to (or otherwise associated with) its own coil repeater assembly. The coil repeater assembly of the mobile device may operate in tandem with coil repeater assembly 4414(a) to increase inductive flux linkage between an active power supply container body 4410 is placed upon and a receiving inductive coil of the mobile device. For example, the mobile device may be received within a presently disclosed mobile device case comprising a coil repeater assembly, as described and depicted in conjunction with FIGS. 14-26. With the combined inductive flux linkage contributions from the mobile device case coil repeater assembly and coil repeater assembly 4414(a), the mobile device can be placed within the recess of container body 4410 in an ad hoc manner (i.e., where precise wireless charging alignment is not present or required) and still be wirelessly charged. The same may be true of other mobile devices placed within the recess of container body 4410. For example, where container body 4410 comprises a toolbox, multiple electronic power tools (which may each have their own coil repeater assembly attached thereto) may be placed within the recess of container body 4410 in an ad hoc manner and still be wirelessly charged by the active power supply (e.g., a transmit coil on the desktop, tabletop, workbench or other surface on which the container is placed).

The wireless charging apparatus may comprise a single wireless repeater coil within the recess of container body 4410, or it may comprise multiple wireless repeater coils placed at determined locations within the bag. For example, the multiple wireless repeater coils may be placed at (e.g., on a surface of or embedded within) one or more bottom or side walls of the container. Where the container includes pockets, one or more wireless repeater coils may be placed at the side pocket location(s) to facilitate device charging for devices stored within such pockets. Further to this example, in the case of a purse, tool bag, or other like container, a side pocket may include a wireless repeater coil and the pocket may be sized to hold one or more wireless devices, such as a cell phone, smartwatch, etc. As another example, in the case of a tool bag one or more pockets may be suitably sized to contain a tool battery or a rechargeable tool itself.

Embodiments described above refer to container implementations in which the container includes one or more repeater coils, without including an active transmitter coil. In further embodiments, the container may include one or more active transmitter coils in addition to one or more repeater coils and may be further configured to connect the one or more active coils to a power source. For example, the wireless charging coil may be powered by DC supply (e.g., a power brick for connection to AC mains power) with a typical output voltage range of 5 to 12 volts and a current rating of at least 1 to 2 amperes, enabling total input power from approximately 5 watts up to 15 watts or higher, depending on device compatibility.

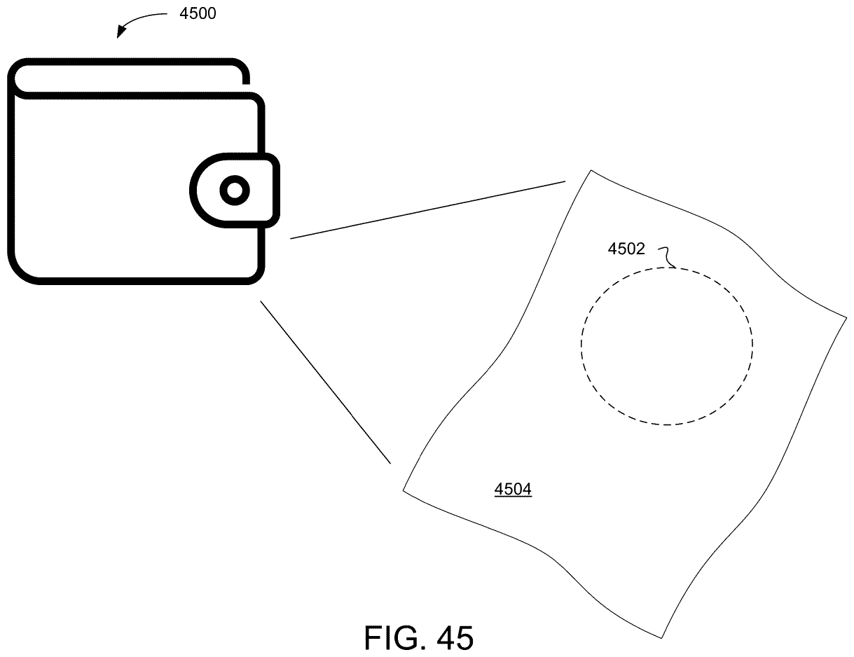

FIGS. 45-47 illustrate additional multi-use wireless charging apparatuses comprising specific types of storage containers. Each multi-use wireless charging apparatus depicted in FIGS. 45-47 may comprise a more specific example of multi-use wireless charging apparatus 4400.

For example, FIG. 45 depicts a multi-use wireless charging apparatus 4500 comprising a wallet. As depicted, multi-use wireless charging apparatus 4500 may comprise a coil repeater assembly 4502 disposed on, or embedded beneath, a surface 4504 of the wallet (e.g., an exterior surface of the wallet, a surface of interior flap of the wallet, etc.). While not depicted, one or more additional coil repeater assemblies may be disposed on, or embedded beneath, other surfaces of the wallet.

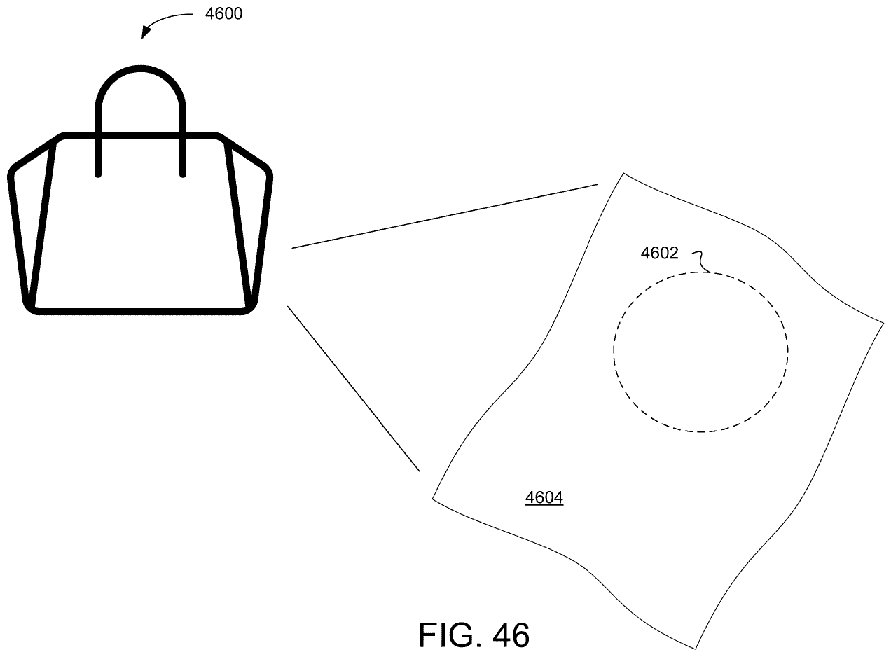

FIG. 46 depicts a multi-use wireless charging apparatus 4600 comprising a bag. The bag may comprise various types of bags, such as a handbag, a purse, a clutch, a backpack, a knapsack, a computer or laptop bag, other types of travel bags or luggage, etc. As depicted, multi-use wireless charging apparatus 4600 may comprise a coil repeater assembly 4602 disposed on, or embedded beneath, a surface 4604 of the bag. While not depicted, one or more additional coil repeater assemblies may be disposed on, or embedded beneath, other surfaces of the bag.

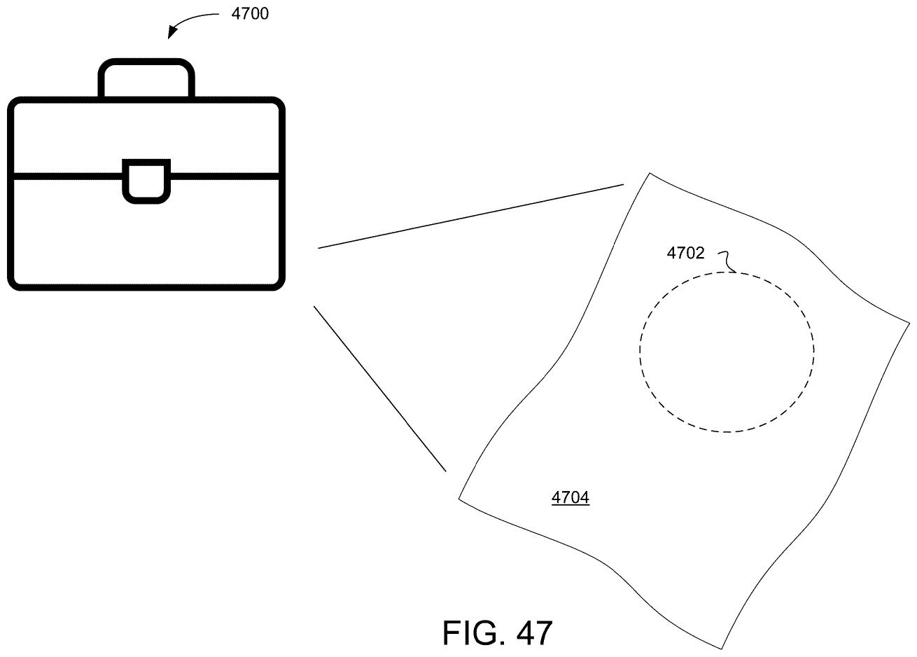

FIG. 47 depicts a multi-use wireless charging apparatus 4700 comprising a suitcase. As depicted, multi-use wireless charging apparatus 4700 may comprise a coil repeater assembly 4702 disposed on, or embedded beneath, a surface 4704 of the suitcase. While not depicted, one or more additional coil repeater assemblies may be disposed on, or embedded beneath, other surfaces of the suitcase. And, as described above with reference to the apparatus of FIGS. 44A-44B, the embodiments of FIGS. 46 and 47, and other like embodiments may include one or more active transmitter coils in addition to one or more repeater coils and may be further configured to connect the one or more active coils to a power source.

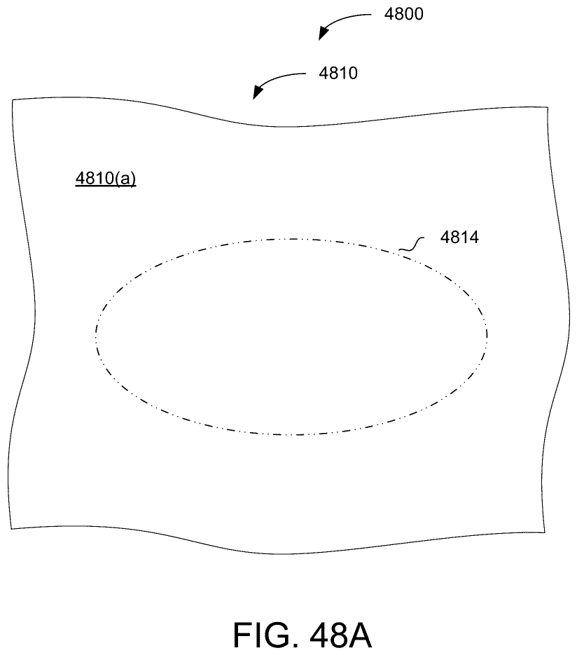

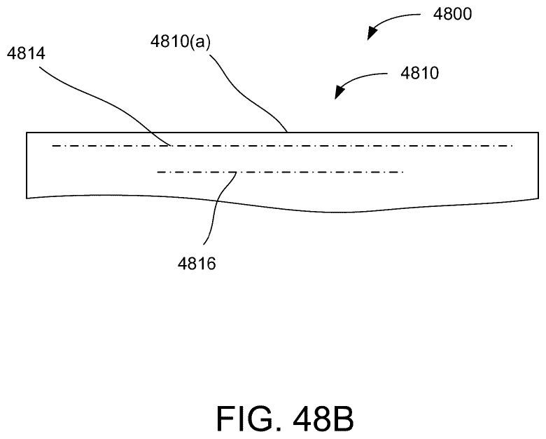

FIGS. 48A-48B illustrate perspective views of an example multi-use wireless charging apparatus 4800.

Multi-use wireless charging apparatus 4800 illustrates a generalized example of furniture comprising a furniture body 4810. As depicted, furniture body 4810 comprises a mobile device-facing surface 4810(a), which may comprise a flat or substantially flat surface of the furniture body (e.g., a tabletop, an upwards-facing surface of a drawer interior, an armrest, etc.).

Multi-use wireless charging apparatus 4800 may comprise various types of furniture including a table, a desk, a drawer, a couch, a chair, a recliner, a stowable airplane tray, etc.

As depicted, multi-use wireless charging apparatus 4800 may further comprise a coil repeater assembly 4814. Coil repeater assembly 4814 may be attached to furniture body 4810 and positioned to increase inductive flux linkage between an active power supply located proximate (including within) furniture body 4810 and receiving inductive coils of one or more devices placed upon mobile device-facing surface 4810(a). Examples of the mobile devices may include mobile phones, smart watches, tablets, e-readers, portable speakers, wireless headphones or ear buds, hearing aids, wireless medical devices, electric power tools, etc.

In some implementations, coil repeater assembly 4814 may be disposed on mobile device-facing surface 4810(a) such as an armrest, tray table, device stand, device pocket or other surface. In other implementations (and as depicted in FIG. 48B), coil repeater assembly 4814 may be embedded within furniture body 4810 adjacent mobile device-facing surface 4810(a).

As depicted in FIG. 48B, in some implementations an active power supply 4816 may be embedded within, or otherwise be attached to, furniture body 4810. In some of such implementations, coil repeater assembly 4814 may be embedded within furniture body 4810 between active power supply 4816 and mobile device-facing surface 4810(a)—thus increasing inductive flux linkage between a receiving inductive coil of a mobile device placed upon mobile device-facing surface 4810(a) and active power supply 4816. In some implementations, an inductive coil of coil repeater assembly 4814 may have wider diameter than an inductive coil of active power supply 4816—thereby effectively extending/improving the lateral offset charging capabilities of active power supply 4816.

As depicted and described in conjunction with FIGS. 32-34, in some implementations mobile device-facing surface 4810(a) may comprise a supporting structure (e.g., a cradle of similar supporting structure) dimensioned to receive and secure a particular size and shape of mobile device. When secured within the supporting structure, the mobile device may be better aligned for wireless charging. However, in other implementations supporting structures or cradles may be excluded from furniture body 4810 and mobile devices may be placed upon mobile device-facing surface 4810(a) in ad hoc manner (i.e., where precise wireless charging alignment is not present or required). As described above, leveraging the unique capabilities of the presently disclosed coil repeater assemblies, the presently disclosed wireless charging apparatuses may improve wireless charging efficiency where air gaps, lateral offsets, tilt angles, or some combination thereof, are present.

As depicted and described in conjunction with FIG. 35, in some implementations one or more non-inductive magnetic structures may be attached to furniture body 4810 and positioned to secure mobile devices to mobile device-facing surface 4810(a). As described above, the one or more non-inductive magnetic structures can also help to radially align the received mobile devices with coil repeater assembly 4814, or other coil repeater assemblies attached to furniture body 4810. In some implementations, the one or more non-inductive magnetic structures may be disposed on mobile device-facing surface 4810(a) or embedded within furniture body 4810 adjacent mobile device-facing surface 4810(a). However, in other implementations non-inductive magnetic structures may be excluded from furniture body 4810 and mobile devices may be placed upon mobile device-facing surface 4810(a) in an ad hoc manner (i.e., where precise wireless charging alignment is not present or required). As described above, leveraging the unique capabilities of the presently disclosed coil repeater assemblies, the presently disclosed wireless charging apparatuses may improve wireless charging range where air gaps, lateral offsets, tilt angles, or some combination thereof, are present.

In some implementations, mobile device-facing surface 4810(a) may comprise a non-slip surface (e.g., a surface comprising a rubber or silicone, a non-slip fabric, a textured or raised pattern, a friction-enhancing polymer, a non-slip vinyl, etc.) or a gripping surface (e.g., a Velcro surface, a surface comprising hook-and-loop fasteners, etc.) that secures mobile devices to furniture body 4810. In some of such implementations, the non-slip or gripping surface (e.g., where the non-slip or gripping surface comprises a raised pattern) may assist with wireless charging alignment.

Various techniques may be used to mechanically attach coil repeater assembly 4814 to furniture body 4810. Such techniques may be used to attach additional coil repeater assemblies to furniture body 4810 as well.

For example, in certain implementations coil repeater assembly 4814 may be printed directly onto mobile device-facing surface 4810(a). For instance, conductive ink may be used to print coil repeater assembly 4814 directly onto mobile device-facing surface 4810(a). This may include ink printing an inductive coil, electrical connections, and attachment pads for any passive components such as, e.g., tuning capacitor(s). In other implementations, layers of conductive material (e.g., graphite) may be 3D printed onto mobile device-facing surface 4810(a) to form coil repeater assembly 4814. In various implementations, the above-described ink printing and 3D printing techniques may be used where coil repeater assembly 4814 is ultimately embedded within furniture body 4810. For example, coil repeater assembly 4814 may be printed directly onto a temporary manufacturing surface of furniture body 4810. Accordingly, additional material may be added to furniture body 4810 to cover coil repeater assembly 4814 and the temporary manufacturing surface—thus embedding coil repeater assembly 4814 within furniture body 4810.

In some implementations, coil repeater assembly 4814 may be fabricated separately from furniture body 4810 and adhered to mobile device-facing surface 4810(a). For example, in some implementations coil repeater assembly 4814 may comprise: (1) a substrate comprising an adhesive disposed on a first surface of the substrate; (2) an inductive coil disposed on a second surface of the substrate or embedded within the substrate; and (3) one or more tuning capacitors disposed on the second surface of the substrate or embedded within the substrate, wherein the one or more tuning capacitors are electrically connected to each end of the inductive coil (such implementations are depicted and described in greater detail in conjunction with FIGS. 23-26). Accordingly, the adhesive may be used to attach the substrate to mobile device-facing surface 4810(a). In some of such implementations, coil repeater assembly 4814 may be removed and replaced on different surfaces of furniture body 4810 depending on use case or scenario.

In certain implementations, coil repeater assembly 4814 may be fabricated separately from furniture body 4810 and stitched onto or into furniture body 4810. For example, in implementations furniture body 4810 may comprise a flexible fabric (e.g., where furniture body 4810 comprises a couch or chair). Accordingly, coil repeater assembly 4814 may be stitched onto or into the flexible fabric of furniture body 4810. In some of such implementations, coil repeater assembly 4814 may comprise: (1) a substrate comprising a flexible fabric; (2) an inductive coil disposed on a surface of the substrate or embedded within the substrate; and (3) one or more tuning capacitors disposed on the surface of the substrate or embedded within the substrate, wherein the one or more tuning capacitors are electrically connected to each end of the inductive coil. Accordingly, the flexible fabric of coil repeater assembly 4814 may be stitched onto or into the flexible fabric of furniture body 4810.

In certain implementations, a mobile device placed upon mobile device-facing surface 4810(a) may be attached to (or otherwise associated with) its own coil repeater assembly. The coil repeater assembly of the mobile device may operate in tandem with coil repeater assembly 4814 to increase inductive flux linkage between an active power supply located proximate (including within) furniture body 4810 and a receiving inductive coil of the mobile device. For example, the mobile device may be received within a mobile device case comprising a coil repeater assembly, as described and depicted in conjunction with FIGS. 14-26. With the combined inductive flux linkage contributions from the mobile device case coil repeater assembly and coil repeater assembly 4814, the mobile device can be placed upon mobile device-facing surface 4810(a) in an ad hoc manner (i.e., where precise wireless charging alignment is not present or required) and still be wirelessly charged. The same may be true of other mobile devices placed upon mobile device-facing surface 4810(a). For example, where furniture body 4810 comprises a drawer, multiple mobile devices (which may each have their own coil repeater assembly attached thereto) may be placed within drawer in an ad hoc manner and still be wirelessly charged by a (single) active power supply located proximate the drawer (e.g., embedded within a bottom panel of the drawer).

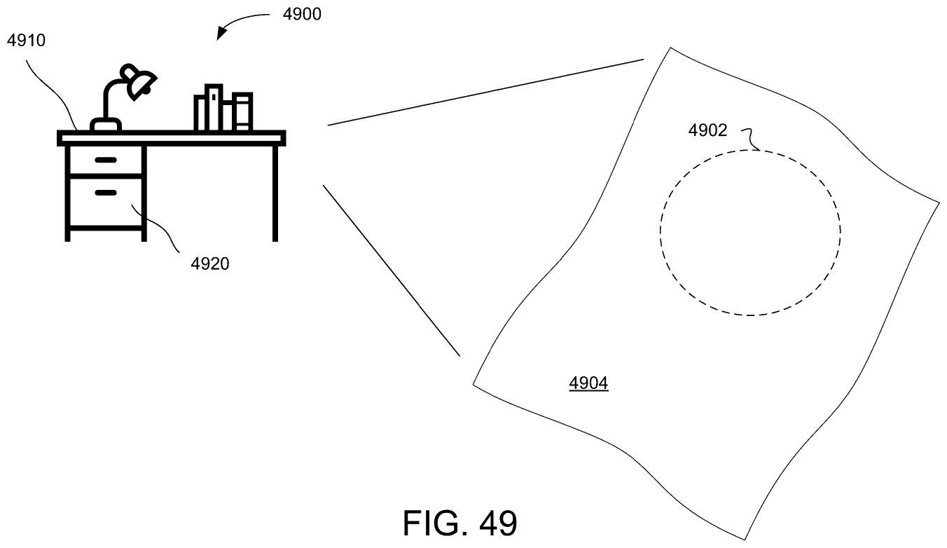

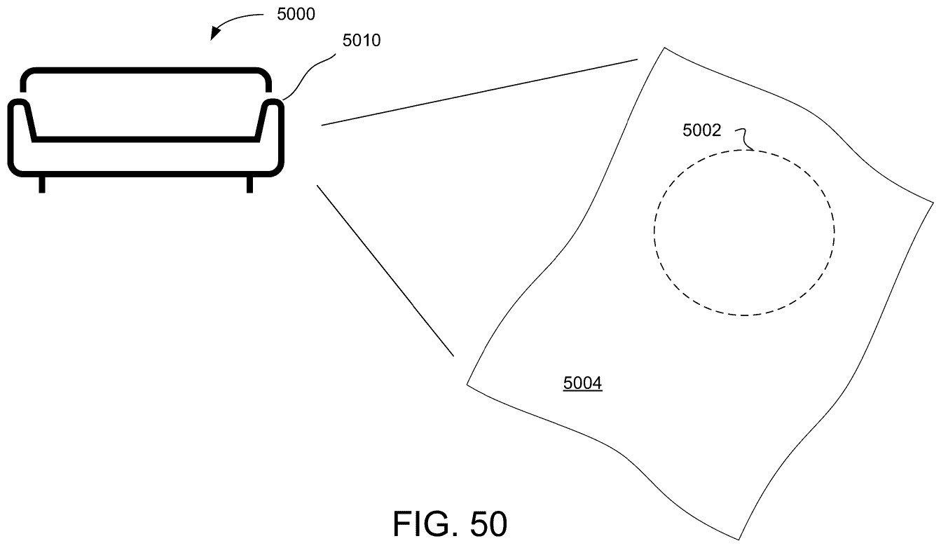

FIGS. 49-50 illustrate additional multi-use wireless charging apparatuses comprising specific types of furniture. Each multi-use wireless charging apparatus depicted in FIGS. 49-50 may comprise a more specific example of multi-use wireless charging apparatus 4800.

For example, FIG. 49 depicts a multi-use wireless charging apparatus 4900 comprising a desk. Multi-use wireless charging apparatus 4900 may comprise a tabletop 4910 and a drawer 4920.

As depicted, multi-use wireless charging apparatus 4900 may comprise a coil repeater assembly 4902 disposed on, or embedded beneath, a mobile device-facing surface 4904. Examples locations for mobile device-facing surface 4904 may include tabletop 4910 and an upwards-facing surface of an interior of drawer 4920. While not depicted, one or more additional coil repeater assemblies may be disposed on, or embedded beneath, other surfaces of the desk.

FIG. 50 depicts a multi-use wireless charging apparatus 5000 comprising a couch comprising an armrest 5010. While in the specific example of FIG. 50 a couch is depicted, the example of FIG. 50 can be extended to other types of furniture (e.g., chairs, loveseats, recliners, beds, etc.).

As depicted, multi-use wireless charging apparatus 5000 may comprise a coil repeater assembly 5002 disposed on, or embedded beneath, a mobile device-facing surface 5004. Examples locations for mobile device-facing surface 5004 may an upwards-facing surface of armrest 5010. While not depicted, one or more additional coil repeater assemblies may be disposed on, or embedded beneath, other surfaces of the couch.

Aside from storage containers and furniture, a presently disclosed multi-use wireless charging apparatus may be incorporated into various other types of consumer products, such as clothing or other wearables, payment cards (e.g., credit or debit cards), or other consumer products.

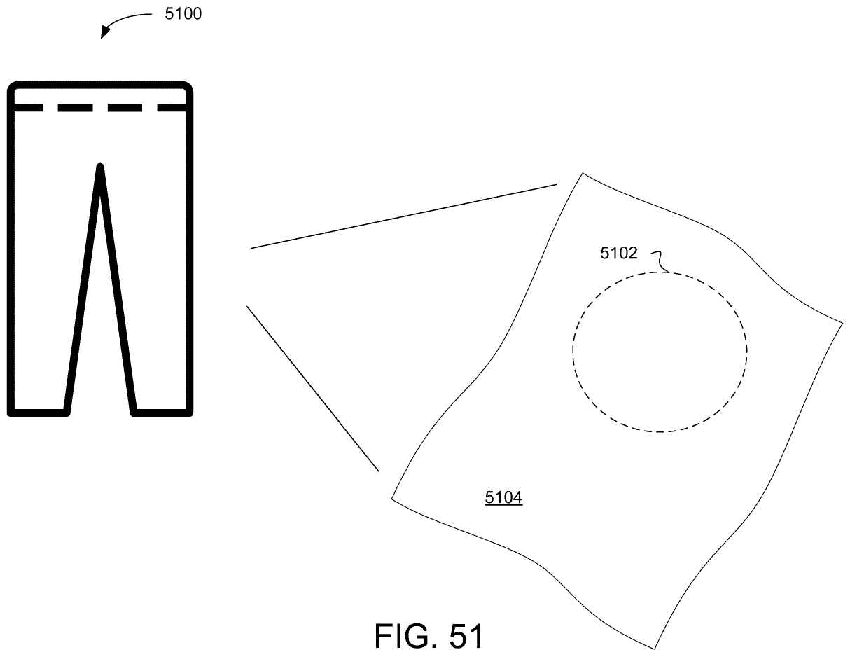

For example, FIG. 51 depicts a multi-use wireless charging apparatus 5100 comprising an article of clothing. As depicted, multi-use wireless charging apparatus 5100 may comprise a coil repeater assembly 5102 disposed on, or embedded beneath, a surface 5104 of multi-use wireless charging apparatus 5100. As described above, in some implementations coil repeater assembly 5102 may be stitched, printed or adhered onto surface 5104 or otherwise embedded in the fabric or between the fabric and a lining. While not depicted, one or more additional coil repeater assemblies may be disposed on, or embedded beneath, other surfaces of the article of clothing. Coil repeater assemblies may be positioned anywhere on an article of clothing, such as on the outside or inside of pockets or at other desirable locations.

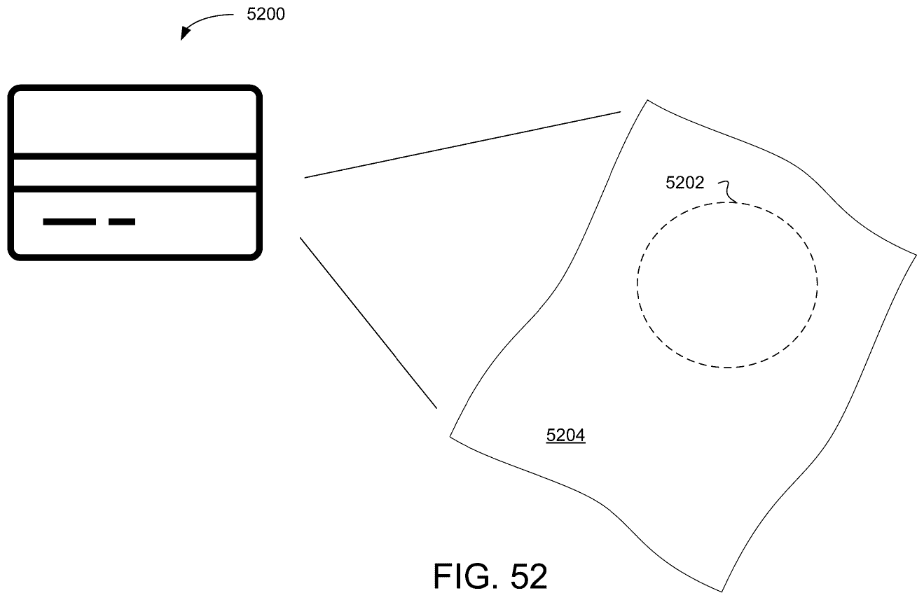

FIG. 52 depicts a multi-use wireless charging apparatus 5200 comprising a payment card (e.g., a debit card or credit card). As depicted, multi-use wireless charging apparatus 5200 may comprise a coil repeater assembly 5202 disposed on, or embedded beneath, a surface 5204 of multi-use wireless charging apparatus 5200. As described above, in some implementations coil repeater assembly 5202 may be printed onto surface 5204 (e.g., via ink printing, 3D printing, or a combination thereof), adhere to surface 5204, or embedded within the card itself. Including a coil repeater assembly 5202 on or within a credit card, debit card, bank card, or other like instrument, can be useful for improving the charging efficiency for wireless mobile devices, especially in applications where the protective case for the wireless mobile device includes a card pocket for holding such cards.

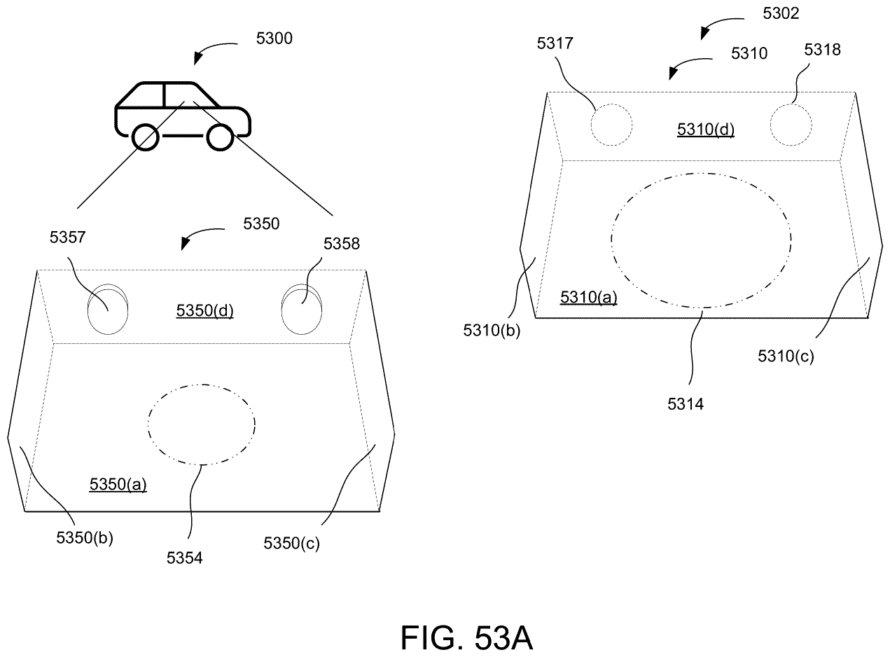

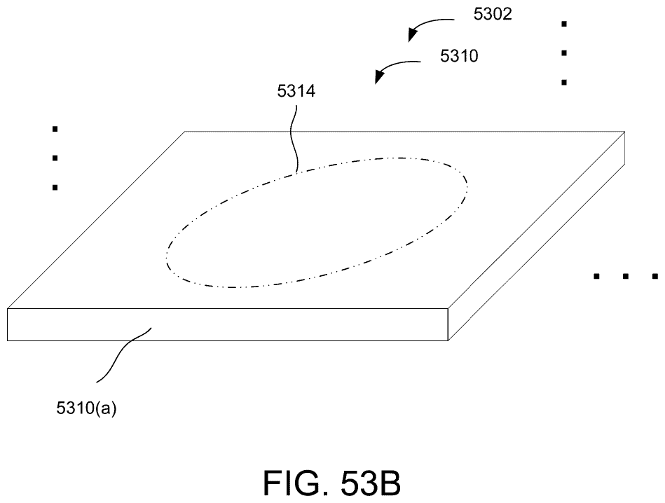

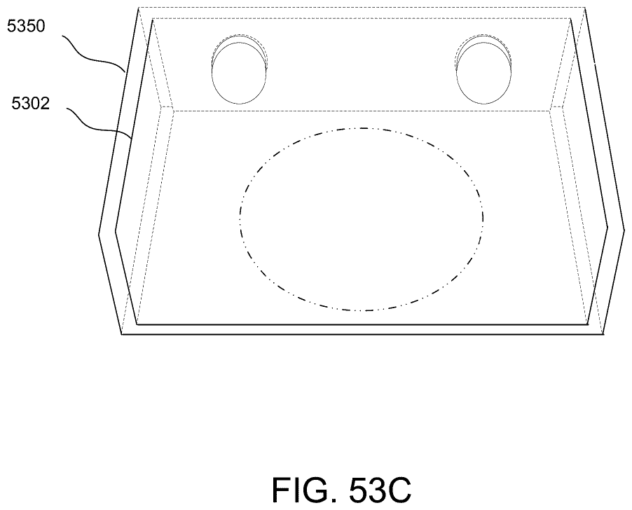

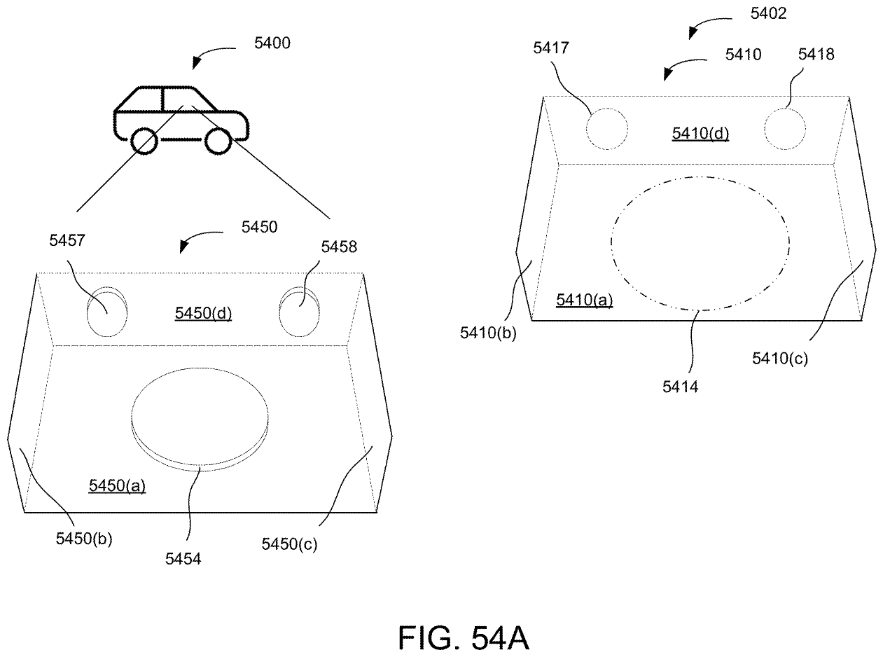

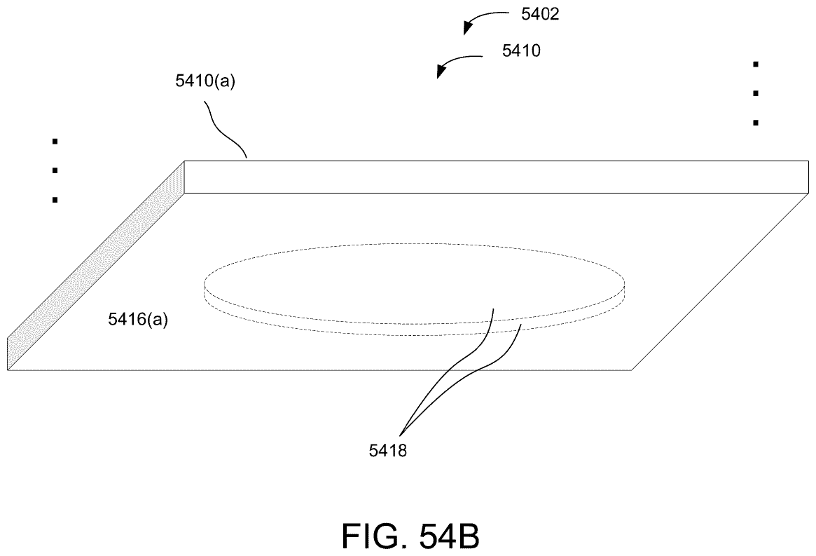

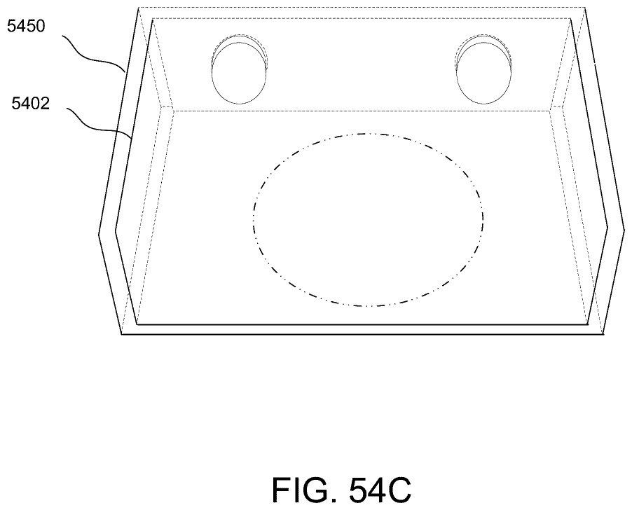

FIGS. 53A-53C and 54A-54C illustrate example in-vehicle wireless charging apparatuses that are dimensioned and configured to fit snugly upon a transmitting wireless charging interface disposed within an interior of a vehicle.

More specifically, 53A-53C and 54A-54C each illustrate an apparatus that: (1) increases or otherwise optimizes inductive flux linkage between a transmitting wireless charging interface disposed within an interior of a vehicle and one or more mobile devices placed upon the apparatus; and (2) fits snugly upon the transmitting wireless charging interface disposed within the interior of the vehicle.

The presently disclosed in-vehicle wireless charging apparatuses can achieve the above-described technical advantages through strategic positioning, orienting, and dimensioning of coil repeater assemblies.

In some implementations, the coil repeater assemblies may comprise the inductive coils described in conjunction with FIGS. 1-11. In other implementations however, other inductive coil configurations may be used.

As alluded to above, the unique properties of the presently disclosed inductive coils can enable wireless charging with larger (e.g., vertical) air gaps and lateral offsets than existing technologies. Relatedly, the presently disclosed inductive coils can enable wireless charging at greater tilt angles than existing technologies. Leveraging these unique capabilities, the presently disclosed in-vehicle wireless charging apparatuses can facilitate wireless charging where air gaps, lateral offsets, tilt angles, or some combination thereof, are present. In some cases, this may allow mobile devices to be placed upon a presently disclosed in-vehicle wireless charging apparatus in an ad hoc manner (i.e., where there is not precise wireless charging alignment) and still be wirelessly charged.

In various implementations, the presently disclosed in-vehicle wireless charging apparatuses can incorporate (or incorporate features of) the multi-device wireless charging apparatuses depicted and described in conjunction with FIGS. 27-41. As described above, such multi-device wireless charging apparatuses may be implemented to facilitate simultaneous multi-device charging using a single active power source conventionally used to wirelessly charge only a single mobile device at a time.

FIGS. 53A-53C illustrate perspective views of an example in-vehicle wireless charging apparatus 5302.

As depicted, in-vehicle wireless charging apparatus 5302 may comprise a body 5310 and a coil repeater assembly 5314 attached to body 5310. More particularly, in the specific example of FIGS. 53A-53C, coil repeater assembly 5314 may be disposed on, or embedded beneath, a mobile device-facing surface of a base 5310(a) of body 5310. While not depicted, in some implementations one or more additional coil repeater assemblies may be attached to body 5310.

As depicted in the specific example of FIG. 53A, in certain cases transmitting wireless charging interface 5354 may be disposed within a recess of an interior console 5350 of a vehicle 5300. The recess of interior console 5350 may be defined by base surface 5350(a) and interior walls 5350(b), 5350(c) and 5350(d). As depicted, in some cases protrusions (e.g., various types of electronic ports or caps covering thereof) may extend outward from an interior wall and into the recess of interior console 5350. For example, protrusions 5357 and 5358 extend outward from interior wall 5350(d) and into the recess of interior console 5350.

As depicted, transmitting wireless charging interface 5354 may be disposed on base surface 5350(a). In the specific implementation of FIGS. 53A-53C, transmitting wireless charging interface 5354 lies approximately flush with the rest of base surface 5350(a). However, and as depicted in FIGS. 54A-54C, in other implementations transmitting wireless charging interface 5354 may be raised above other portions of base surface 5350(a).

As depicted in FIGS. 53A and 53C, body 5310 may be dimensioned to fit snugly within the recess of interior console 5350 when in-vehicle wireless charging apparatus 5302 is placed upon transmitting wireless charging interface 5354. Such a snug, or tight fit, may help in securing in-vehicle wireless charging apparatus 5302 within the recess of interior console 5350. Such a snug fit may also reduce a vertical air gap between transmitting wireless charging interface 5354 and coil repeater assembly 5314. Such a snug fit can also help with aligning transmitting wireless charging interface 5354 and coil repeater assembly 5314.

For example, base 5310(a) of body 5310 may have approximately analogous, but slightly smaller (e.g., within a few centimeters), dimensions as base surface 5350(a) of interior console 5350. Likewise, walls 5310(b)-5310(d) of body 5310 may be dimensioned and angled such that body 5310 fits snugly within the interior walls 5350(b)-5350(d) of interior console 5350 when in-vehicle wireless charging apparatus 5302 is placed upon transmitting wireless charging interface 5354. Relatedly, wall 5310(d) may comprise apertures 5317 and 5318 with corresponding dimensions and locations to protrusions 5357 and 5358. Accordingly, protrusions 5357 and 5358 may extend through apertures 5317 and 5318 respectively when in-vehicle wireless charging apparatus 5302 is placed within the recess of interior console 5350 (see e.g., FIG. 53B).

Moreover, and as depicted, coil repeater assembly 5314 may be positioned such that it is aligned over transmitting wireless charging interface 5354 when in-vehicle wireless charging apparatus 5302 is placed within the recess of interior console 5350. Accordingly, coil repeater assembly 5314 may be positioned to increase inductive flux linkage between transmitting wireless charging interface 5354 and receiving inductive coils of one or more mobile devices upon a mobile device-facing (e.g., upwards-facing) surface of base 5310(a). As depicted, in certain implementations an inductive coil of coil repeater assembly 5314 may have a wider diameter than an inductive coil associated with transmitting wireless charging interface 5354—thereby effectively extending/improving the lateral offset charging capabilities of transmitting wireless charging interface 5354.

As depicted and described in conjunction with FIGS. 30 and 41, in some implementations a non-inductive magnetic structure may be attached to body 5310 and positioned to secure body 5310 to transmitting wireless charging interface 5354. As described above, the non-inductive magnetic structure can also help to radially align transmitting wireless charging interface 5354 with coil repeater assembly 5314, or other coil repeater assemblies attached to body 5310. In some implementations, the non-inductive magnetic structure may be disposed on a transmitting wireless charging interface-facing surface of base 5310(a), or embedded within base 5310(a) adjacent the transmitting wireless charging interface-facing surface of base 5310(a).

As depicted and described in conjunction with FIGS. 32-34, in some implementations the mobile device-facing surface of base 5310(a) may comprise a supporting structure (e.g., a cradle of similar supporting structure) dimensioned to receive and secure a particular size and shape of mobile device. When secured within the supporting structure, the mobile device may be better aligned for wireless charging. However, in other implementations supporting structures or cradles may be excluded from base 5310(a) and mobile devices may be placed upon the mobile device-facing surface of base 5310(a) in an ad hoc manner (i.e., where precise wireless charging alignment is not present or required). As described above, leveraging the unique capabilities of the presently disclosed coil repeater assemblies, the presently disclosed wireless charging apparatuses may improve wireless charging range where air gaps, lateral offsets, tilt angles, or some combination thereof, are present.

As depicted and described in conjunction with FIG. 35, in some implementations one or more non-inductive magnetic structures may be attached to body 5310 and positioned to secure mobile devices to the mobile device-facing surface of base 5310(a). As described above, the one or more non-inductive magnetic structures can also help to radially align the received mobile devices with coil repeater assembly 5314, or other coil repeater assemblies attached to body 5310. In some implementations, the one or more non-inductive magnetic structures may be disposed on the mobile device-facing surface of base 5310(a), or embedded within base 5310(a) adjacent the mobile device-facing surface of base 5310(a). However, in other implementations non-inductive magnetic structures may be excluded from body 5310 and mobile devices may be placed upon the mobile device-facing surface of base 5310(a) in an ad hoc manner (i.e., where precise wireless charging alignment is not present or required). As described above, leveraging the unique capabilities of the presently disclosed coil repeater assemblies, the presently disclosed wireless charging apparatuses may improve wireless charging range where air gaps, lateral offsets, tilt angles, or some combination thereof, are present.

In some implementations, the mobile device-facing surface of base 5310(a) may comprise a non-slip surface (e.g., a surface comprising a rubber or silicone, a non-slip fabric, a textured or raised pattern, a friction-enhancing polymer, a non-slip vinyl, etc.) or a gripping surface (e.g., a Velcro surface, a surface comprising hook-and-loop fasteners, etc.) that secures mobile devices to the mobile device-facing surface of base 5310(a). In some of such implementations, the non-slip or gripping surface (e.g., where the non-slip or gripping surface comprises a raised pattern) may assist with wireless charging alignment.

Various techniques may be used to mechanically attach coil repeater assembly 5314 to base 5310(a). Such techniques may be used to attach additional coil repeater assemblies to body 5310 as well.

For example, in certain implementations coil repeater assembly 5314 may be printed directly onto a surface (e.g., the mobile device-facing surface) of base 5310(a). For instance, conductive ink may be used to print coil repeater assembly 5314 directly onto the surface. This may include ink printing an inductive coil, electrical connections, and attachment pads for any passive components such as, e.g., tuning capacitor(s). In other implementations, layers of conductive material (e.g., graphite) may be 3D printed onto the surface to form coil repeater assembly 5314. In various implementations, the above-described ink printing and 3D printing techniques may be used where coil repeater assembly 5314 is ultimately embedded within base 5310(a). For example, coil repeater assembly 5314 may be printed directly onto a temporary manufacturing surface of base 5310(a). Accordingly, additional material may be added to base 5310(a) to cover coil repeater assembly 5314 and the temporary manufacturing surface—thus embedding coil repeater assembly 5314 within base 5310(a).

In some implementations, coil repeater assembly 5314 may be fabricated separately from base 5310(a) and adhered to a surface (e.g., the mobile device-facing surface) of base 5310(a). For example, in some implementations coil repeater assembly 5314 may comprise: (1) a substrate comprising an adhesive disposed on a first surface of the substrate; (2) an inductive coil disposed on a second surface of the substrate or embedded within the substrate; and (3) one or more tuning capacitors disposed on the second surface of the substrate or embedded within the substrate, wherein the one or more tuning capacitors are electrically connected to each end of the inductive coil (such implementations are depicted and described in greater detail in conjunction with FIGS. 23-26). Accordingly, the adhesive may be used to attach the substrate to the surface of base 5310(a). In some of such implementations, coil repeater assembly 5314 may be removed and replaced on different surfaces of base 5310(a) depending on use case or scenario.

In certain implementations, coil repeater assembly 5314 may be fabricated separately from base 5310(a) and stitched onto or into base 5310(a). For example, in implementations base 5310(a) may comprise a flexible fabric. Accordingly, coil repeater assembly 5314 may be stitched onto or into the flexible fabric of base 5310(a). In some of such implementations, coil repeater assembly 5314 may comprise: (1) a substrate comprising a flexible fabric; (2) an inductive coil disposed on a surface of the substrate or embedded within the substrate; and (3) one or more tuning capacitors disposed on the surface of the substrate or embedded within the substrate, wherein the one or more tuning capacitors are electrically connected to each end of the inductive coil. Accordingly, the flexible fabric of coil repeater assembly 5314 may be stitched onto or into the flexible fabric of base 5310(a).

In certain implementations, a mobile device placed upon base 5310(a) may be attached to (or otherwise associated with) its own coil repeater assembly. The coil repeater assembly of the mobile device may operate in tandem with coil repeater assembly 5314 to increase inductive flux linkage between transmitting wireless charging interface 5354 and a receiving inductive coil of the mobile device. For example, the mobile device may be received within a mobile device case comprising a coil repeater assembly, as described and depicted in conjunction with FIGS. 14-26. With the combined inductive flux linkage contributions from the mobile device case coil repeater assembly and coil repeater assembly 5314, the mobile device can be placed upon base 5310(a) in an ad hoc manner (i.e., where precise wireless charging alignment is not present or required) and still be wirelessly charged. The same may be true of other mobile devices placed upon base 5310(a).

FIGS. 54A-54C illustrate perspective views of an example in-vehicle wireless charging apparatus 5402. FIGS. 54A and 54C also illustrate a transmitting wireless charging interface 5454 disposed within a recess of an interior console 5450 of a vehicle 5400.

As depicted, in-vehicle wireless charging apparatus 5402 and interior console 5450 (including their constituent elements) are substantially similar to corresponding in-vehicle wireless charging apparatus 5302 and interior console 5350 respectively—except that: (1) transmitting wireless charging interface 5454 is raised above other portions of a base surface 5450(a) of interior console 5450; and (2) base 5410(a) of in-vehicle wireless charging apparatus 5402 comprises a recess 5418 on its transmitting wireless charging interface-facing (i.e., bottom) surface that is dimensioned to snugly accommodate (the raised) transmitting wireless charging interface 5454. Other elements of FIGS. 54A-54C are analogous to their corresponding reference numerals in FIGS. 53A-53C, and will not be described here again for brevity.

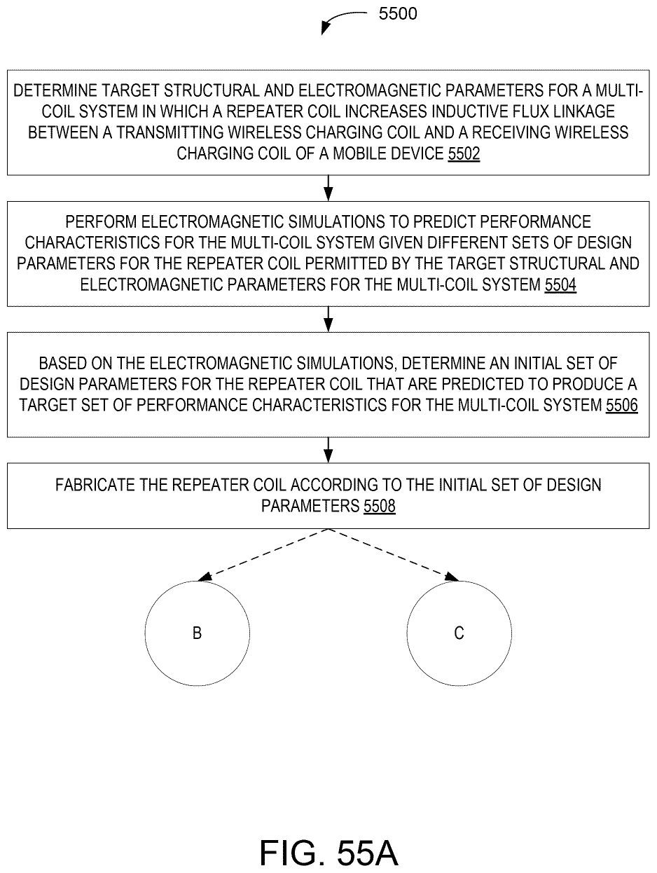

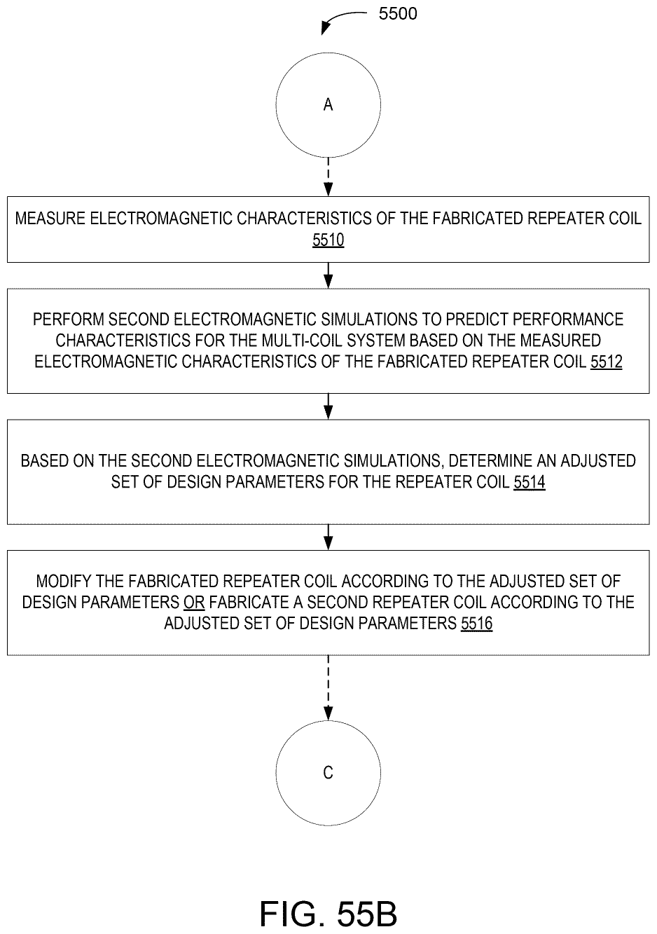

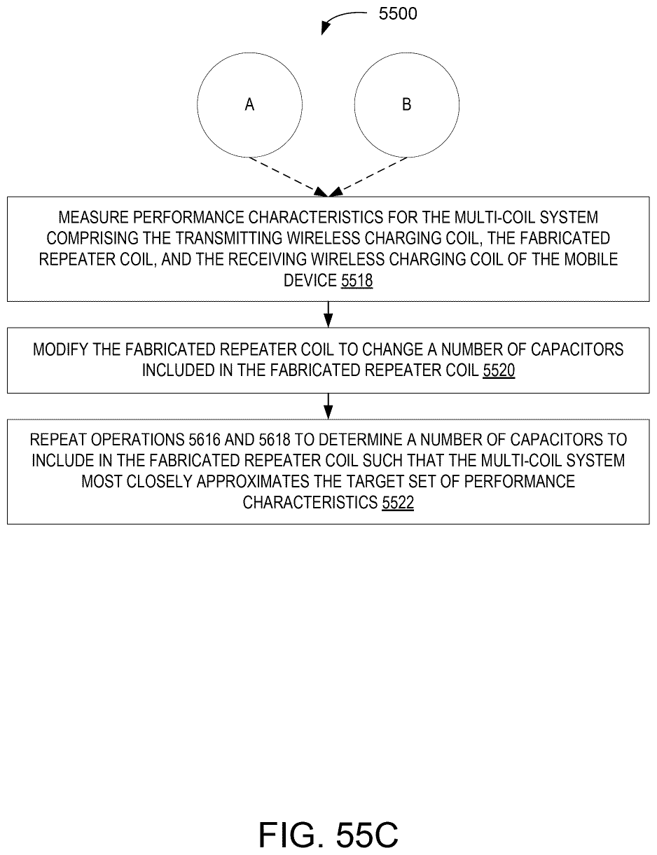

FIGS. 55A-55C illustrate an example process 5500 for designing, fabricating, and testing repeater coils (sometimes referred to herein as coil repeater assemblies) for wireless charging, according to one or more embodiments.

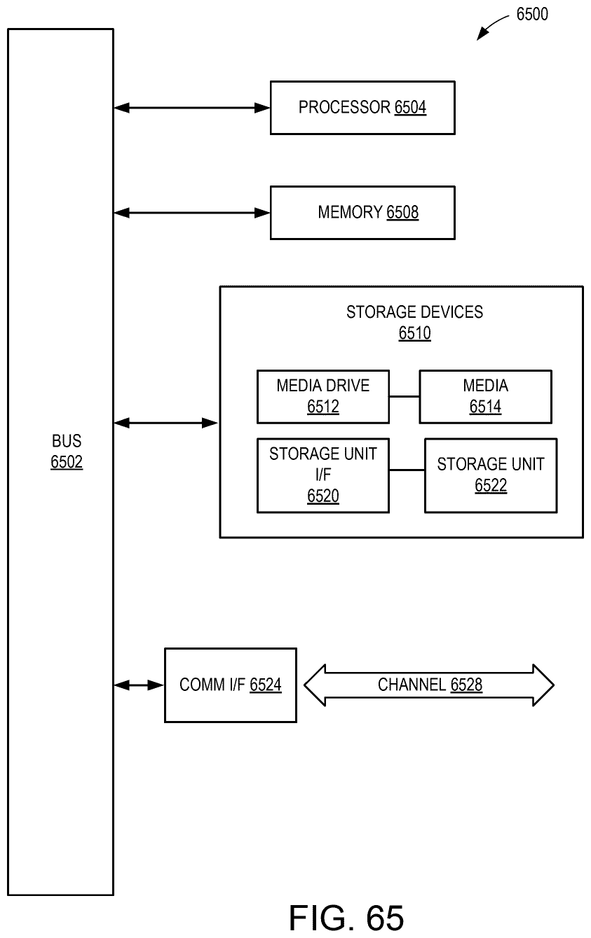

In some implementations, one or more of the operations of process 5500 may be performed automatically by one or more computing components or computing systems, such as computing component 6500 of FIG. 65.

As depicted, an operation 5502 of process 5500 may involve determining target structural and electromagnetic parameters for a multi-coil system in which a repeater coil increases inductive flux linkage between a transmitting wireless charging coil and a receiving wireless charging coil of a mobile device. The transmitting wireless charging coil may be implemented in an external wireless charger, such as a wireless charging pad or other external wireless charging source. The mobile device may comprise various types of mobile devices, including mobile phones, smart watches, e-readers, portable speakers, wireless headphones or ear buds, hearing aids, wireless medical devices, electric power tools, etc.

The target structural and electromagnetic parameters for the multi-coil system may include structural and electromagnetic parameters for a transmitting wireless charging coil that is expected to be used in the multi-coil system. Examples of such structural parameters may include structural dimensions (e.g., diameter) of the transmitting wireless charging coil. Examples of such electromagnetic parameters may include various types of electromagnetic specifications for the transmitting wireless charging coil (e.g., rated transmit power or transmit power settings, rated transmit voltage or transmit voltage settings, resonant frequency, inductance, resistance, quality factor, etc.).

The target structural and electromagnetic parameters for the multi-coil system may also include structural dimensions for an external wireless charger that the transmitting wireless charging coil is expected to be implemented in. Such structural dimensions may take into account a (vertical) air gap between the transmitting wireless charging coil and a wireless charging interface of the external wireless charger.

The target structural and electromagnetic parameters for the multi-coil system may also include structural and electromagnetic parameters for a receiving wireless charging coil of a mobile device that is expected to be included in the multi-coil system. Examples of such structural parameters may include structural dimensions (e.g., diameter) of the receiving wireless charging coil. Examples of such electromagnetic parameters may include various types of electromagnetic specifications for the receiving wireless charging coil (e.g., rated receive power or receive power settings, rated receive voltage or receive voltage settings, resonant frequency, inductance, resistance, quality factor, etc.).

The target structural and electromagnetic parameters for the multi-coil system may also include structural dimensions for the mobile device that the receiving wireless charging coil is expected to be implemented in. Such structural dimensions may take into account a (vertical) air gap between the receiving wireless charging coil and a wireless charging interface of the mobile device.

The target structural and electromagnetic parameters for the multi-coil system may also include structural dimensions of an apparatus (e.g., any of the apparatuses depicted and described in above) that the repeater coil is expected to be implemented in. The structural dimensions of the apparatus may accordingly limit the structural dimensions of the repeater coil (e.g., may limit a range of diameters for the repeater coil) that are possible. The structural dimensions of the apparatus may also limit the breadth of positional relationships between the repeater coil and the transmitting and receiving wireless charging coils respectively within the multi-coil system.

In some implementations, the target structural and electromagnetic parameters for the multi-coil system may include expected positional relationships between and among the transmitting wireless charging coil, the repeater coil, and the receiving wireless charging coil within the multicoil system For example, the target structural and electromagnetic parameters for the multi-coil system may include any one or combination of: (a) expected (vertical) air gap between the transmitting wireless charging coil and the repeater coil within the multi-coil system; (b) expected (vertical) air gap between the repeater coil and the receiving wireless charging coil within the multi-coil system; (c) expected (vertical) air gap between the transmitting wireless charging coil and the receiving wireless charging coil within the multi-coil system; (d) expected lateral misalignment between the transmitting wireless charging coil and the repeater coil within the multi-coil system; (e) expected lateral misalignment between the repeater coil and the receiving wireless charging coil within the multi-coil system; (f) expected lateral misalignment between the transmitting wireless charging coil and the receiving wireless charging coil within the multi-coil system; (g) expected tilt angle between the transmitting wireless charging coil and the repeater coil within the multi-coil system; (h) expected tilt angle between the repeater coil and the receiving wireless charging coil within the multi-coil system; or (i) expected tilt angle between the transmitting wireless charging coil and the receiving wireless charging coil within the multi-coil system

In certain implementations, the target structural and electromagnetic parameters for the multi-coil system may include expected material properties of the repeater coil. For example, in some implementations an inductive coil of the repeater coil may be formed from copper traces. However, in other implementations the inductive coil of the repeater coil may be formed from other materials, such as conductive ink, carbon-based materials (e.g., graphene, graphite, carbon nanotubes, etc.), other metals such as silver, etc. Accordingly, material properties (e.g., electrical properties, thermal properties, structural properties, etc.) of the foregoing materials may be included in the target structural and electromagnetic parameters for the multi-coil system.

In various implementations, the target structural and electromagnetic parameters for the multi-coil system may include minimum or maximum values for design parameters for the repeater coil based on manufacturing constraints. For example, manufacturing constraints may place minimum or maximum limits on any one or combination of: (i) width or thickness for individual traces of the inductive coil of the repeater coil; (ii) spacing between individual traces of the inductive coil; (iii) a number of layers that may be included in the inductive coil; (iii) spacing between the layers of inductive coil; or (iv) other design parameters for the repeater coil.

In some implementations, the target structural and electromagnetic parameters for the multi-coil system may also comprise environmental conditions (or a range of environmental conditions) in which the multi-coil system is expected to operate. Examples of such environmental conditions may include temperature (or temperature range), moisture or humidity levels (or ranges of moisture or humidity levels), etc.

Referring again to FIG. 55, an operation 5504 of process 5500 may involve performing electromagnetic simulations (and in some cases, thermal or operating temperature-related simulations) to predict performance characteristics for the multi-coil system given different sets of design parameters for the repeater coil permitted by the target structural and electromagnetic parameters for the multi-coil system. Based on the electromagnetic simulations, an operation 5506 of process 5500 may involve determining an initial set of design parameters for the repeater coil that are predicted to produce a target set of performance characteristics for the multi-coil system.

The initial set of design parameters for the repeater coil may comprise various types of shapes, dimensions, and structural configurations the repeater coil.

For example, in certain implementations the repeater coil may comprise one of the inductive coils described in conjunctions with FIGS. 1-11, one of the coil repeater assemblies described in conjunction with FIGS. 12-26, or some combination thereof. In such implementations, the repeater coil may comprise: (a) an inductive coil comprising turns of a trace bundle; (b) one or more tuning capacitors electrically connected to each end of the inductive coil; and (c) the trace bundle comprising traces formed from trace segments electrically interconnected by interlayer connectors, a respective trace comprising electrically interconnected trace segments across multiple layers. Accordingly, the initial set of design parameters for the repeater coil may comprise any one or combination of: (i) a determined number of turns for the trace bundle; (ii) a determined width or thickness for individual traces of the trace bundle; (iii) a determined spacing between individual traces of the trace bundle within a respective layer; (vi) a determined number of layers for the trace bundle; (v) a determined spacing between the layers of the trace bundle; (vi) a determined diameter of the inductive coil formed by the trace bundle; or (vii) a determined number for the one or more tuning capacitors.

The target set of performance characteristics for the multi-coil system may comprise various types of performance characteristics than can be predicted from the electromagnetic simulations.

For example, in some implementations the target set of performance characteristics may relate to power transfer efficiency between the transmitting wireless charging coil and the receiving wireless charging coil. In certain implementations, such power transfer efficiency may be defined as a percentage of the inductive energy transmitted by the transmitting wireless coil that is received by the receiving wireless charging coil. As non-limiting examples, the target set of performance characteristics related to power transfer efficiency may comprise any one or combination of: (i) a target power transfer efficiency (e.g., 70%) between the transmitting wireless charging coil and the receiving wireless charging coil within the multi-coil system; (ii) a target power transfer efficiency (e.g., 70%) between the transmitting wireless charging coil and the receiving wireless charging coil within the multi-coil system given a target air gap between the transmitting wireless charging coil and the receiving wireless charging coil; (iii) a target power transfer efficiency (e.g., 70%) between the transmitting wireless charging coil and the receiving wireless charging coil within the multi-coil system given a target lateral misalignment between the transmitting wireless charging coil and the receiving wireless charging coil; (iv) a target power transfer efficiency (e.g., 70%) between the transmitting wireless charging coil and the receiving wireless charging coil within the multi-coil system given a target tilt angle between the transmitting wireless charging coil and the receiving wireless charging coil; (v) a target range of air gaps between the transmitting wireless charging coil and the receiving wireless charging coil within the multi-coil system where a target power transfer efficiency (e.g., 70%) between the transmitting wireless charging coil and the receiving wireless charging coil is achieved; (vi) a target range of lateral misalignments between the transmitting wireless charging coil and the receiving wireless charging coil within the multi-coil system where a target power transfer efficiency (e.g., 70%) between the transmitting wireless charging coil and the receiving wireless charging coil is achieved; or (vii) a target range of tilt angles between the transmitting wireless charging coil and the receiving wireless charging coil within the multi-coil system where a target power transfer efficiency (e.g., 70%) between the transmitting wireless charging coil and the receiving wireless charging coil is achieved. In various implementations, the above-referenced target power transfer efficiency values may be tied to an applicable standard, such as the Qi standard for wireless charging, although this need not be the case.

In certain implementations, the target set of performance characteristics for the multi-coil system may relate to power received at the receiving wireless charging coil. As non-limiting examples, such target performance characteristics may comprise any one or combination of: (i) a target power (e.g., 15 W) received at the receiving wireless charging coil; (ii) a target power (e.g., 15 W) received at the receiving wireless charging coil given a target air gap between the transmitting wireless charging coil and the receiving wireless charging coil; (iii) a target power (e.g., 15 W) received at the receiving wireless charging coil given a target lateral misalignment between the transmitting wireless charging coil and the receiving wireless charging coil; (iv) a target power (e.g., 15 W) received at the receiving wireless charging coil given a target tilt angle between the transmitting wireless charging coil and the receiving wireless charging coil; (v) a target range of air gaps between the transmitting wireless charging coil and the receiving wireless charging coil where power received at the receiving wireless charging coil exceeds a minimum value (e.g., 12 W); (vi) a target range of lateral misalignments between the transmitting wireless charging coil and the receiving wireless charging coil where power received at the receiving wireless charging coil exceeds a minimum value (e.g., 12 W); or (vii) a target range of tilt angles between the transmitting wireless charging coil and the receiving wireless charging coil where power received at the receiving wireless charging coil exceeds a minimum value (e.g., 12 W). In various implementations, the above-referenced receive power values may be tied to an applicable standard, such as the Qi standard for wireless charging, although this need not be the case.

In various implementations, the target set of performance characteristics for the multi-coil system may relate to operating temperature values of the coils or other temperature-sensitive components of the multi-coil system. As non-limiting examples, such target performance characteristics may comprise any one or combination of: (i) a target operating temperature (or target range of operating temperatures) for the transmitting wireless charging coil (or more particularly, for different regions or components of the transmitting wireless charging coil); (ii) a target operating temperature (or target range of operating temperatures) for the repeater coil (or more particularly, for different regions or components of the repeater coil); (iii) a target operating temperature (or target range of operating temperatures) for the receiving wireless charging coil (or more particularly, for different regions or components of the receiving wireless charging coil); (iv) a target operating temperature (or target range of operating temperatures) for different surfaces or regions of an external wireless charger that the transmitting wireless charging coil is implemented in; (v) a target operating temperature (or target range of operating temperatures) for different surfaces or regions of an apparatus that the repeater coil is implemented in; or (vi) a target operating temperature (or target range of operating temperatures) for different surfaces or regions of the mobile device that the receiving wireless charging coil is implemented in.

As may be appreciated, other performance characteristics may also be included in the target set of performance characteristics depending on implementation.

Various techniques or software programs may be used to perform the above-referenced simulations.

As alluded to above, in some implementations the repeater coil may be implemented in one of the multi-device wireless charging apparatuses depicted and described in conjunction with FIGS. 27-43. In some of such implementations, determining the target structural and electromagnetic parameters for the multi-coil system may take into account structural dimensions (or ranges of possible structural dimensions) for the multi-device wireless charging apparatus. Relatedly, in certain of such implementations performing the electromagnetic simulations (and in some cases, thermal or operating temperature-related simulations) to predict performance characteristics for the multi-coil system may further comprise predicting performance characteristics for the multi-coil system given different sets of structural dimensions for the multi-device wireless charging apparatus and different positions (e.g., different locations, orientations, or some combination thereof) for the repeater coil within the multi-device wireless charging apparatus. Accordingly, determining the initial set of design parameters for the repeater coil may further comprise determining an initial set of structural dimensions for the multi-device wireless charging apparatus and an initial placement of the repeater coil within the multi-device wireless charging apparatus based on the simulations.

As described above, in some implementations the multi-device charging apparatus may further comprise a second repeater coil. Accordingly, performing the electromagnetic simulations (and in some cases, thermal or operating temperature-related simulations) to predict performance characteristics for the multi-coil system may further comprise predicting performance characteristics for the multi-coil system given: (i) different sets of design parameters for the second repeater coil; and (ii) different positions for the second repeater coil within the multi-device wireless charging apparatus. Relatedly, determining the initial set of design parameters for the repeater coil may further comprise determining: (i) an initial set of design parameters for the second repeater coil; and (ii) an initial placement of the second repeater coil within the multi-device wireless charging apparatus. Such a methodology may be replicated for any additional repeater coils which may be included in the multi-device charging apparatus.

As alluded to above, in various implementations the repeater coil may be implemented in one of the multi-use wireless charging apparatuses depicted and described in conjunction with FIGS. 44-54. In some of such implementations, determining the target structural and electromagnetic parameters for the multi-coil system may take into account structural dimensions (or ranges of possible structural dimensions) for the multi-use wireless charging apparatus. Relatedly, in certain of such implementations performing the electromagnetic simulations (and in some cases, thermal or operating temperature-related simulations) to predict performance characteristics for the multi-coil system may further comprise predicting performance characteristics for the multi-coil system given different sets of structural dimensions for the multi-use wireless charging apparatus and different positions (e.g., different locations, orientations, or some combination thereof) for the repeater coil within the multi-use wireless charging apparatus. Accordingly, determining the initial set of design parameters for the repeater coil may further comprise determining an initial set of structural dimensions for the multi-use wireless charging apparatus and an initial placement of the repeater coil within the multi-use wireless charging apparatus based on the simulations.

As described above, in some implementations the multi-use charging apparatus may further comprise a second repeater coil. Accordingly, performing the electromagnetic simulations (and in some cases, thermal or operating temperature-related simulations) to predict performance characteristics for the multi-coil system may further comprise predicting performance characteristics for the multi-coil system given: (i) different sets of design parameters for the second repeater coil; and (ii) different positions for the second repeater coil within the multi-use wireless charging apparatus. Relatedly, determining the initial set of design parameters for the repeater coil may further comprise determining: (i) an initial set of design parameters for the second repeater coil; and (ii) an initial placement of the second repeater coil within the multi-use wireless charging apparatus. Such a methodology may be replicated for any additional repeater coils which may be included in the multi-use charging apparatus.

Referring again to FIG. 55, an operation 5508 of process 5500 may involve fabricating the repeater coil according to the (determined) initial set of design parameters. As alluded to above, in implementations where the repeater coil is implemented in a wireless charging apparatus of the presently disclosed technology (e.g., a mobile device case, multi-device wireless charging apparatus, a multi-use wireless charging apparatus, etc.), fabricating the repeater coil may further comprise fabricating the wireless charging apparatus according to the (determined) initial set of structural dimensions for the wireless charging apparatus and fabricating the repeater coil within the wireless charging apparatus according to the initial (determined) placement of the repeater coil within the wireless charging apparatus. Relatedly, in implementations where one or more additional repeater coils are to be included in the wireless charging apparatus, fabricating the repeater coil may further comprise fabricating the wireless charging apparatus according to the (determined) initial set of structural dimensions for the wireless charging apparatus and fabricating the additional repeater coil(s) within the wireless charging apparatus according to the initial (determined) placement(s) for the repeater coil(s) within the wireless charging apparatus.

As depicted in FIGS. 55B-55C, in certain implementations process 5500 may include additional operations related to testing and refining the fabricated repeater coil.

For example (and as depicted in FIG. 55B), in some implementations process 5500 may further include operations 5510-5516.

Operation 5510 may involve measuring electromagnetic characteristics of the fabricated repeater coil. Non-limiting examples of the measured electromagnetic characteristics may include any one or combination of: (i) inductance of the fabricated repeater coil; (ii) resistance of the fabricated repeater coil; or (iii) a quality factor for the fabricated repeater coil.

Accordingly, operation 5512 may involve performing second electromagnetic simulations (and in some cases, second thermal or temperature-related simulations) to predict performance characteristics for the multi-coil system based on the measured electromagnetic characteristics of the fabricated repeater coil. Relatedly, operation 5514 may involve determining an adjusted set of design parameters for the repeater coil based on the second simulations. Such operations may be performed in the same/similar manner as operations 5504-5506 from FIG. 55A.

Thus operation 5516 may involve: (a) modifying the fabricated repeater coil according to the adjusted set of design parameters; or (b) fabricating a second repeater coil according to the adjusted set of design parameters.

As depicted in FIG. 55C, in some implementations process 5500 may further include operations 5518-5522. In certain of such implementations, operations 5518-5522 may be performed after operation 5508 (from FIG. 55A). In other implementations, operations 5518-5522 may be performed after operation 5516 (from FIG. 55B).

As depicted, operation 5518 may involve measuring performance characteristics for the multi-coil system comprising the transmitting wireless charging coil, the fabricated repeater coil, and the receiving wireless charging coil of the mobile device. Such measured performance characteristics may be the same/similar performance characteristics as the target performance characteristics described in conjunction with operation 5506.

Operation 5520 may involve modifying the fabricated repeater coil to change a number of capacitors included in the fabricated repeater coil. Accordingly, operation 5522 may involve repeating operations 5518 and operations 5520 to determine a number of capacitors to include in the fabricated repeater coil such that the multi-coil system most closely approximates the target set of performance characteristics

As described above, the capacitors of the repeater coil may form a tuning subcircuit as an auxiliary tuning stage to help provide that the repeater coil resonates at the same frequency as other components of the multi-coil system (e.g., the transmitting wireless charging coil and the receiving wireless charging coil of the mobile device). The tuning subcircuit may include one or more tuning capacitors that can be selected (e.g., inserted or changed) to adjust or fine-tune the resonant frequency of the repeater coil. The one or more capacitors may comprise various types of capacitors, such as small capacitors (e.g., used in manufacturing PCBs and/or thin film or flexible circuits), thin film capacitors, etc. The one or more capacitors can be selected based on the particular requirements for the repeater coil such as, e.g., capacitance value, size/space considerations, etc.

As described above in conjunction FIG. 15B, the one or more capacitors of the repeater coil may be electrically coupled or connected in parallel. In some implementations, the one or more capacitors may be coupled or connected in other circuit configurations (e.g., series, series-parallel, etc.).

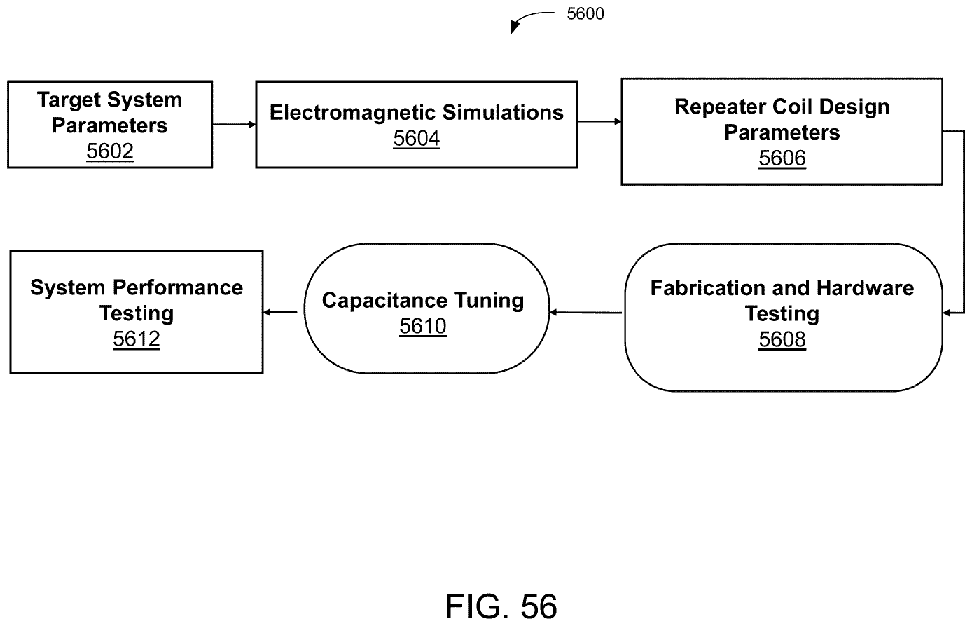

FIG. 56 depicts an example flowchart 5600 for designing, fabricating, and testing repeater coils for wireless charging, according to one or more embodiments.

As may be appreciated, in some implementations one or more of the operations of process 5600 may be performed automatically by one or more computing components or computing systems, such as computing component 6500 of FIG. 65.

An operation 5602 of flowchart 5600 may involve determining target structural and electromagnetic parameters for a multi-coil system in which a repeater coil increases inductive flux linkage between a transmitting wireless charging coil and a receiving wireless charging coil of a mobile device. Operation 5602 may be performed in the same/similar manner as described above for operation 5502 of process 5500.

An operation 5604 of flowchart 5600 may involve performing electromagnetic simulations (and in some cases, thermal or operating temperature-related simulations) to predict performance characteristics for the multi-coil system given different sets of design parameters for the repeater coil permitted by the target structural and electromagnetic parameters for the multi-coil system. Operation 5604 may be performed in the same/similar manner as described above for operation 5504 of process 5500.

Based on the simulations of operation 5604, an operation 5606 of flowchart 5600 may involve determining an initial set of design parameters for the repeater coil that are predicted to produce a target set of performance characteristics for the multi-coil system. Operation 5606 may be performed in the same/similar manner as described above for operation 5506 of process 5500.

An operation 5608 of flowchart 5600 may involve fabricating the repeater coil according to the initial set of design parameters and measuring electromagnetic characteristics of the fabricated repeater coil. Operation 5608 may be performed in the same/similar manner as described above for operations 5508 and 5510 of process 5500.

In various implementations, operations 5604-5608 may be iteratively repeated to refine the repeater coil.

An operation 5610 of flowchart 5600 may involve tuning the fabricated repeater coil by changing a number of capacitors included in the fabricated repeater coil. Operation 5610 may be performed in the same/similar manner as described above for operation 5520 of process 5500.

An operation 5612 of flowchart 5600 may involve measuring performance characteristics for the multi-coil system comprising the transmitting wireless charging coil, the fabricated repeater coil, and the receiving wireless charging coil of the mobile device. Operation 5612 may be performed in the same/similar manner as described above for operation 5518 of process 5500.

In various implementations, operations 5610-5612 may be iteratively repeated to refine the repeater coil.

FIGS. 42-43 and 57-65 depict graphs illustrating measured performance characteristics for various example multi-coil systems, according to one or more embodiments.

As may be appreciated, the graphs of FIGS. 42-43 and 57-65 are merely illustrative examples, and should not limit the scope or breadth of embodiments and implementations described herein.

As discussed above, FIGS. 42-43 illustrate graphs depicting effective charging ranges for example repeater coils disclosed herein. Each repeater coil was tested in a multi-coil system where the applicable repeater coil was positioned to increase inductive flux linkage between a transmitting wireless charging coil and a receiving wireless charging coil of a mobile device.

More specifically, the graphs of FIGS. 42-43 illustrate measured performance characteristics from example experiments where different repeater coils disclosed herein were attached to an interior surface of a mobile device case (e.g., as depicted and described in conjunction with FIGS. 14-26).

In the example experiments, a mobile device was received within the mobile device case, and various performance characteristics were tested for the different repeater coils at: (1) different (vertical) air gaps between a wireless charging interface of the mobile device (wherein the mobile device comprises the receiving wireless charging coil proximate the wireless charging interface of the mobile phone) and a wireless charging interface of an external wireless charger (wherein the external wireless charger comprises the transmitting wireless charging coil proximate the wireless charging interface of the external wireless charger); and (2) different lateral offsets between a center of the wireless charging interface of the mobile device and a center of the wireless charging interface of an external wireless charger.

Graphs 4200 and 4300 were derived from these measured performance characteristics.

Before describing graphs 4200 and 4300 in more detail, it may be appreciated that the measured performance characteristics reflected in graphs 4200 and 4300 may be similar (and can be extended) to various example apparatuses/repeater coils disclosed herein, including without limitation: (a) the mobile device cases and repeater coils depicted and described in conjunction with FIGS. 14-26; (b) the multi-device wireless charging apparatuses and repeater coils depicted and described in conjunction with FIGS. 27-41; and (c) the multi-use wireless charging apparatuses and repeater coils depicted and described in conjunction with FIGS. 44-54. As described above, each of these apparatuses may comprise, inter alia, a surface configured to receive a wireless charging interface of a mobile device and a repeater coil disposed on, or embedded beneath, the surface to increase inductive flux between the wireless charging interface of the mobile device and a wireless charging interface of an external wireless charger.

As depicted in FIG. 42, graph 4200 plots an effective charging range for the different repeater coils as a function of (vertical) air gap on the y-axis and lateral offset (i.e., misalignment) on the x-axis. As used herein, an effective charging range for a repeater coil (or an apparatus incorporating the repeater coil) may comprise a spatial region of air gaps, lateral offsets, tilt angles, or any combination thereof, where power transfer efficiency (sometimes referred to herein as wireless charging efficiency) is [X]% or greater. In certain implementations, such power transfer efficiency may be defined as a percentage of the inductive energy transmitted by the transmitting wireless coil that is received by the receiving wireless charging coil. The above-described air gaps may be measured between a wireless charging interface of the mobile device and a wireless charging interface of the external wireless charger. Likewise, the lateral offsets may be measured from a center of the wireless charging interface of the mobile device and a center of the wireless charging interface of the external wireless charger. Tilt angles may be measured between a plane across which the wireless charging interface of the mobile device is disposed and a plane across which the wireless charging interface of the external wireless charger is disposed. As may be appreciated, in some implementations the above-referenced air gaps, lateral offsets and tilt angles may be measured between transmitting and receiving wireless charging coils instead of wireless charging interfaces. In various implementations, such measurements may serve as proxies for each other.

Referring again to FIG. 42, graph 4200 includes: (1) a curve 4202 that bounds an effective charging range for a first configuration where no repeater coil was included in the mobile device case; (2) a curve 4204 that bounds an effective charging range for a second configuration where a repeater coil comprising one tuning capacitor was included in the mobile device case; (3) a curve 4206 that bounds an effective charging range for a third configuration where a repeater coil comprising two tuning capacitors was included in the mobile device case; (4) a curve 4208 that bounds an effective charging range for a fourth configuration where a repeater coil comprising three tuning capacitors was included in the mobile device case; (5) a curve 4210 that bounds an effective charging range for a fifth configuration where a repeater coil comprising four tuning capacitors was included in the mobile device case; and (6) a curve 4212 that bounds an effective charging range for a sixth configuration where a repeater coil comprising five tuning capacitors was included in the mobile device case. In the example experiments, each capacitor comprised a 120 nanofarad (NF) capacitor. As may be appreciated, the tuning capacitors may have different capacitances in different implementations.

As depicted, the maximum air gap in the effective charging range for the sixth configuration (i.e., where the repeater coil comprising five tuning capacitors was included in the mobile device case) was approximately 7.8 millimeters (mm). By contrast, the maximum air gap in the effective charging range for the first configuration (i.e., where no repeater coil was included in the mobile device case) was approximately 1 mm. As may be appreciated, this significant increase in air gap-related effective charging range can be attributed in part to the unique capabilities of the presently disclosed repeater coils.

Related to above, the maximum lateral offset in the effective charging range for the sixth configuration (i.e., where the repeater coil comprising five tuning capacitors was included in the mobile device case) was approximately 16 mm. By contrast, the lateral offset in the effective charging range for the first configuration (i.e., where no repeater coil was included in the mobile device case) was approximately 5 mm. As may be appreciated, this significant increase in lateral offset-related effective charging range can be attributed in part to the unique capabilities of the presently disclosed repeater coils.

As illustrated in graph 4200, the presently disclosed repeater coils can also extend effective charging ranges for air gap and lateral offset simultaneously. For example, the effective charging range for the sixth configuration (i.e., where the repeater coil comprising five tuning capacitors was included in the mobile device case) includes configurations where there was an air gap of approximately 4 mm and a lateral offset of approximately 12 mm. Such a configuration is well outside the effective charging range for the first configuration (i.e., where no repeater coil was included in the mobile device case).

Referring now to FIG. 43, graph 4300 is analogous to graph 4200 except graph 4300 is plotted in three dimensions. Namely, air gap is plotted on the z-axis and lateral offsets in two dimensions are plotted on the x-axis and y-axis respectively.

Similar to graph 4200, graph 4300 includes: (1) a boundary surface 4302 that bounds an effective charging range for a first configuration where no repeater coil was included in the mobile device case; (2) a boundary surface 4304 that bounds an effective charging range for a second configuration where a repeater coil comprising one tuning capacitor was included in the mobile device case; and (3) a boundary surface 4306 that bounds an effective charging range for a third configuration where a repeater coil comprising two tuning capacitors was included in the mobile device case. As depicted, the effective charging range for the third configuration is the largest/most extensive.

As may be appreciated, the measure performance characteristics illustrated in graphs 4200 and 4300 also demonstrate how the presently disclosed repeater coils can extend effective charging ranges to include configurations for a number of tilt angles between the wireless charging interface of the mobile device and the wireless charging interface of the active power supply. For example, in certain implementations the presently disclosed coil repeater coils can extend effective charging ranges to include configurations where a tilt angle between the wireless charging interface of the mobile device and the wireless charging interface of the active power supply exceeds 10, or even 25 degrees.

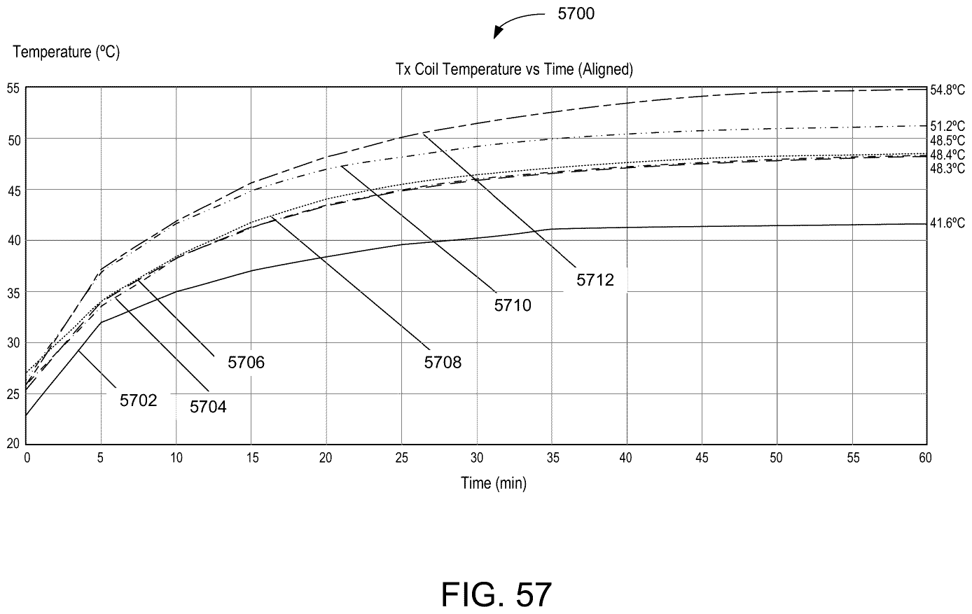

The graphs of FIGS. 57-64 were derived from the same/similar example experiments as the graphs of FIGS. 42 and 43.

Namely, graph 5700 of FIG. 57 plots temperature of the transmitting wireless charging coil (on the y-axis) as a function of time (on the x-axis) in multi-coil systems comprising different repeater coils.

Graph 5700 includes: (1) a curve 5702 that plots temperature of the transmitting wireless charging coil in a first multi-coil system where no repeater coil was included in the mobile device case; (2) a curve 5704 that plots temperature of the transmitting wireless charging coil in a second multi-coil system where a repeater coil comprising one tuning capacitor was included in the mobile device case; (3) a curve 5706 that plots temperature of the transmitting wireless charging coil in a third multi-coil system where a repeater coil comprising two tuning capacitors was included in the mobile device case (curve 5706 substantially overlaps curve 5704); (4) a curve 5708 that plots temperature of the transmitting wireless charging coil in a fourth multi-coil system where a repeater coil comprising three tuning capacitors was included in the mobile device case (curve 5708 substantially overlaps curves 5704 and 5706); (5) a curve 5710 that plots temperature of the transmitting wireless charging coil in a fifth multi-coil system where a repeater coil comprising four tuning capacitors was included in the mobile device case; and (6) a curve 5712 that plots temperature of the transmitting wireless charging coil in a sixth multi-coil system where a repeater coil comprising five tuning capacitors was included in the mobile device case.

As depicted, in the example experiments temperature for the transmitting wireless charging coil generally increased when a repeater coil was included in the multi-coil systems. Relatedly, an increasing number of tuning capacitors also contributed to temperature increases. Various implementations can take these measured (or predicted) temperature increases into account when designing parameters of the repeater coil and/or multi-coil system.

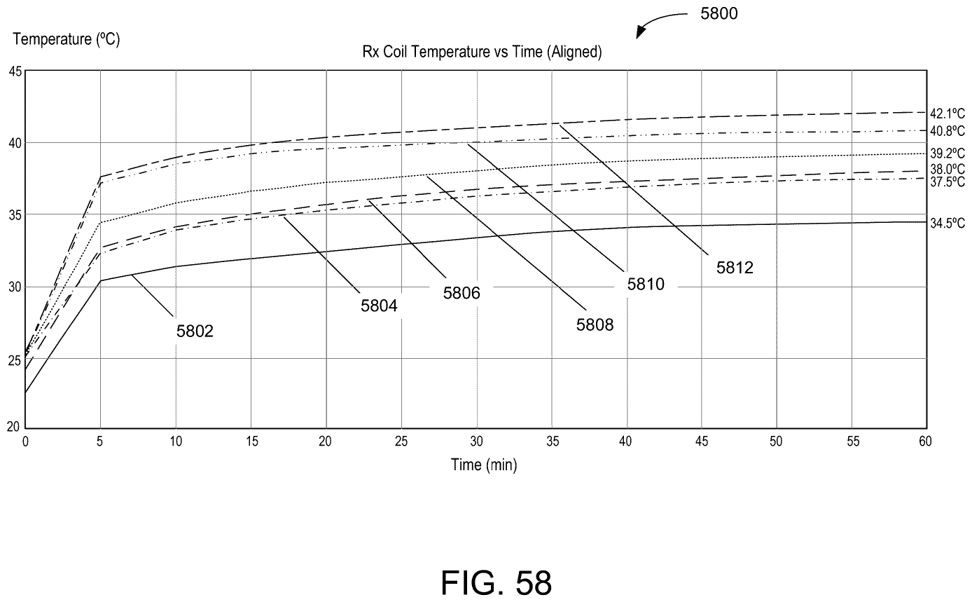

Graph 5800 of FIG. 58 plots temperature of the receiving wireless charging coil (on the y-axis) as a function of time (on the x-axis) in multi-coil systems comprising different repeater coils.

Graph 5800 includes: (1) a curve 5802 that plots temperature of the receiving wireless charging coil in a first multi-coil system where no repeater coil was included in the mobile device case; (2) a curve 5804 that plots temperature of the receiving wireless charging coil in a second multi-coil system where a repeater coil comprising one tuning capacitor was included in the mobile device case; (3) a curve 5806 that plots temperature of the receiving wireless charging coil in a third multi-coil system where a repeater coil comprising two tuning capacitors was included in the mobile device case; (4) a curve 5808 that plots temperature of the receiving wireless charging coil in a fourth multi-coil system where a repeater coil comprising three tuning capacitors was included in the mobile device case; (5) a curve 5810 that plots temperature of the receiving wireless charging coil in a fifth multi-coil system where a repeater coil comprising four tuning capacitors was included in the mobile device case; and (6) a curve 5812 that plots temperature of the receiving wireless charging coil in a sixth multi-coil system where a repeater coil comprising five tuning capacitors was included in the mobile device case.

As depicted, in the example experiments temperature for the receiving wireless charging coil generally increased when a repeater coil was included in the multi-coil systems. Relatedly, an increasing number of tuning capacitors also contributed to temperature increases. Various implementations can take these measured (or predicted) temperature increases into account when designing parameters of the repeater coil and/or multi-coil system.

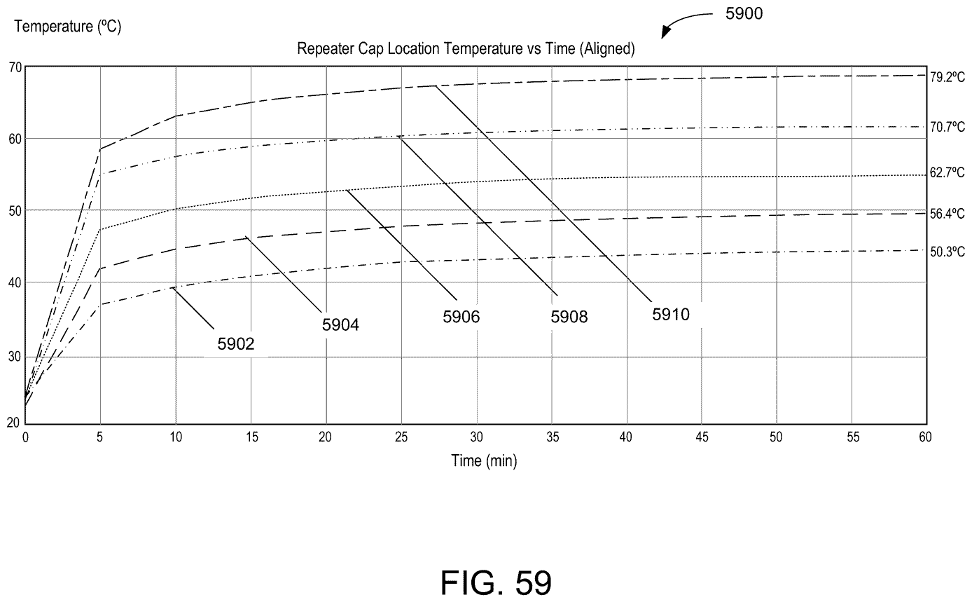

Graph 5900 of FIG. 59 plots temperature of the tuning capacitor(s) of the repeater coil (on the y-axis) as a function of time (on the x-axis) in multi-coil systems comprising different repeater coils.

Graph 5900 includes: (1) a curve 5902 that plots capacitor temperature in the repeater coil in a first multi-coil system where the repeater coil comprises one tuning capacitor; (2) a curve 5904 that plots capacitor temperature in the repeater coil in a second multi-coil system where the repeater coil comprises two tuning capacitors; (3) a curve 5906 that plots capacitor temperature in the repeater coil in a third multi-coil system where the repeater coil comprises three tuning capacitors; (4) a curve 5908 that plots capacitor temperature in the repeater coil in a fourth multi-coil system where the repeater coil comprises four tuning capacitors; and (5) a curve 5910 that plots capacitor temperature in the repeater coil in a fifth multi-coil system where the repeater coil comprises five tuning capacitors.

As depicted, in the example experiments capacitor temperature for the repeater coil generally increased with an increasing number of tuning capacitors. Various implementations can take these measured (or predicted) temperature increases into account when designing parameters of the repeater coil and/or multi-coil system.

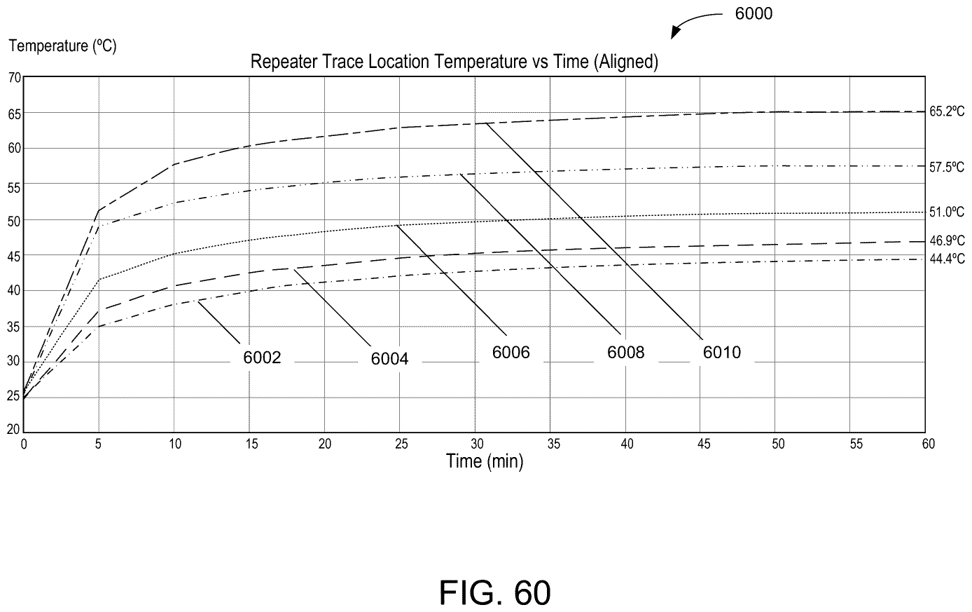

Graph 6000 of FIG. 60 plots temperature of the inductive coil of the repeater coil (on the y-axis) as a function of time (on the x-axis) in multi-coil systems comprising different repeater coils.

Graph 6000 includes: (1) a curve 6002 that plots inductive coil temperature in the repeater coil in a first multi-coil system where the repeater coil comprised one tuning capacitor; (2) a curve 6004 that plots inductive coil temperature in the repeater coil in a second multi-coil system where the repeater coil comprised two tuning capacitors; (3) a curve 6006 that plots inductive coil temperature in the repeater coil in a third multi-coil system where the repeater coil comprised three tuning capacitors; (4) a curve 6008 that plots inductive coil temperature in the repeater coil in a fourth multi-coil system where the repeater coil comprised four tuning capacitors; and (5) a curve 6010 that plots inductive coil temperature in the repeater coil in a fifth multi-coil system where the repeater coil comprised five tuning capacitors.

As depicted, in the example experiments inductive coil temperature for the repeater coil generally increased with an increasing number of tuning capacitors. Various implementations can take these measured (or predicted) temperature increases into account when designing parameters of the repeater coil and/or multi-coil system.

As illustrated when comparing graph 5900 to graph 6000, the final steady state temperature of the inductive coils for the above-referenced example designs was lower than the temperature at the capacitors. This may indicate that improvements to repeater coil design that involve multiple parallel capacitors can reduce losses in the capacitors.

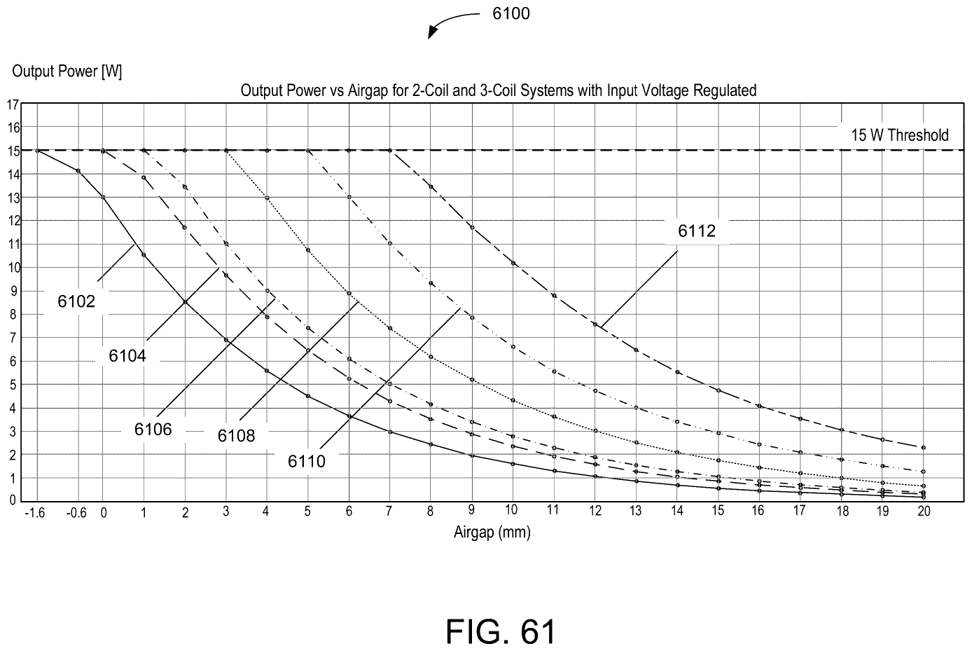

Graph 6100 of FIG. 61 plots power received by the receiving wireless charging coil of the mobile device (on the y-axis) as a function of (vertical) air gap between the wireless charging interface of the external wireless charger and the wireless charging interface of the mobile device. In the example experiments, received power was regulated according to the Qi standard not to exceed 15 W.

Graph 6100 includes: (1) a curve 6102 that plots received power in a first multi-coil system where no repeater coil was included in the multi-coil system; (2) a curve 6104 that plots received power in a second multi-coil system where the repeater coil comprised one tuning capacitor; (3) a curve 6106 that plots received power in a third multi-coil system where the repeater coil comprised two tuning capacitors; (4) a curve 6108 that plots received power in a fourth multi-coil system where the repeater coil comprised three tuning capacitors; (5) a curve 6110 that plots received power in a fifth multi-coil system where the repeater coil comprised four tuning capacitors; and (6) a curve 6112 that plots received power in a sixth multi-coil system where the repeater coil comprised five tuning capacitors.

As depicted, in the example experiments the received power maintained higher values as air gap increased for multi-coil systems that included a repeater coil. Moreover, received power generally maintained higher values as air gap increased for multi-coil systems that included an increasing number of tuning capacitors. For example, and as indicated by curve 6112, received power maintained at or around 15 W for air gaps as high as 7 mm for the sixth multi-coil system where the repeater coil comprised five tuning capacitors. By contrast, and as indicated by curve 6102, received power dropped much more quickly as air gap increased for the first multi-coil system where no repeater coil was included. Various implementations can take these measured results into account when designing parameters of the repeater coil and/or multi-coil system.

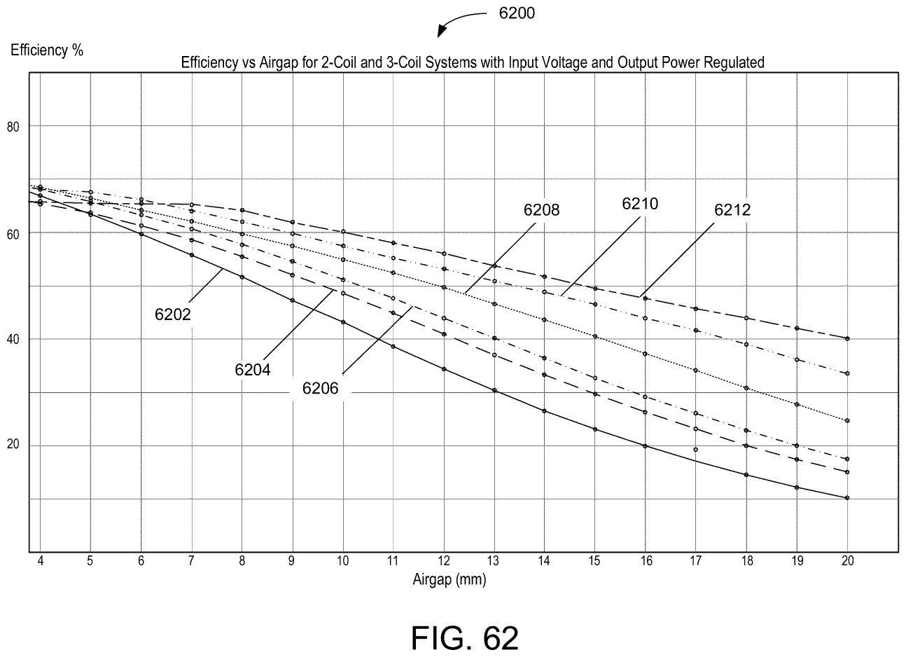

Graph 6200 of FIG. 62 plots power transfer efficiency (on the y-axis) as a function of (vertical) air gap between the wireless charging interface of the external wireless charger and the wireless charging interface of the mobile device. In the example experiments, received power was regulated according to the Qi standard not to exceed 15 W.

Graph 6200 includes: (1) a curve 6202 that plots power transfer efficiency in a first multi-coil system where no repeater coil was included in the multi-coil system; (2) a curve 6204 that plots power transfer efficiency in a second multi-coil system where the repeater coil comprised one tuning capacitor; (3) a curve 6206 that plots power transfer efficiency in a third multi-coil system where the repeater coil comprised two tuning capacitors; (4) a curve 6208 that plots power transfer efficiency in a fourth multi-coil system where the repeater coil comprised three tuning capacitors; (5) a curve 6210 that plots power transfer efficiency in a fifth multi-coil system where the repeater coil comprised four tuning capacitors; and (6) a curve 6212 that plots power transfer efficiency in a sixth multi-coil system where the repeater coil comprised five tuning capacitors.

As depicted, in the example experiments power transfer efficiency generally maintained higher values as air gap increased for multi-coil systems that included a repeater coil. Moreover, received power generally maintained higher values as air gap increased for multi-coil systems that included an increasing number of tuning capacitors. However, at some smaller air gaps multi-coil systems that incorporated repeater coils with fewer tuning capacitors demonstrated higher efficiency than multi-coil systems that incorporated repeater coils with fewer tuning capacitors. For example, at a 5 mm air gap, the fifth multi-coil system where the repeater coil comprised four tuning capacitors demonstrated a higher power transfer efficiency than the sixth multi-coil system where the repeater coil comprised five tuning capacitors. Various implementations can take these measured results into account when designing parameters of the repeater coil and/or multi-coil system.

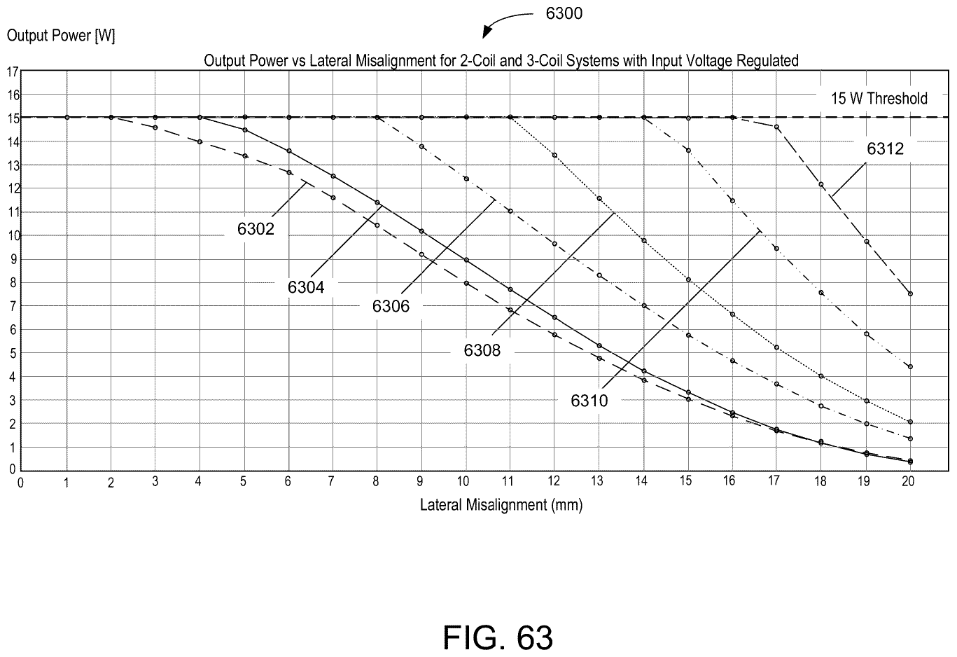

Graph 6300 of FIG. 63 plots power received by the receiving wireless charging coil of the mobile device (on the y-axis) as a function of lateral offset between the wireless charging interface of the external wireless charger and the wireless charging interface of the mobile device. In the example experiments, received power was regulated according to the Qi standard not to exceed 15 W.

Graph 6300 includes: (1) a curve 6302 that plots received power in a first multi-coil system where no repeater coil was included in the multi-coil system; (2) a curve 6304 that plots received power in a second multi-coil system where the repeater coil comprised one tuning capacitor; (3) a curve 6306 that plots received power in a third multi-coil system where the repeater coil comprised two tuning capacitors; (4) a curve 6308 that plots received power in a fourth multi-coil system where the repeater coil comprised three tuning capacitors; (5) a curve 6310 that plots received power in a fifth multi-coil system where the repeater coil comprised four tuning capacitors; and (6) a curve 6312 that plots received power in a sixth multi-coil system where the repeater coil comprised five tuning capacitors.

As depicted, in the example experiments the received power maintained higher values as lateral offset increased for multi-coil systems that included a repeater coil. Moreover, received power generally maintained higher values as lateral offset increased for multi-coil systems that included an increasing number of tuning capacitors. For example, and as indicated by curve 6312, received power maintained at or around 15 W for lateral offsets as high as 16 mm for the sixth multi-coil system where the repeater coil comprised five tuning capacitors. By contrast, and as indicated by curve 6302, received power dropped much more quickly as lateral offset increased for the first multi-coil system where no repeater coil was included. Various implementations can take these measured results into account when designing parameters of the repeater coil and/or multi-coil system.

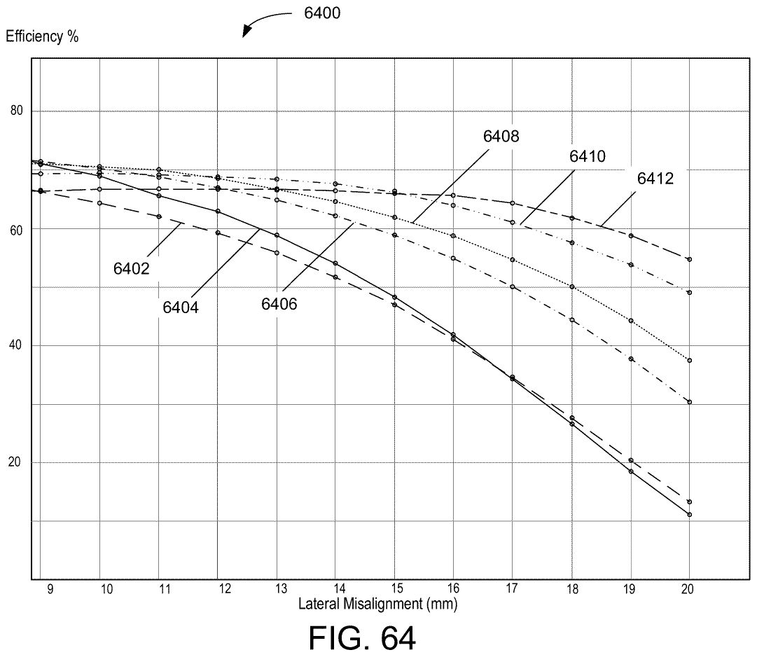

Graph 6400 of FIG. 64 plots power transfer efficiency (on the y-axis) as a function of (vertical) lateral offset between the wireless charging interface of the external wireless charger and the wireless charging interface of the mobile device. In the example experiments, received power was regulated according to the Qi standard not to exceed 15 W.

Graph 6400 includes: (1) a curve 6402 that plots power transfer efficiency in a first multi-coil system where no repeater coil was included in the multi-coil system; (2) a curve 6404 that plots power transfer efficiency in a second multi-coil system where the repeater coil comprised one tuning capacitor; (3) a curve 6406 that plots power transfer efficiency in a third multi-coil system where the repeater coil comprised two tuning capacitors; (4) a curve 6408 that plots power transfer efficiency in a fourth multi-coil system where the repeater coil comprised three tuning capacitors; (5) a curve 6410 that plots power transfer efficiency in a fifth multi-coil system where the repeater coil comprised four tuning capacitors; and (6) a curve 6412 that plots power transfer efficiency in a sixth multi-coil system where the repeater coil comprised five tuning capacitors.

As depicted, in the example experiments power transfer efficiency generally maintained higher values as lateral offset increased for multi-coil systems that included a repeater coil. Moreover, received power generally maintained higher values as lateral offset increased for multi-coil systems that included an increasing number of tuning capacitors. However, at some smaller lateral offsets multi-coil systems that incorporated repeater coils with fewer tuning capacitors demonstrated higher efficiency than multi-coil systems that incorporated repeater coils with fewer tuning capacitors. For example, at a 9 mm lateral offset, the fifth multi-coil system where the repeater coil comprised four tuning capacitors demonstrated a higher power transfer efficiency than the sixth multi-coil system where the repeater coil comprised five tuning capacitors. Various implementations can take these measured results into account when designing parameters of the repeater coil and/or multi-coil system.

### ADDITIONAL NOTES AND EXAMPLES

Example A1 includes a mobile device case for attachment to a mobile device, comprising a case body, and a first coil repeater assembly comprising a wireless charging repeater circuit and a substrate, wherein the wireless charging repeater circuit comprises a first inductive coil disposed on a first surface of the substrate, and a first tuning capacitor electrically coupled to each end of the first inductive coil, wherein the wireless charging repeater circuit excludes electrical connection to an active component that supplies power, wherein the first coil repeater assembly is arranged on or within an interior surface of the case body such that, when the mobile device case is attached to a mobile device, the first inductive coil is located proximate to a wireless charging coil in the mobile device.

Example A2 includes the mobile device case of Example A1, wherein the substrate comprises a printed circuit board.

Example A3 includes the mobile device case of Example A1, wherein the substrate comprises a thin film and the wireless charging coil repeater circuit includes a flexible circuit or a thin film circuit.

Example A4 includes the mobile device case of Example A1, wherein the first coil repeater assembly includes a magnetic core located in the center of the first inductive coil.

Example A5 includes the mobile device case of Example A1, further comprising a first recessed region in the case body to hold at least a portion of the first coil repeater assembly.

Example A6 includes the mobile device case of Example A5, further comprising a second recessed region in the case body to hold a component of the wireless charging repeater circuit, wherein the second recessed region has a depth different than a depth of the first recessed region.

Example A7 includes the mobile device case of Example A1, wherein the first tuning capacitor comprises a plurality of physical capacitors connected in parallel.

Example A8 includes the mobile device case of Example A7, wherein the case body includes a socket to hold at least one of the plurality of physical capacitors, and wherein the at least one of the plurality of physical capacitors is removeable.

Example A9 includes the mobile device case of Example A1, further comprising a second coil repeater assembly located parallel to the first coil repeater assembly, wherein the second coil repeater assembly comprises a second substrate including a second inductive coil disposed on a first surface of the second substrate, and a second tuning capacitor electrically coupled to each end of the second inductive coil, wherein the second inductive coil and the second tuning capacitor are part of the wireless charging repeater circuit.

Example MA1 includes a method of constructing a mobile device case for attachment to a mobile device, comprising forming a first coil repeater assembly comprising a wireless charging repeater circuit and a substrate, wherein the wireless charging repeater circuit comprises a first inductive coil disposed on a first surface of the substrate, and a first tuning capacitor electrically coupled to each end of the first inductive coil, wherein the wireless charging repeater circuit excludes electrical connection to an active component that supplies power, and arranging the first coil repeater assembly on or within an interior surface of a case body of a mobile device case such that, when the mobile device case is attached to a mobile device, the first inductive coil is located proximate to a wireless charging coil in the mobile device.

Example MA2 includes the method of Example MA1, further comprising arranging a magnetic core in the center of the first inductive coil.

Example MA3 includes the method of Example MA1, further comprising arranging at least a portion of the first coil repeater assembly within a first recessed region in the case body.

Example MA4 includes the method of Example MA3, further comprising arranging a component of the wireless charging repeater circuit within a second recessed region in the case body, wherein the second recessed region has a depth different than a depth of the first recessed region.

Example MA5 includes the method of Example MA1, wherein the first tuning capacitor comprises a plurality of physical capacitors connected in parallel, wherein at least one of the plurality of physical capacitors is removeable, and wherein the method further comprises arranging at least one of the plurality of physical capacitors in a socket in the case body.

Example MA6 includes the method of Example MA1, further comprising arranging a second coil repeater assembly located parallel to the first coil repeater assembly, wherein the second coil repeater assembly comprises a second substrate including a second inductive coil disposed on a first surface of the second substrate, and a second tuning capacitor electrically coupled to each end of the second inductive coil, and wherein the second inductive coil and the second tuning capacitor are part of the wireless charging repeater circuit.

Example B1 includes a mobile device case for attachment to a mobile device, comprising a case body, a wireless charging repeater circuit comprising an inductive coil, and a tuning capacitor electrically coupled to each end of the inductive coil, wherein the wireless charging repeater circuit excludes electrical connection to an active component that supplies power, wherein the inductive coil comprises a conductor-filled microchannel coil formed in the case body such that, when the mobile device case is attached to a mobile device, the inductive coil is located proximate to a wireless charging coil in the mobile device.

Example B2 includes the mobile device case of Example B1, wherein the conductor-filled microchannel coil comprises a metallic material that is a liquid or paste.

Example B3 includes the mobile device case of Example B1, further comprising a magnetic core located in the center of the microchannel coil.

Example B4 includes the mobile device case of Example B1, further comprising a recessed region in the case body to hold the tuning capacitor of the wireless charging repeater circuit.

Example B5 includes the mobile device case of Example B1, wherein the tuning capacitor comprises a plurality of physical capacitors connected in parallel.

Example B6 includes the mobile device case of Example B5, wherein the case body includes a socket to hold at least one of the plurality of physical capacitors, and wherein the at least one of the plurality of physical capacitors is removeable.

Example MB1 includes a method of constructing a mobile device case for attachment to a mobile device, comprising forming a microchannel coil disposed within a first surface of a case body of a mobile device case, filling the microchannel coil with a conductive material to form an inductive coil, and electrically connecting a tuning capacitor to each end of the inductive coil to form a wireless charging repeater circuit, wherein the wireless charging repeater circuit excludes electrical connection to an active component that supplies power, wherein the inductive coil is located proximate to a wireless charging coil in a mobile device when the mobile device case is attached to the mobile device.

Example MB2 includes the method of Example MB1, wherein the conductor-filled microchannel comprises a metallic material that is a liquid or paste.

Example MB3 includes the method of Example MB1, wherein the microchannel coil is formed within the first surface of the case body via injection molding or three-dimensional (3D) printing.

Example MB4 includes the method of Example MB1, wherein the microchannel coil is sealed after being filled with the conductive material.

Example MB5 includes the method of Example MB1, further comprising arranging a magnetic core in the center of the microchannel coil.

Example MB6 includes the method of Example MB1, wherein the tuning capacitor comprises a plurality of physical capacitors connected in parallel, wherein at least one of the plurality of physical capacitors is removeable, and wherein the method further comprises arranging at least one of the plurality of physical capacitors in a socket in the case body.

Example C1 includes a mobile device case for attachment to a mobile device, comprising a case body, and a first coil repeater assembly comprising a wireless charging repeater circuit and a substrate, wherein the wireless charging repeater circuit comprises a first inductive coil disposed on a first surface of the substrate, and a first tuning capacitor electrically coupled to each end of the first inductive coil, wherein the wireless charging repeater circuit excludes electrical connection to an active component that supplies power, and wherein the substrate includes an adhesive disposed on a second surface of the substrate, the second surface of the substrate being on an opposite side of the substrate relative to the first surface, wherein the first coil repeater assembly is attached via the adhesive to an interior surface of the case body such that, when the mobile device case is attached to a mobile device, the first inductive coil is located proximate to a wireless charging coil in the mobile device.

Example C2 includes the mobile device case of Example C1, wherein the substrate comprises one or more of a thin flexible polymer or a paper material.

Example C3 includes the mobile device case of Example C1 or C2, wherein the substrate comprises a thin rigid material.

Example C4 includes the mobile device case of any of Examples C1-C3, wherein the first inductive coil is an ink-printed coil.

Example C5 includes the mobile device case of any of Examples C1-C4, wherein the first inductive coil is a multi-layer ink-printed coil, wherein a second layer of the multi-layer ink-printed coil is disposed on a second substrate parallel to the substrate.

Example C6 includes the mobile device case of any of Examples C1-C5, wherein the first inductive coil is a litz coil comprising one or more layers.

Example C7 includes the mobile device case of any of Examples C1-C6, further comprising a second coil repeater assembly located parallel to the first coil repeater assembly, wherein the second coil repeater assembly comprises a second inductive coil disposed on a first surface of a second substrate, and a second tuning capacitor electrically coupled to each end of the second inductive coil, wherein the second inductive coil and the second tuning capacitor are part of the wireless charging repeater circuit, wherein the second substrate includes an adhesive on a second surface of the second substrate, the second surface of the second substrate being on an opposite side of the second substrate relative to the first surface of the second substrate, and wherein the second coil repeater assembly is attached via the adhesive on the second substrate to an exterior surface of the case body, the exterior surface of the case body being on an opposite side of the case body relative to the first surface of the case body, such that the second inductive coil is located proximate to the first inductive coil.

Example MC1 includes a method of constructing a mobile device case comprising forming a first coil repeater assembly comprising a wireless charging repeater circuit and a substrate, wherein the wireless charging repeater circuit comprises a first inductive coil disposed on a first surface of the substrate, and a first tuning capacitor electrically coupled to each end of the first inductive coil, wherein the wireless charging repeater circuit excludes electrical connection to an active component that supplies power, and wherein the substrate includes an adhesive on a second surface of the substrate, the second surface of the substrate being on an opposite side of the substrate relative to the first surface, and attaching the first coil repeater assembly via the adhesive to an interior surface of the case body such that, when the mobile device case is attached to a mobile device, the first inductive coil is located proximate to a wireless charging coil in the mobile device.

Example MC2 includes the method of Example MC1, wherein the substrate comprises one or more of a thin flexible polymer or a paper material.

Example MC3 includes the method of Example MC1 or MC2, wherein the substrate comprises a thin rigid material.

Example MC4 includes the method of any of Examples MC1-MC3, wherein the first inductive coil is an ink-printed coil.

Example MC5 includes the method of any of Examples MC1-MC4, wherein the first inductive coil is a multi-layer ink-printed coil, wherein a second layer of the multi-layer ink-printed coil is disposed on a second substrate parallel to the substrate.

Example MC6 includes the method of any of Examples MC1-MC5, wherein the first inductive coil is a litz coil comprising one or more layers.

Example MC7 includes the method of any of Examples MC1-MC6, further comprising forming a second coil repeater assembly comprising a second inductive coil disposed on a first surface of a second substrate, and a second tuning capacitor electrically coupled to each end of the second inductive coil, and wherein the second inductive coil and the second tuning capacitor are part of the wireless charging repeater circuit, and wherein the second substrate includes an adhesive on a second surface of the second substrate, the second surface of the second substrate being on an opposite side of the second substrate relative to the first surface of the second substrate, and attaching the second coil repeater assembly via the adhesive on the second substrate to an exterior surface of the case body, the exterior surface of the case body being on an opposite side of the case body relative to the first surface of the case body, such that the second inductive coil is located proximate to the first inductive coil.

Example D1 includes a coil repeater assembly for wireless charging of a mobile device, comprising a wireless charging repeater circuit, and a substrate, wherein the wireless charging repeater circuit comprises an inductive coil disposed on a first surface of the substrate, and a tuning capacitor electrically coupled to each end of the first inductive coil, wherein the wireless charging repeater circuit excludes electrical connection to an active component that supplies power, and wherein the substrate includes an adhesive on a second surface of the substrate, the second surface of the substrate being on an opposite side of the substrate relative to the first surface.

Example D2 includes the coil repeater assembly of Example D1, wherein the substrate comprises one or more of a thin flexible polymer or a paper material.

Example D3 includes the coil repeater assembly of Example D1 or D2, wherein the substrate comprises a thin rigid material.

Example D4 includes the coil repeater assembly of any of Examples D1-D3, wherein the inductive coil is an ink-printed coil.

Example D5 includes the coil repeater assembly of any of Examples D1-D4, wherein the inductive coil is a multi-layer ink-printed coil, wherein a layer of the multi-layer ink-printed coil is disposed on a second substrate parallel to the substrate.

Example D6 includes the coil repeater assembly of any of Examples D1-D5, wherein the inductive coil is a litz coil comprising one or more layers.

Example MD1 includes a method comprising providing a coil repeater assembly for wireless charging of a mobile device, wherein the coil repeater assembly comprises a wireless charging repeater circuit, and a substrate, wherein the wireless charging repeater circuit comprises an inductive coil disposed on a first surface of the substrate, and a tuning capacitor electrically coupled to each end of the inductive coil, wherein the wireless charging repeater circuit excludes electrical connection to an active component that supplies power, and wherein the substrate includes an adhesive on a second surface of the substrate, the second surface of the substrate being on an opposite side of the substrate relative to the first surface, and attaching the coil repeater assembly via the adhesive to a surface of a vehicle such that the inductive coil is located proximate to a wireless charging driver coil in the vehicle.

Example MD2 includes the method of Example MD1, wherein the substrate comprises one or more of a thin flexible polymer or a paper material.

Example MD3 includes the method of Example MD1 or MD2, wherein the substrate comprises a thin rigid material.

Example MD4 includes the method of any of Examples MD1-MD3, wherein the inductive coil is an ink-printed coil.

Example MD5 includes the method of any of Examples MD1-MD4, wherein the inductive coil is a multi-layer ink-printed coil, wherein a layer of the multi-layer ink-printed coil is disposed on a second substrate parallel to the substrate.

Example MD6 includes the method of any of Examples MD1-MD5, wherein the inductive coil is a litz coil comprising one or more layers.

In some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 65. Various embodiments are described in terms of this example-computing component 6500. For example, computing component 6500 may be implemented to execute trace design system or portions thereof. After reading this description, it will become apparent to a person skilled in the relevant art how to implement the application using other computing components or architectures.

Referring now to FIG. 65, computing component 6500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 6500 might also represent computing capabilities embedded within or otherwise available to a given device. For example, a computing component might be found in other electronic devices such as, for example, portable computing devices, and other electronic devices that might include some form of processing capability.

Computing component 6500 might include, for example, one or more processors, controllers, control components, or other processing devices. This can include a processor, and/or any one or more of the components making up trace design system and/or wireless charging system 1100. Processor 6504 might be implemented using a general-purpose or special-purpose processing engine such as, for example, a microprocessor, controller, or other control logic. Processor 6504 may be connected to a bus 6502. However, any communication medium can be used to facilitate interaction with other components of computing component 6500 or to communicate externally.

Computing component 6500 might also include one or more memory components, simply referred to herein as main memory 6508. For example, random access memory (RAM) or other dynamic memory, might be used for storing information and instructions to be executed by processor 6504. Main memory 6508 might also be used for storing temporary variables or other intermediate information during execution of instructions to be executed by processor 6504. Computing component 6500 might likewise include a read only memory (“ROM”) or other static storage device coupled to bus 6502 for storing static information and instructions for processor 6504.

The computing component 6500 might also include one or more various forms of information storage mechanism 6510, which might include, for example, a media drive 6512 and a storage unit interface 6520. The media drive 6512 might include a drive or other mechanism to support fixed or removable storage media 6514. For example, a hard disk drive, a solid-state drive, a magnetic tape drive, an optical drive, a compact disc (CD) or digital video disc (DVD) drive (R or RW), or other removable or fixed media drive might be provided. Storage media 6514 might include, for example, a hard disk, an integrated circuit assembly, magnetic tape, cartridge, optical disk, a CD or DVD. Storage media 6514 may be any other fixed or removable medium that is read by, written to or accessed by media drive 6512. As these examples illustrate, the storage media 6514 can include a computer usable storage medium having stored therein computer software or data.

In alternative embodiments, information storage mechanism 6510 might include other similar instrumentalities for allowing computer programs or other instructions or data to be loaded into computing component 6500. Such instrumentalities might include, for example, a fixed or removable storage unit 6522 and an interface 6520. Examples of such storage units 6522 and interfaces 6520 can include a program cartridge and cartridge interface, a removable memory (for example, a flash memory or other removable memory component) and memory slot. Other examples may include a PCMCIA slot and card, and other fixed or removable storage units 6522 and interfaces 6520 that allow software and data to be transferred from storage unit 6522 to computing component 6500.

Computing component 6500 might also include a communications interface 6524. Communications interface 6524 might be used to allow software and data to be transferred between computing component 6500 and external devices. Examples of communications interface 6524 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 6524 may be carried on signals, which can be electronic, electromagnetic (which includes optical) or other signals capable of being exchanged by a given communications interface 6524. These signals might be provided to communications interface 6524 via a channel 6528. Channel 6528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 6508, storage unit 6522, media 6514, and channel 6528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 6500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The term “coupled” may be used herein to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). In addition, the terms “first”, “second”, etc. may be used herein only to facilitate discussion, and carry no particular temporal or chronological significance unless otherwise indicated.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A multi-use wireless charging apparatus comprising:
a body configured to be used for one or more purposes other than wireless charging; and
one or more coil repeater assemblies attached to the body;
wherein the one or more coil repeater assemblies are configured to increase inductive flux linkage between an active power supply located proximate the body and receiving inductive coils of one or more devices placed proximate the body.

2. The multi-use wireless charging apparatus of claim 1, wherein the one or more coil repeater assemblies comprise an inductive coil disposed on a surface of the body.

3. The multi-use wireless charging apparatus of claim 2, wherein the inductive coil comprises a conductive ink that is ink-printed onto the surface of the body.

4. The multi-use wireless charging apparatus of claim 2, wherein the inductive coil comprises a conductive material that is 3D-printed onto the surface of the body.

5. The multi-use wireless charging apparatus of claim 1, wherein the one or more coil repeater assemblies comprise:
a substrate comprising an adhesive disposed on a first surface of the substrate, wherein the substrate is attached to a surface of the body via the adhesive;
an inductive coil disposed on a second surface of the substrate or embedded within the substrate; and
one or more tuning capacitors disposed on the second surface of the substrate or embedded within the substrate, wherein the one or more tuning capacitors are electrically connected to each end of the inductive coil.

6. The multi-use wireless charging apparatus of claim 1, wherein the one or more coil repeater assemblies comprise an inductive coil embedded within the body.

7. The multi-use wireless charging apparatus of claim 1, wherein:
the body comprises a flexible fabric; and
the one or more coil repeater assemblies comprise:
a substrate stitched into the flexible fabric of the body;
an inductive coil disposed on a surface of the substrate or embedded within the substrate; and
one or more tuning capacitors disposed on the surface of the substrate or embedded within the substrate, wherein the one or more tuning capacitors are electrically connected to each end of the inductive coil.

8. The multi-use wireless charging apparatus of claim 1, wherein the one or more coil repeater assemblies comprise an inductive coil of wider diameter than a transmitting inductive coil of the active power supply.

9. The multi-use wireless charging apparatus of claim 1, wherein the active power supply is mechanically integrated with the body.

10. The multi-use wireless charging apparatus of claim 1, further comprising a non-inductive magnetic structure attached to the body and positioned to secure the body to a wireless charging interface of the active power supply.

11. The multi-use wireless charging apparatus of claim 10, wherein the non-inductive magnetic structure is positioned to align the one or more coil repeater assemblies with the wireless charging interface of the active power supply when the body is magnetically secured to the wireless charging interface of the active power supply.

12. The multi-use wireless charging apparatus of claim 10, wherein the non-inductive magnetic structure is disposed on an outer surface of the body or embedded within the body.

13. The multi-use wireless charging apparatus of claim 1, wherein an outer surface of the body comprises a recess dimensioned to snugly accommodate a wireless charging interface of the active power supply when the body is placed upon the wireless charging interface of the active power supply.

14. The multi-use wireless charging apparatus of claim 1, wherein the body comprises a cradle dimensioned to receive a first device of the one or more devices.

15. The multi-use wireless charging apparatus of claim 14, wherein the cradle comprises a recess in the body dimensioned to snugly accommodate the first device.

16. The multi-use wireless charging apparatus of claim 14, wherein the cradle comprises one or more structures extending outwards from a mobile device-facing surface of the body.

17. The multi-use wireless charging apparatus of claim 1, wherein a mobile device-facing surface of the body comprises a non-slip surface or a gripping surface.

18. The multi-use wireless charging apparatus of claim 1, further comprising a non-inductive magnetic structure attached to the body and positioned to secure the one or more devices to a mobile device-facing surface of the body.

19. The multi-use wireless charging apparatus of claim 1, wherein the one or more coil repeater assemblies comprise:
an inductive coil comprising turns of a trace bundle;
one or more tuning capacitors electrically connected to each end of the inductive coil; and
the trace bundle comprising traces formed from trace segments electrically interconnected by interlayer connectors, a respective trace comprising electrically interconnected trace segments across multiple layers.

20. The multi-use wireless charging apparatus of claim 1, wherein the one or more coil repeater assemblies comprise an inductive coil comprising:
a first conductor layer comprising first trace segments;
a second conductor layer comprising second trace segments; and
an insulating layer disposed between the first and second conductor layers.

21. The multi-use wireless charging apparatus of claim 20, wherein:
each trace of the formed traces comprises a respective subset of the first trace segments electrically interconnected by a subset of the interlayer connectors to a corresponding subset of the second trace segments such that the interconnected trace segments are woven through and around the insulating layer; and
the traces are formed as a conductive line woven through and around the insulating layer to form the inductive coil.

22. The multi-use wireless charging apparatus of claim 21, wherein the interlayer connectors comprise through vias filled with a conductive material.

23. The multi-use wireless charging apparatus of claim 1, wherein the multi-use wireless charging apparatus comprises a payment card.

24. The multi-use wireless charging apparatus of claim 1, wherein the multi-use wireless charging apparatus comprises a mouse pad.

25. The multi-use wireless charging apparatus of claim 1, wherein the multi-use wireless charging apparatus comprises wireless speakers.

26. The multi-use wireless charging apparatus of claim 1, wherein the multi-use wireless charging apparatus comprises wireless headphones.

27. The multi-use wireless charging apparatus of claim 1, wherein the multi-use wireless charging apparatus comprises an article of clothing.

28. The multi-use wireless charging apparatus of claim 1, wherein the multi-use wireless charging apparatus comprises a storage container and the body comprises a container body, wherein the storage container comprises:
the container body;
a recess defined by walls of the container body; and
the one or more coil repeater assemblies attached to the container body and positioned to increase inductive flux linkage between the active power supply and the receiving inductive coils of the one or more devices when the container body is placed upon the active power supply and the one or more devices are placed within the recess.

29. The multi-use wireless charging apparatus of claim 28, wherein the storage container comprises at least one of:
a purse;
a handbag;
a clutch;
a suitcase;
a toolbox;
a wallet;
a jewelry tray; or
a valet tray.

30. The multi-use wireless charging apparatus of claim 29, wherein the one or more coil repeater assemblies comprise:
a first coil repeater assembly attached to an inner surface of a wall of the container body; and
a second coil repeater attached to an outer wall of the container body opposite the first coil repeater assembly.

31. The multi-use wireless charging apparatus of claim 1, wherein the multi-use wireless charging apparatus comprises furniture and the body comprises a furniture body, wherein the furniture comprises:
the furniture body comprising a mobile device-facing surface; and
the one or more coil repeater assemblies attached to the furniture body and positioned to increase inductive flux between the active power supply located proximate the furniture body and the receiving inductive coils of the one or more devices placed upon the mobile device-facing surface of the furniture body.

32. The multi-use wireless charging apparatus of claim 31, wherein:
the furniture body comprises a drawer; and
the mobile device-facing surface comprises an interior surface of the drawer.

33. The multi-use wireless charging apparatus of claim 31, wherein:
the furniture body comprises a desk or table; and
the mobile device-facing surface comprises an upwards-facing surface of the desk or table.

34. The multi-use wireless charging apparatus of claim 31, wherein:
the furniture body comprises an airplane tray; and
the mobile device-facing surface comprises an upwards-facing surface of the airplane tray.

35. The multi-use wireless charging apparatus of claim 31, wherein:
the furniture body comprises at least one of a chair, a recliner, or a couch; and
the mobile device-facing surface comprises an armrest of the at least one of the chair, the recliner, or the couch.

36. The multi-use wireless charging apparatus of claim 31, wherein a first coil repeater assembly of the one or more coil repeater assemblies is disposed on the mobile device-facing surface of the furniture body or embedded within the furniture body adjacent the mobile device-facing surface of the furniture body.

37. The multi-use wireless charging apparatus of claim 31, wherein the active power supply is mechanically integrated with the furniture body.

38. The multi-use wireless charging apparatus of claim 31, wherein the one or more coil repeater assemblies comprise:
a substrate comprising an adhesive disposed on a first surface of the substrate, wherein the substrate is attached to the mobile device-facing surface of the furniture body via the adhesive;
an inductive coil disposed on a second surface of the substrate or embedded within the substrate; and
one or more tuning capacitors disposed on the second surface of the substrate or embedded within the substrate, wherein the one or more tuning capacitors are electrically connected to each end of the inductive coil.

39. The multi-use wireless charging apparatus of claim 31, wherein:
the active power supply comprises a transmitting inductive coil embedded within the furniture body; and
the one or more coil repeater assemblies comprise an inductive coil embedded within the furniture body between the transmitting inductive coil and the mobile device-facing surface of the furniture body.

40. An apparatus comprising:
a body dimensioned to fit snugly upon a transmitting wireless charging interface disposed within an interior of a vehicle; and
one or more coil repeater assemblies attached to the body;
wherein the one or more coil repeater assemblies are configured to increase inductive flux linkage between the transmitting wireless charging interface and a receiving wireless charging interface of a mobile device placed upon the body.

41. The apparatus of claim 40, wherein:
the transmitting wireless charging interface is disposed within a recess of a console of the vehicle; and
the body is dimensioned to fit snugly within the recess of the console when the body is placed upon the transmitting wireless charging interface.

42. The apparatus of claim 40, wherein:
the transmitting wireless charging interface comprises a raised wireless charging pad disposed within the interior of the vehicle; and
the body comprises a recess on a transmitting wireless charging interface-facing surface of the body, wherein the recess is dimensioned to snugly accommodate the raised wireless charging pad when the body is placed upon the raised wireless charging pad.

43. The apparatus of claim 40, wherein the one or more coil repeater assemblies comprise an inductive coil positioned to radially align with the transmitting wireless charging interface when the body is fit snugly upon the transmitting wireless charging interface.

44. The apparatus of claim 43, wherein the inductive coil has a wider diameter than an inductive coil associated with the transmitting wireless charging interface.

45. The apparatus of claim 40, further comprising a non-inductive magnetic structure attached to the body and positioned to secure the body to the transmitting wireless charging interface.

46. The apparatus of claim 45, wherein the non-inductive magnetic structure is disposed on a transmitting wireless charging interface-facing surface of the body or embedded within the body.

47. The apparatus of claim 40, wherein the body comprises a cradle dimensioned to receive the mobile device.

48. The apparatus of claim 47, wherein the cradle comprises a recess in the body dimensioned to snugly accommodate the mobile device.

49. The apparatus of claim 47, wherein the cradle comprises one or more structures extending outwards from the body.

50. The apparatus of claim 40, wherein a mobile device-facing surface of the body comprises a non-slip surface or a gripping surface.

51. The apparatus of claim 40, further comprising a non-inductive magnetic structure attached to the body and positioned to secure the mobile device to the body.

52. The apparatus of claim 40, wherein the body comprises:
a first surface for receiving the mobile device; and
a second surface for receiving a second mobile device;
wherein the one or more coil repeater assemblies are positioned to increase inductive flux linkage between the transmitting wireless charging interface and each of the mobile device and the second mobile device when the mobile device and the second mobile device are received on the first and second surfaces of the body respectively.

53. The apparatus of claim 40, wherein the one or more coil repeater assemblies comprise:
an inductive coil comprising turns of a trace bundle;
one or more tuning capacitors electrically connected to each end of the inductive coil; and
the trace bundle comprising traces formed from trace segments electrically interconnected by interlayer connectors, a respective trace comprising electrically interconnected trace segments across multiple layers.

54. The apparatus of claim 40, wherein the one or more coil repeater assemblies comprise an inductive coil comprising:
a first conductor layer comprising first trace segments;
a second conductor layer comprising second trace segments; and
an insulating layer disposed between the first and second conductor layers.

55. The apparatus of claim 54, wherein:
each trace of the formed traces comprises a respective subset of the first trace segments electrically interconnected by a subset of the interlayer connectors to a corresponding subset of the second trace segments such that the interconnected trace segments are woven through and around the insulating layer; and
the traces are formed as a conductive line woven through and around the insulating layer to form the inductive coil.

56. The apparatus of claim 55, wherein the interlayer connectors comprise through vias filled with a conductive material.

57. A method of constructing an apparatus for wireless charging, the method comprising:
forming a coil repeater assembly comprising:
a substrate;
an inductive coil disposed on a surface of the substrate or embedded within the substrate; and
one or more tuning capacitors disposed on the surface of the substrate or embedded within the substrate; and
attaching the coil repeater assembly to a body of the apparatus.

58. The method of claim 57, wherein:
the coil repeater assembly further comprises an adhesive disposed on a second surface of the substrate opposite the first surface; and
attaching the coil repeater assembly to the body of the apparatus comprises attaching the coil repeater assembly to the body of the apparatus via the adhesive.

59. The method of claim 57, wherein:
the body of the apparatus comprises a flexible fabric; and
attaching the coil repeater assembly to the body of the apparatus comprises stitching the substrate to the body of the apparatus.

60. The method of claim 59, wherein the body of the apparatus comprises at least one of:
an article of clothing;
a wallet;
a purse;
a handbag;
a clutch; and
a suitcase.

61. The method of claim 57, wherein attaching the coil repeater assembly to the body of the apparatus comprises embedding the coil repeater assembly within the body of the apparatus.

62. The method of claim 61, wherein embedding the coil repeater assembly within the body of the apparatus comprises:
printing the coil repeater assembly onto a temporary construction surface of the body of the apparatus; and
adding additional material to the body of the apparatus to cover the coil repeater assembly and the temporary construction surface of the body of the apparatus.

63. The method of claim 62, wherein printing the coil repeater assembly onto the temporary construction surface of the body of the apparatus comprises:
using conductive ink to print the coil repeater assembly onto the temporary construction surface of the body of the apparatus.

64. The method of claim 62, wherein printing the coil repeater assembly onto the temporary construction surface of the body of the apparatus comprises:
3D printing layers of conductive material to form the coil repeater assembly onto the temporary construction surface of the body of the apparatus.

65. The method of claim 57, wherein attaching the coil repeater assembly to the body of the apparatus comprises printing the coil repeater assembly onto a surface of the body of the apparatus.

66. The method of claim 65, wherein printing the coil repeater assembly onto the surface of the body of the apparatus comprises:
using conductive ink to print the coil repeater assembly onto the surface of the body of the apparatus.

67. The method of claim 65, wherein printing the coil repeater assembly onto the surface of the body of the apparatus comprises:
3D printing layers of conductive material to form the coil repeater assembly onto the surface of the body of the apparatus.
